(19) United States
(12) Patent Application Publication
(10) Pub. No.: US 2024/0127265 A1
(43) Pub. Date: Apr. 18, 2024

(54) SYSTEM TO GENERATE SUPPLEMENT OR NUTRITIONAL FACT PANELS AND LABEL WARNINGS FOR PERSONALIZED NUTRITION PRODUCTS

(71) Applicant: Ok Capsule, Inc., Reno, NV (US)

(72) Inventors: Noah Austin, Mill Valley, CA (US); Stephen Ludin, Mill Valley, CA (US)

(21) Appl. No.: 18/487,282

(22) Filed: Oct. 16, 2023

Related U.S. Application Data
(60) Provisional application No. 63/379,497, filed on Oct. 14, 2022.

(51) Int. Cl. G06Q 30/018; B31D 1/02; B65B 59/00; B65B 61/26; G06Q 10/087

(52) U.S. Cl. CPC G06Q 30/018; B31D 1/027; B65B 59/001; B65B 59/003; B65B 61/26; G06Q 10/087; G06K 15/024

(57) ABSTRACT

Provided herein are systems and methods for generate Supplement Fact Panels and label warnings for personalized nutrition products.

### CROSS-REFERENCE TO RELATED APPLICATIONS

The present application claims priority to U.S. provisional application Ser. No. 63/379,497, filed Oct. 14, 2022, which is herein incorporated by reference its entirety.

### BACKGROUND

The invention relates to the production of state and federally mandated nutritional information documents and label information, including warnings specifically for unique, personalized packaged food or medicinal products intended for consumption by a single, named individual or for personalized fact panels as well as standard, mass produced panels.

The current method and process for generating supplement fact panels assumes a one-to-many model: One fact panel is applicable to many consumers. In the emerging personalized nutrition market, one fact panel may only be applicable to a single consumer. The current system is wholly incompatible with this emerging personalized nutrition market. Offering every consumer the exact same serving size defeats the primary purpose of tailored nutrition products, and prevents consumers from understanding exactly what they are taking, which is the very purpose of the mandated fact panels.

At market scale, it becomes economically infeasible to create individual fact panels using current, manual systems. The process cannot be automated without the ability to receive dynamic lists of ingredients and variable serving sizes.

The present invention attempts to solve these problems, as well as others.

### SUMMARY OF THE INVENTION

Provided herein are systems and methods to generate Supplement or Nutritional Fact Panels and label warnings for personalized nutrition products.

The methods and systems are set forth in part in the description which follows, and in part will be obvious from the description, or can be learned by practice of the methods and systems. The advantages of the methods and systems will be realized and attained by means of the elements and combinations particularly pointed out in the appended claims. It is to be understood that both the foregoing general description and the following detailed description are exemplary and explanatory only and are not restrictive of the methods and systems, as claimed.

Accordingly, it is an object of the invention not to encompass within the invention any previously known product, process of making the product, or method of using the product such that Applicants reserve the right and hereby disclose a disclaimer of any previously known product, process, or method. It is further noted that the invention does not intend to encompass within the scope of the invention any product, process, or making of the product or method of using the product, which does not meet the written description and enablement requirements of the USPTO (35 U.S.C. § 112, first paragraph) or the EPO (Article 83 of the EPC), such that Applicants reserve the right and hereby disclose a disclaimer of any previously described product, process of making the product, or method of using the product. It may be advantageous in the practice of the invention to be in compliance with Art. 53(c) EPC and Rule 28(b) and (c) EPC. All rights to explicitly disclaim any embodiments that are the subject of any granted patent(s) of applicant in the lineage of this application or in any other lineage or in any prior filed application of any third party is explicitly reserved. Nothing herein is to be construed as a promise.

### BRIEF DESCRIPTION OF THE DRAWINGS

In the accompanying figures, like elements are identified by like reference numerals among the several preferred embodiments of the present invention.

FIG. 1 is a schematic flow chart for the nutritional and supplement warning label system and method, according to one embodiment.

FIGS. 2A-2B are fact panels for two separate products, the food-based multi-iron fact panel and the stress B complex fact panel.

FIGS. 3A-3B are fact panels for the food-based multi-iron fact panel and the stress B complex fact panel 1, except both products have a serving size of 2.

FIGS. 4A-4B are fact panels for the food-based multi-iron fact panel and the stress B complex fact panel as a “consolidated” version where all ingredients for all supplements included in a single pack are combined into a single fact panel.

FIG. 5 is table of all the ingredients and supplements used in the nutritional and supplement warning label system and method, according to one embodiment.

### DETAILED DESCRIPTION OF THE INVENTION

The foregoing and other features and advantages of the invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof.

Embodiments of the invention will now be described with reference to the Figures, wherein like numerals reflect like elements throughout. The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

The use of the terms “a” and “an” and “the” and similar referents in the context of describing the invention are to be construed to cover both the singular and the plural, unless otherwise indicated herein or clearly contradicted by context. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Recitation of ranges of values herein are merely intended to serve as a shorthand method of referring individually to each separate value falling within the range, unless otherwise indicated herein, and each separate value is incorporated into the specification as if it were individually recited herein. The word “about,” when accompanying a numerical value, is to be construed as indicating a deviation of up to and inclusive of 10% from the stated numerical value. The use of any and all examples, or exemplary language (“e.g.” or “such as”) provided herein, is intended merely to better illuminate the invention and does not pose a limitation on the scope of the invention unless otherwise claimed. No language in the specification should be construed as indicating any nonclaimed element as essential to the practice of the invention.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### DESCRIPTION OF EMBODIMENTS

The nutritional and supplement warning label system and method relates to the production of state and federally mandated nutritional information documents and label information, including warnings specifically for unique, personalized packaged food, or general food products, or medicinal products intended for consumption by a single individual or multiple individuals.

When a personalized supplement order is placed, the supplements and serving sizes are variable. Due to the variation in serving size for each product, the amount of any ingredient per serving also varies. This causes the percent of daily allowance to also be variable. In contrast, the conventional labeling applies to a single bottle that is all of the same product, and the serving size, and amounts per serving are dictated in advance based on standard inputs such as a fixed serving size.

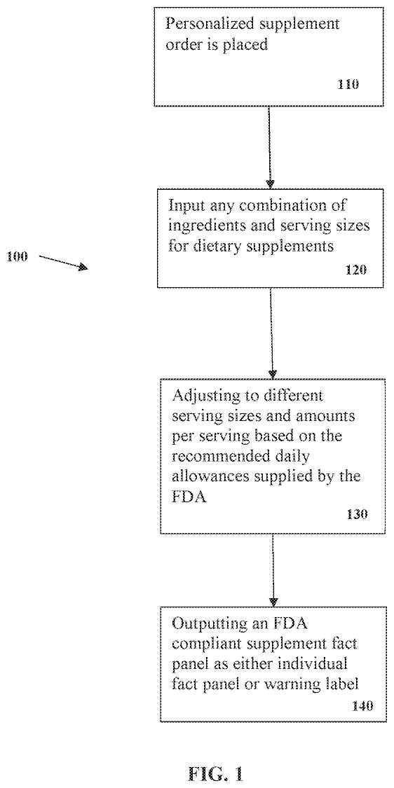

As shown in FIG. 1, the nutritional and supplement warning label system and method 100 comprises placing a personalized supplement order 110, inputting any combination of ingredients and serving sizes for dietary supplements 120, adjusting to different serving sizes and amounts per serving based on FDA recommended daily allowances 130, and outputting an FDA compliant supplement fact panel as either individual fact panels or combined fact panels, a combined “pack-based” fact panel, or warning label 140. In one embodiment, the method comprises creating a SFP in different compliant formats based on packaging size. The Amount Per Serving is calculated for each supplement, then the values are summed and consolidated to produce a fact panel for the entire pack instead of for each supplement product. In one embodiment, custom serving sizes may be employed where a standard is overridden by the client on the formulary, and can also be further overridden by the consumer/practitioner at the individual order level.

The nutritional and supplement warning label system and method allows nutrition to be personalized for each individual. In so doing, the fact panel adjusts to different serving sizes and the amounts per serving based on the recommended daily allowances supplied by the FDA, according to one embodiment. In another embodiment, the only relation daily allowances is in the percentage display based on the ingredient amount and serving size combination.

The nutritional and supplement warning label system and method may operate modules or software from an Application Program Interface (API) endpoint, according to one embodiment. In other embodiments, the nutritional and supplement warning label system and method could operate in alternative platforms or modules including a desktop computer, a stand-alone web page, QR code implementation, a kiosk at a store, on a cell phone or tablet, or combinations thereof. API access to the system is used in a machine automated order system, according to one embodiment.

The nutritional and supplement warning label system and method comprises a plurality of attributes or functional inputs and outputs. The nutritional and supplement warning label system and method comprises an input any ingredient or combination thereof, an input any product for which ingredient information is available, an input of any combination of products for which ingredient information is available, an input barcode scans on the manufacturing floor to print all required information, output could include a QR code that encodes all the fact panel information in one of a variety of formats, or a specific data format such as JSON, an output compliant nutritional labels or “fact panels” and applicable warnings based on the inputs, an output separated or combined pack-based labels, an output information to any printing press or label printer, a validation individual ingredients against state or federally mandated amounts, or a calculation of ingredient amounts and percent daily values based on individualized or variable serving sizes.

The serving size depends on the product in which the ingredient is included. The product, which is an amalgam of ingredients, has a serving size. Serving sizes for each product are not regulated by the FDA. The display of the ingredients according to the chosen serving size is regulated by the FDA.

The nutritional and supplement warning label system and method comprises an internally orchestrated software component of a comprehensive order processing system for personalized nutrition products. The nutritional and supplement warning label system and method comprises an Application Programming Interface endpoint that outputs Documents, images and/or data for a supplement fact panel. The nutritional and supplement warning label system and method comprises operating through an API endpoint enabling process automation, according to one embodiment. In another embodiment, nutritional and supplement warning label system and method comprises operating through a standalone application running on a compute device such as desktop computer, phone, tablet, watch, or the like.

The nutritional and supplement warning label system and method accepts serving size as a variable, floating point number parameter instead of a predefined integer.

The nutritional and supplement warning label system and method outputs an FDA compliant Supplement Fact Panel or nutritional fact panel for any food product.

The nutritional and supplement warning label system and method outputs an FDA Nutrition Fact Panel.

The nutritional and supplement warning label system and method operates through an API endpoint enabling process automation and orchestration.

The nutritional and supplement warning label system and method developed a REST API endpoint that accesses the fact panel generation software. This API endpoint is incorporated into an automated order validation and processing system:

The nutritional and supplement warning label system and method accepts a floating point or integer for serving size.

The nutritional and supplement warning label system and method includes ability to provide both whole and fractional serving sizes creates the ability to tailor nutrition to an individual based on a body measurement such as weight, body mass index, blood sugar concentrations, or others. This level of precision is unachievable in current systems.

The nutritional and supplement warning label system and method outputs a Supplement Fact Panel.

The output of the nutritional and supplement warning label system and method is a compliant, consumer facing Supplement Fact Panel (SFP). The supplement fact panel is a mandated portion of packaging for ingestible products. In contrast, existing systems output nutritional information, but not an FDA compliant document. Generally, the values retired by current solutions are manually added to a label, and then multiple humans verify the information.

The nutritional and supplement warning label system and method calculates and verifies the values automatically. The fact panels for an order are machine generated in an overnight process, however they could be generated in real time as well.

The nutritional and supplement warning label system and method comprises submitting a serving size, and a list of ingredients and their respective quantities. The list of ingredients can include duplicate ingredients whose amounts will be summed, or be de-duplicated.

The nutritional and supplement warning label system and method can group same ingredients.

The nutritional and supplement warning label system and method calculates the amounts present for each ingredient.

The nutritional and supplement warning label system and method verifies that none of the amounts exceed safety or legal limits.

The nutritional and supplement warning label system and method can validate any requirements prior to outputting a label.

In other embodiment, the nutritional and supplement warning label system and method could be practiced as a standalone system on a desktop computer.

The nutritional and supplement warning label system and method could be practiced on a portable device.

The nutritional and supplement warning label system and method could be practiced by scanning a barcode and referencing a standard database of products or product constituents.

The alternative embodiments include methods and systems to include additional features related to the ability to incorporate the generated fact panels into other content, and smarter handling of content within the brochure.

Ingredients

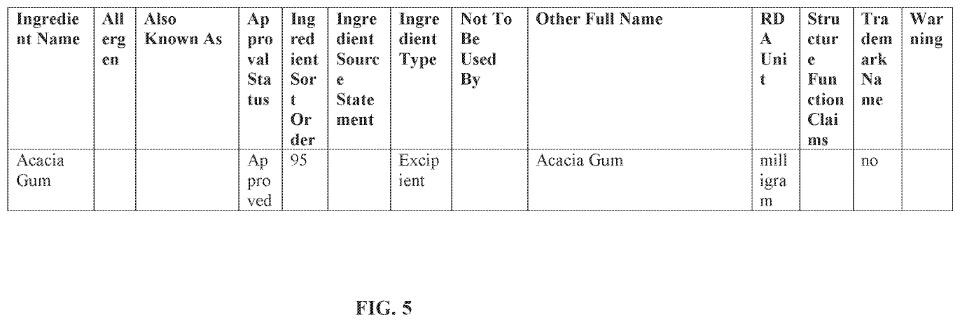

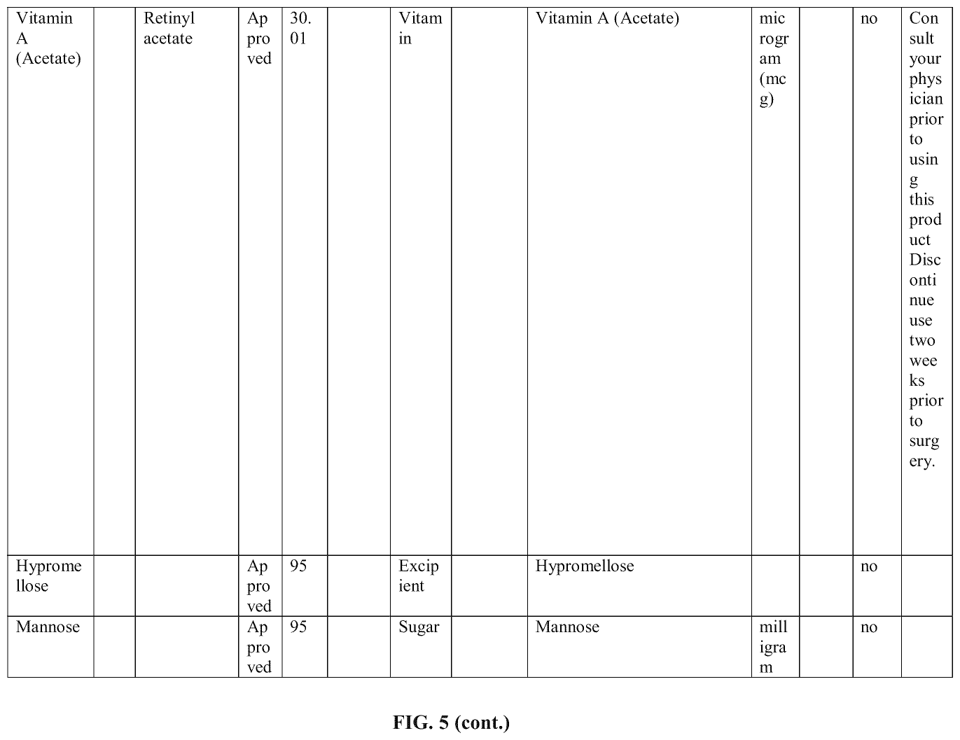

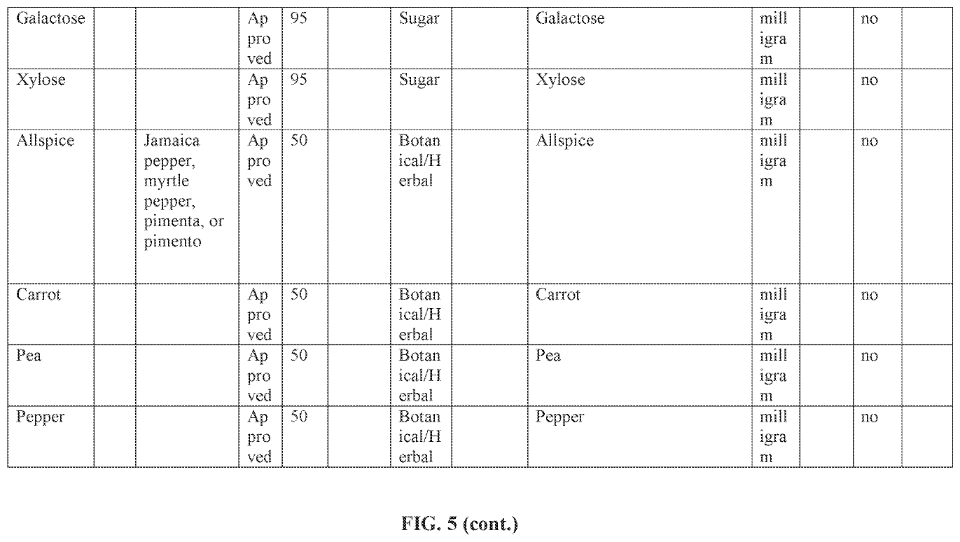

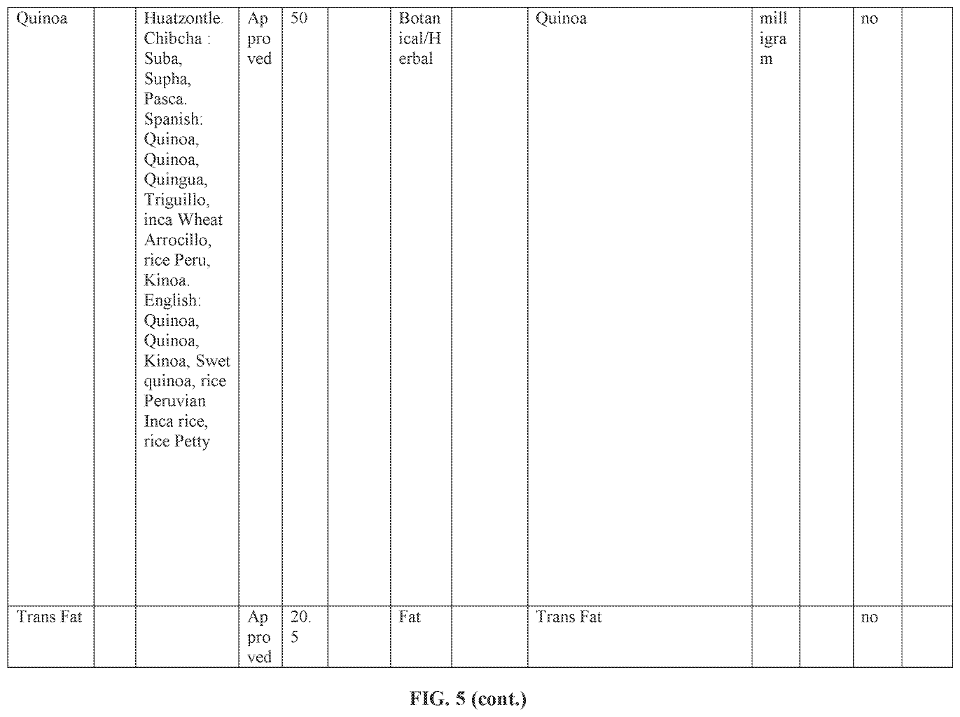

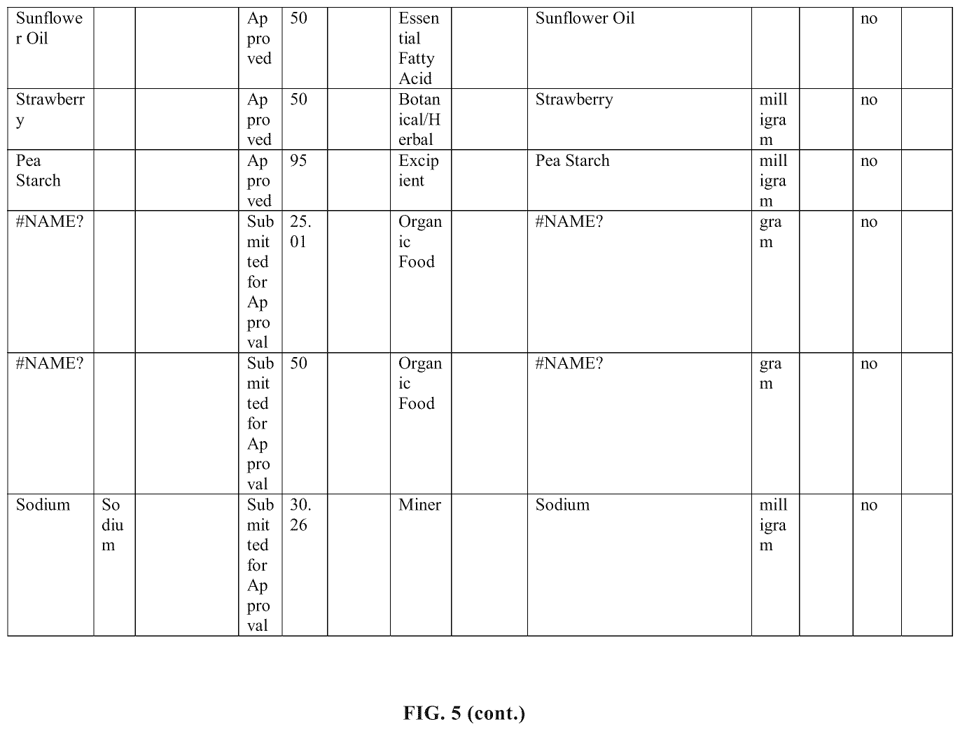

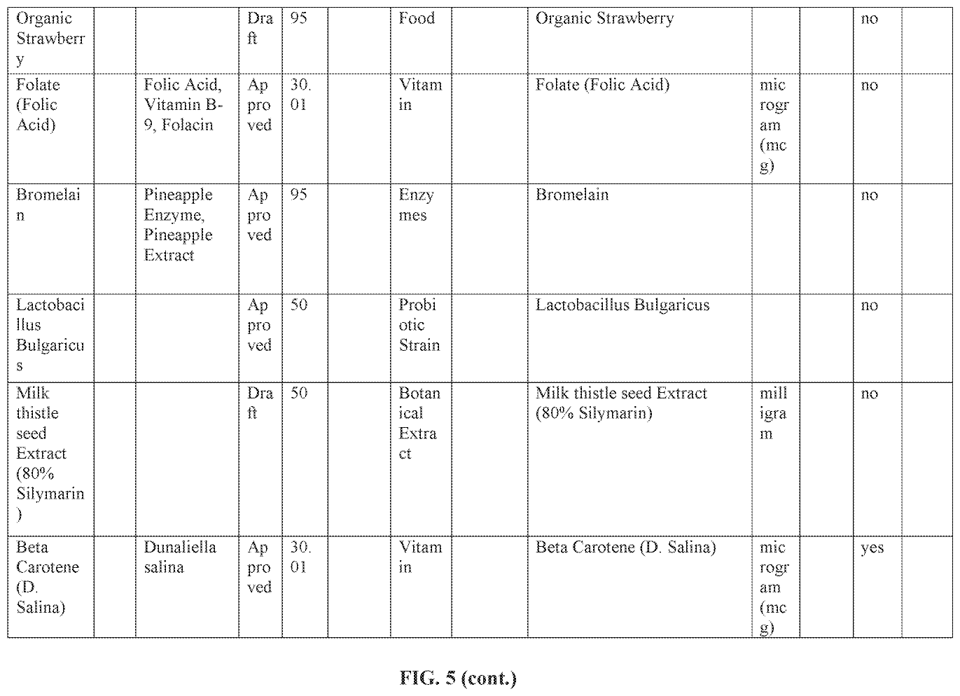

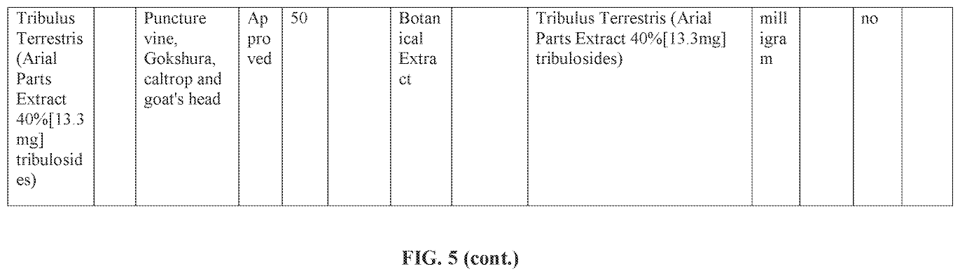

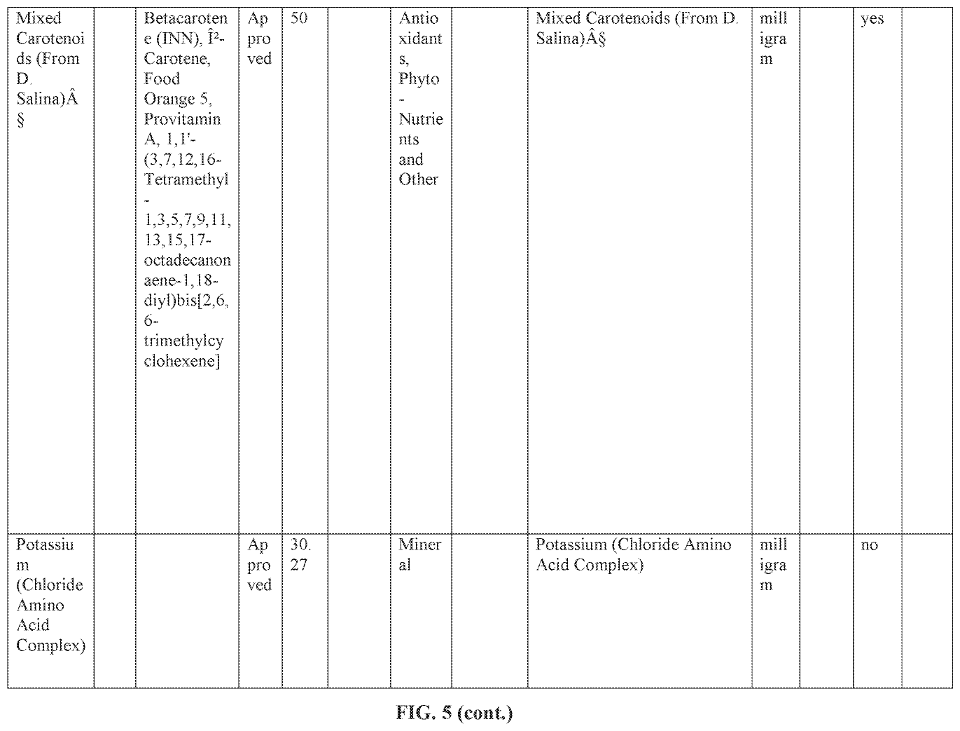

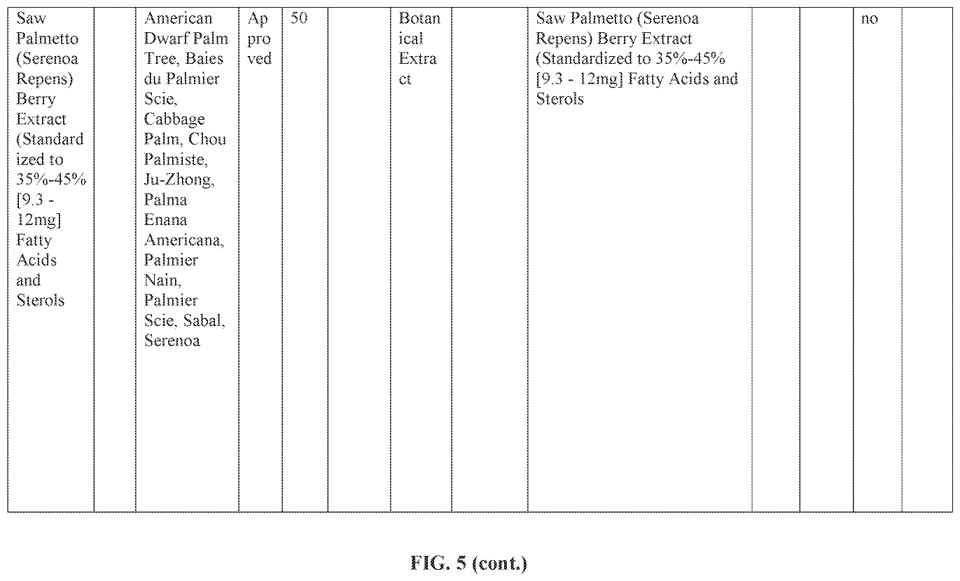

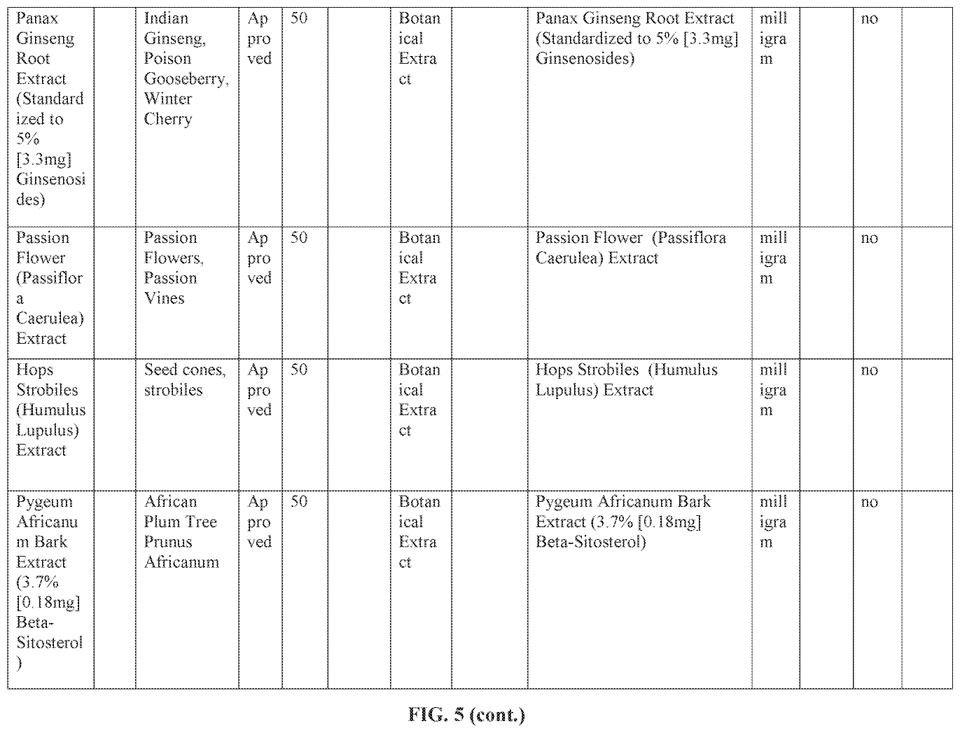

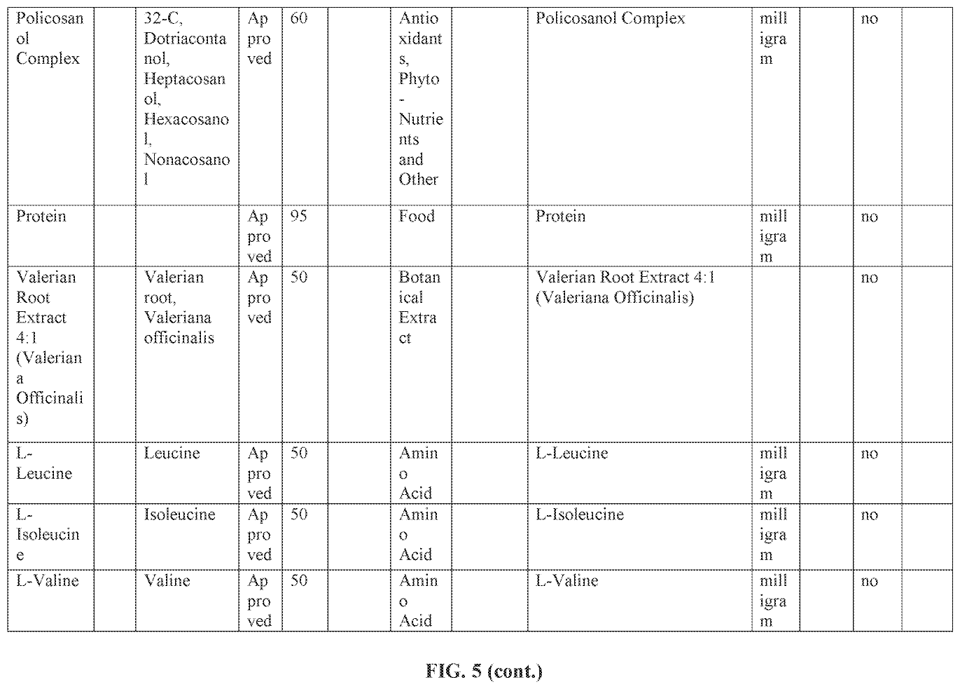

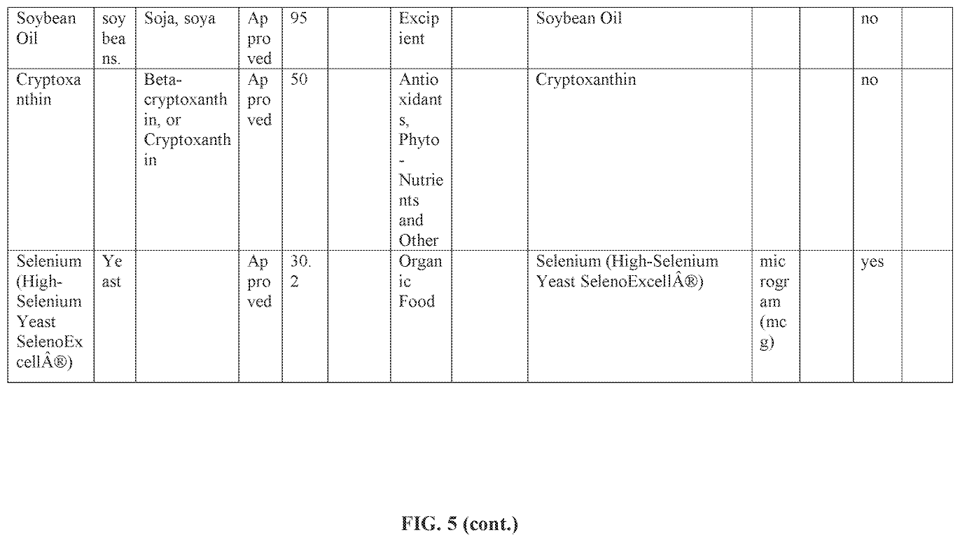

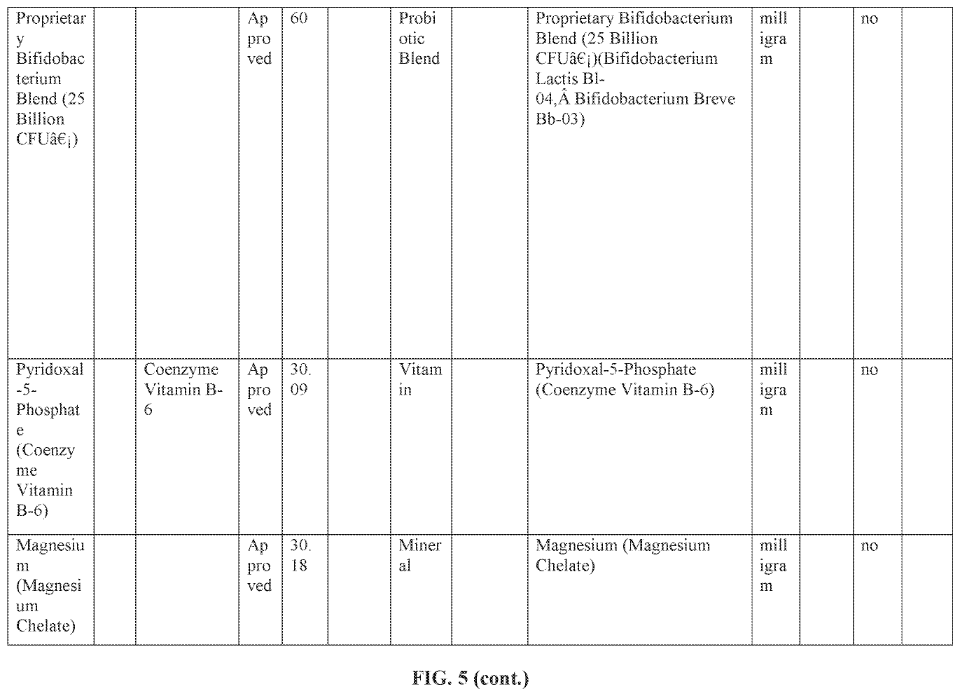

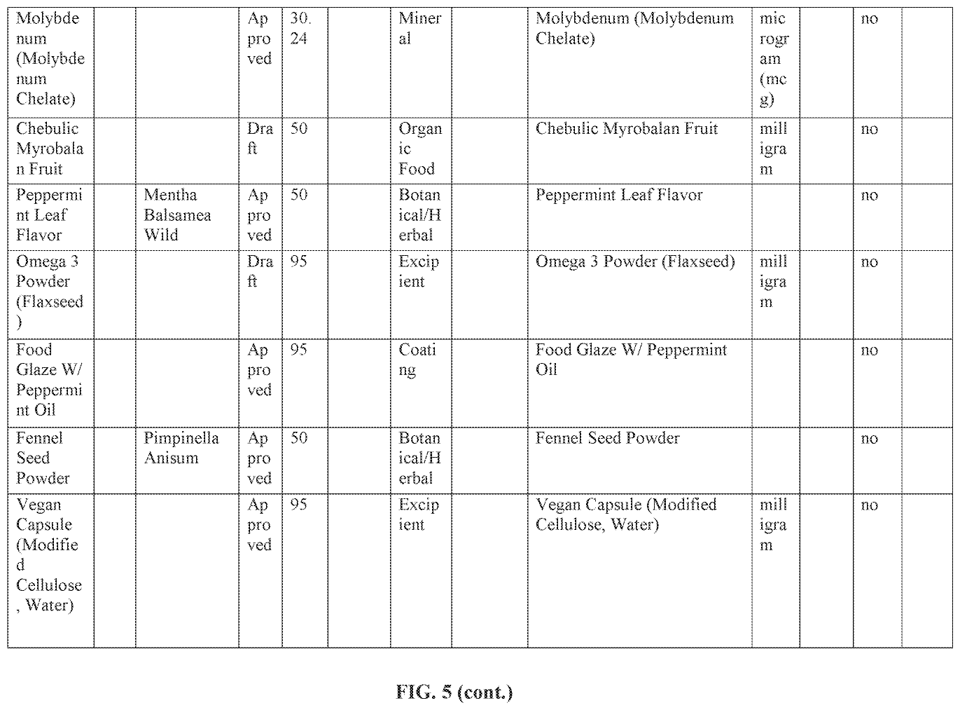

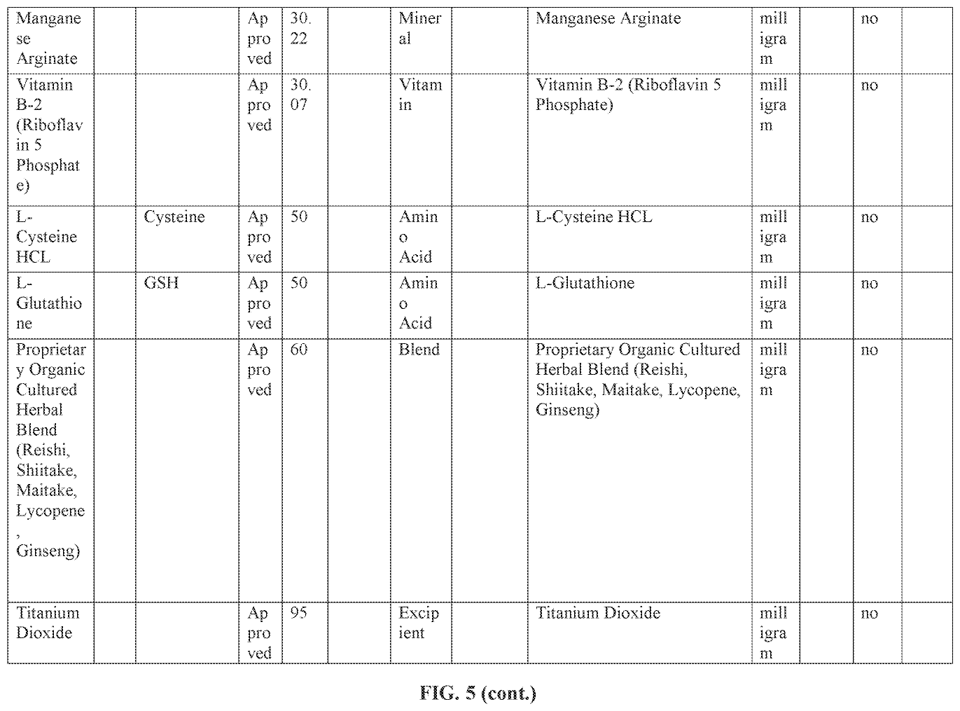

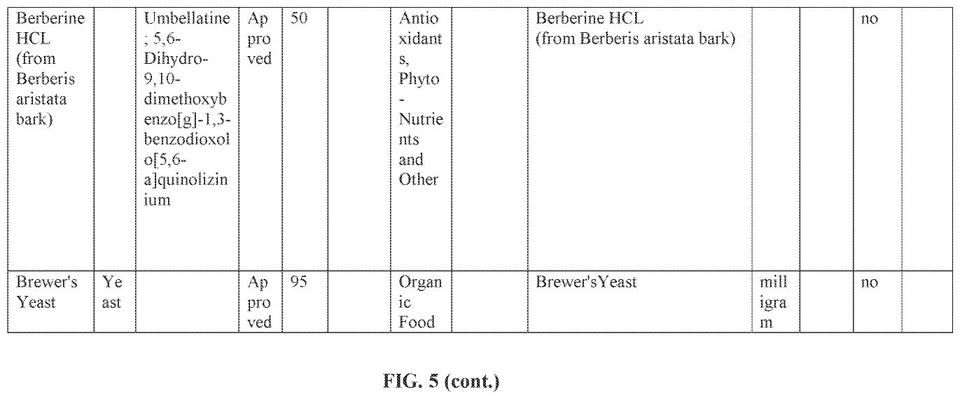

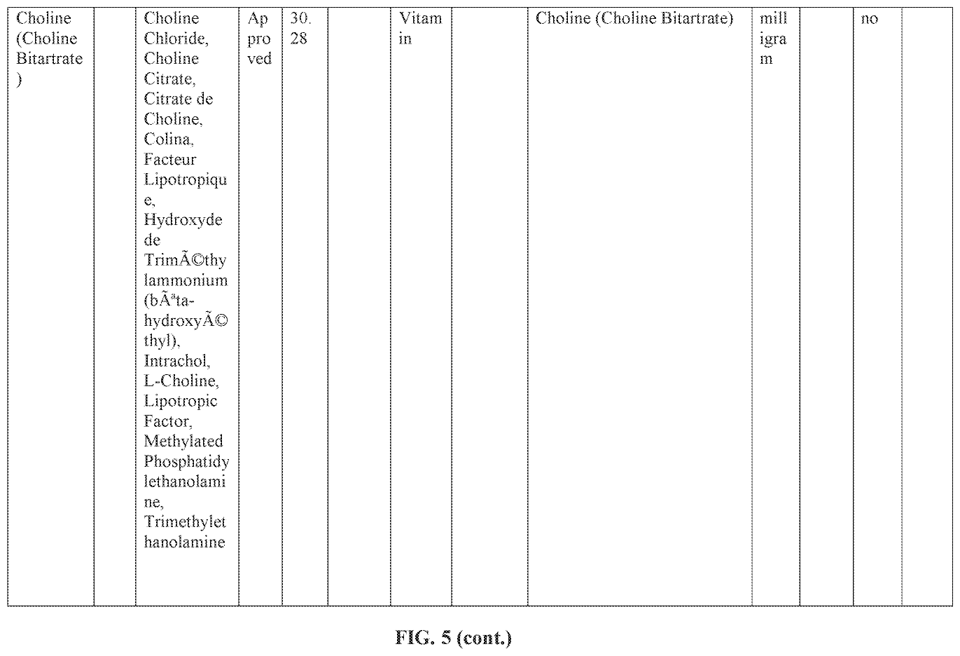

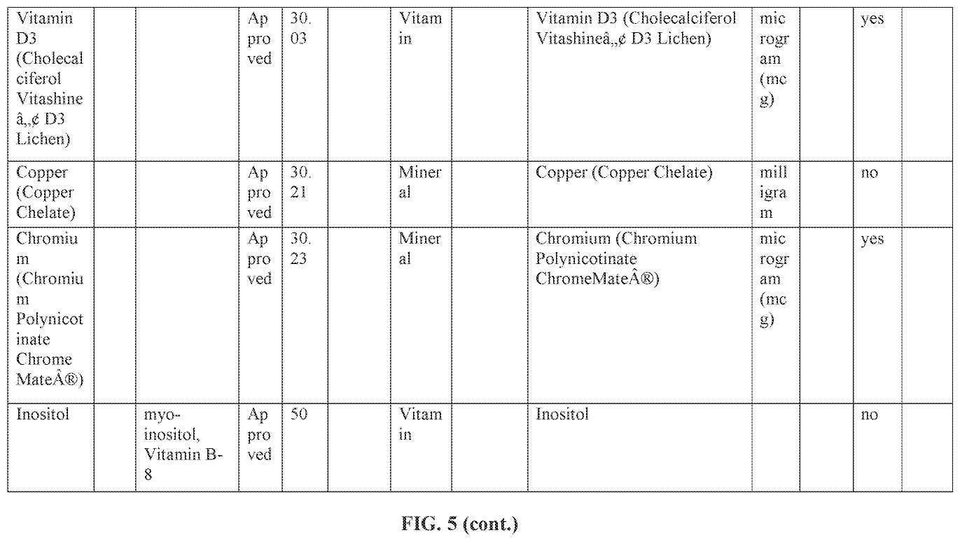

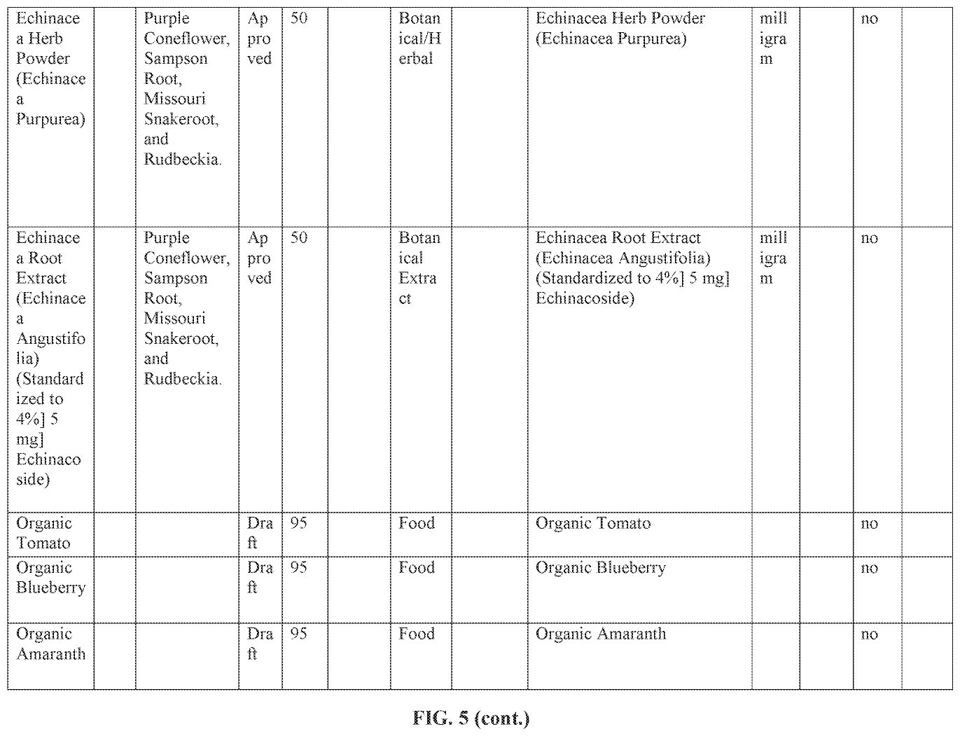

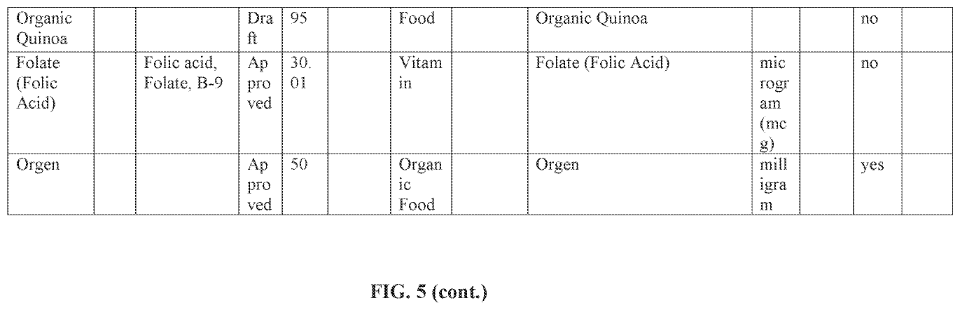

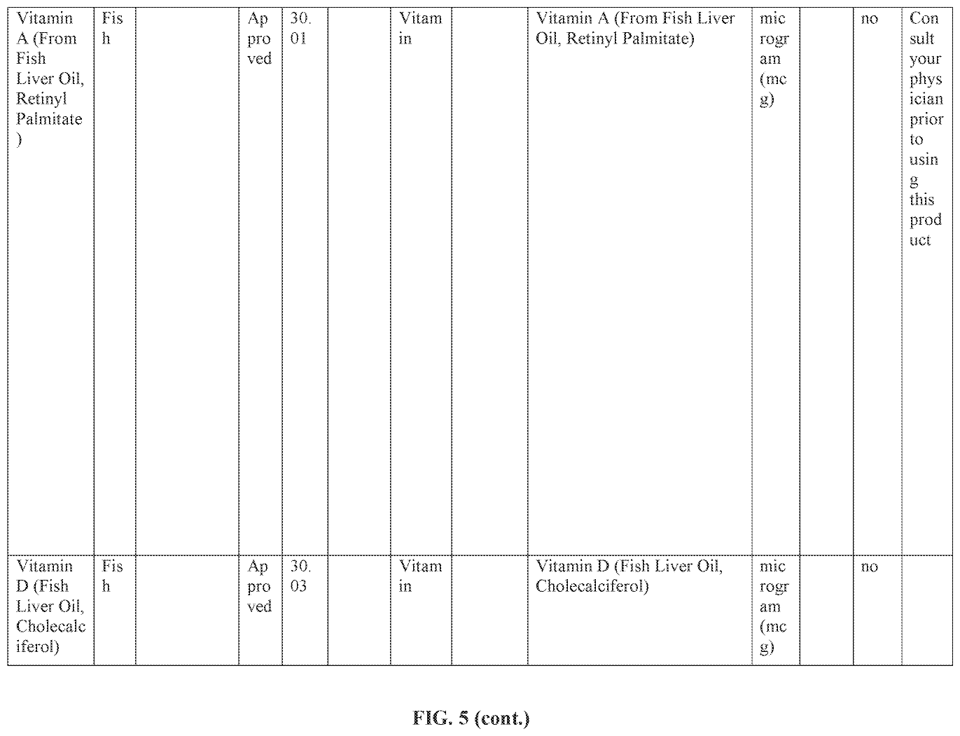

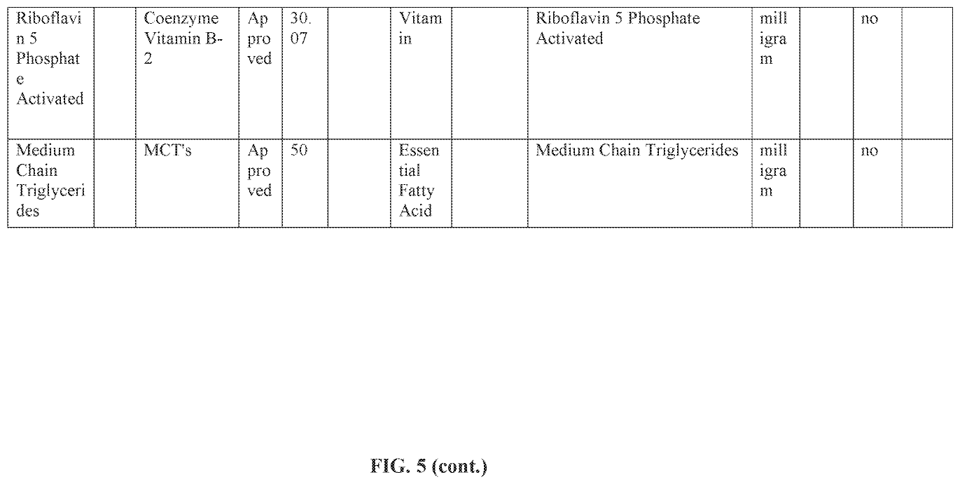

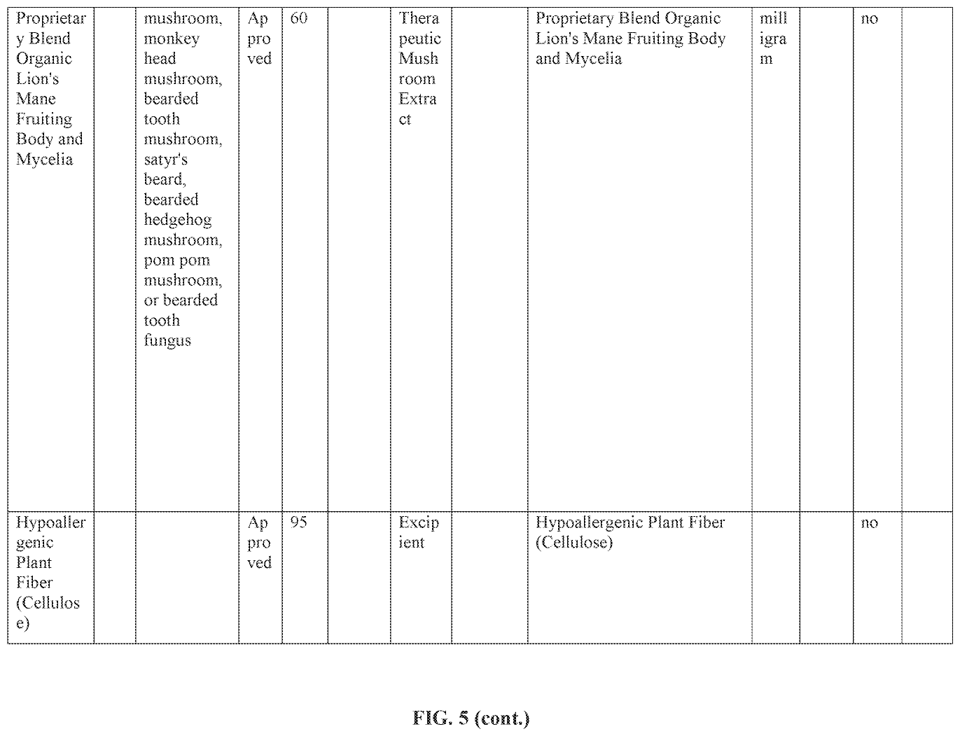

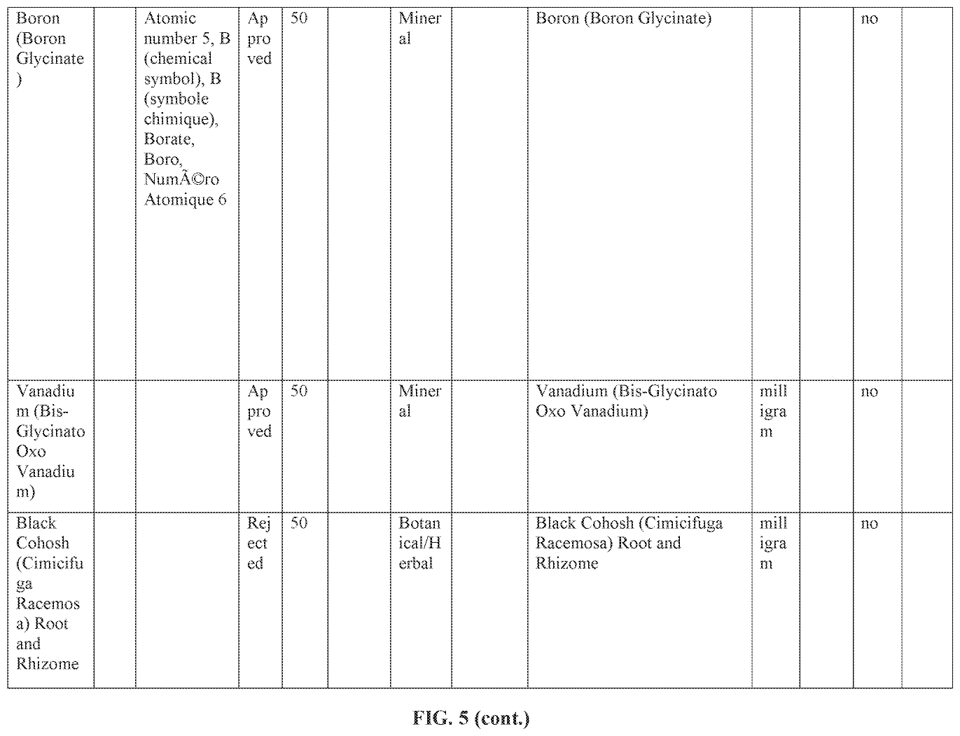

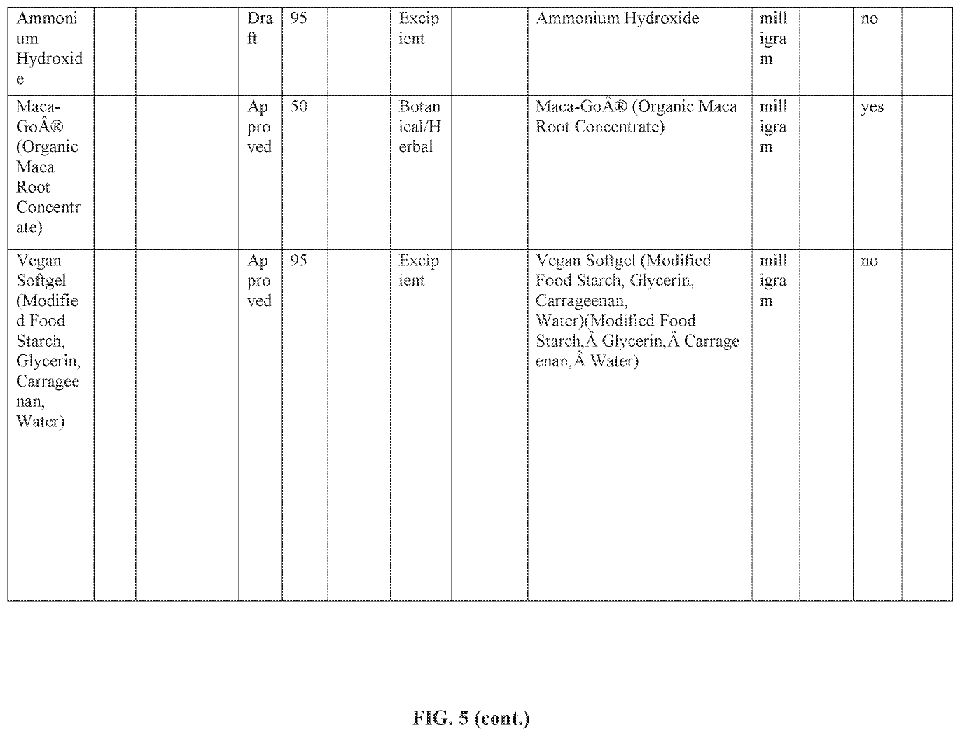

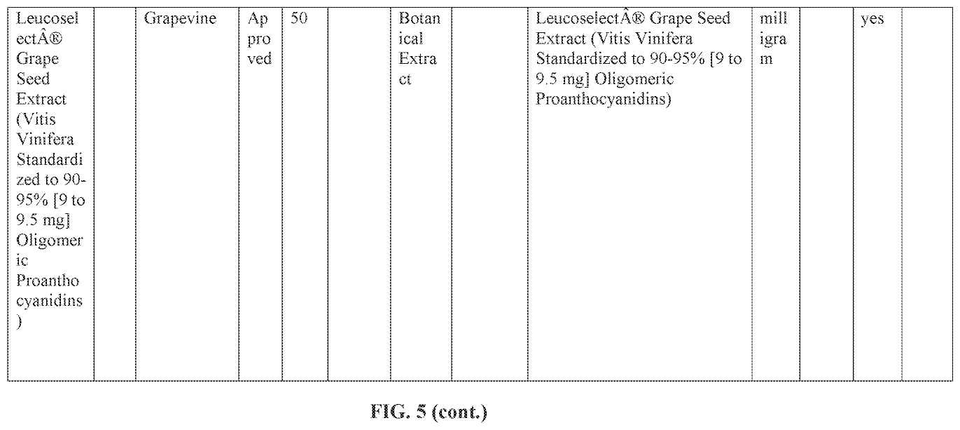

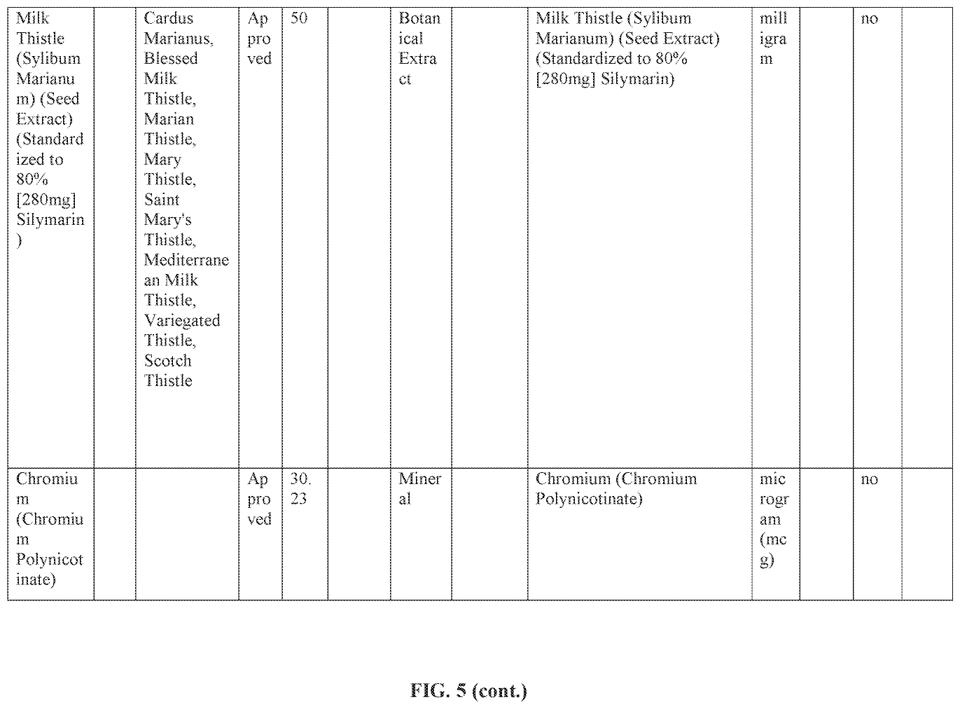

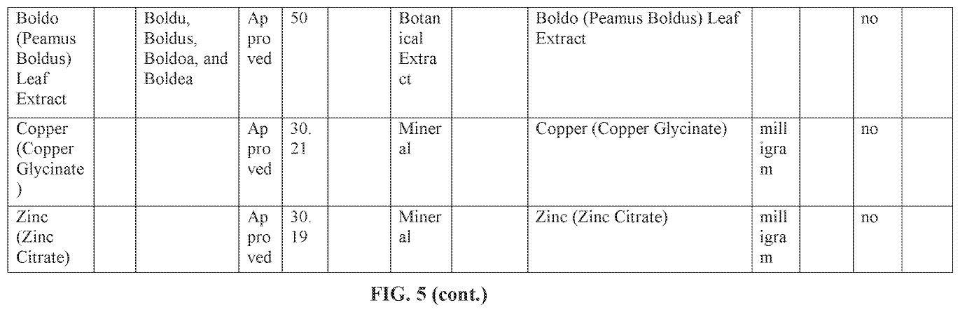

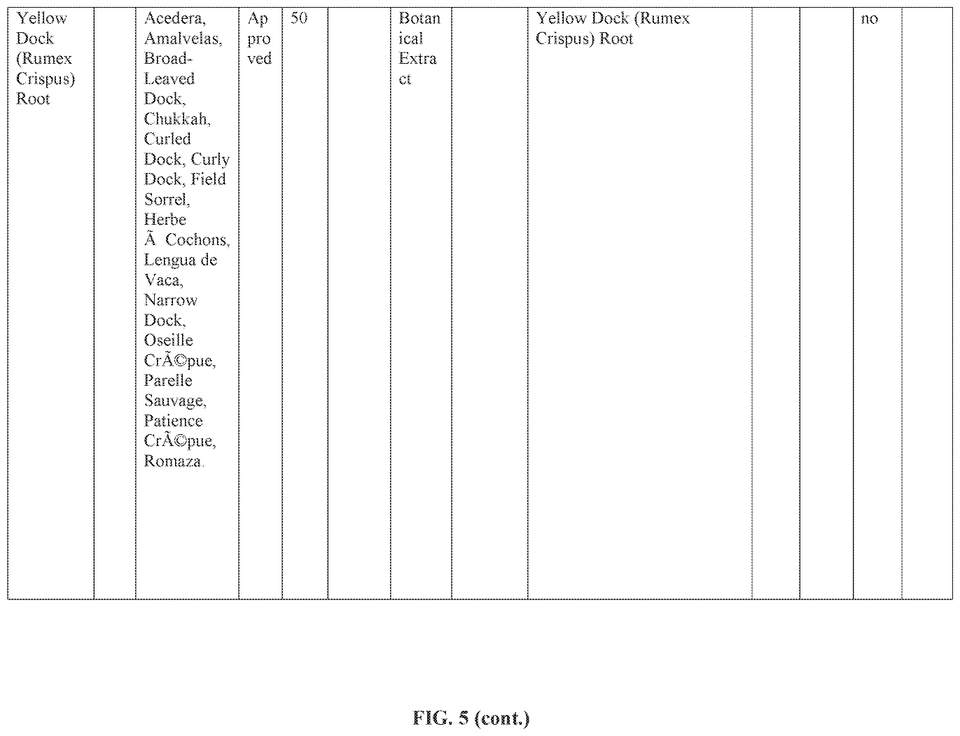

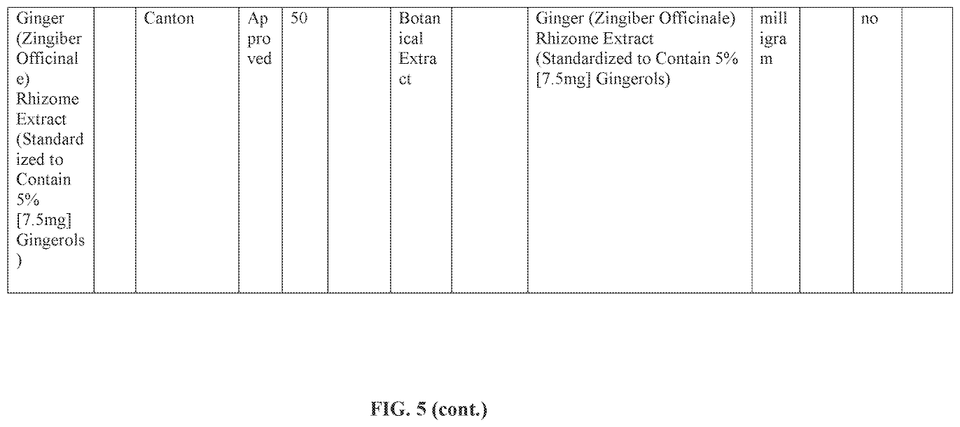

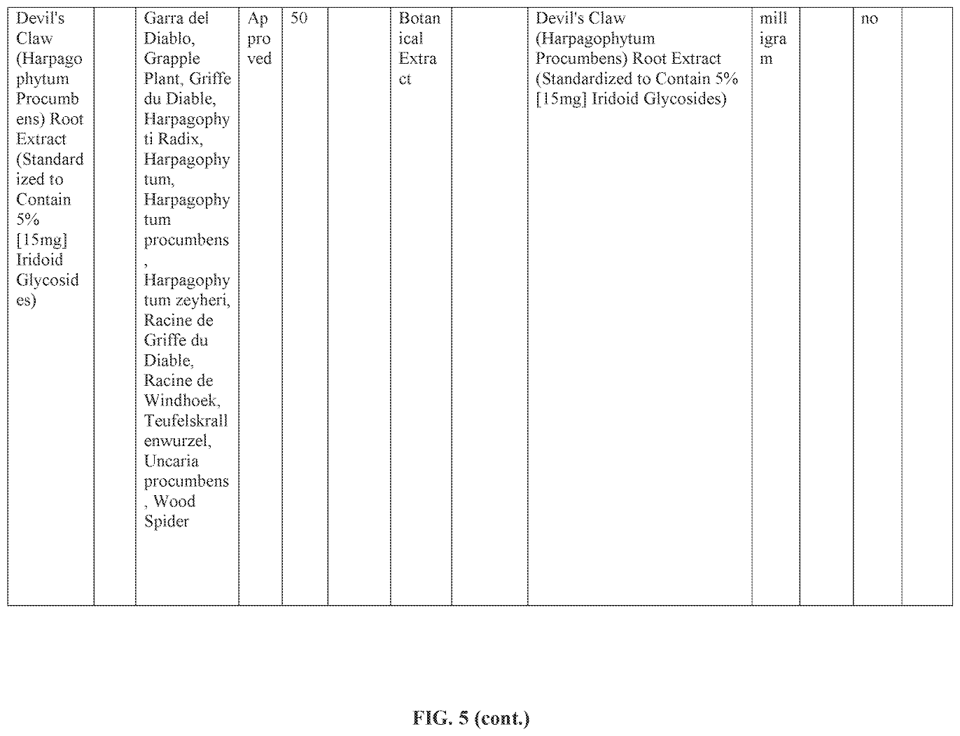

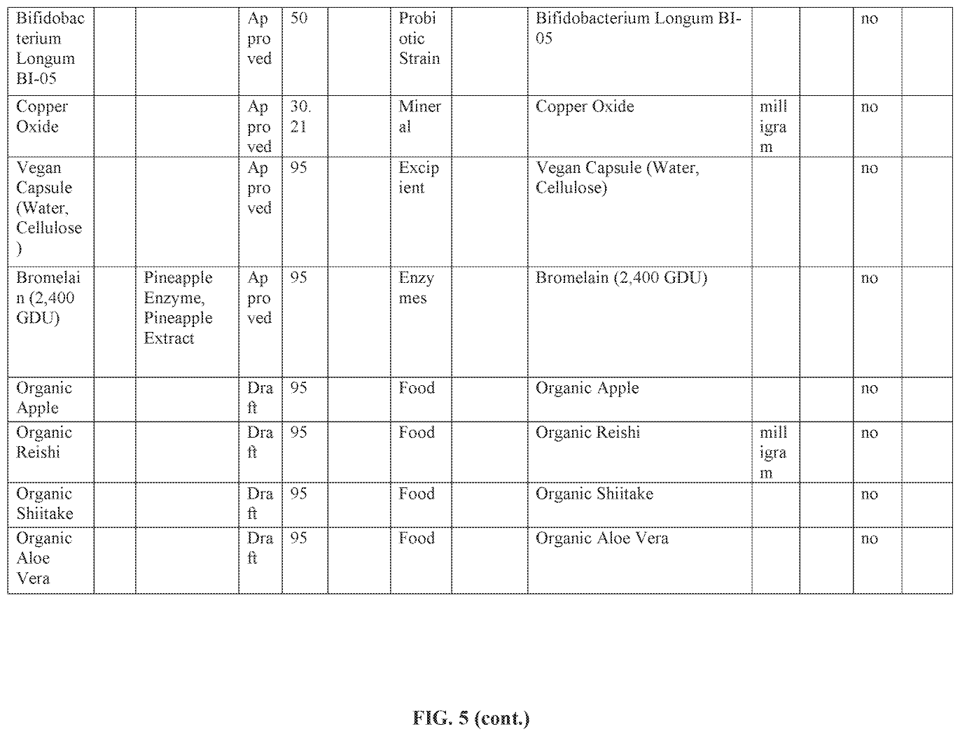

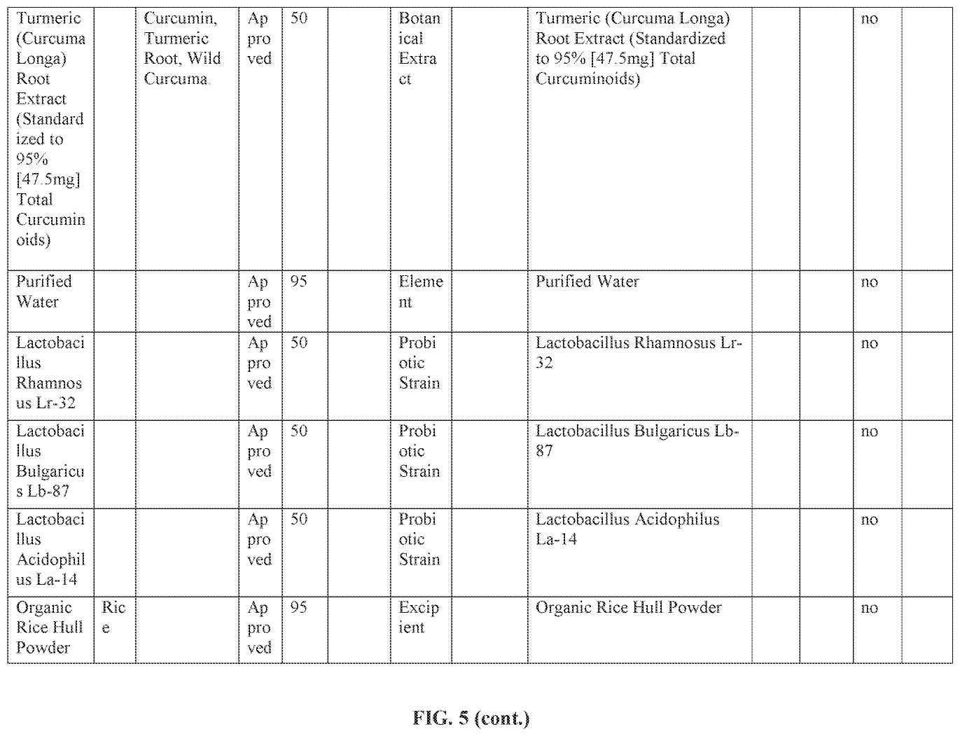

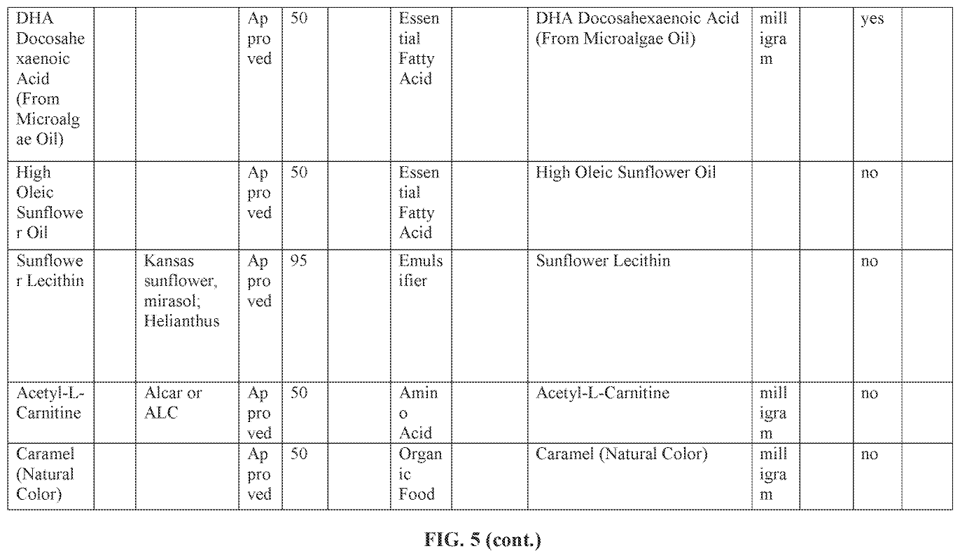

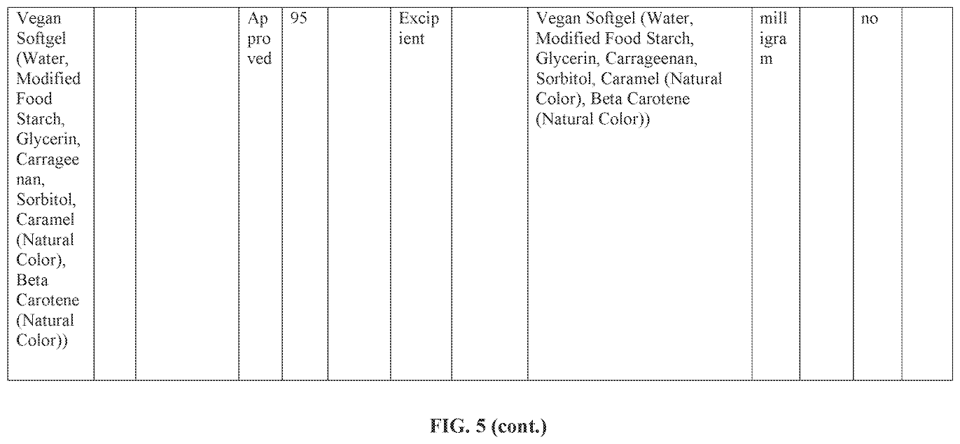

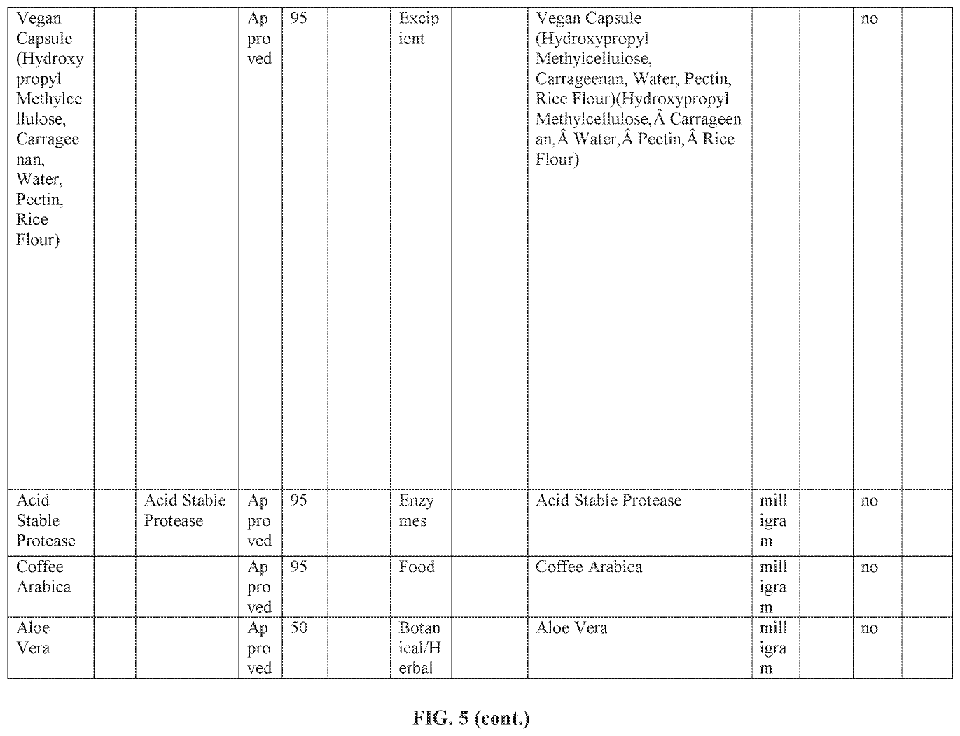

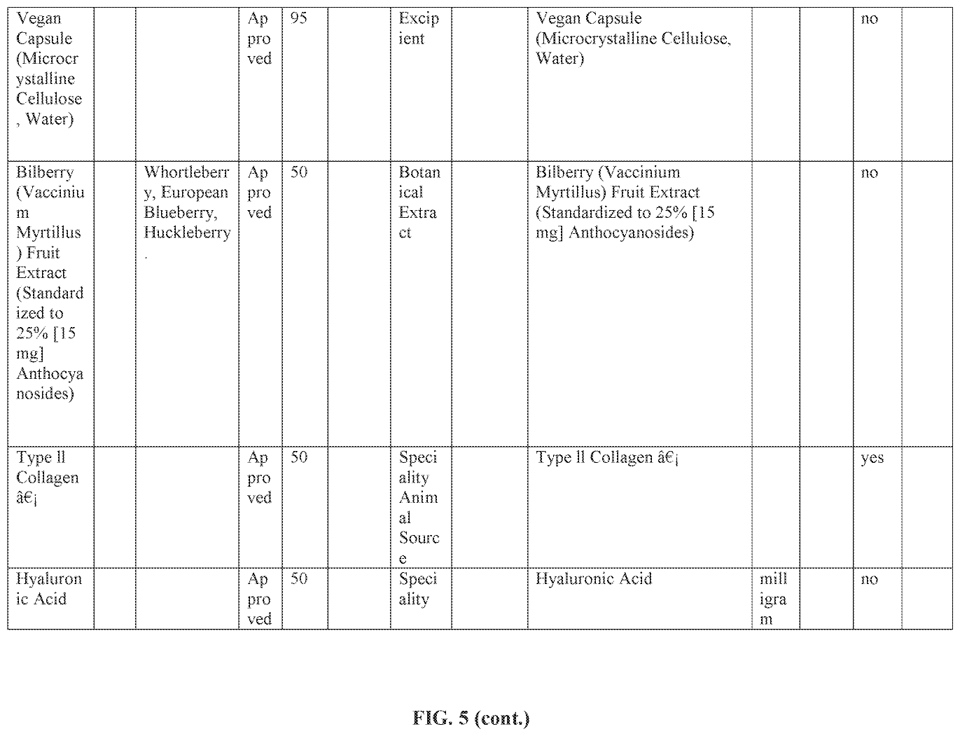

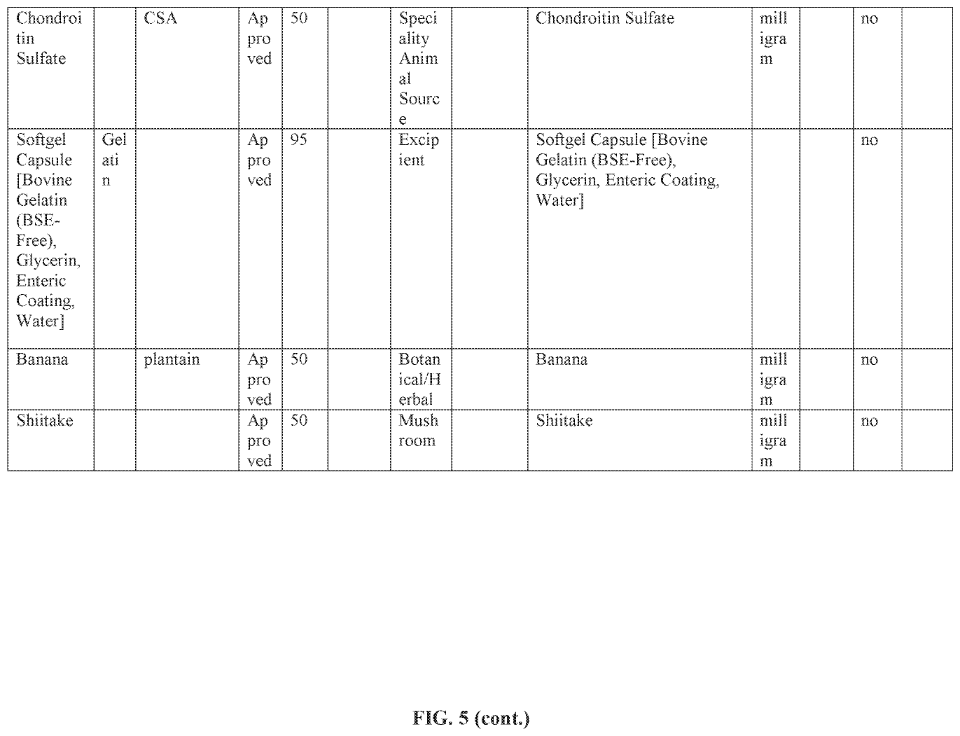

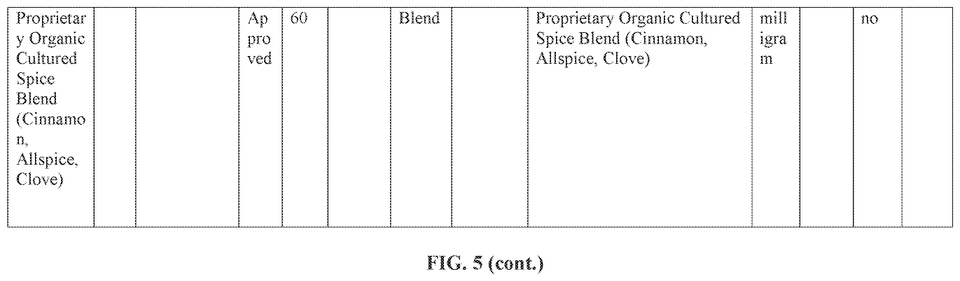

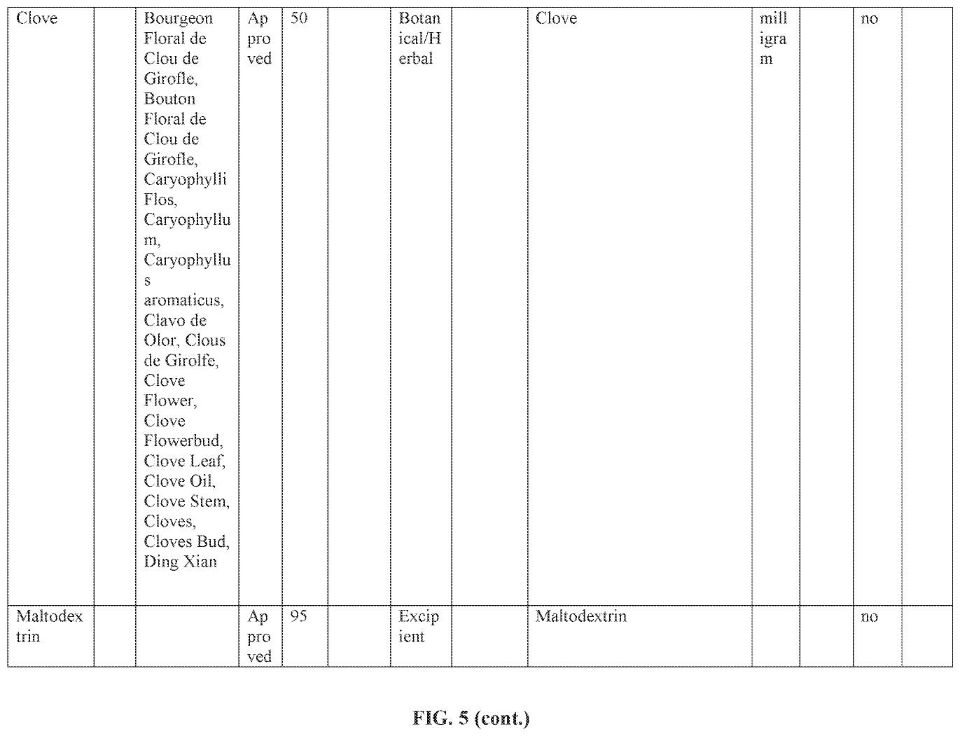

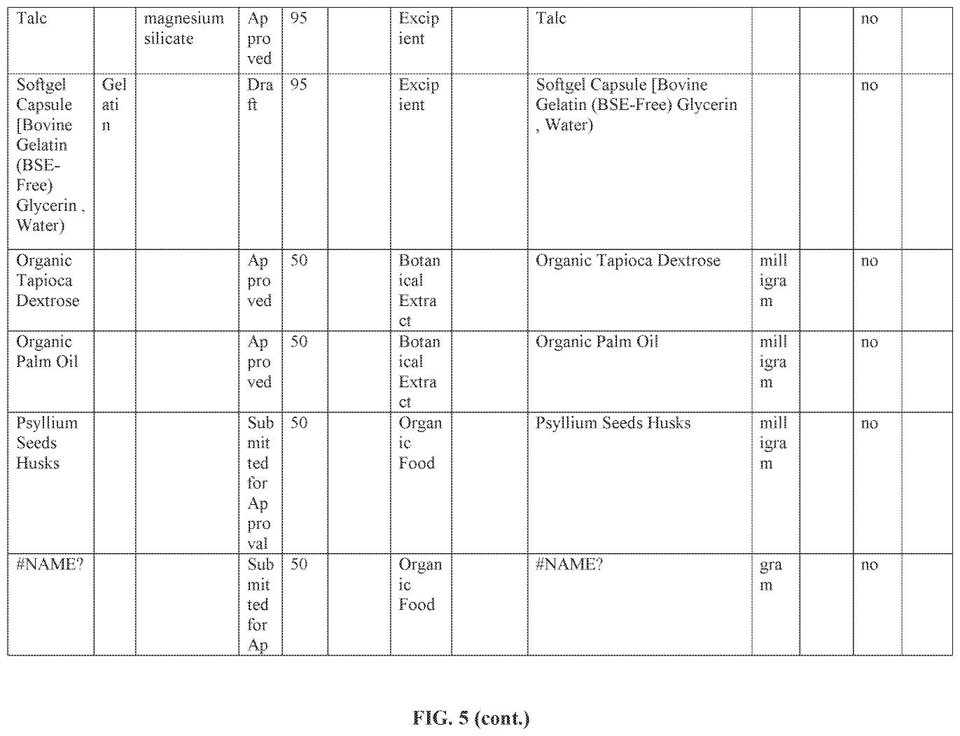

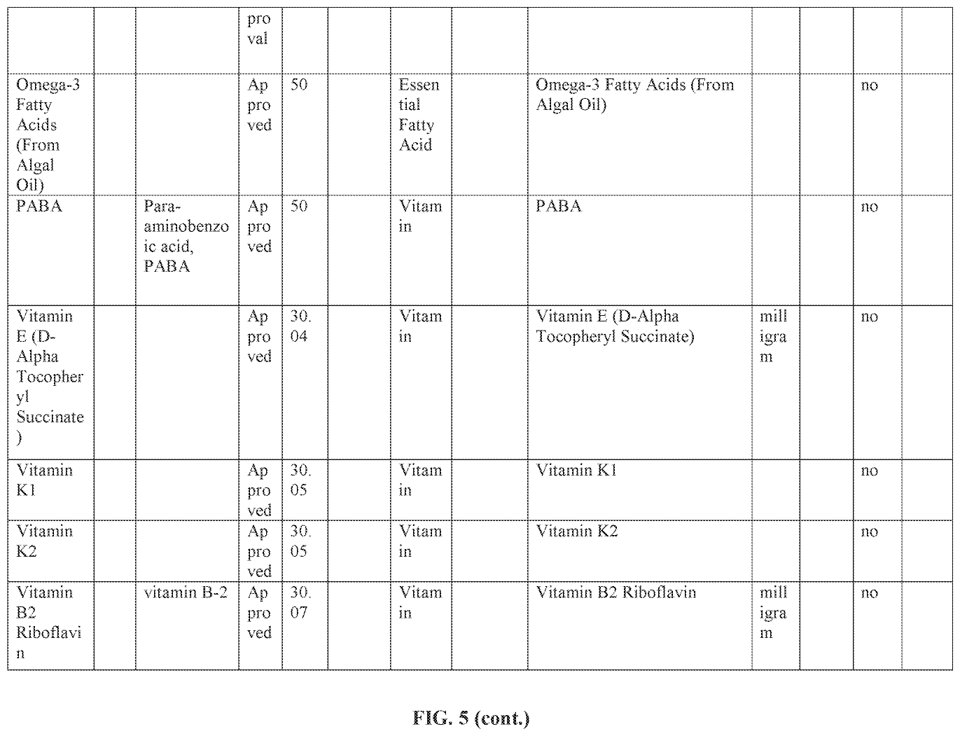

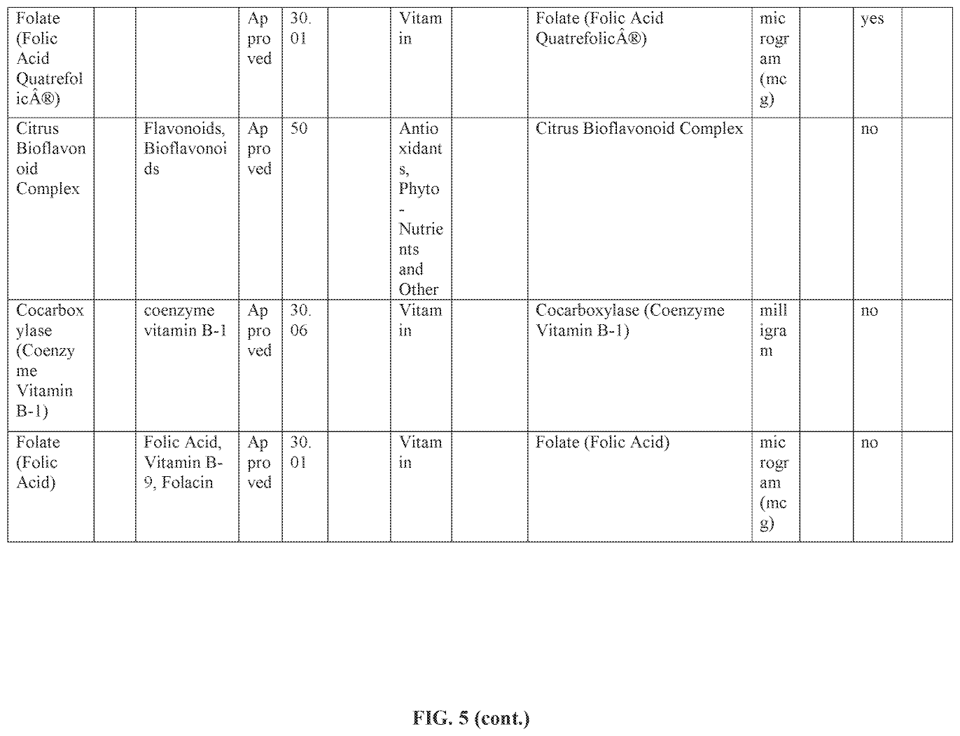

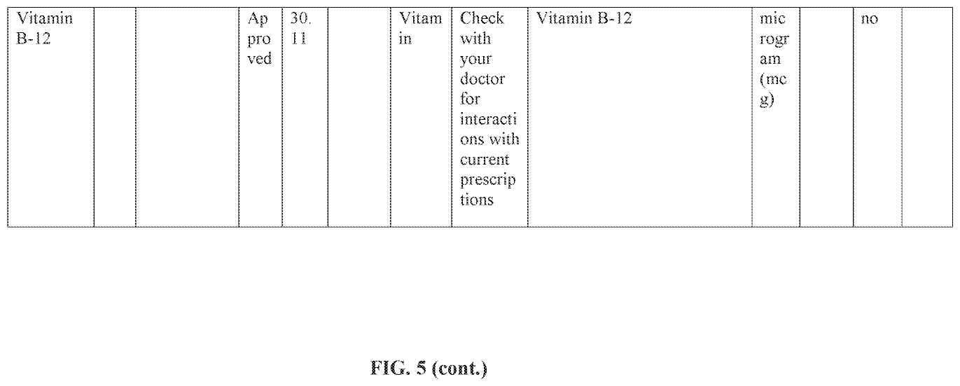

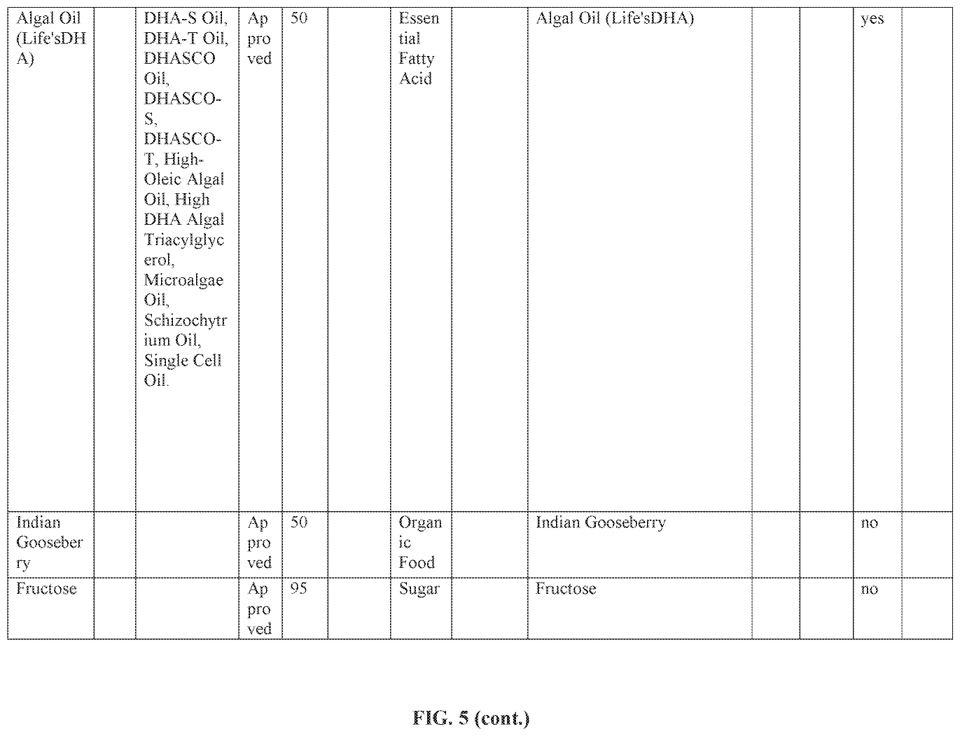

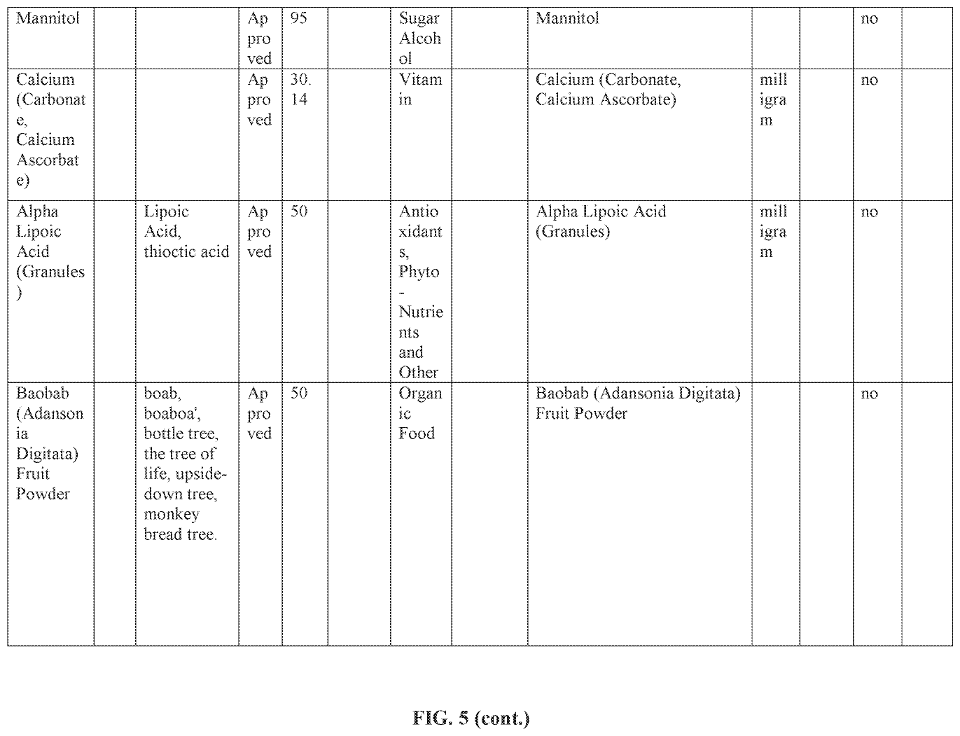

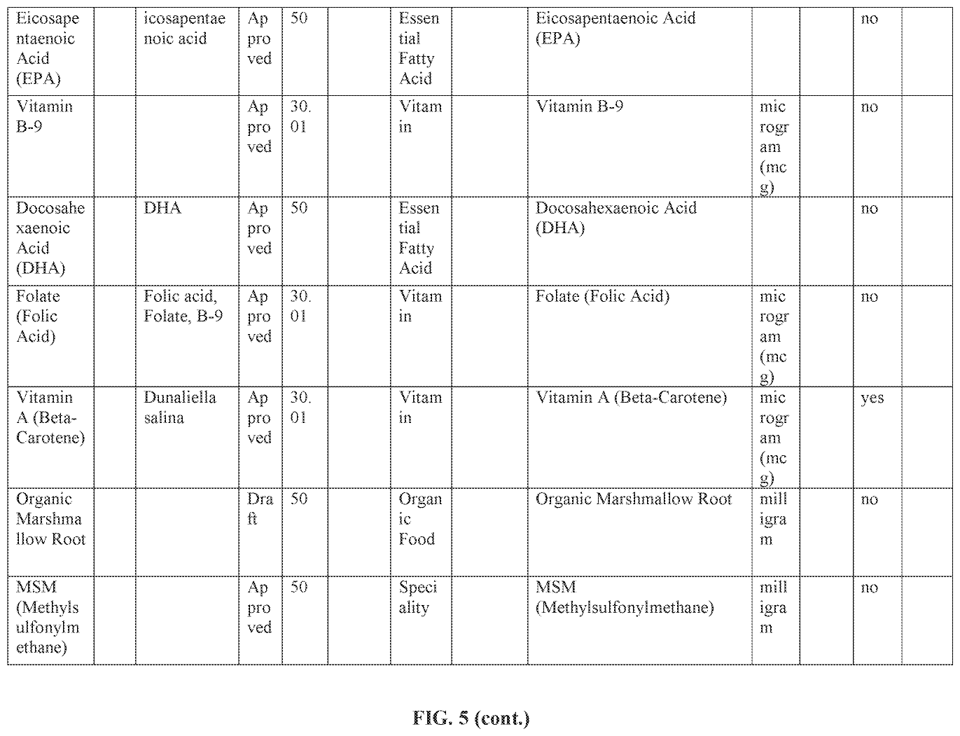

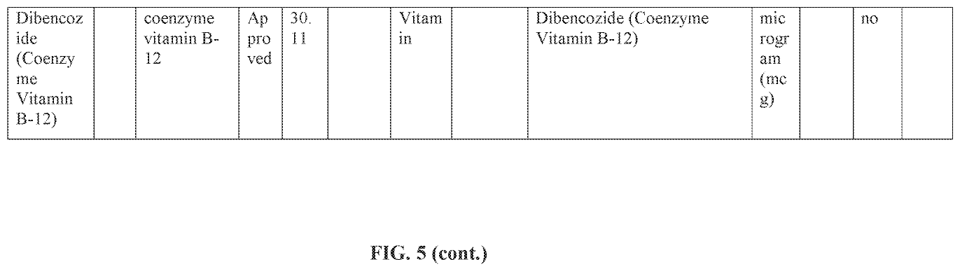

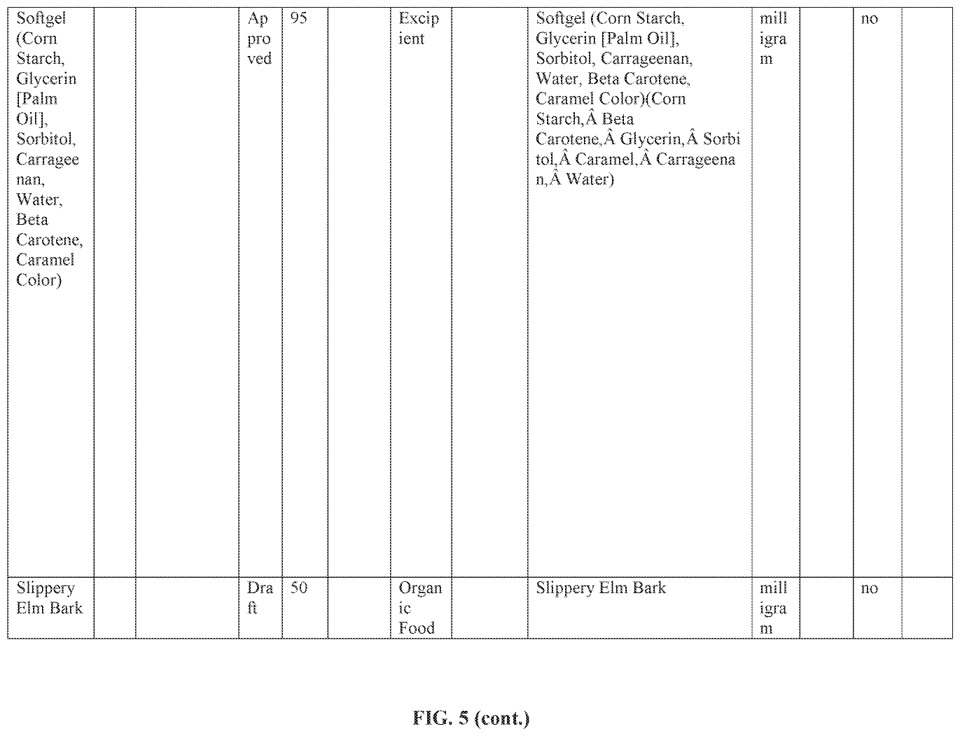

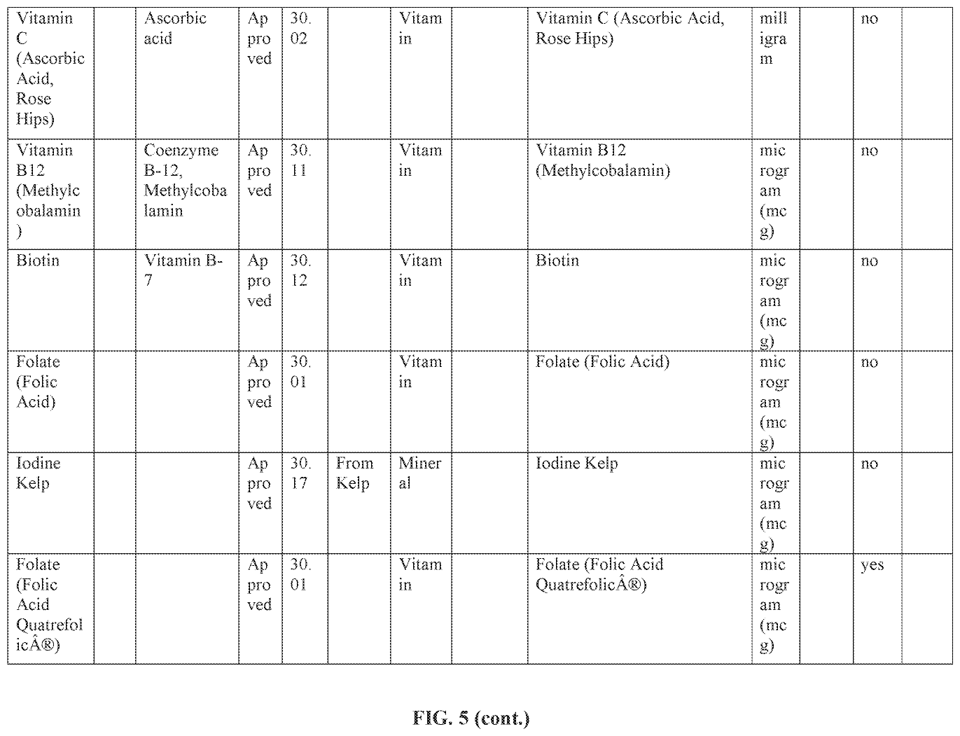

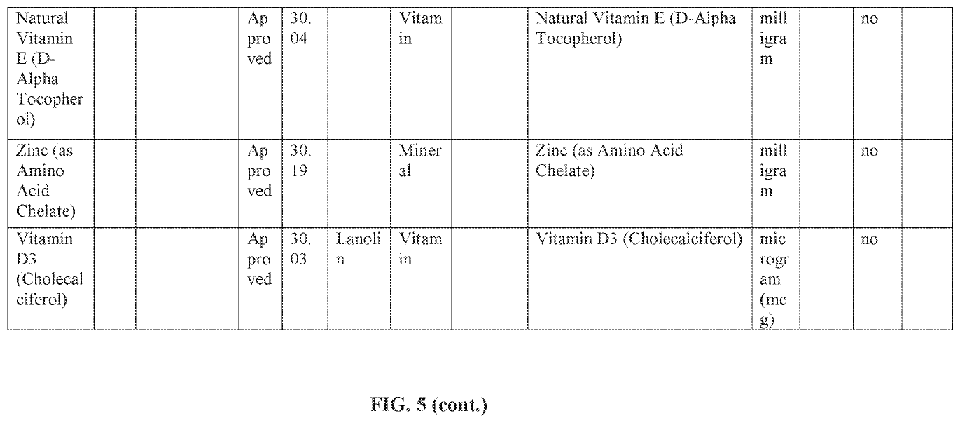

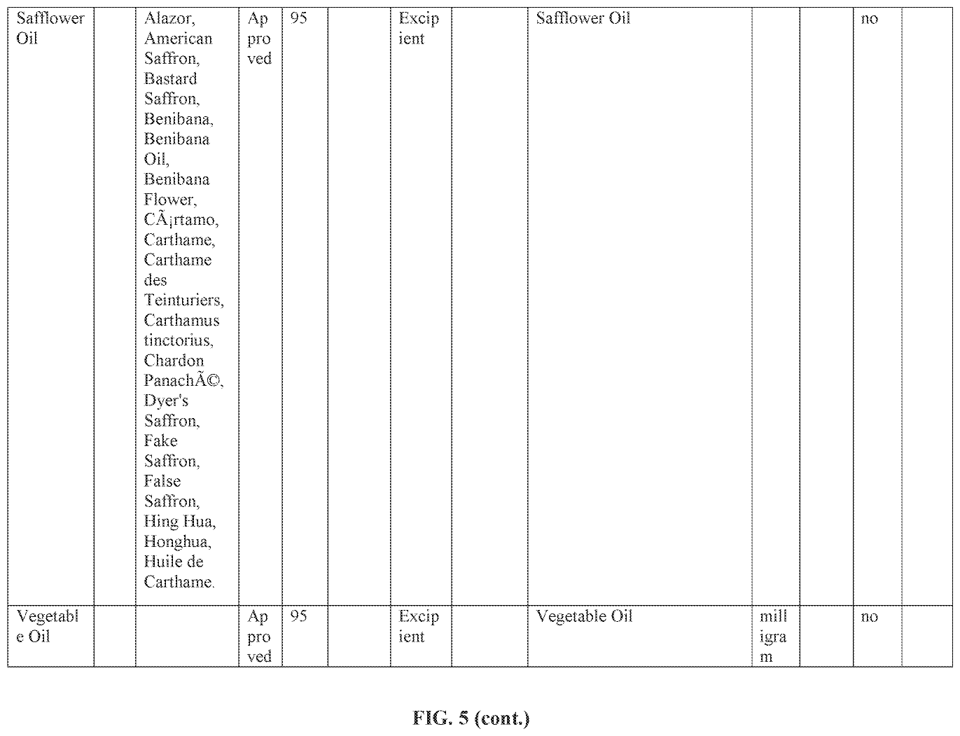

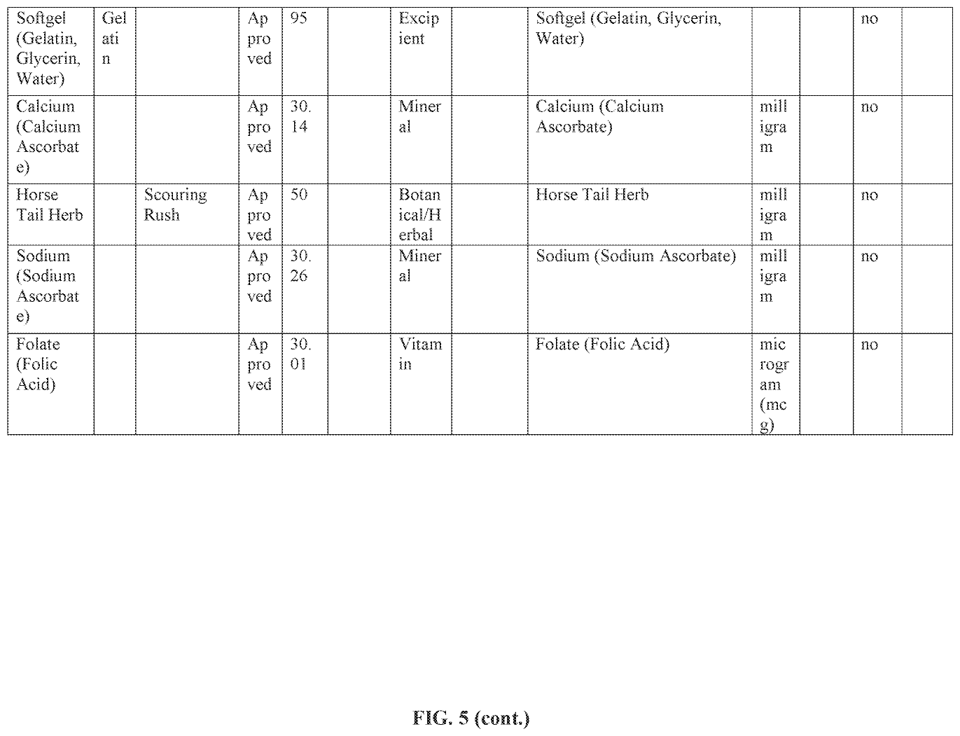

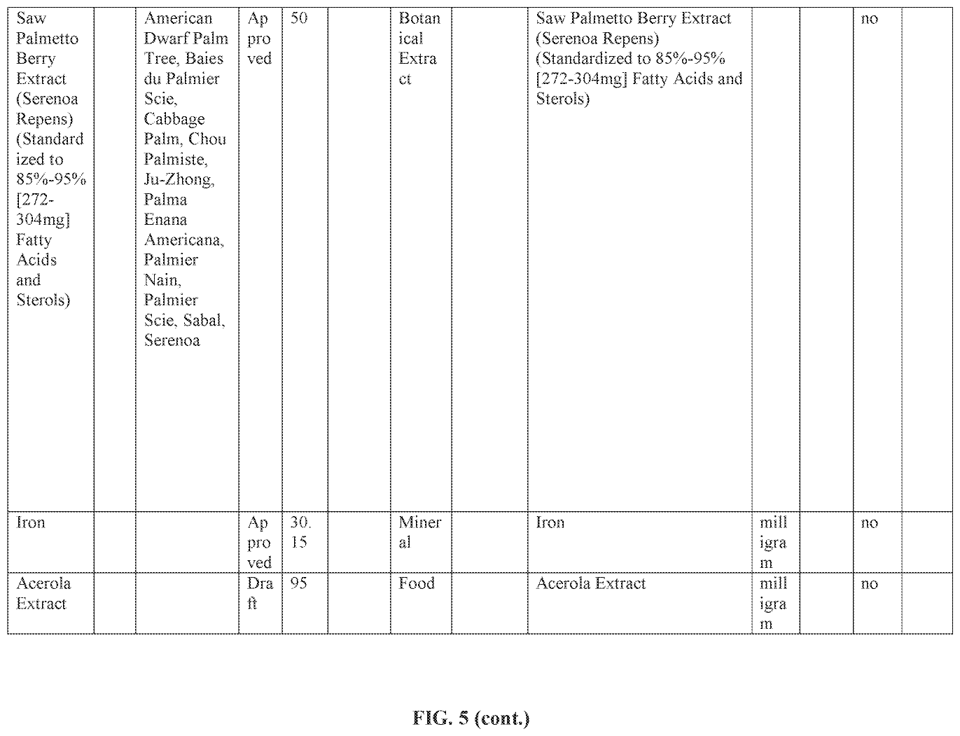

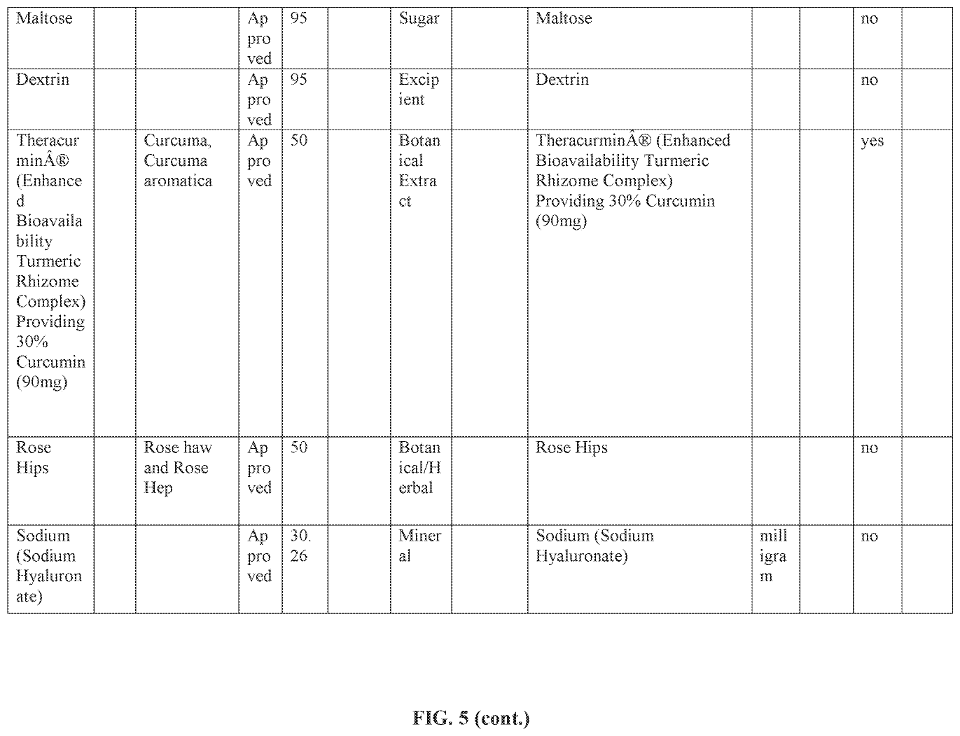

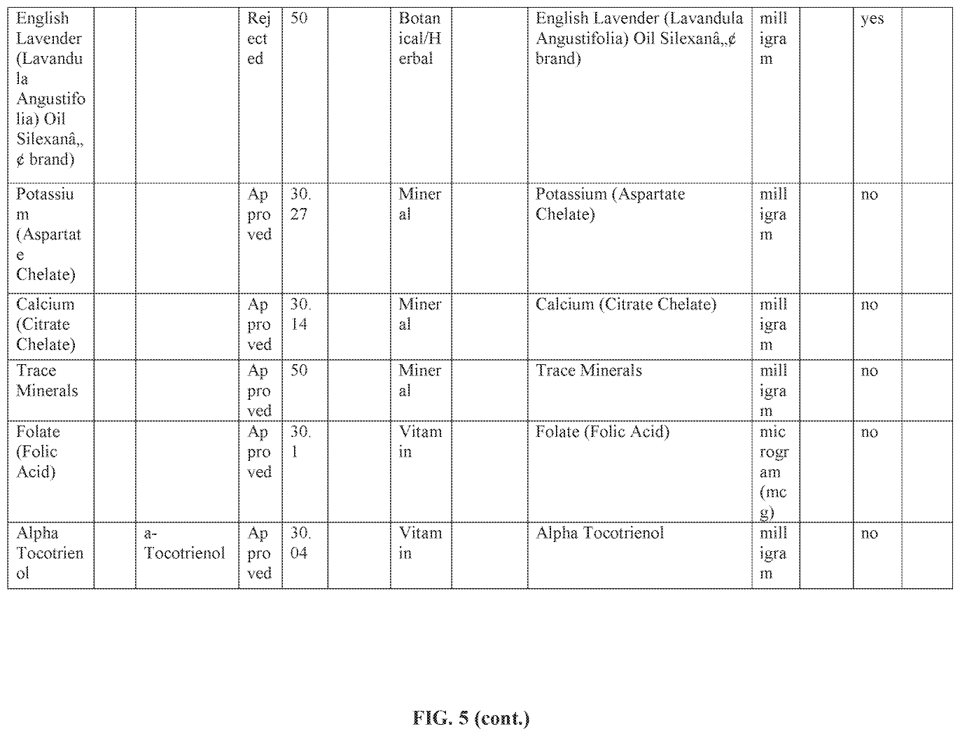

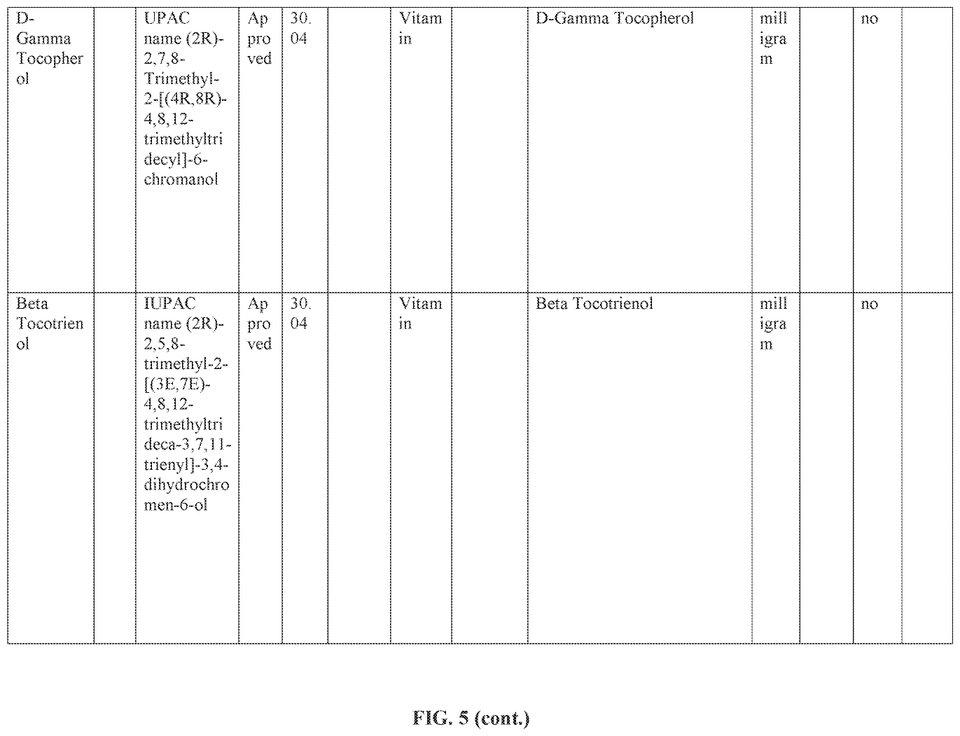

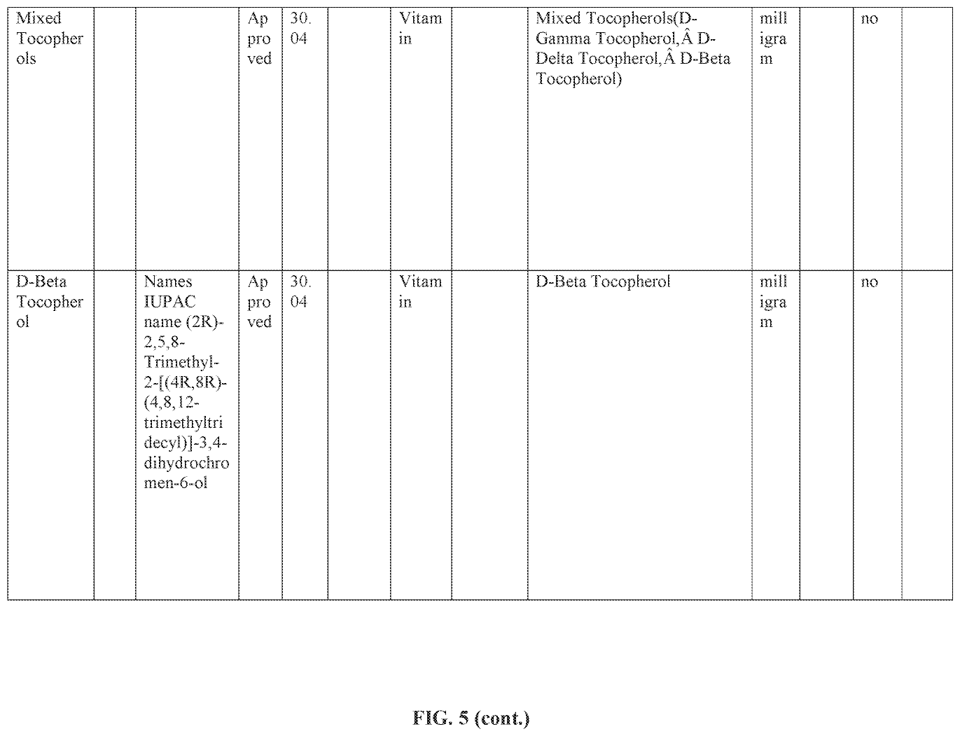

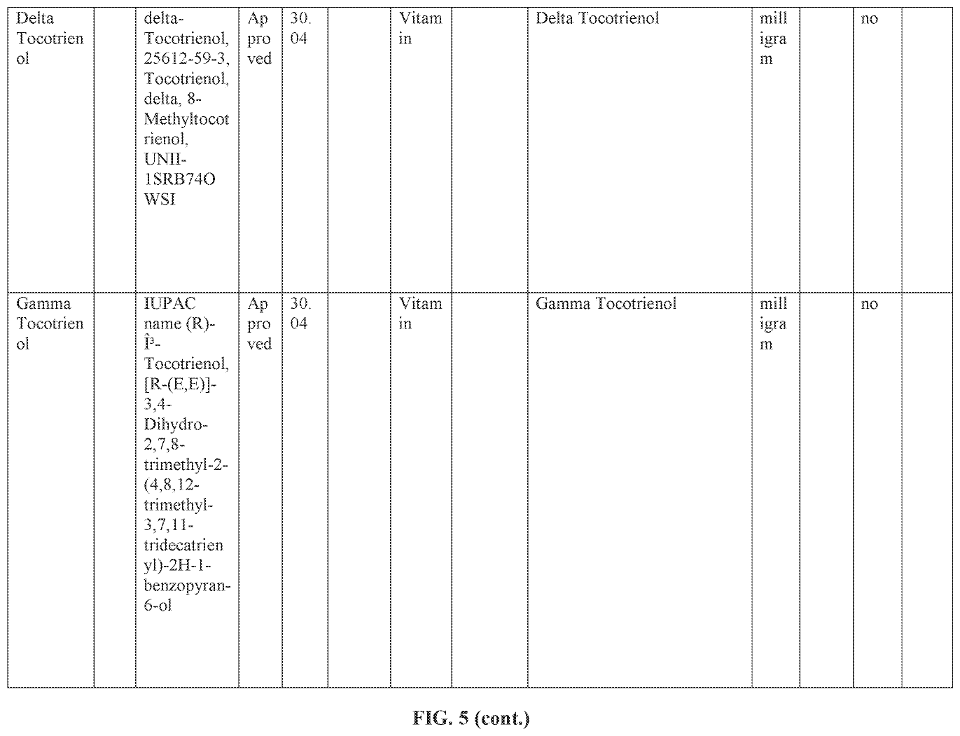

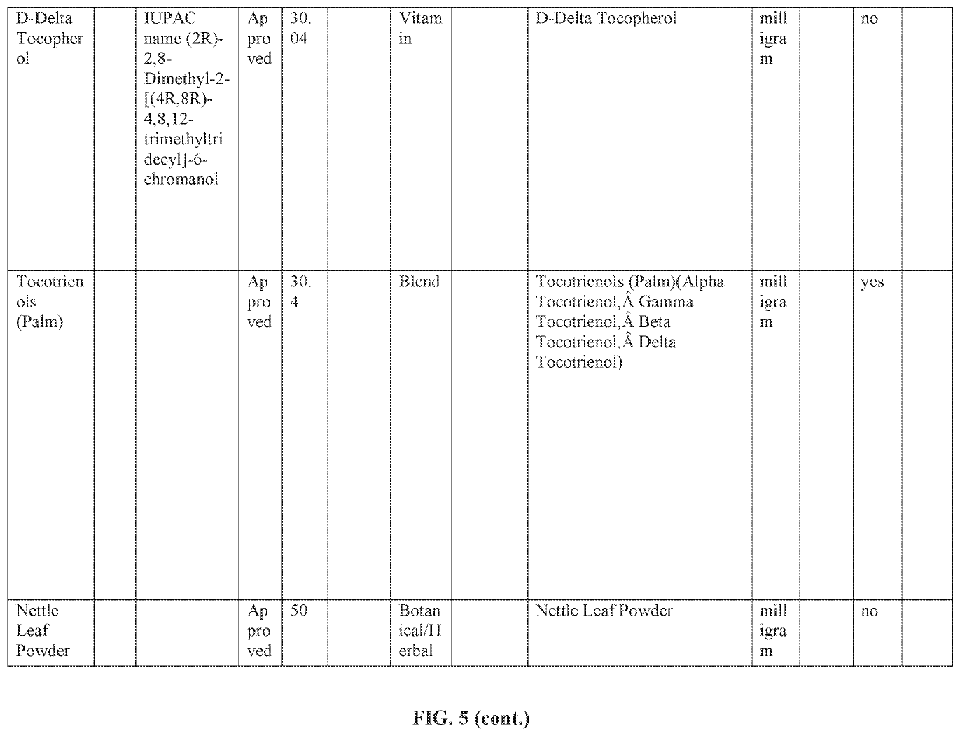

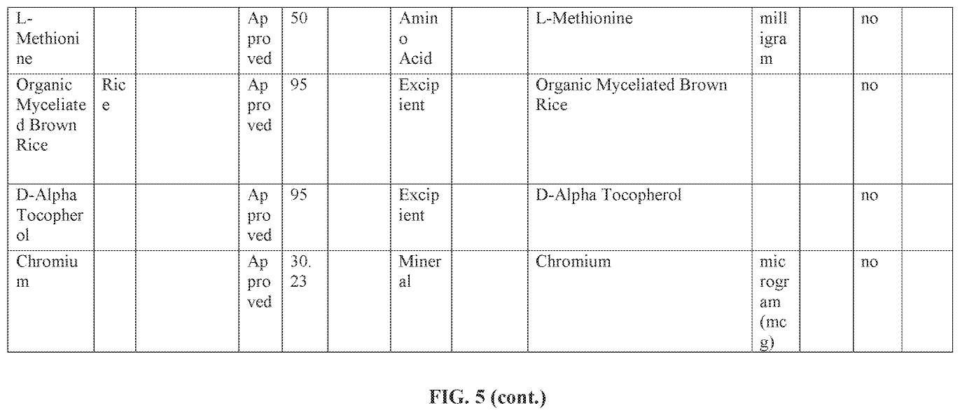

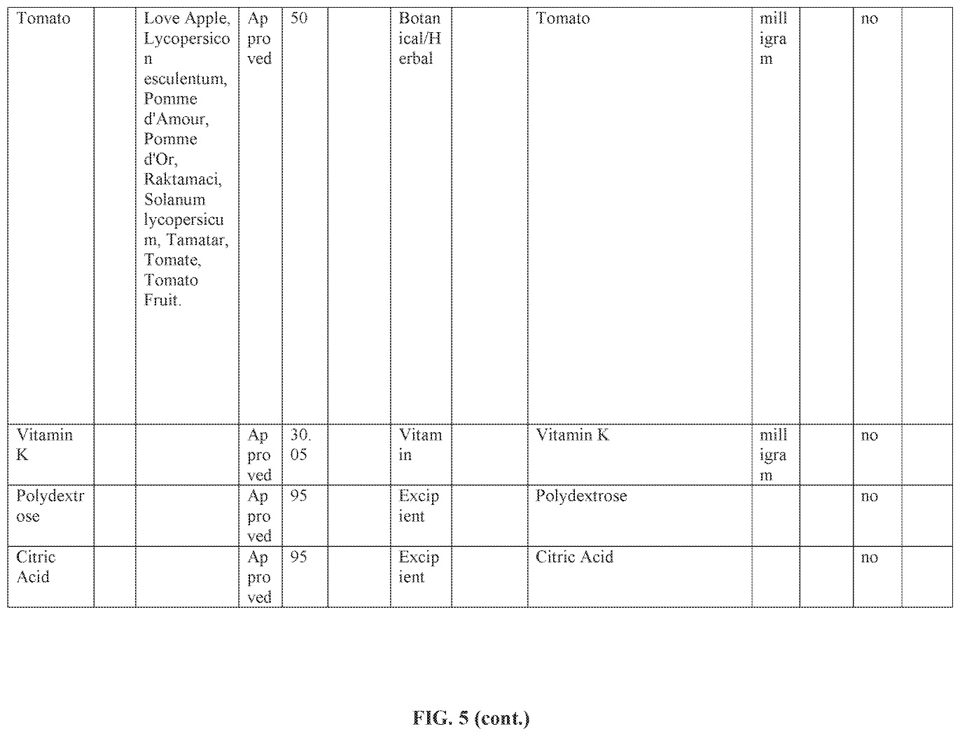

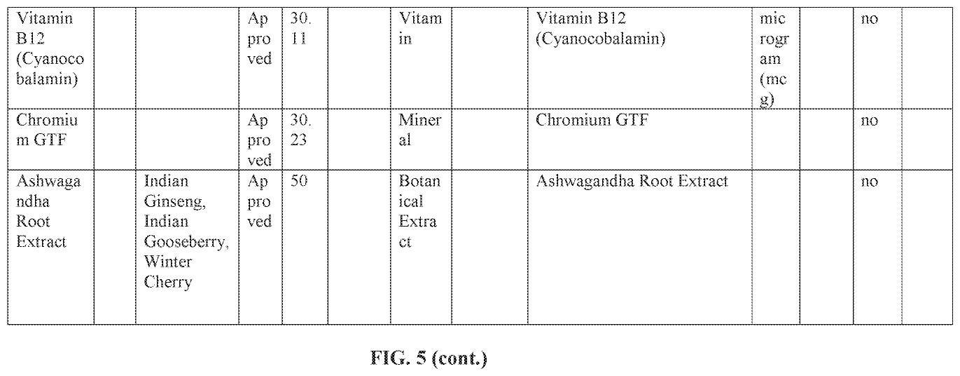

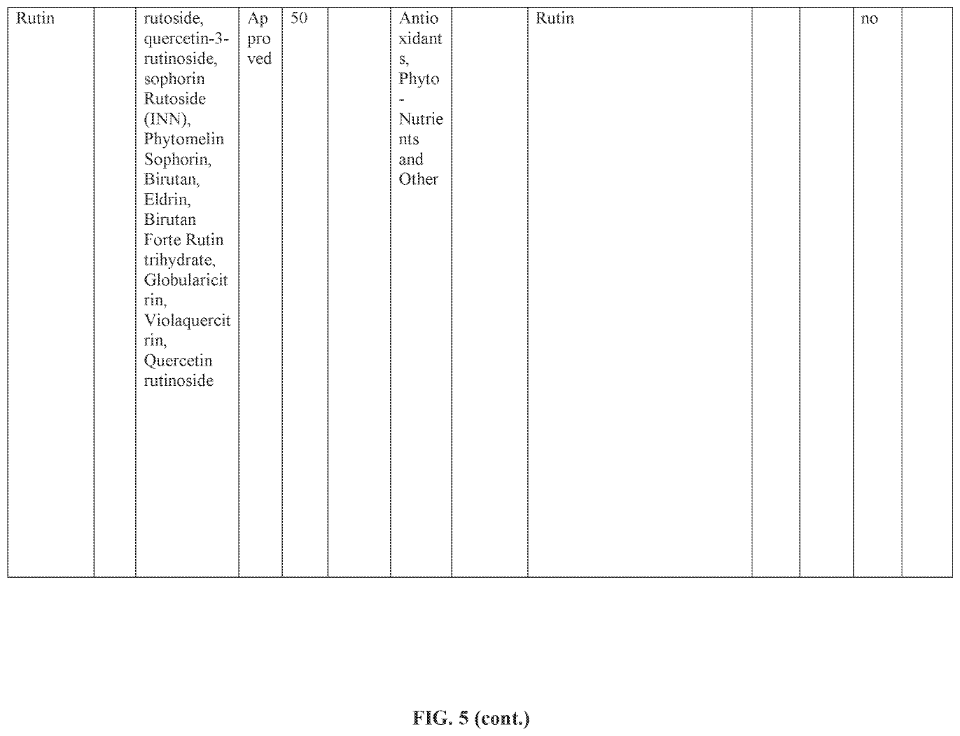

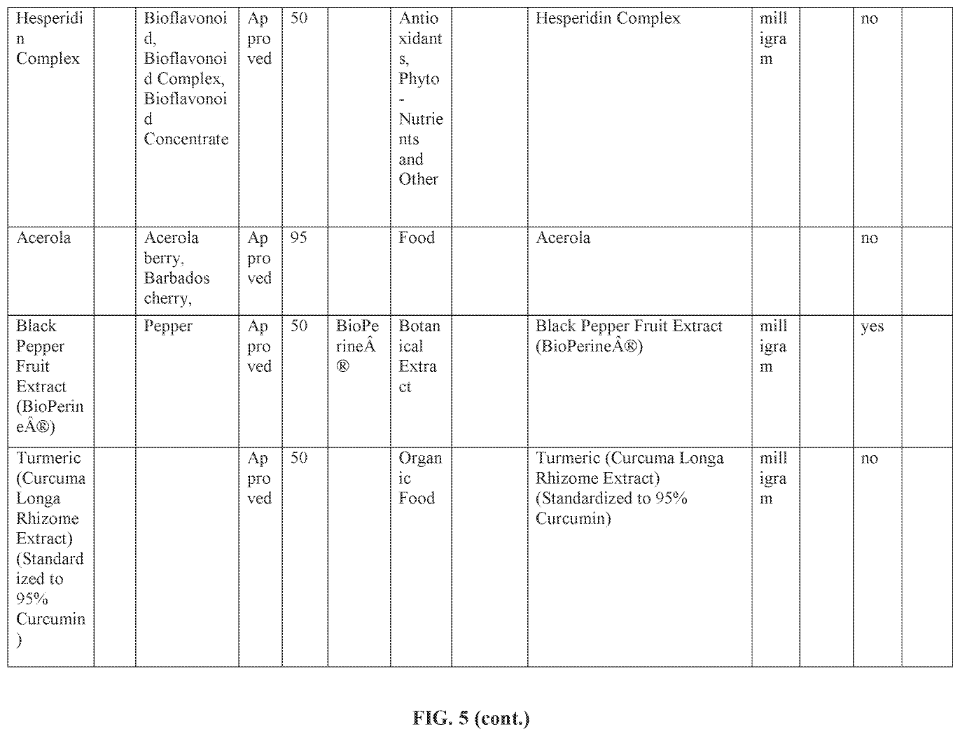

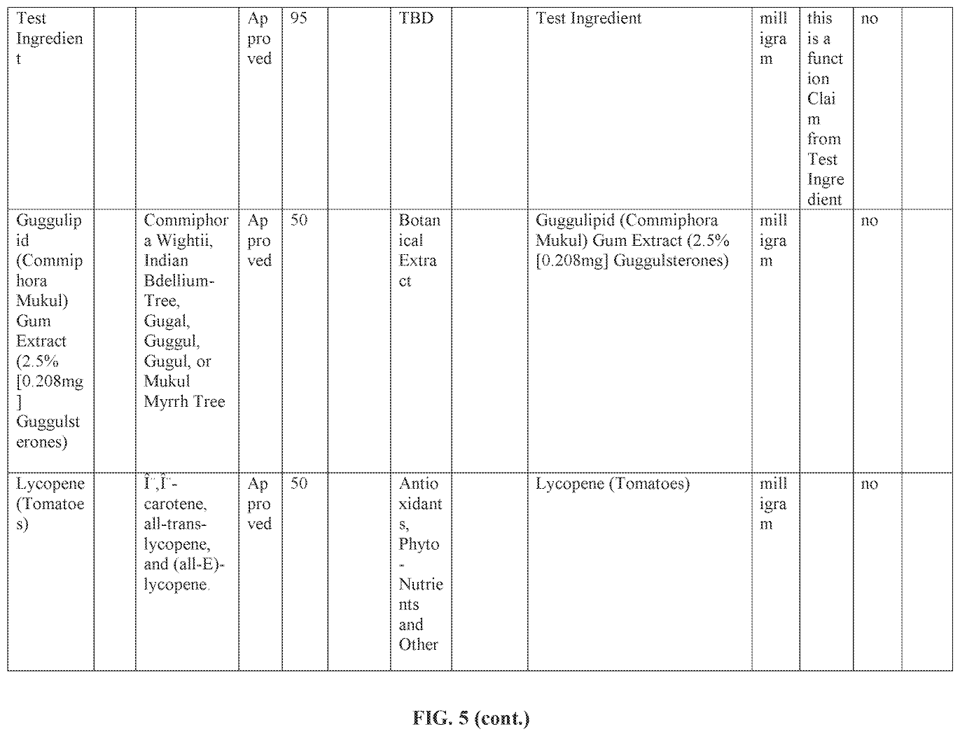

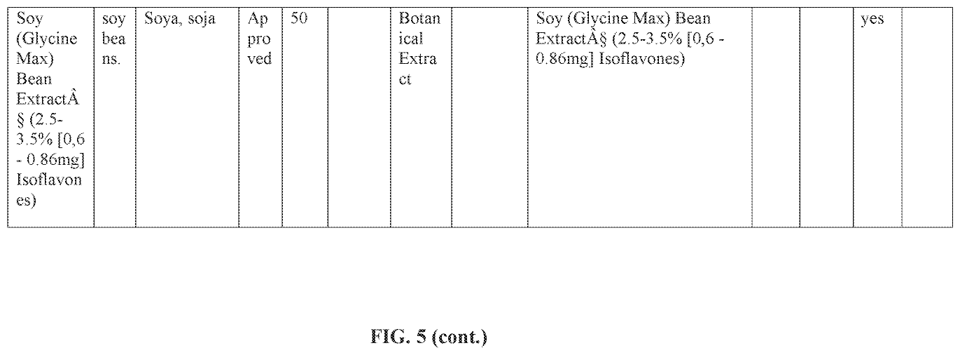

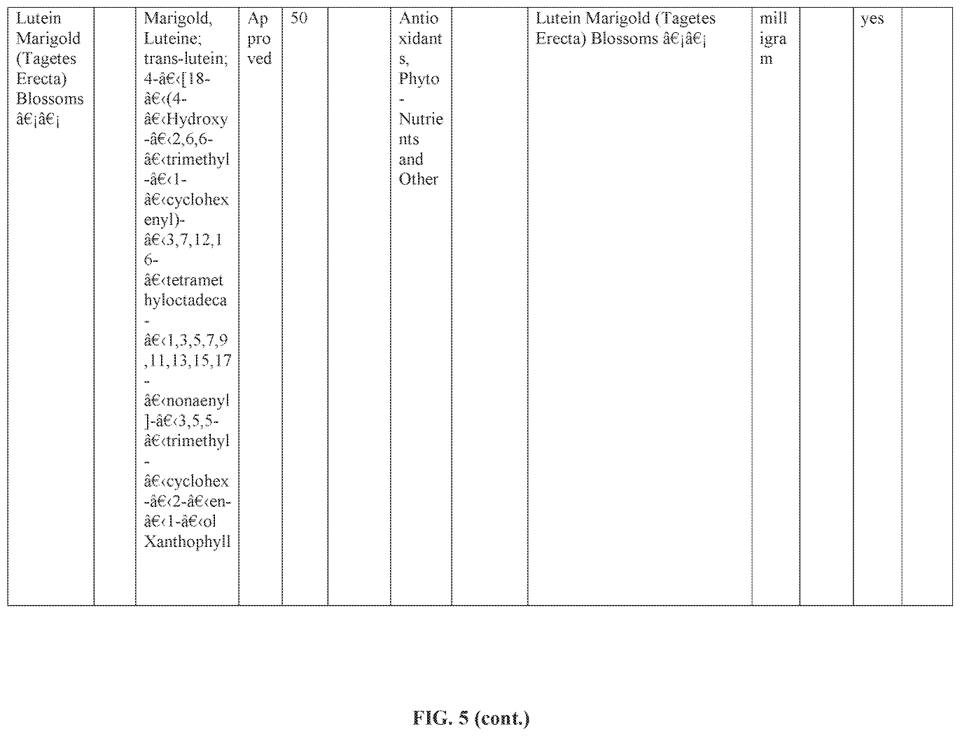

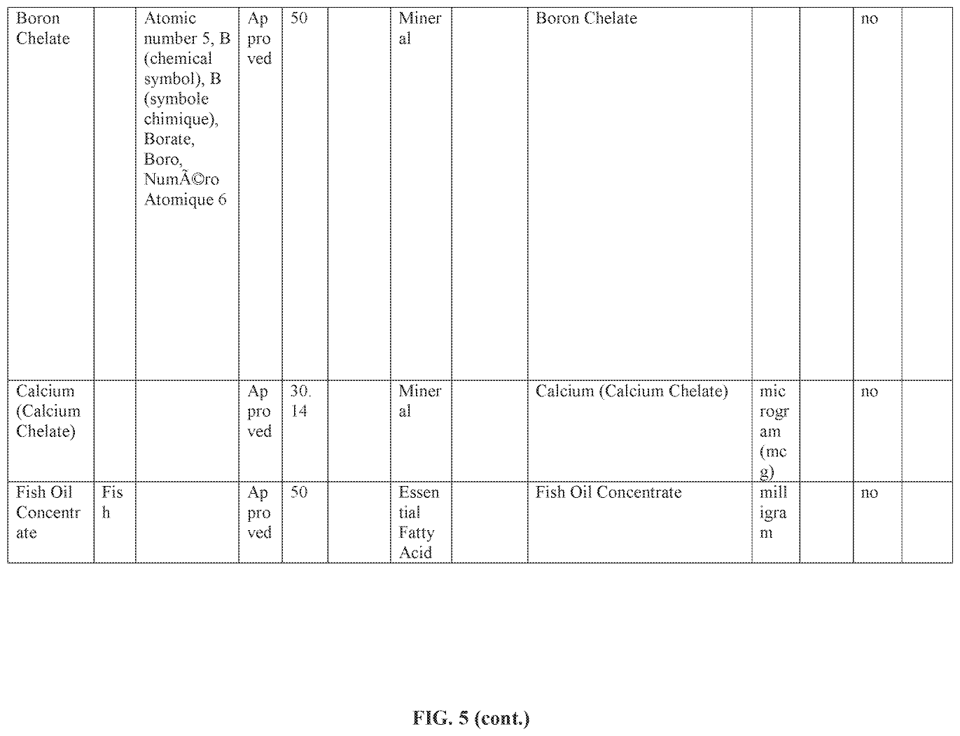

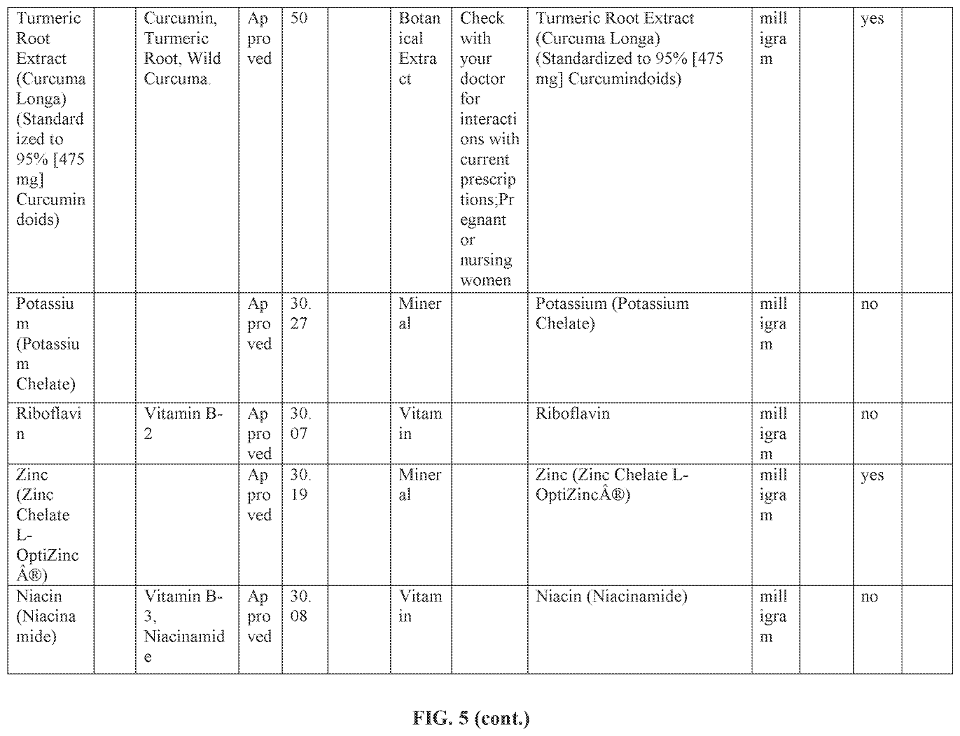

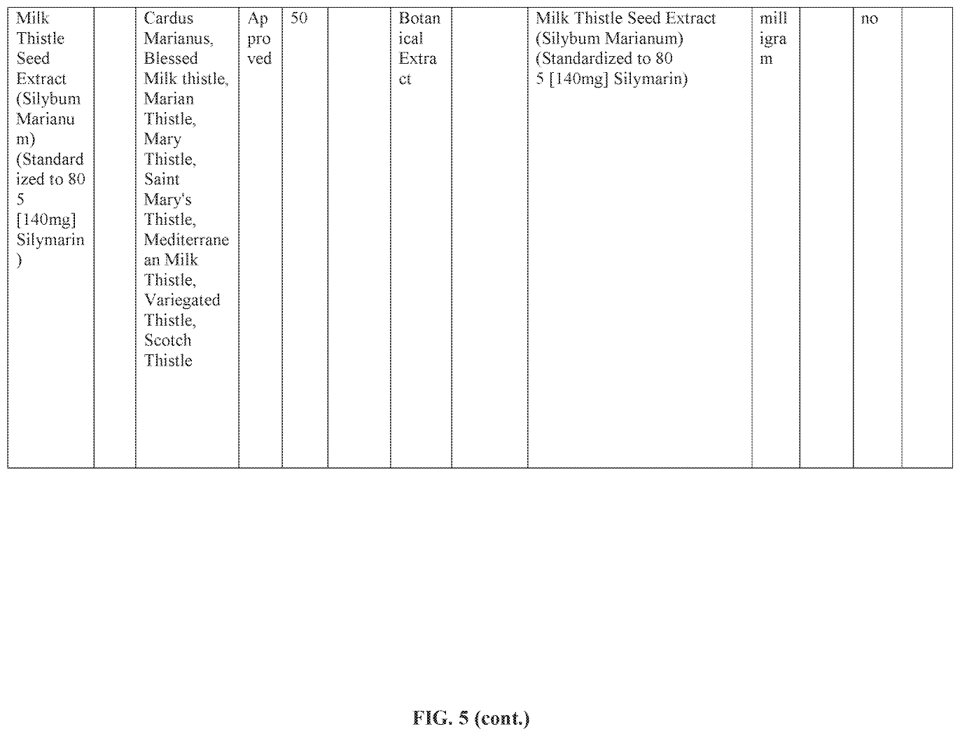

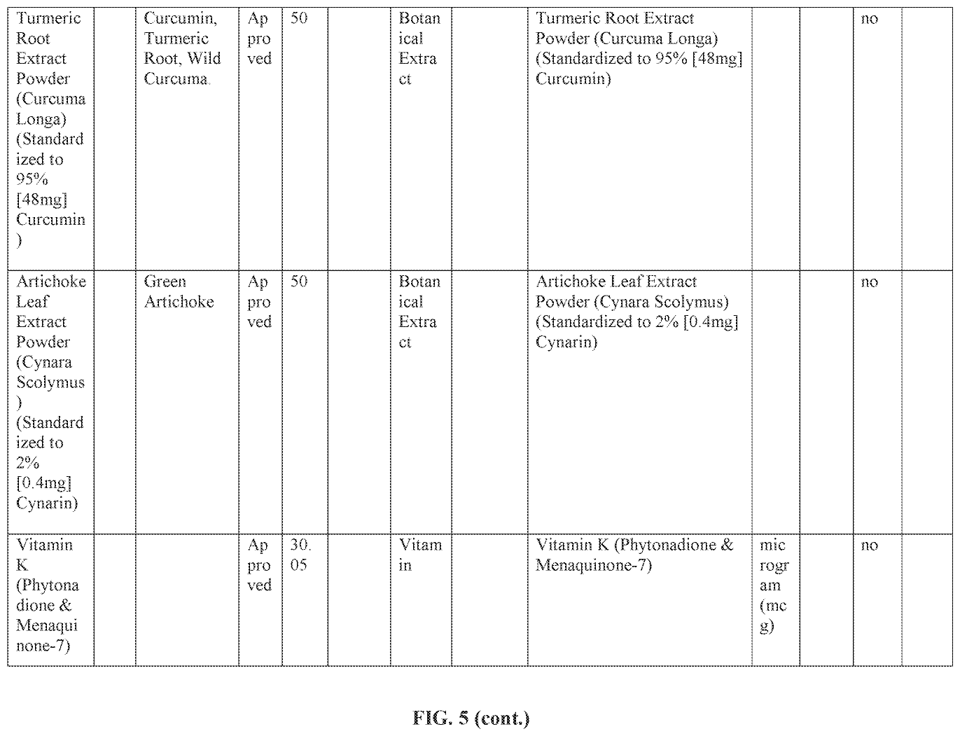

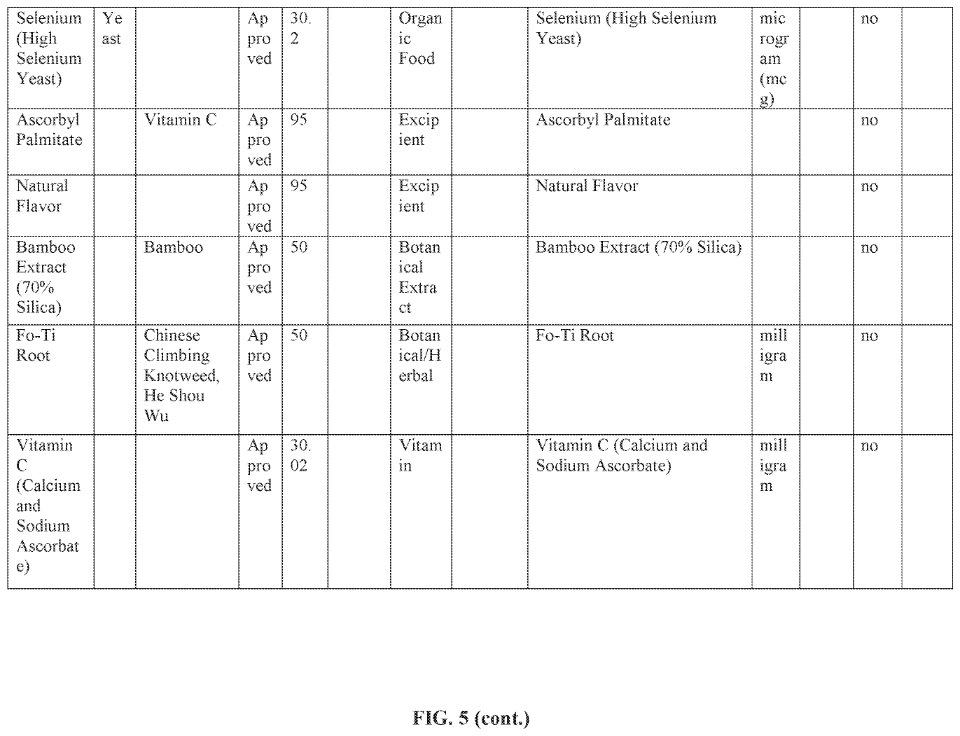

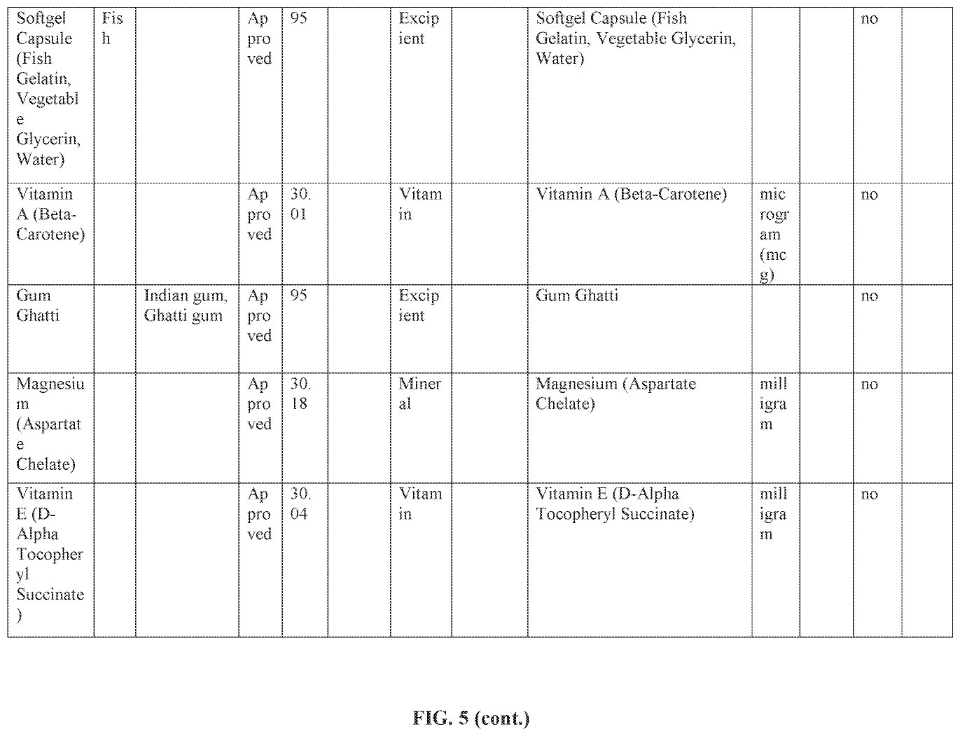

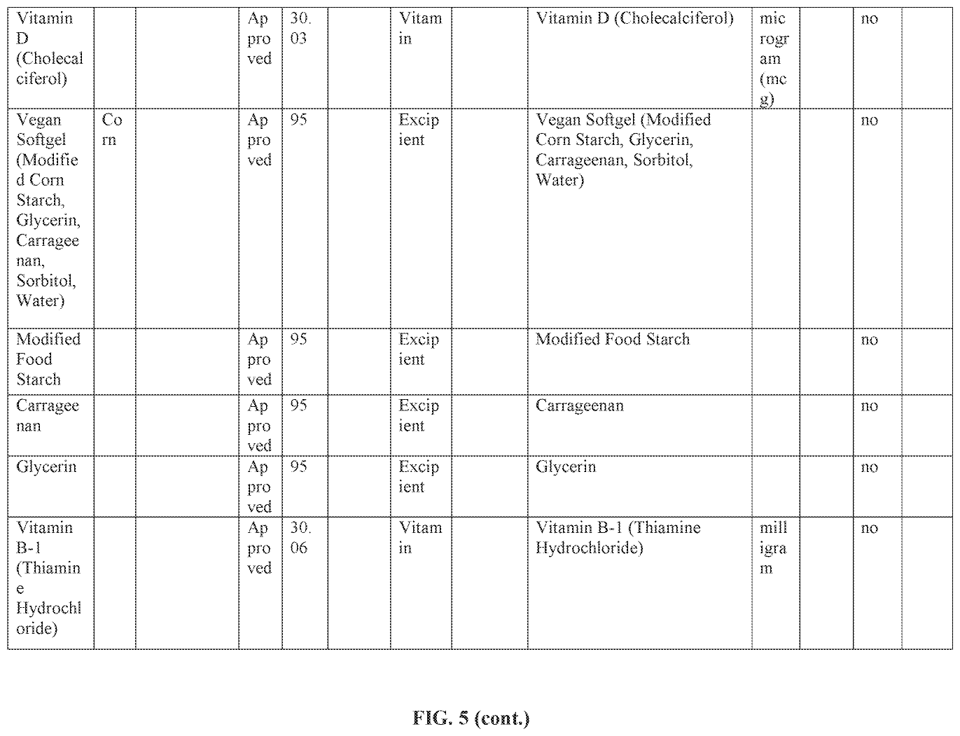

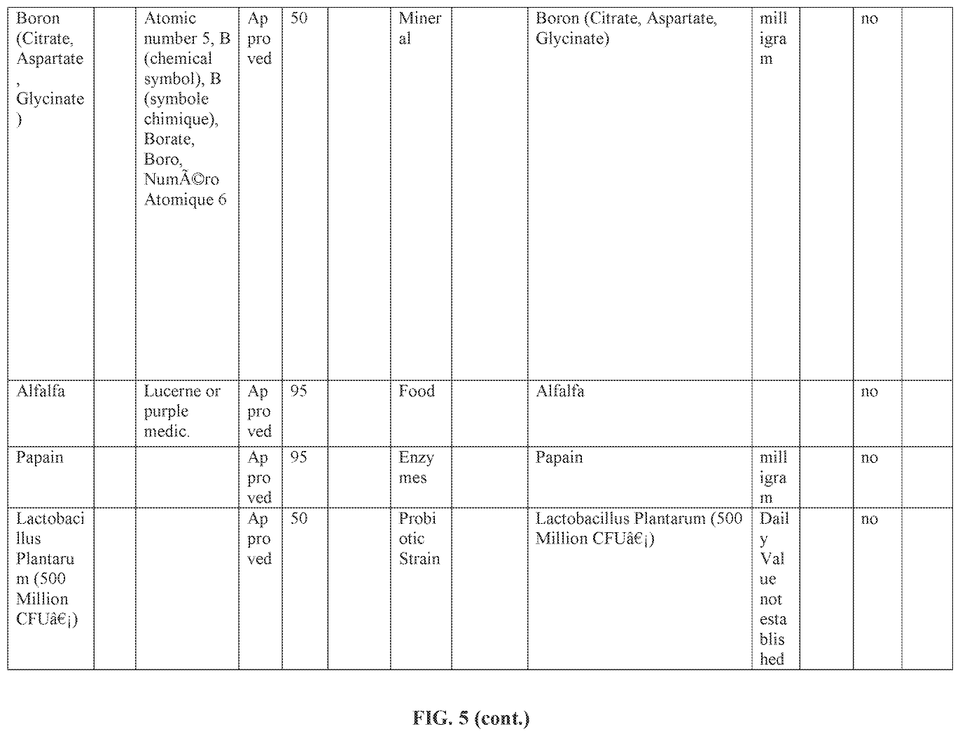

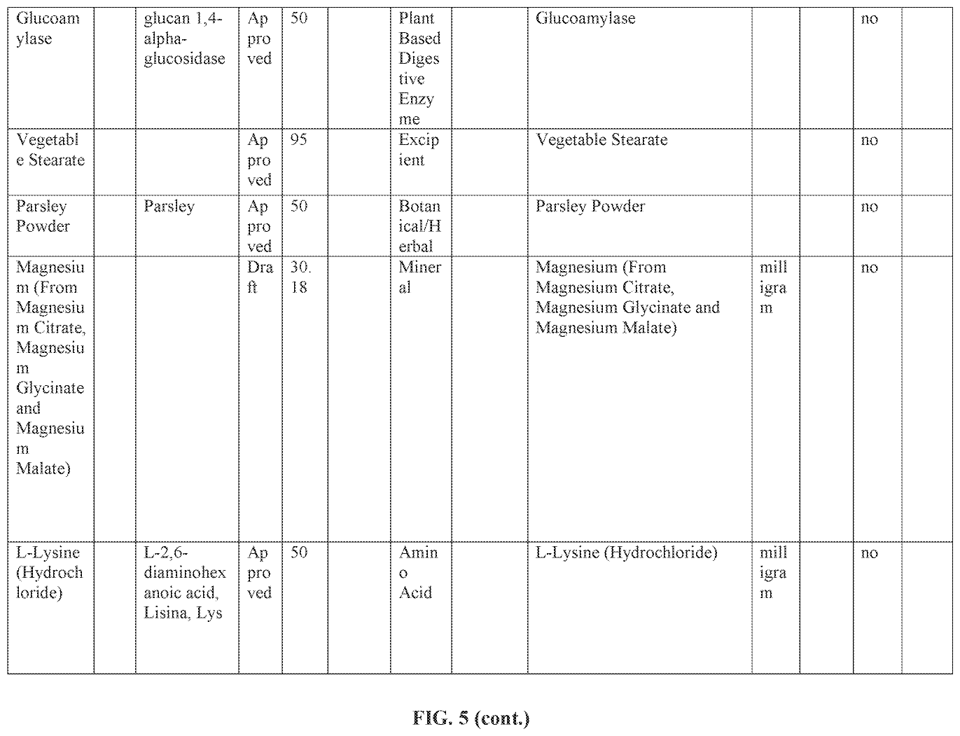

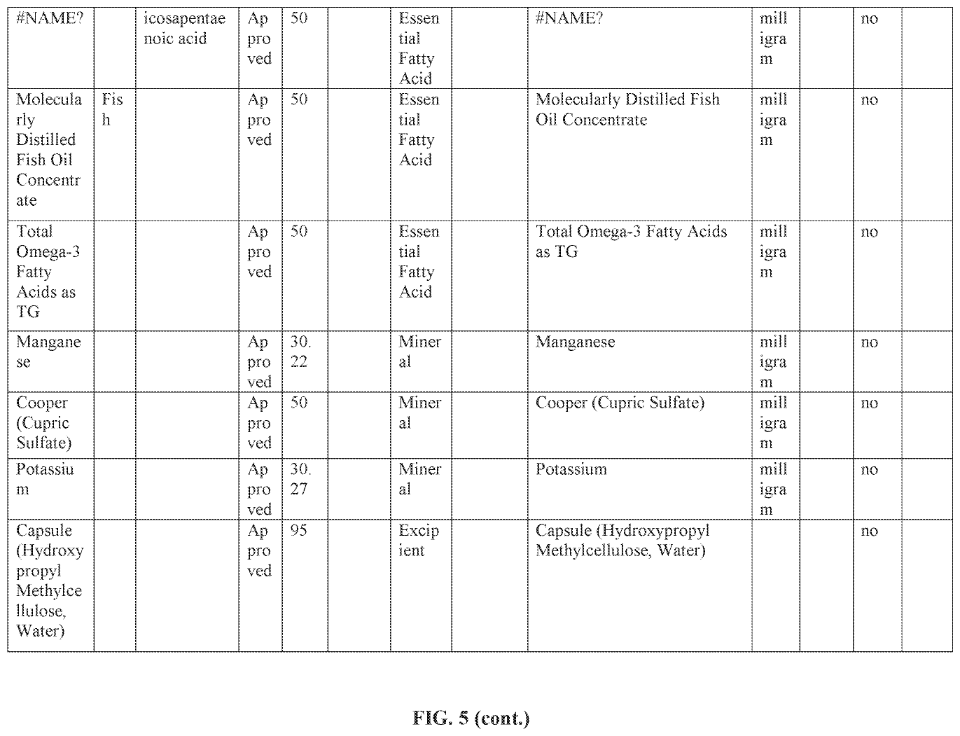

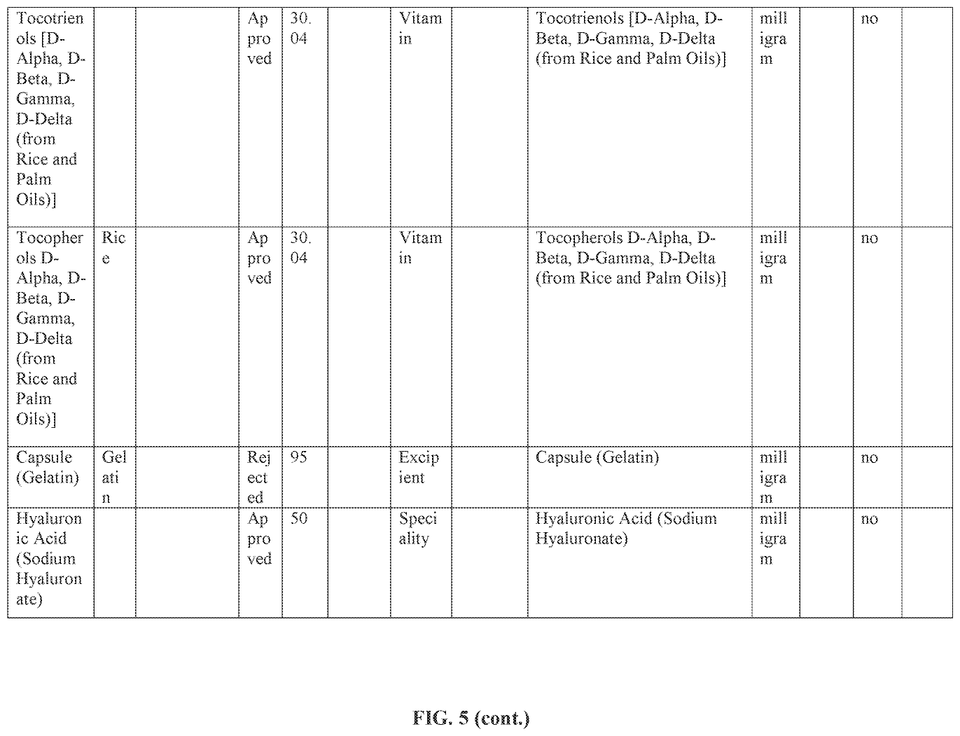

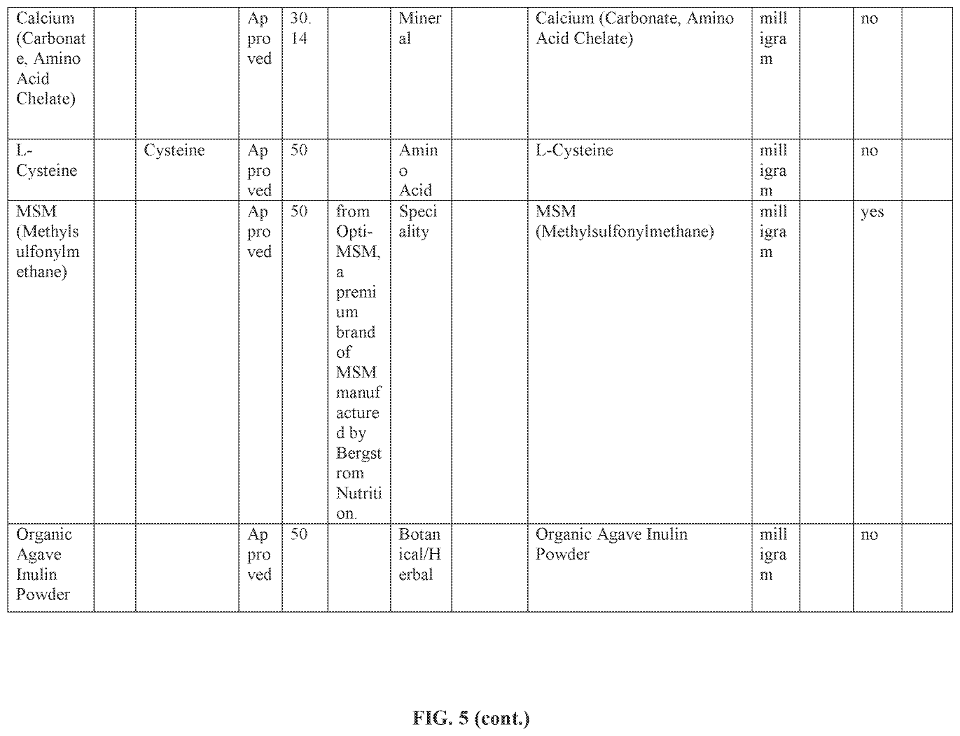

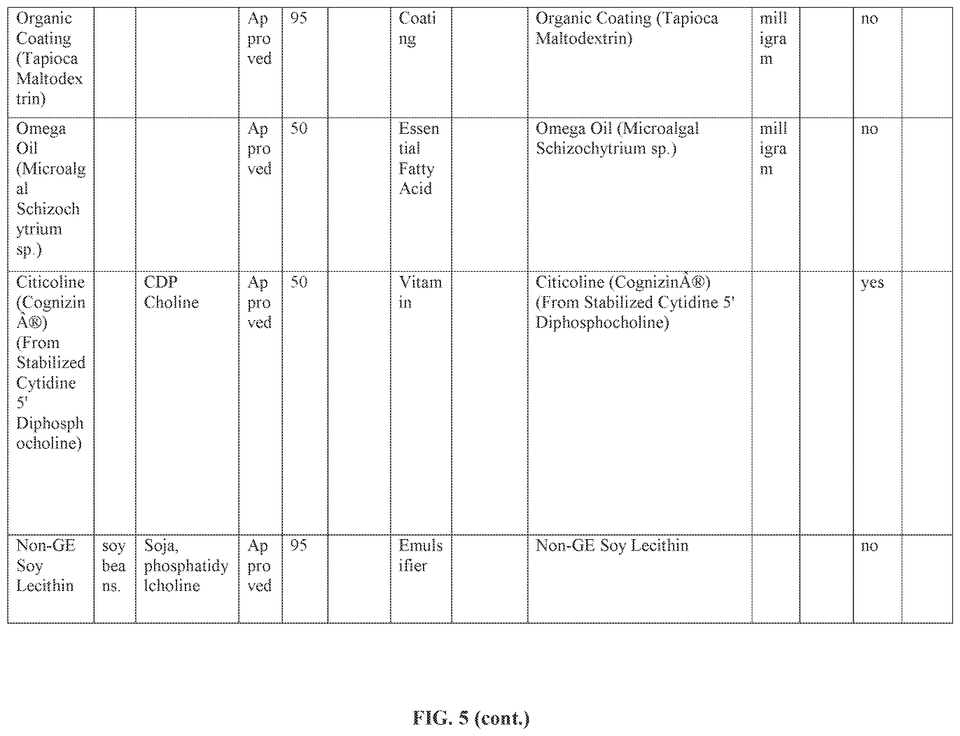

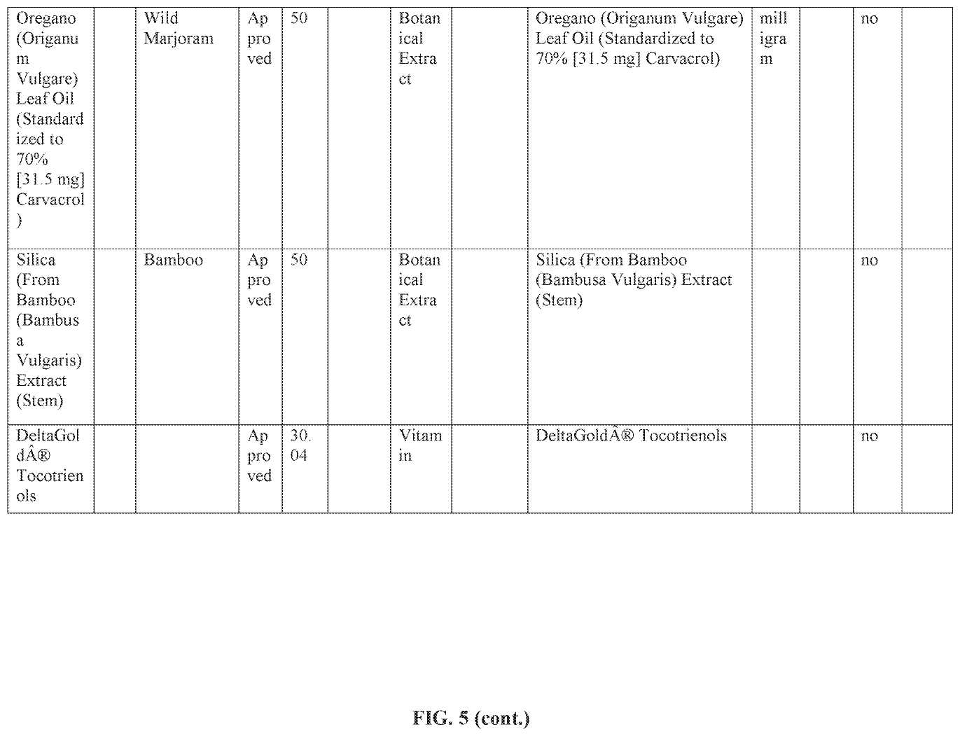

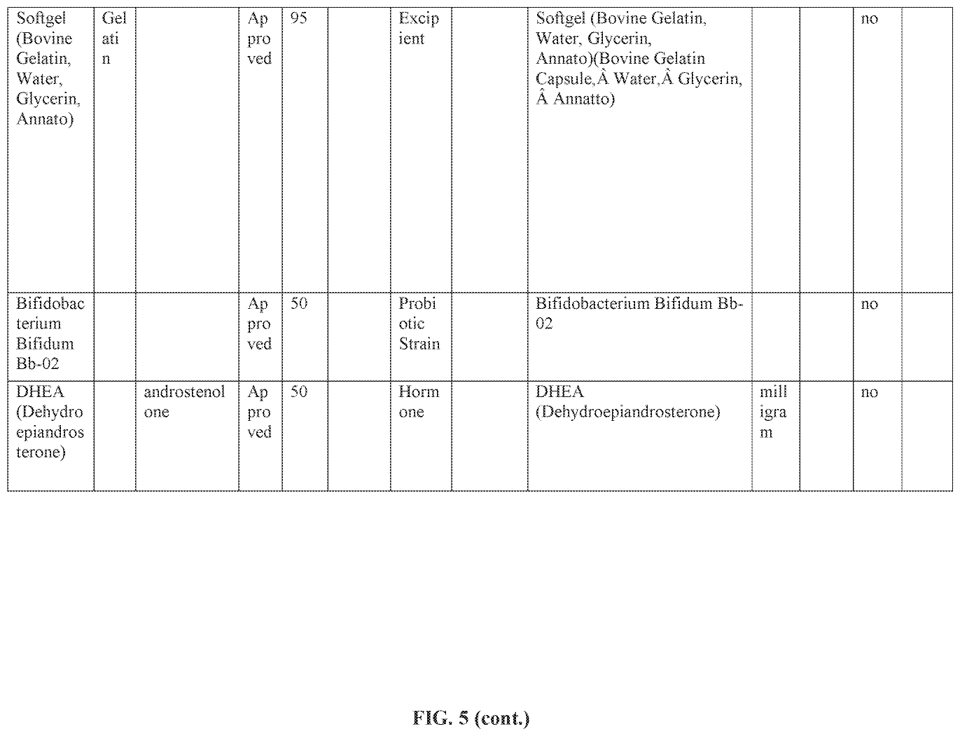

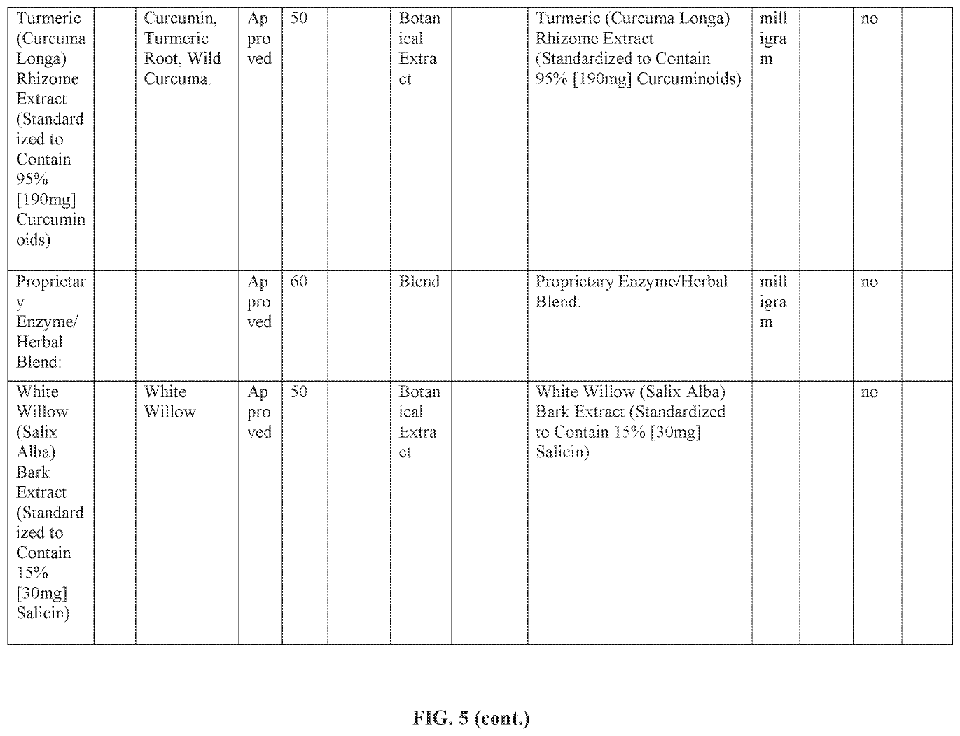

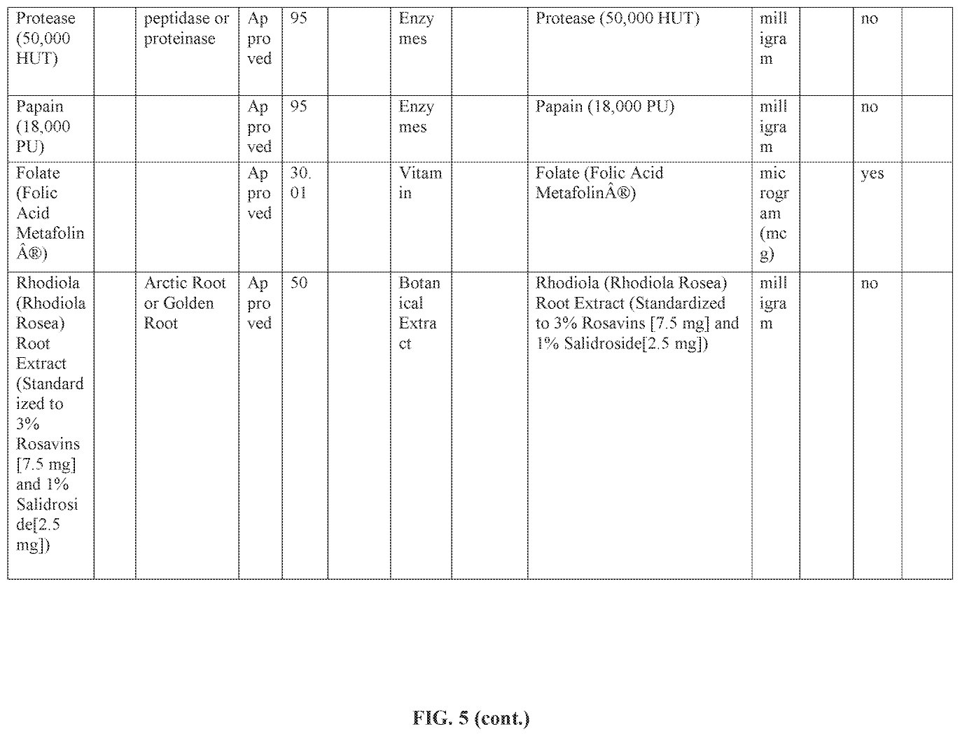

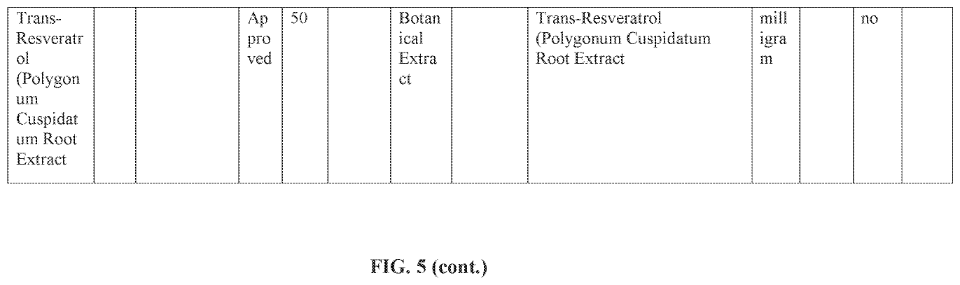

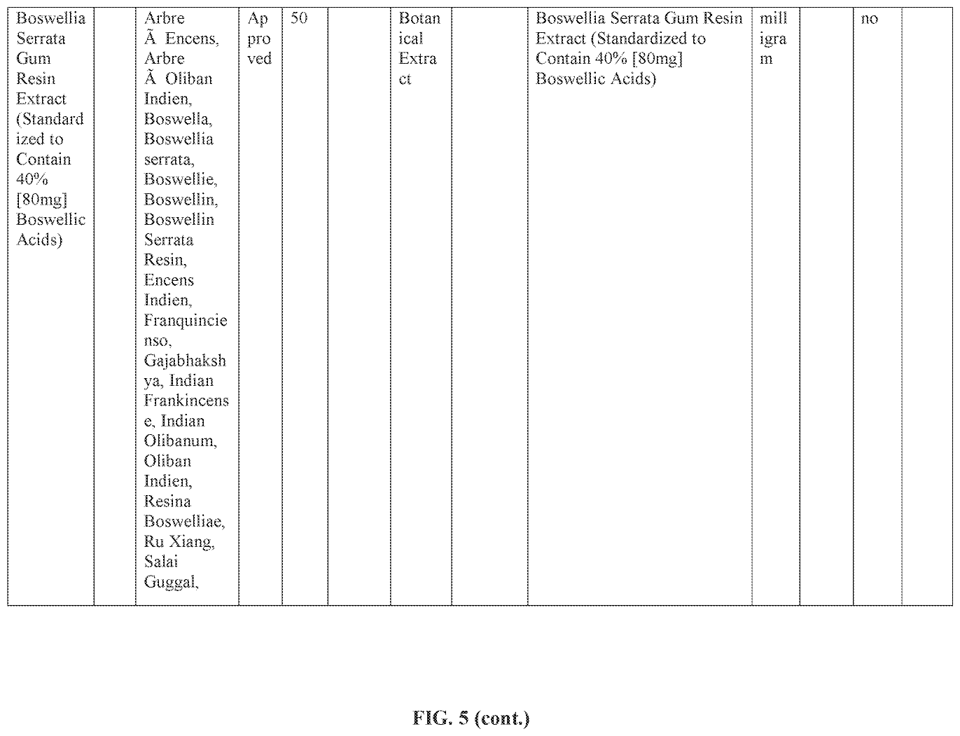

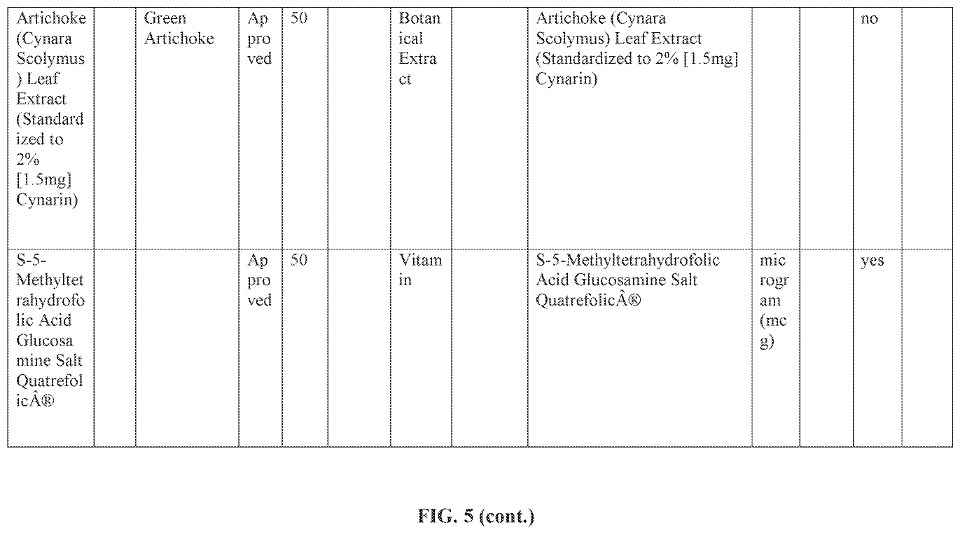

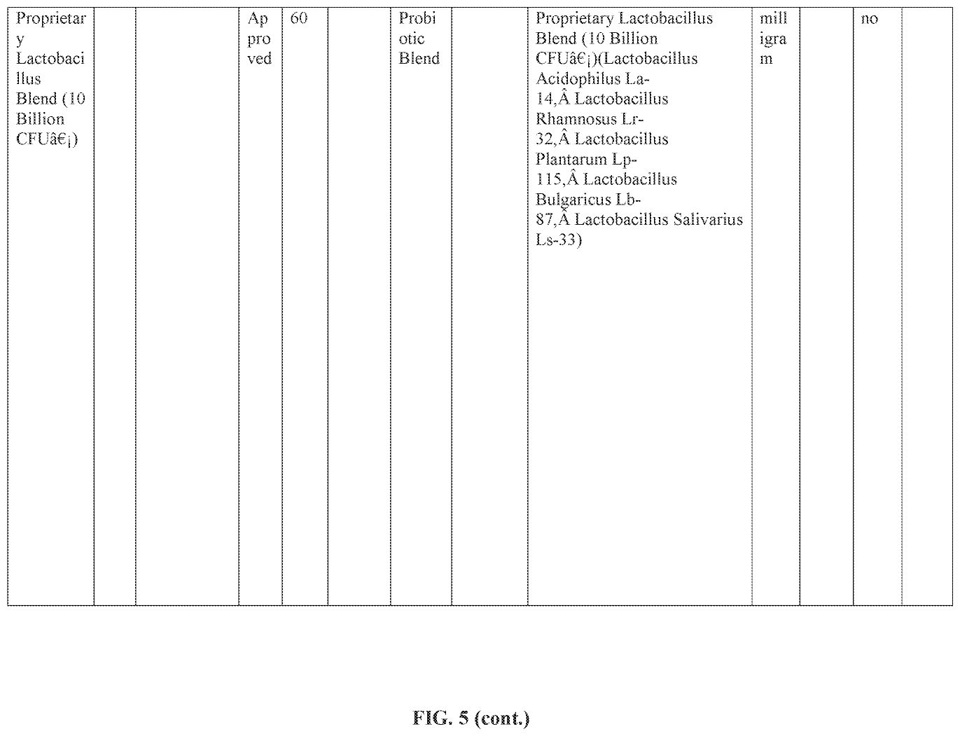

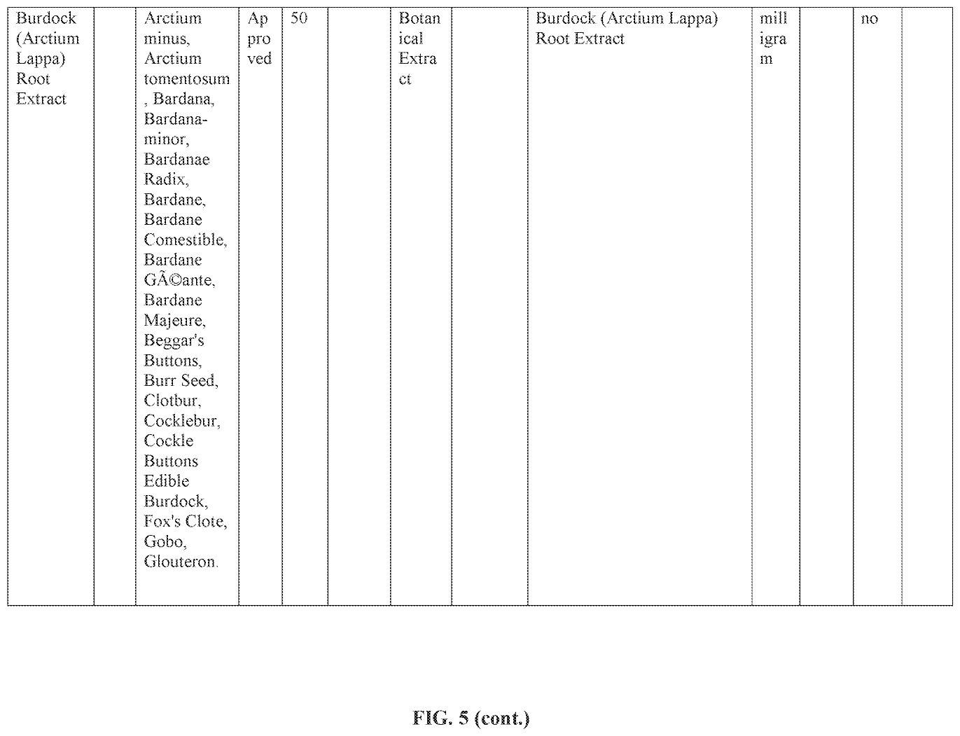

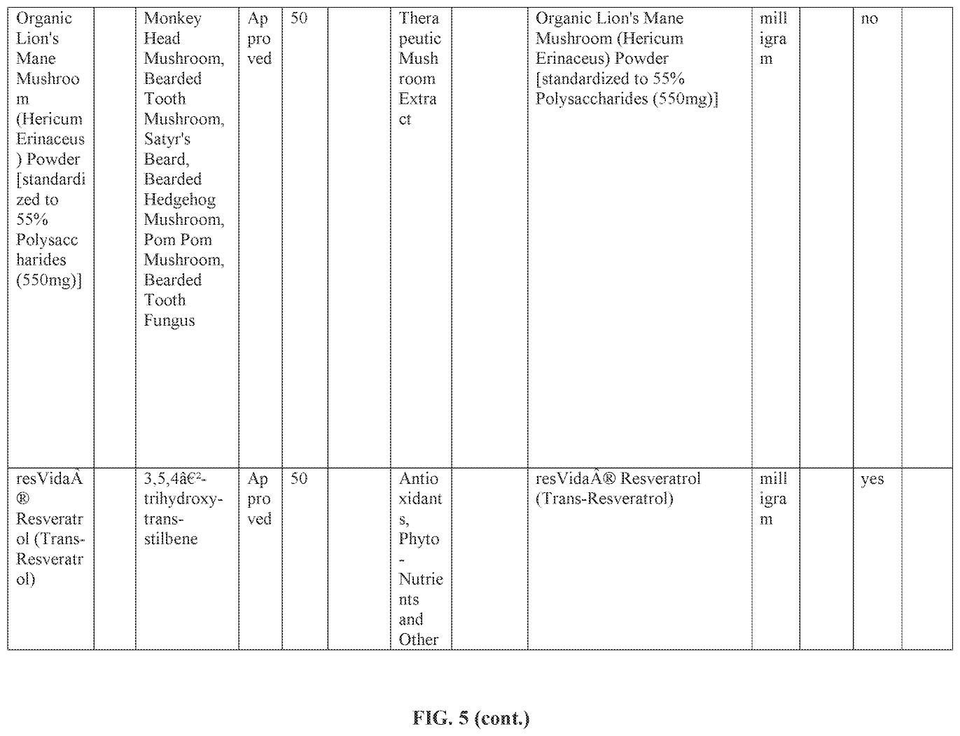

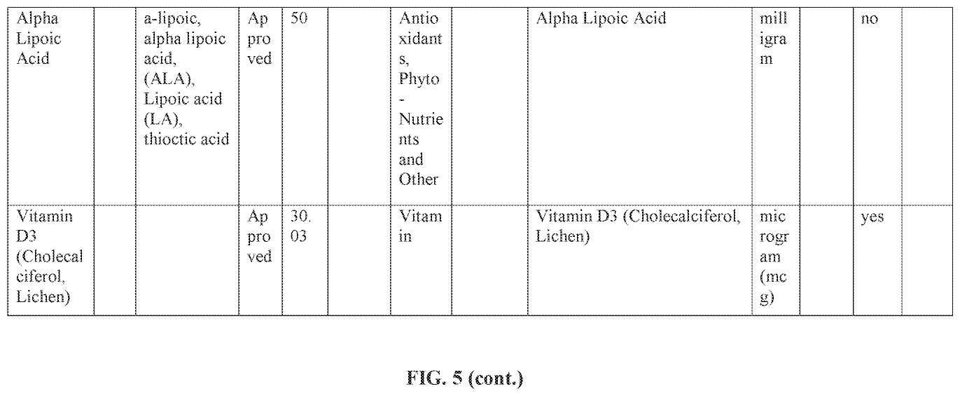

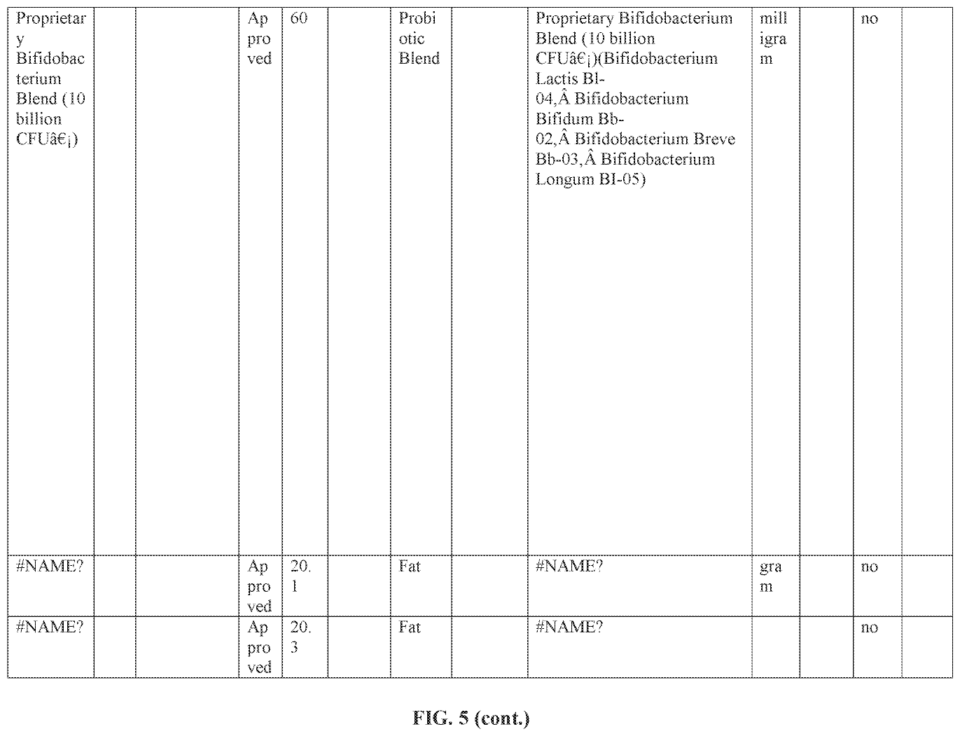

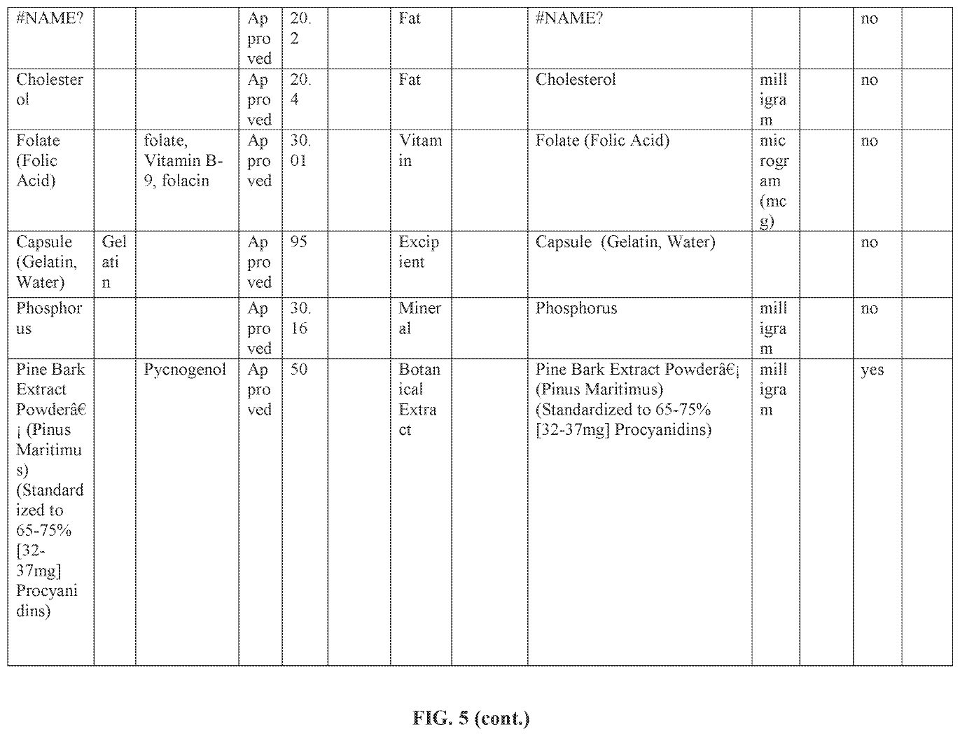

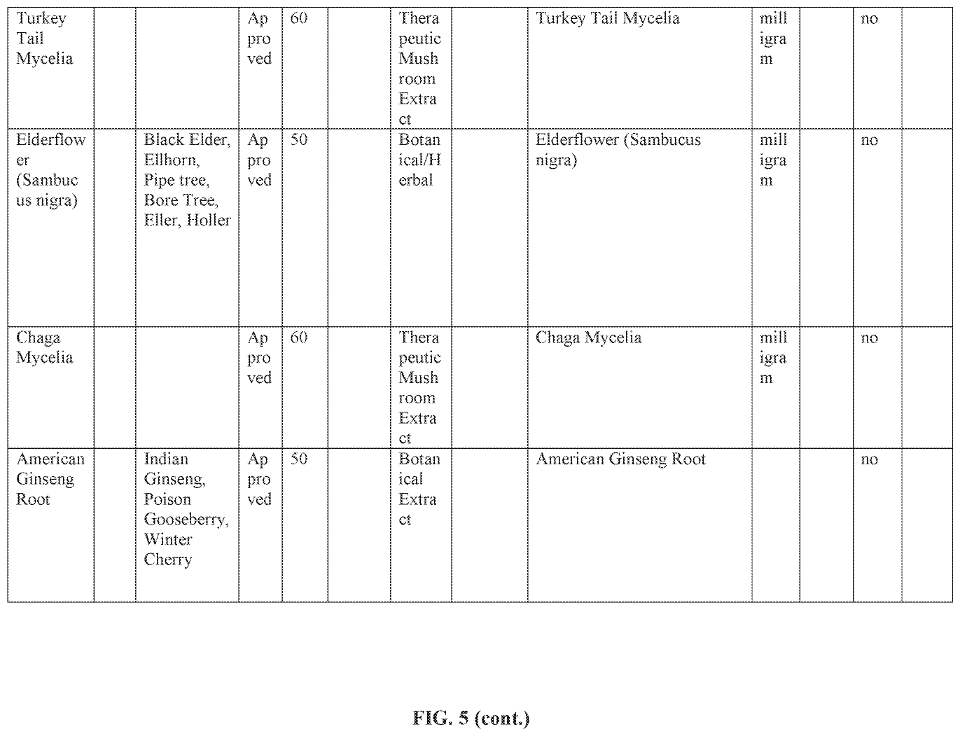

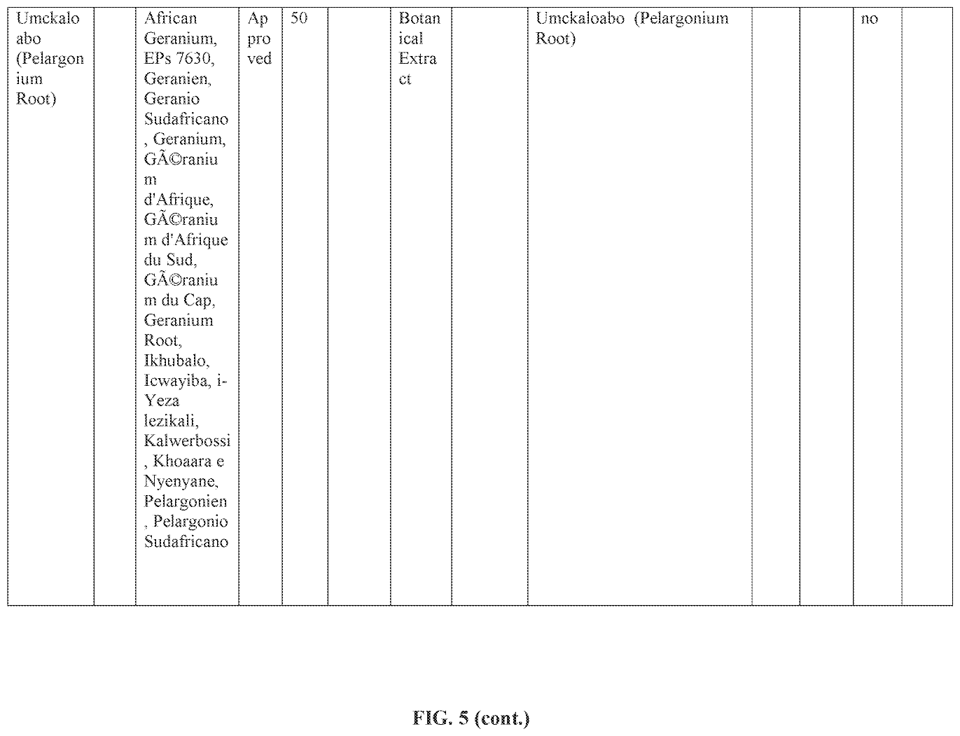

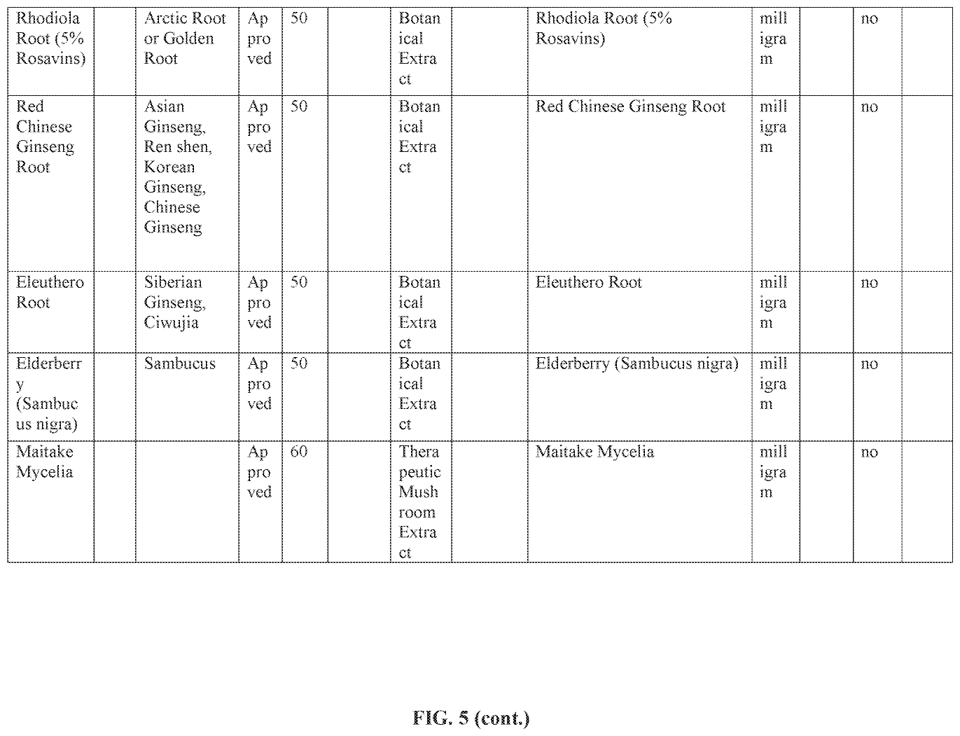

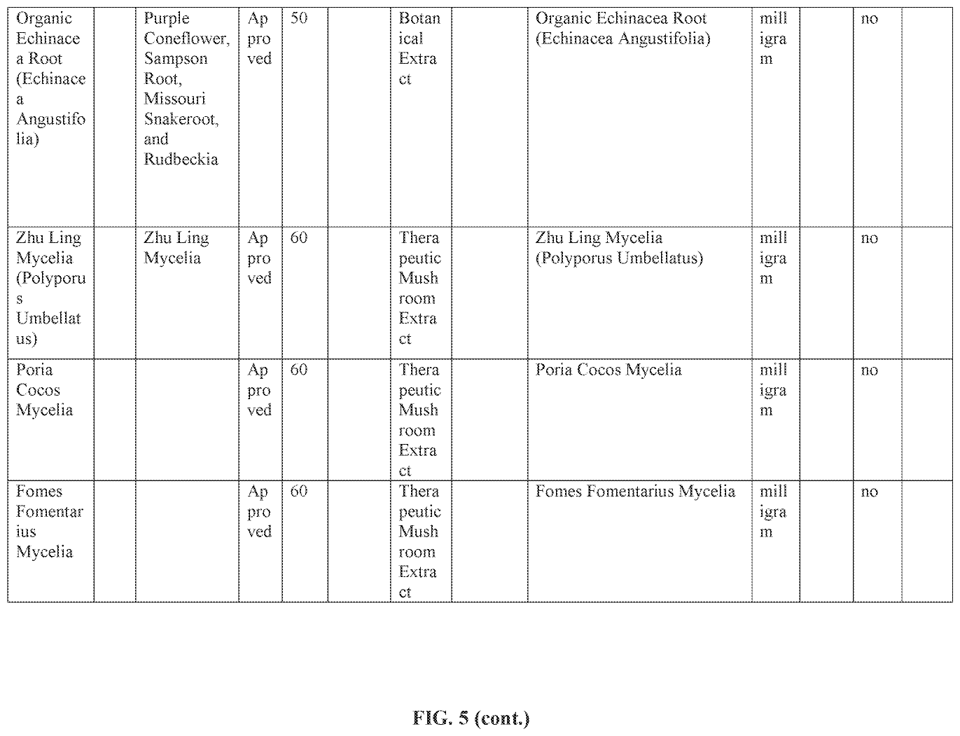

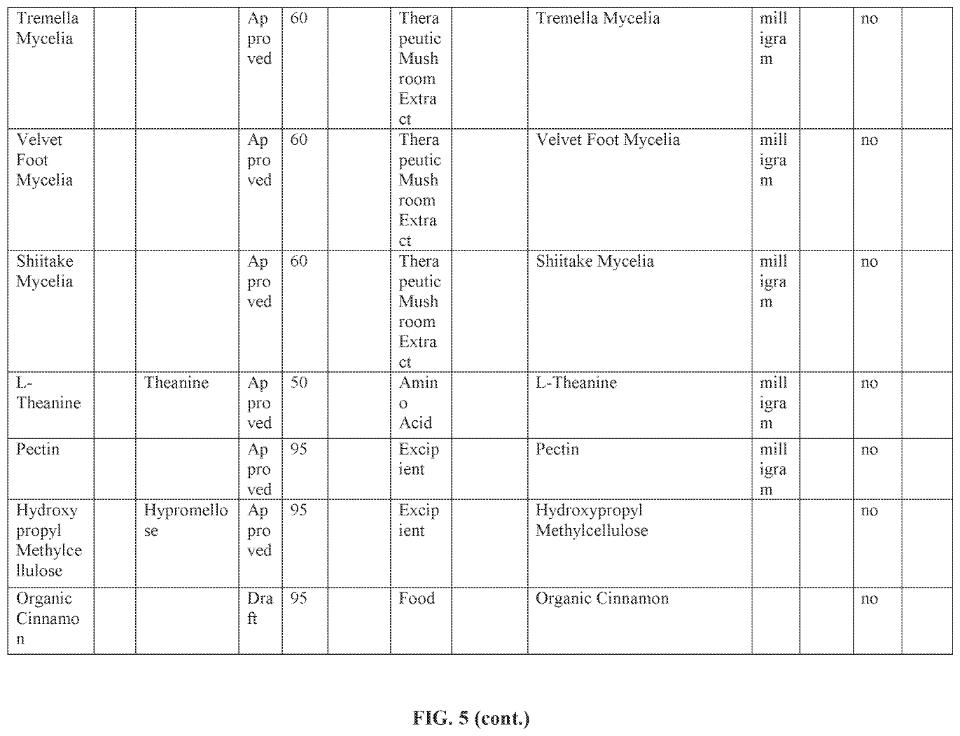

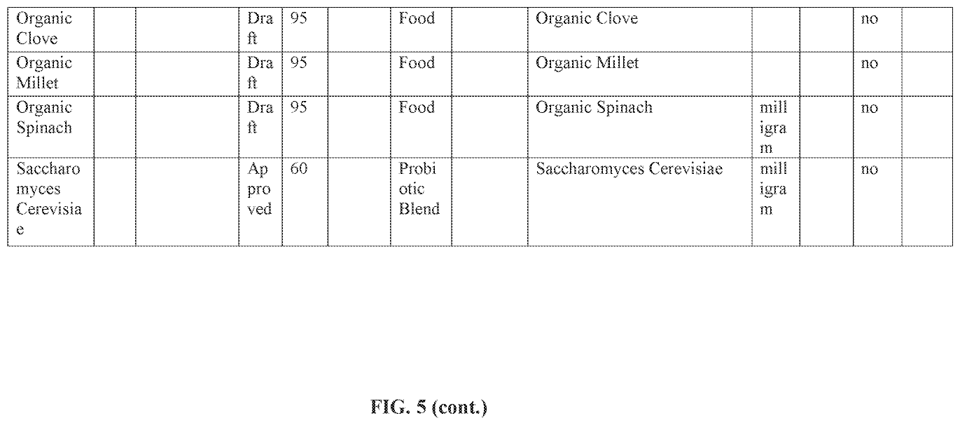

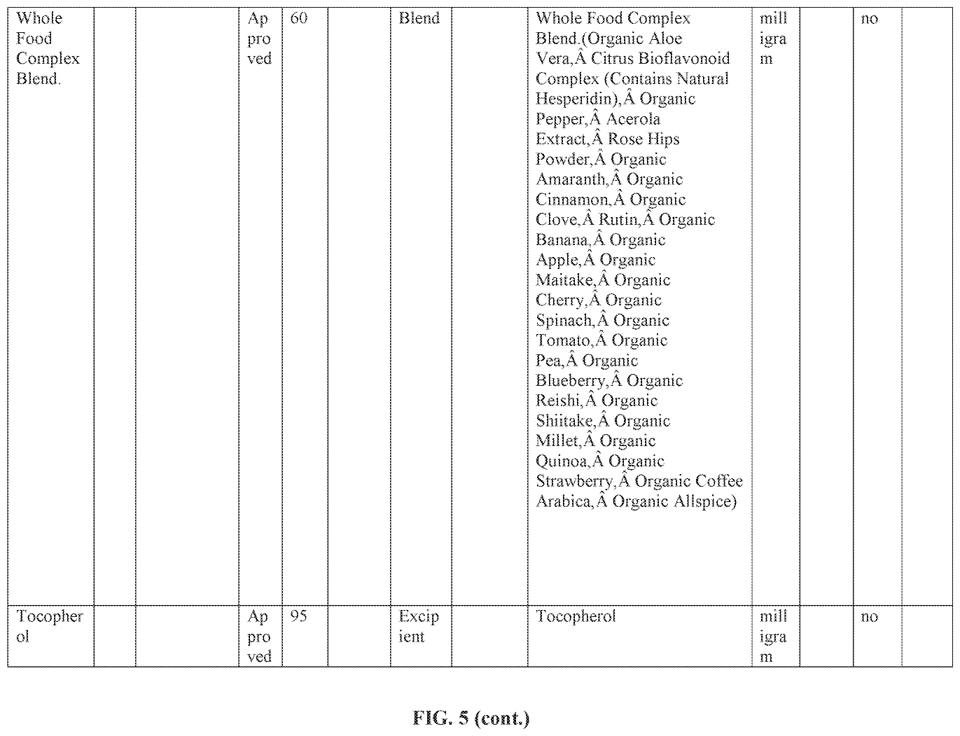

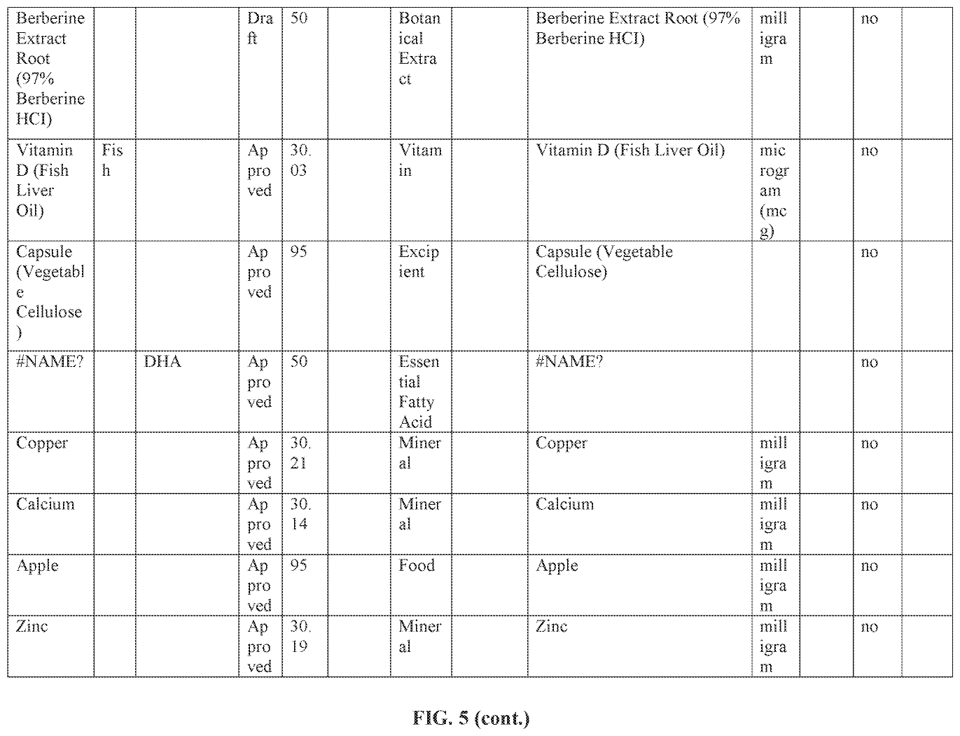

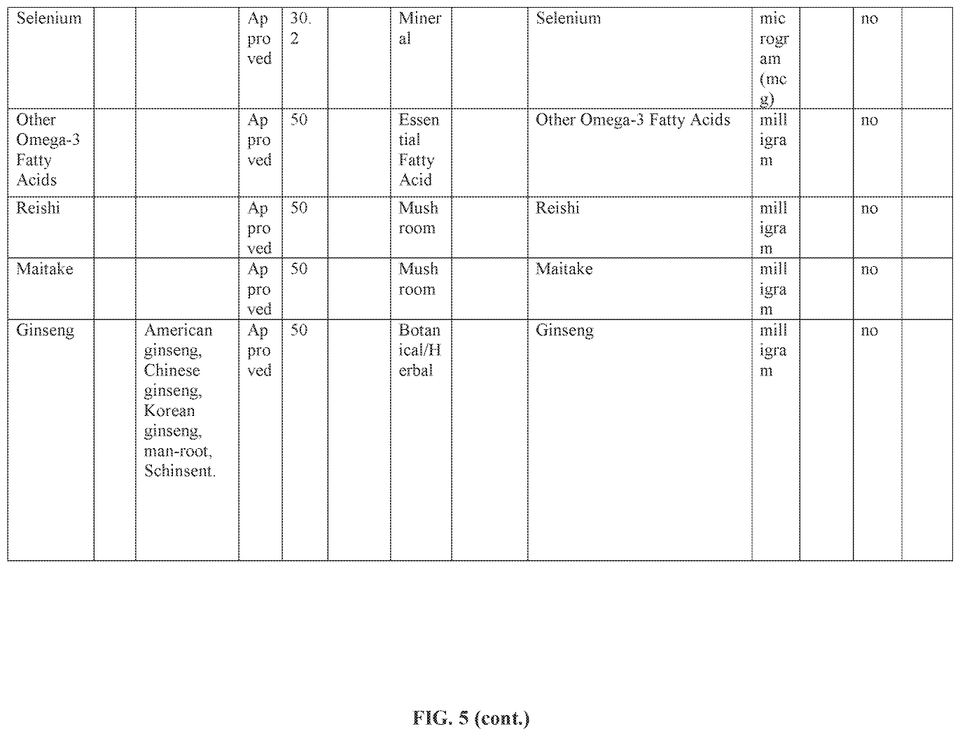

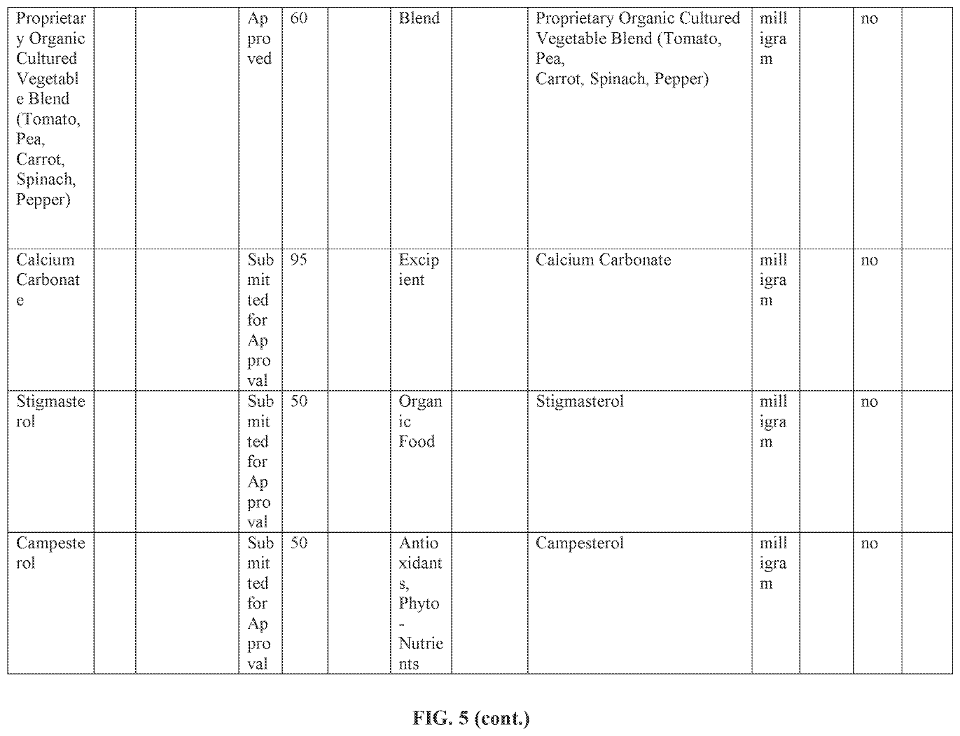

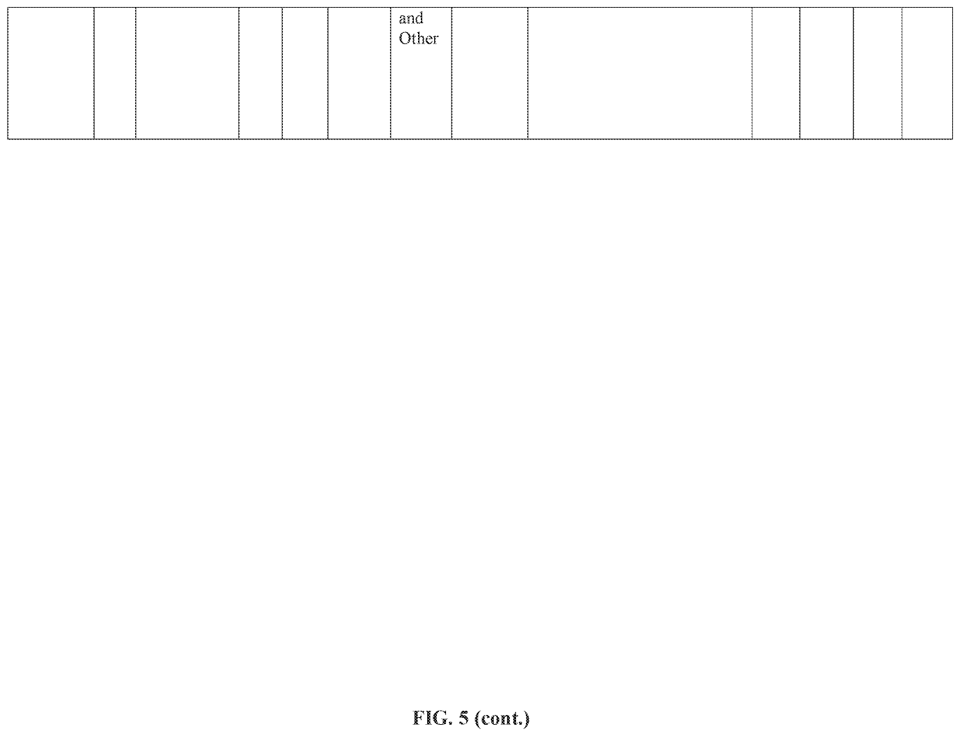

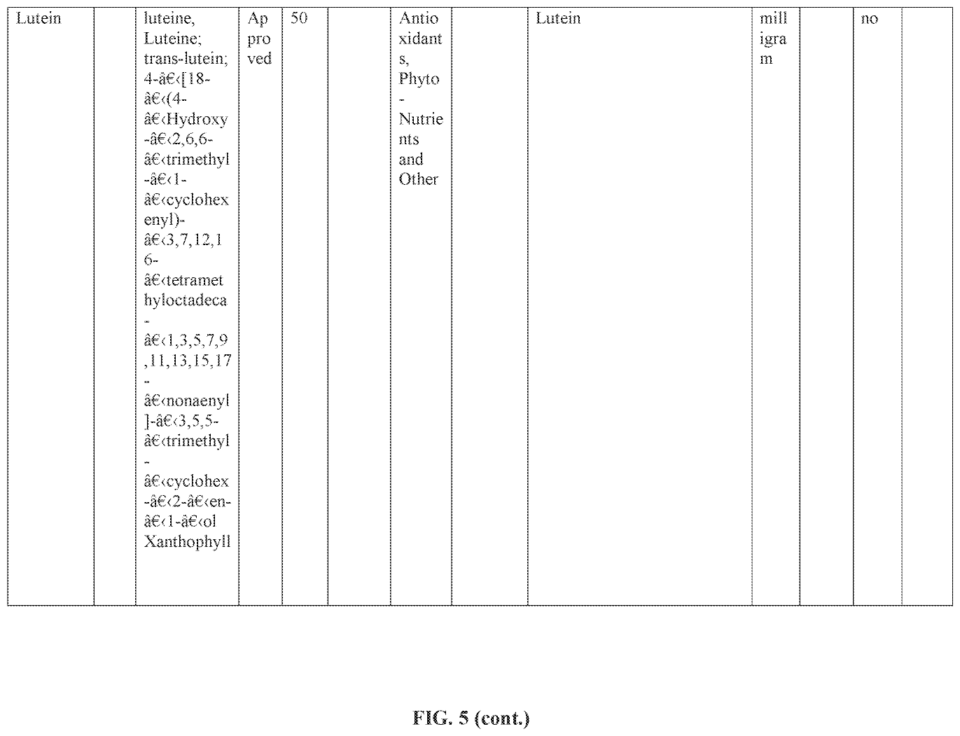

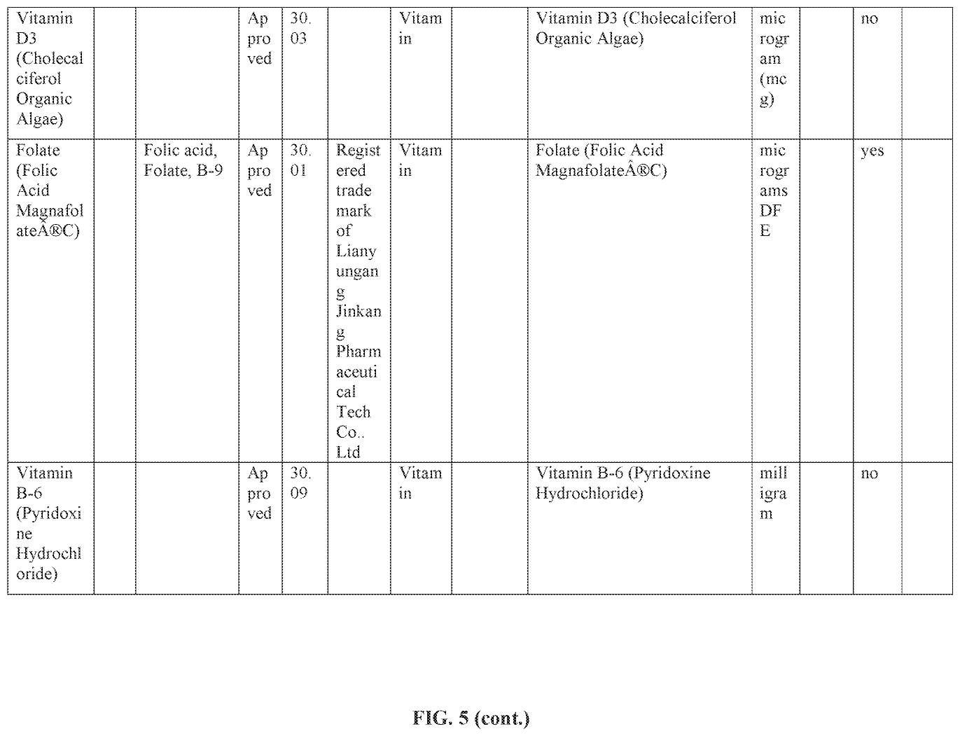

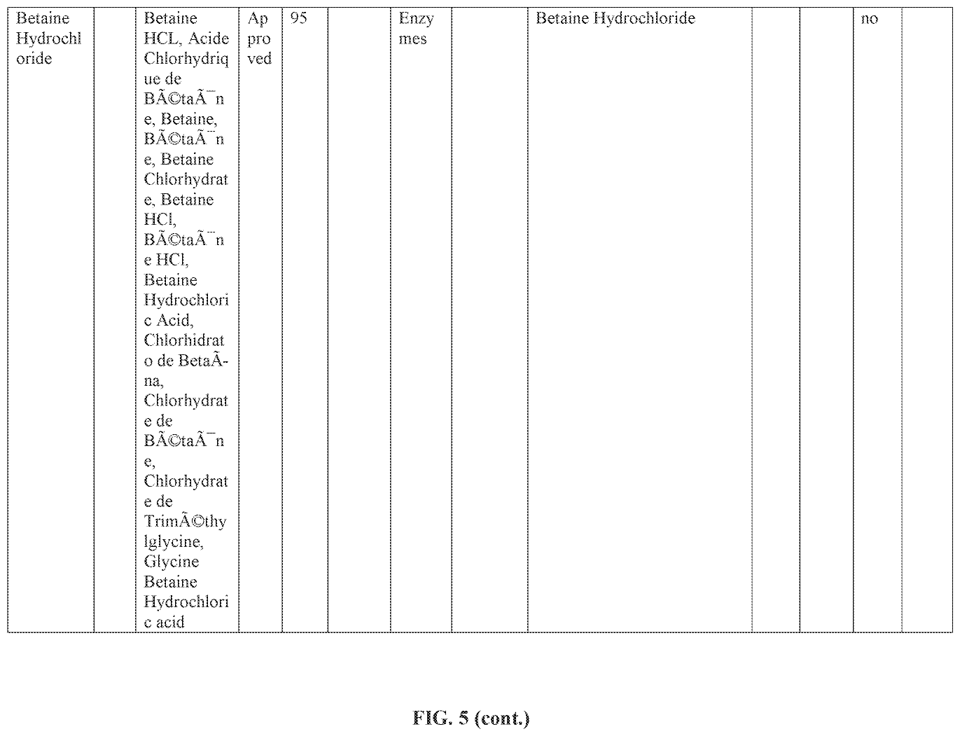

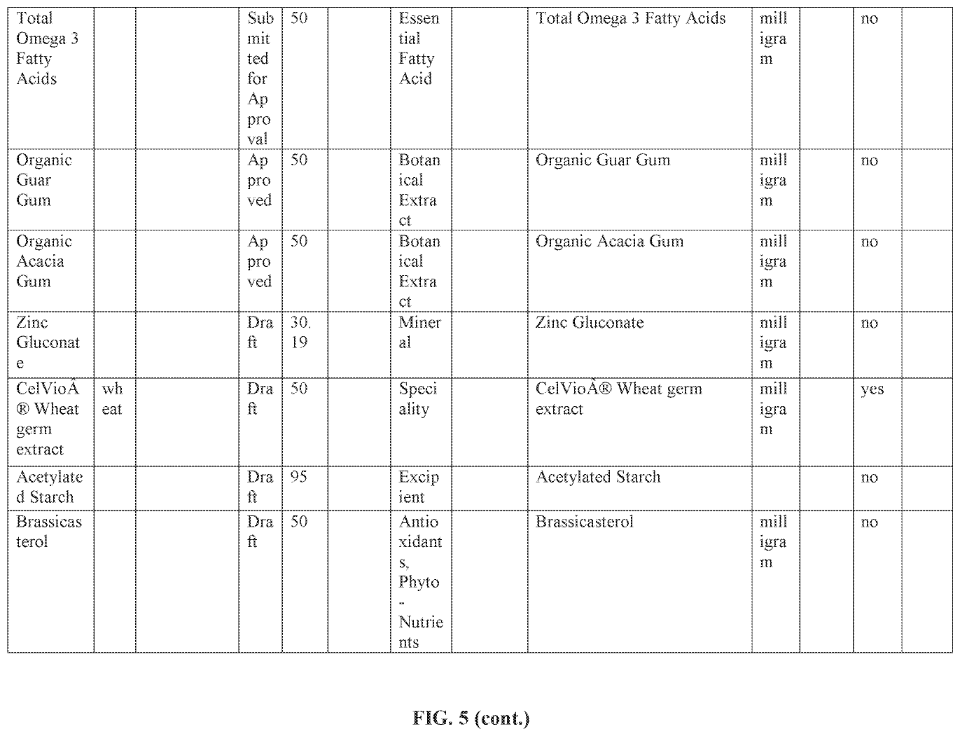

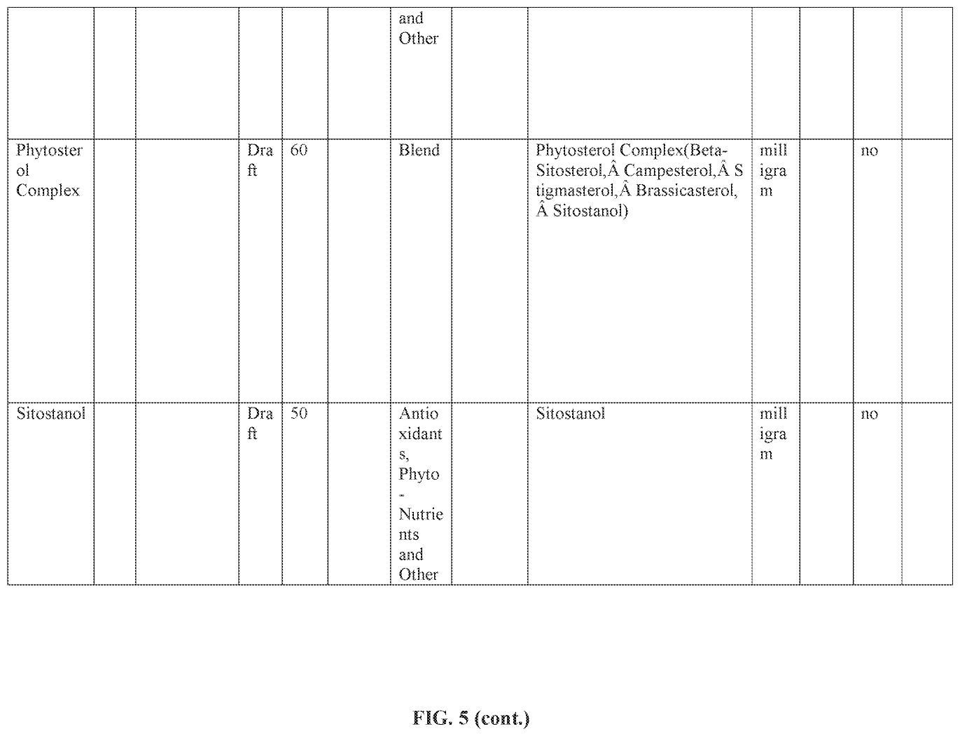

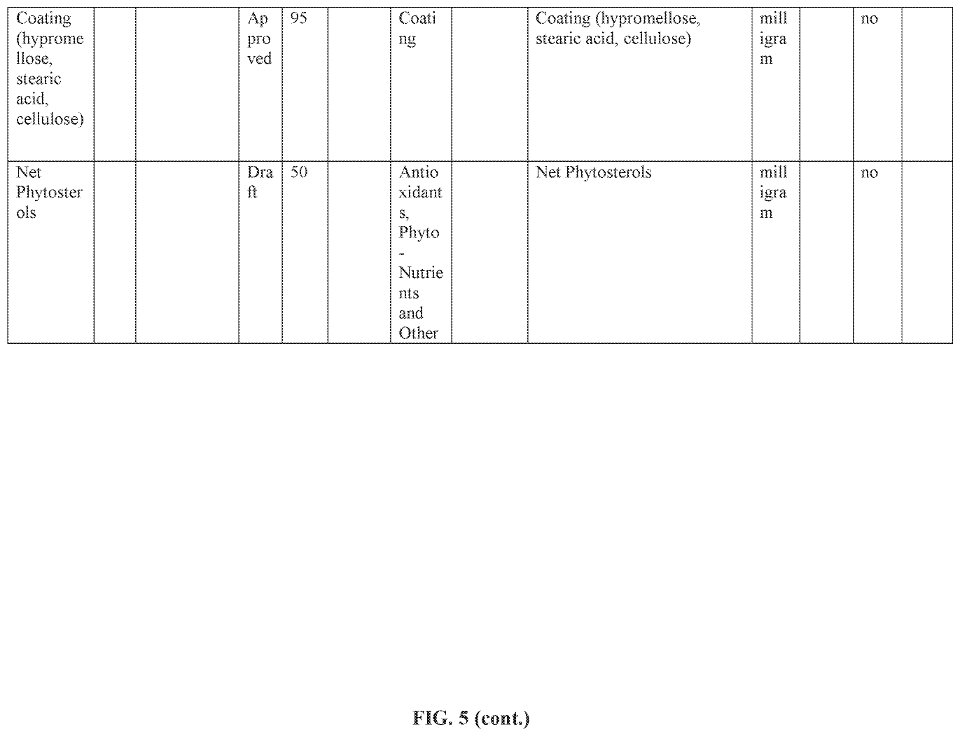

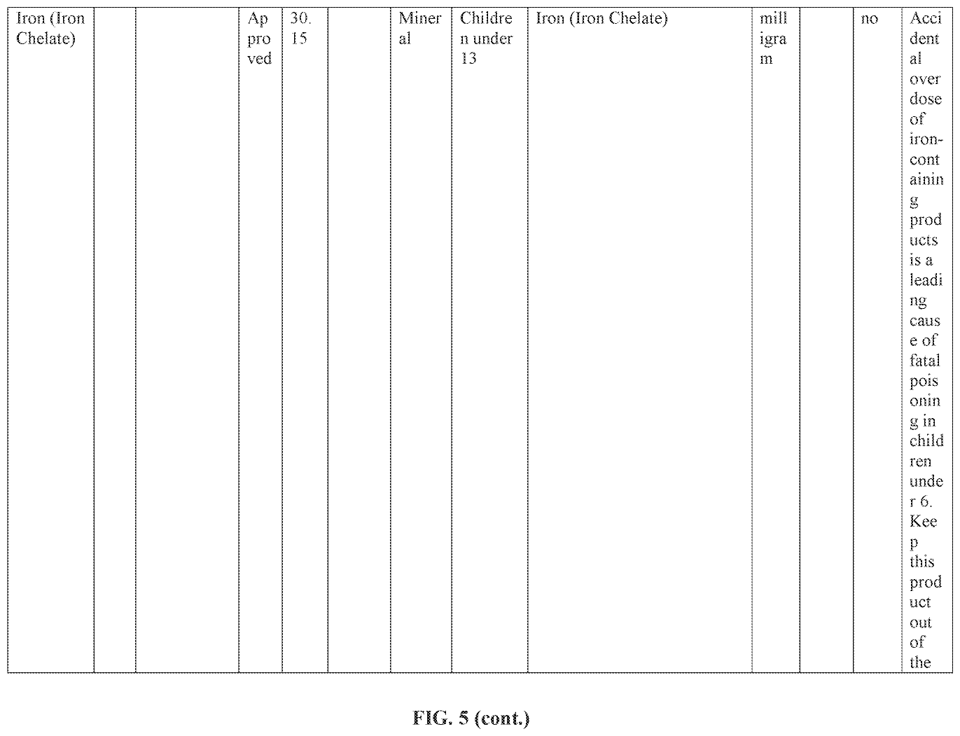

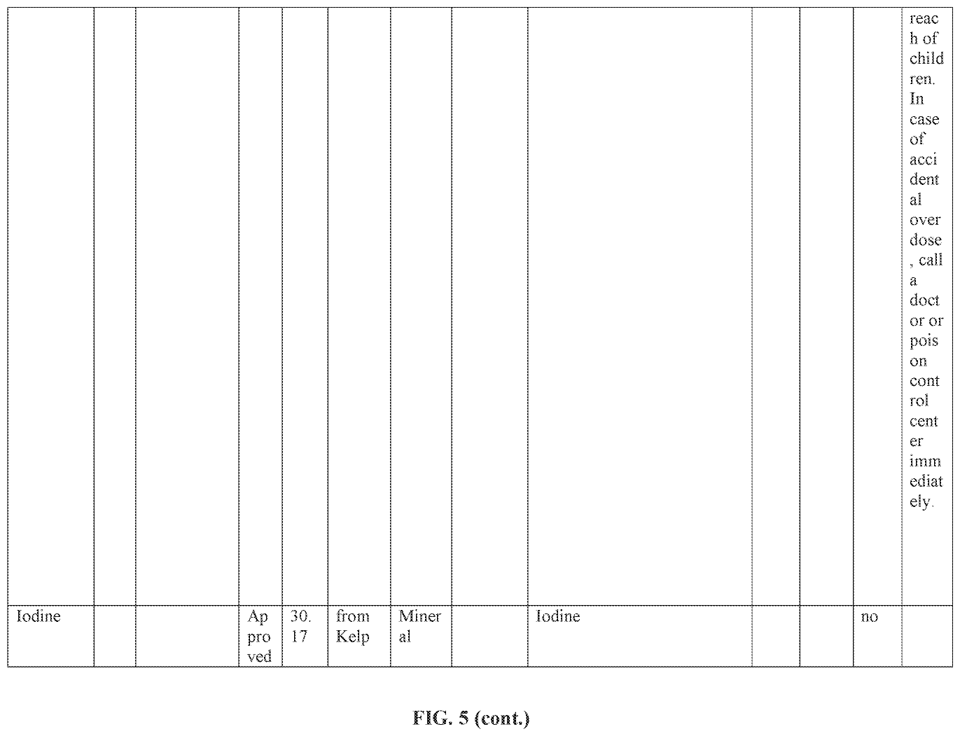

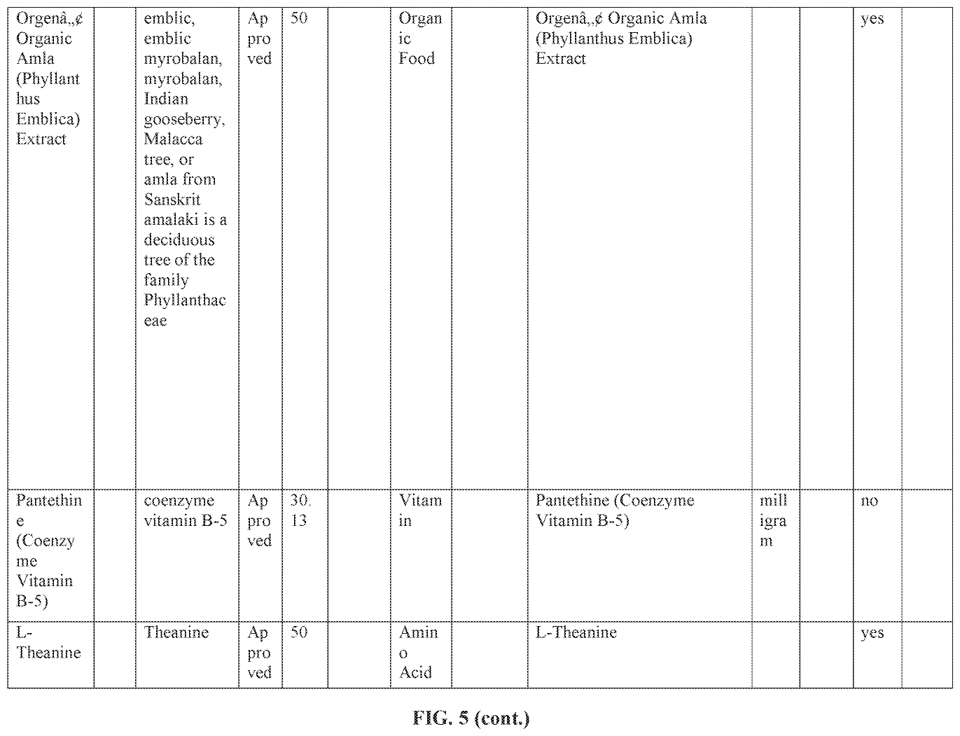

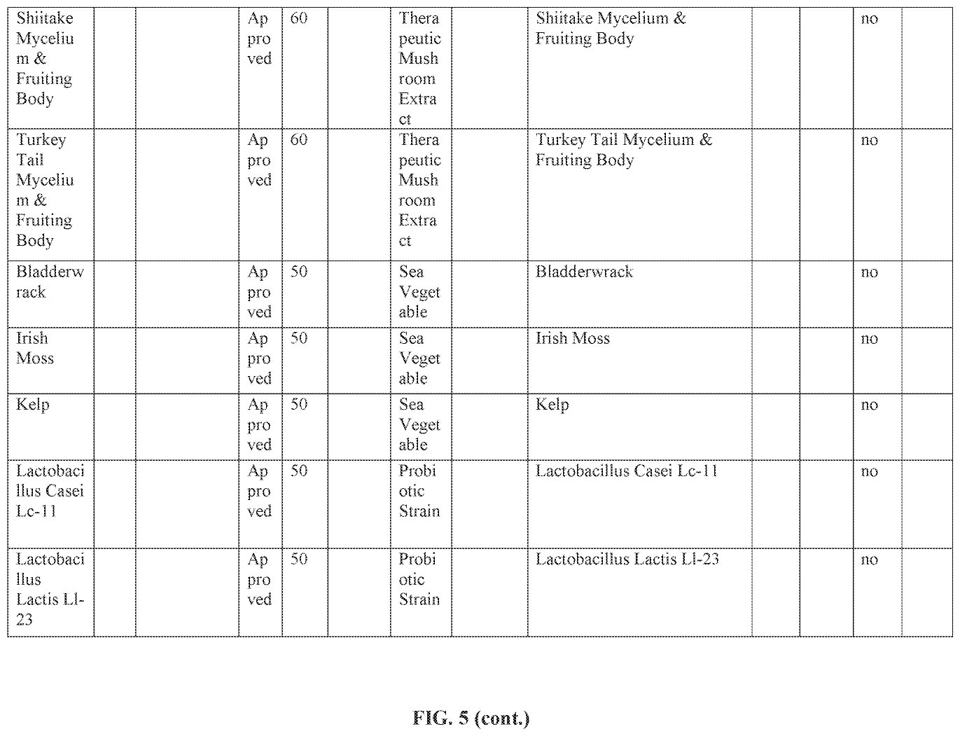

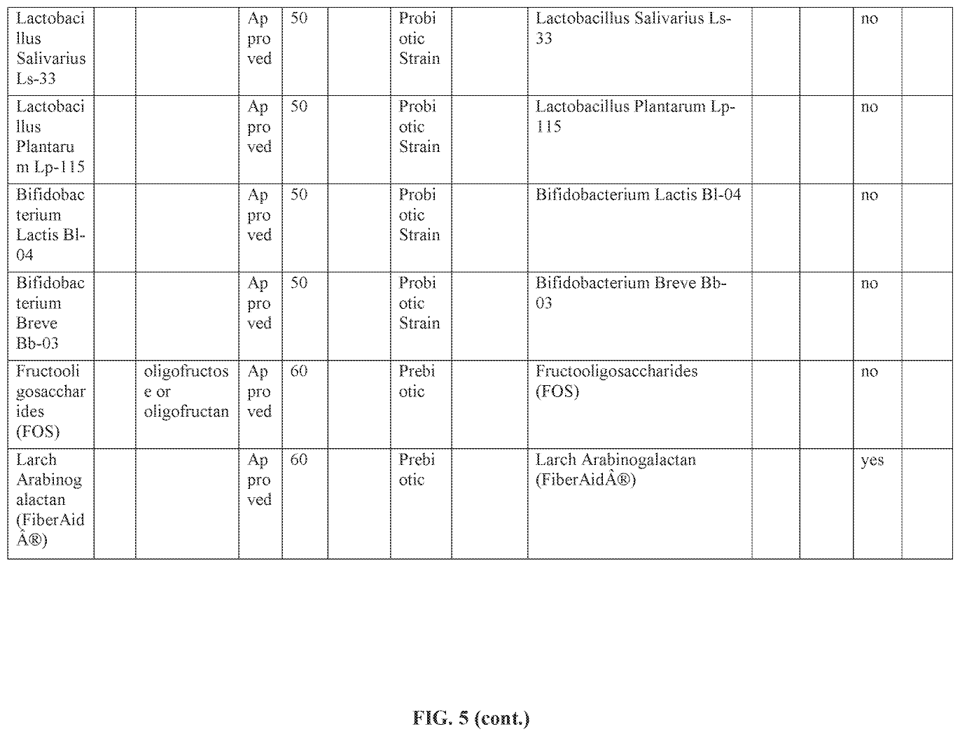

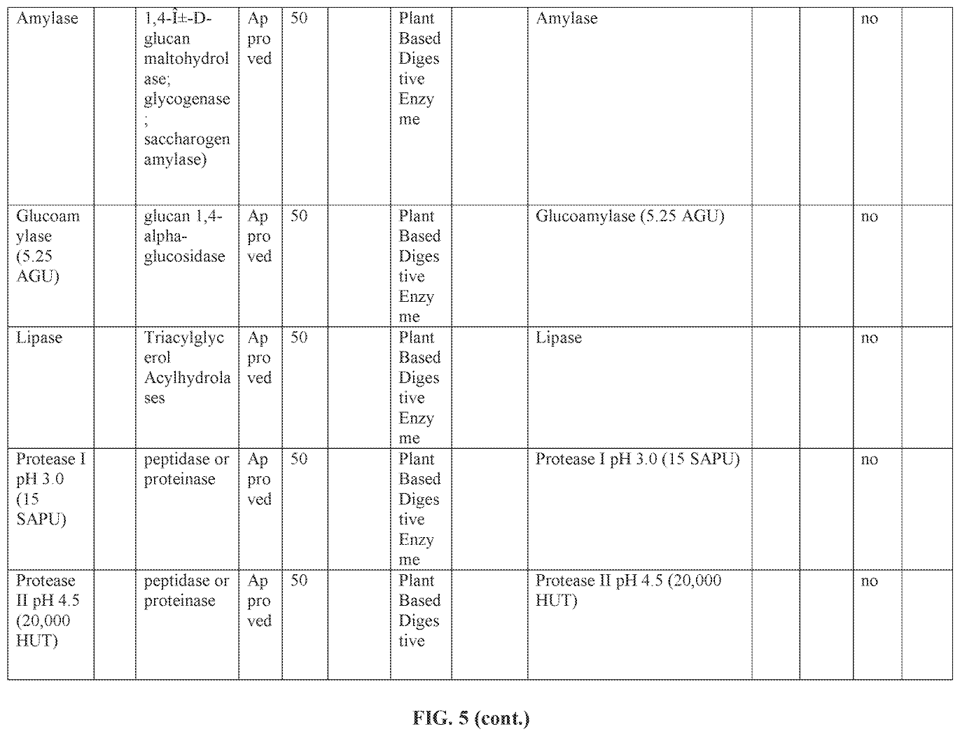

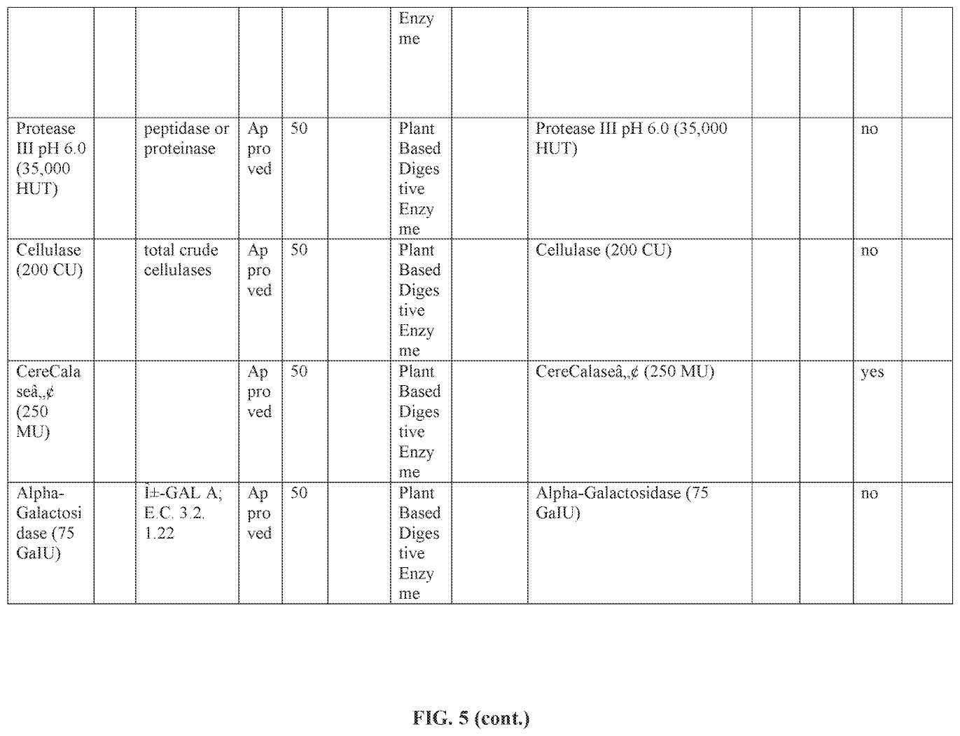

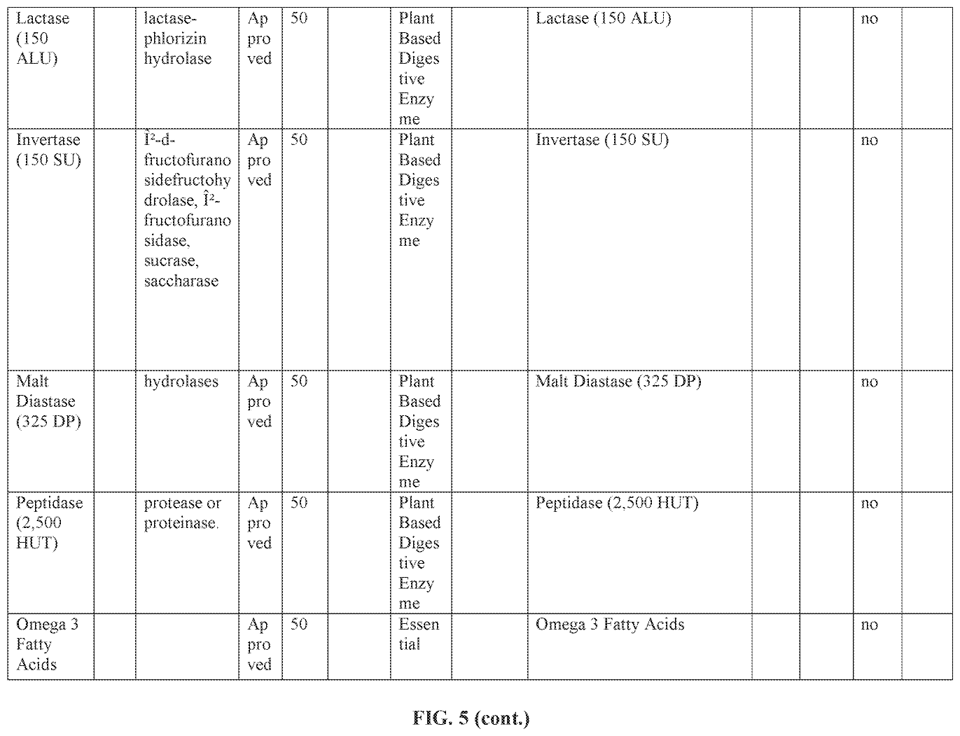

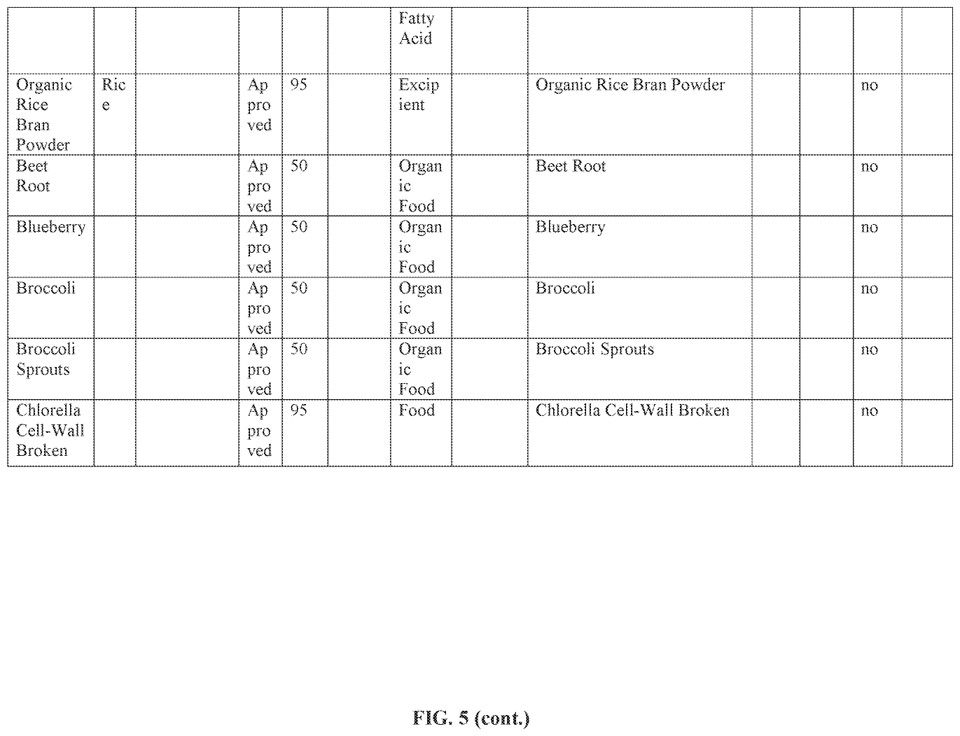

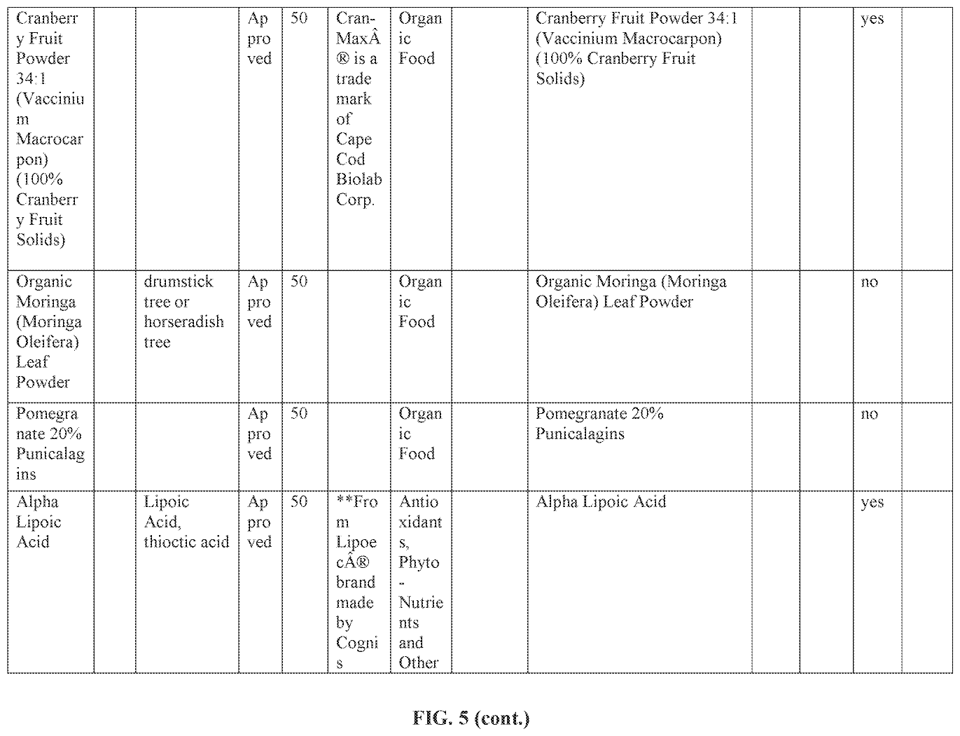

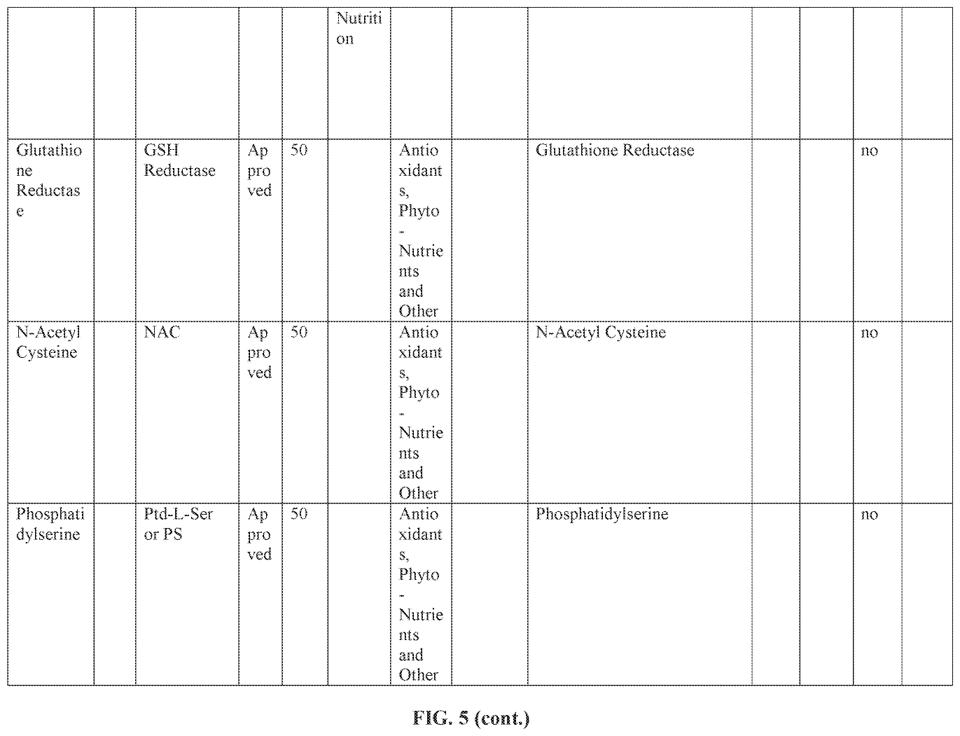

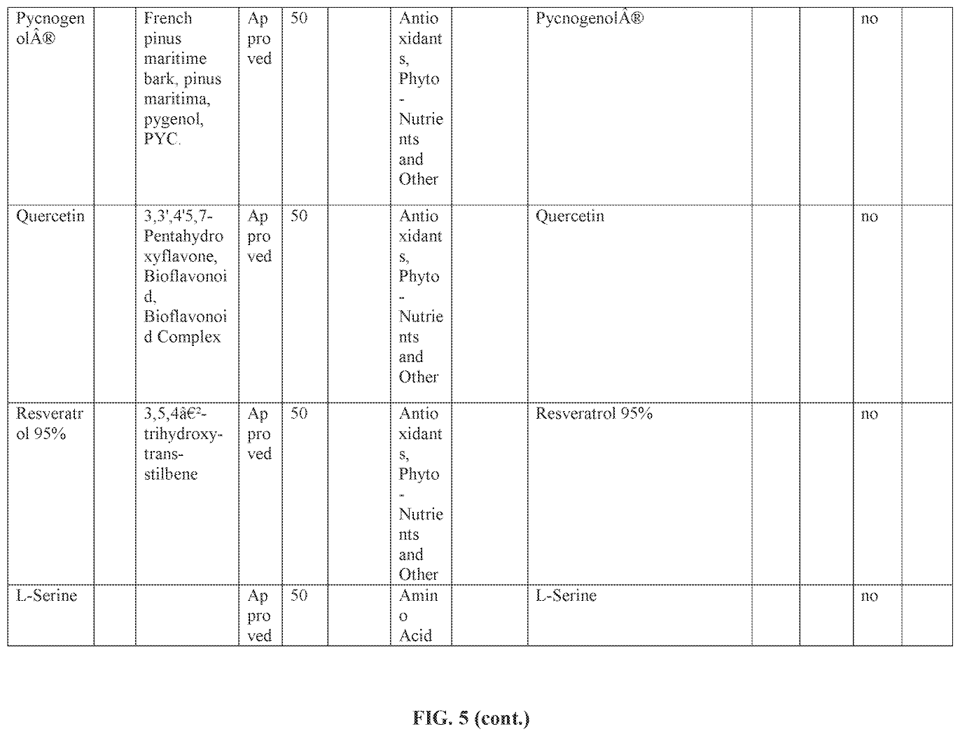

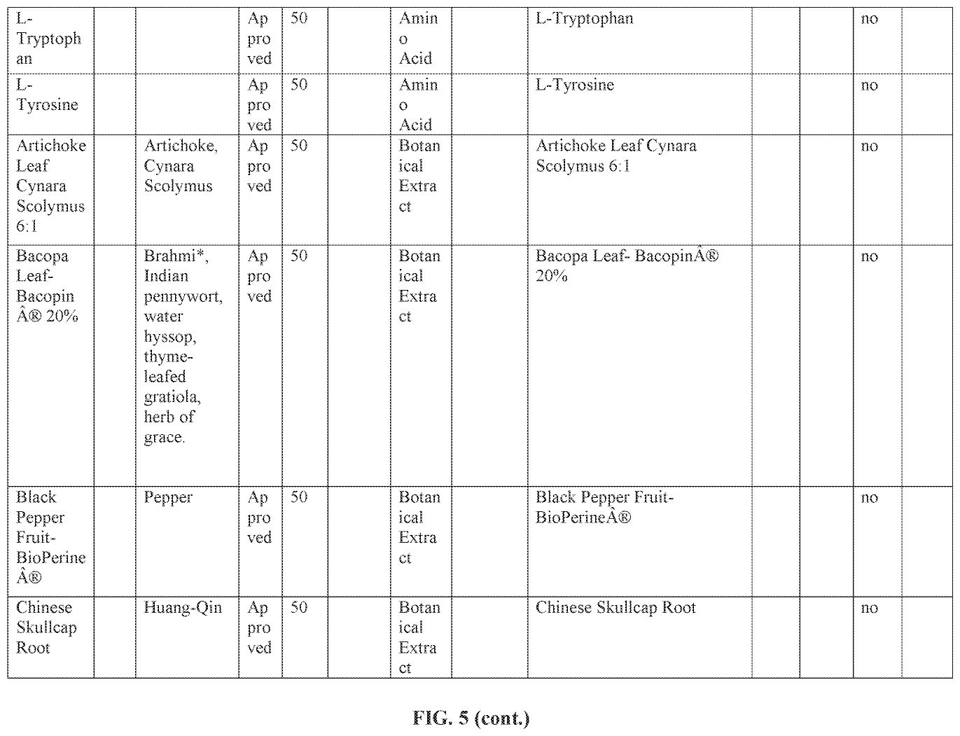

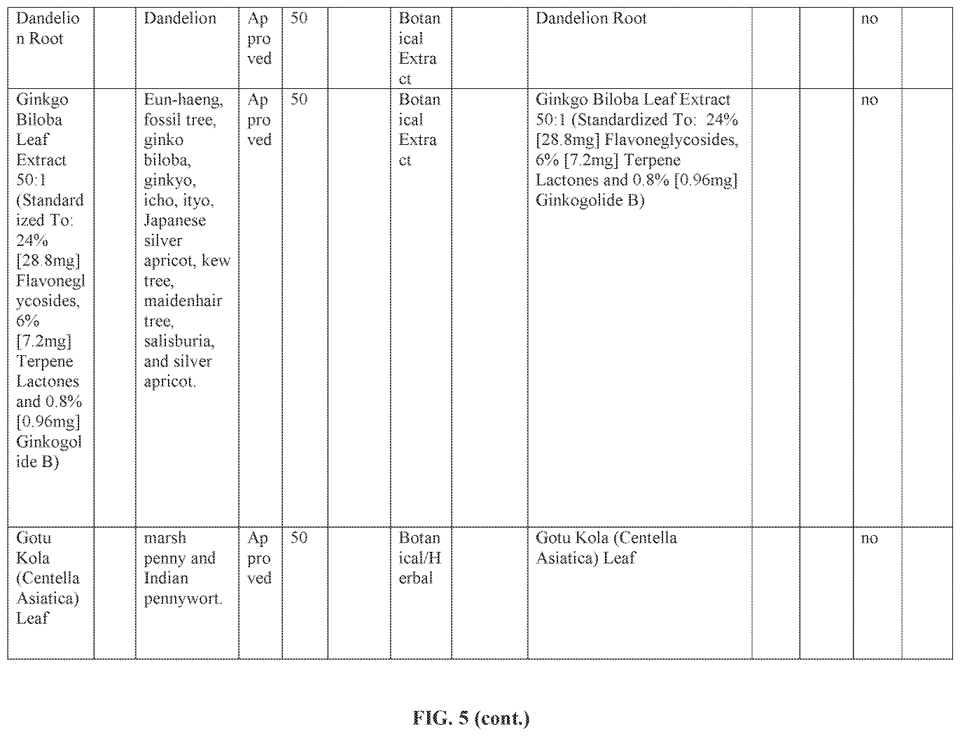

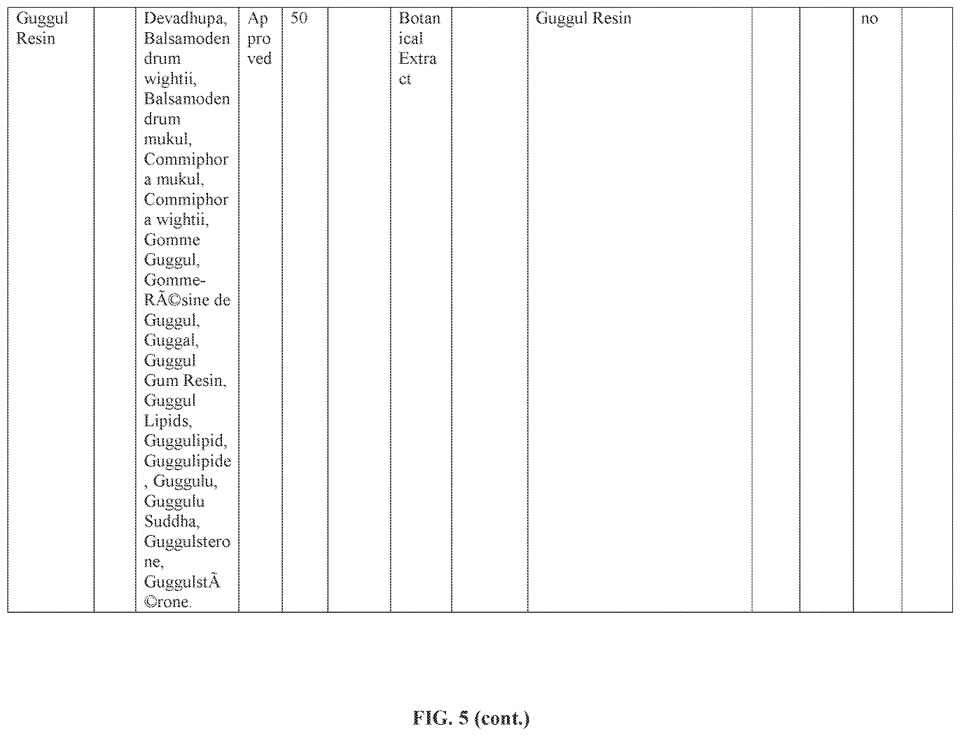

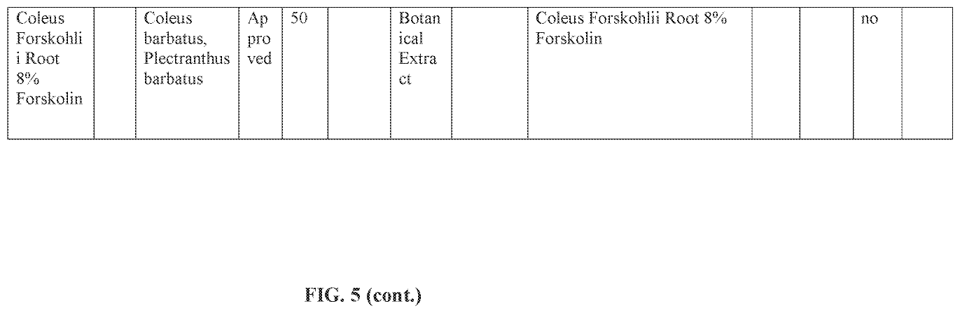

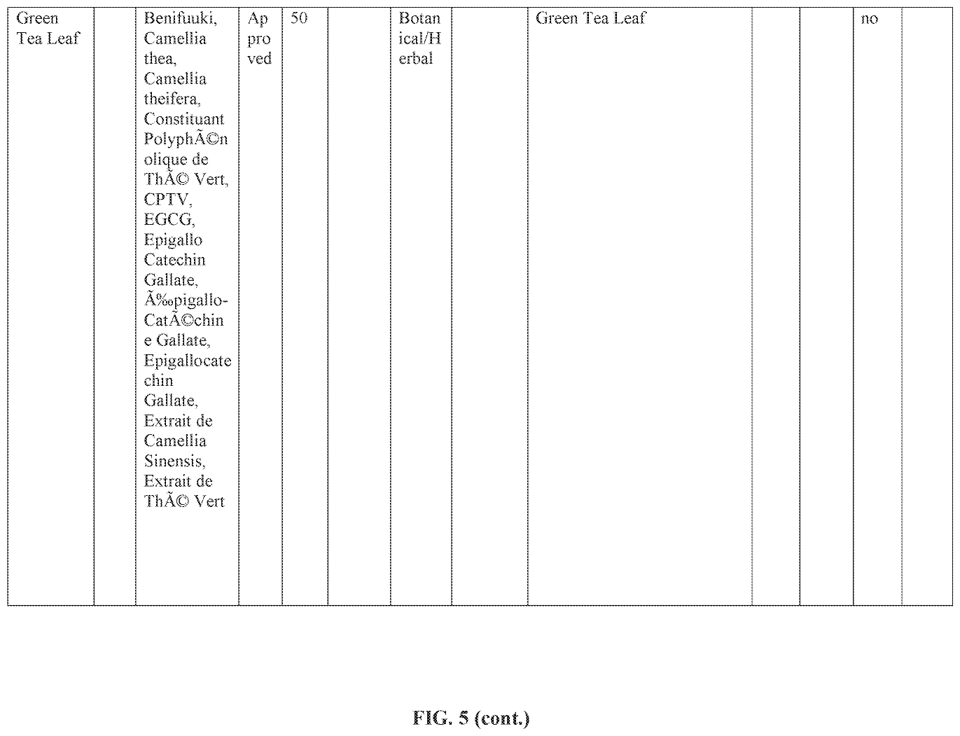

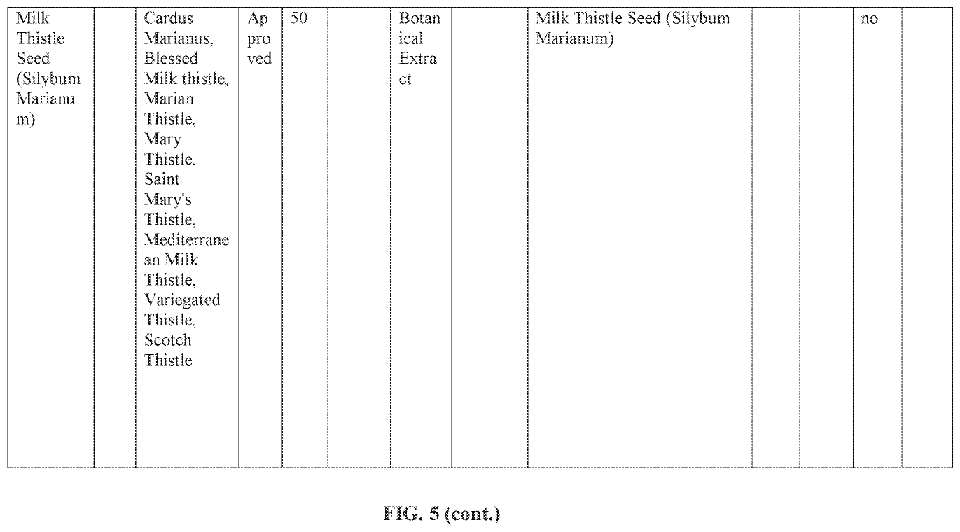

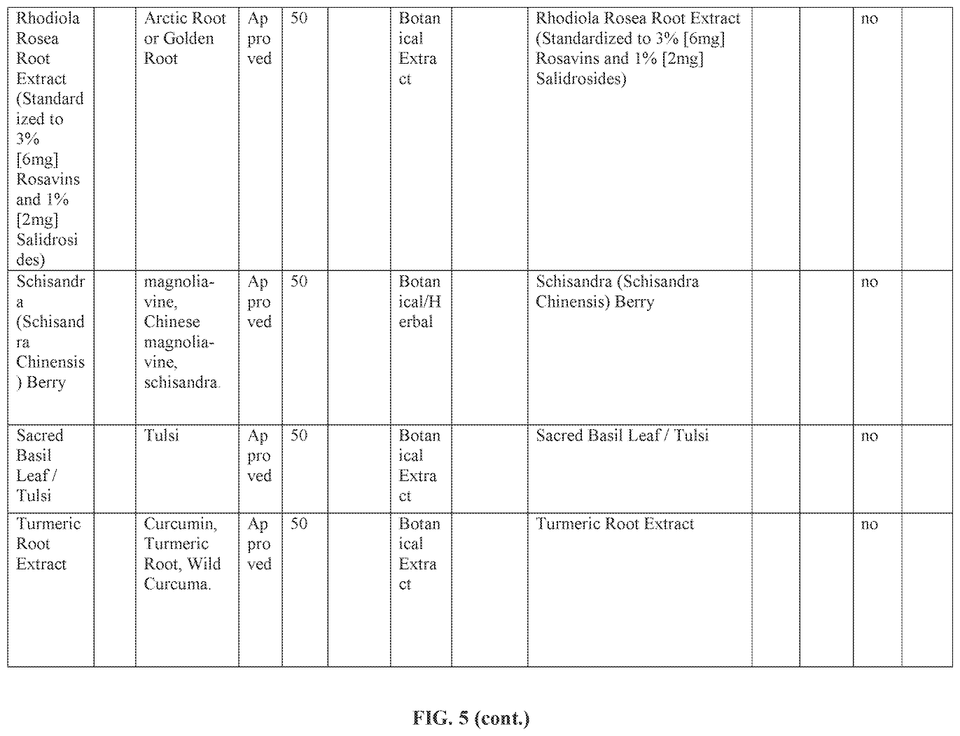

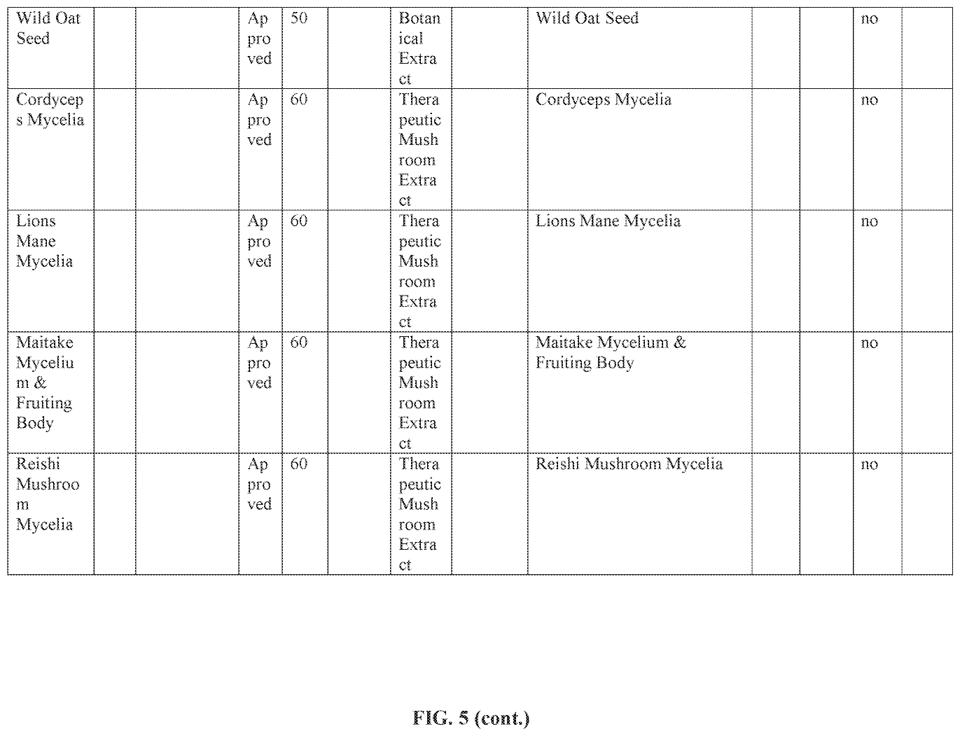

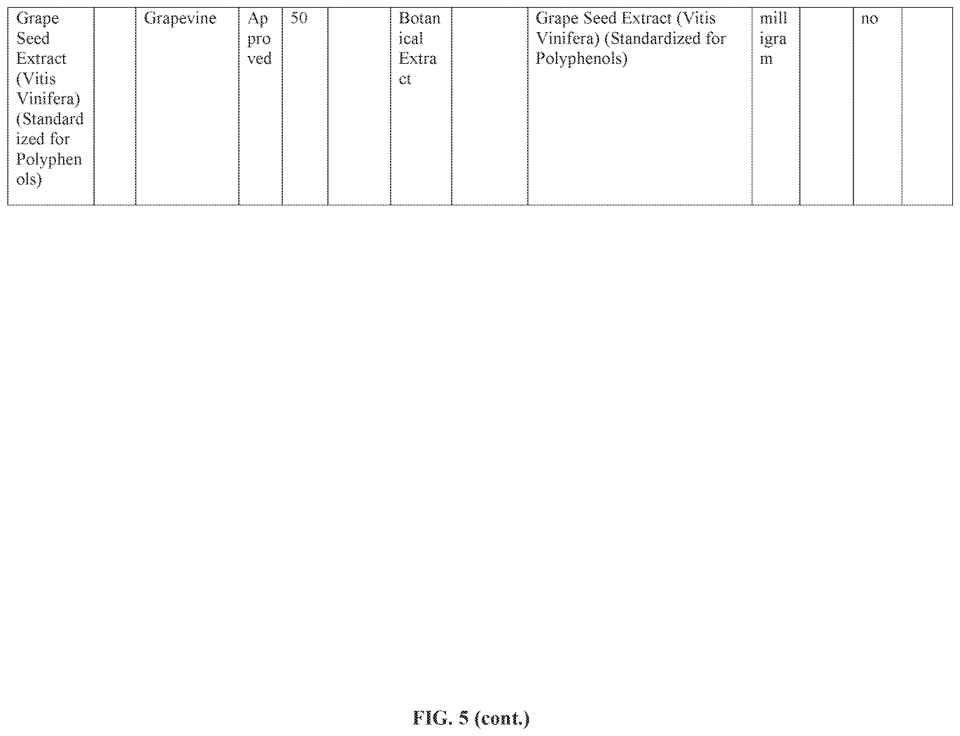

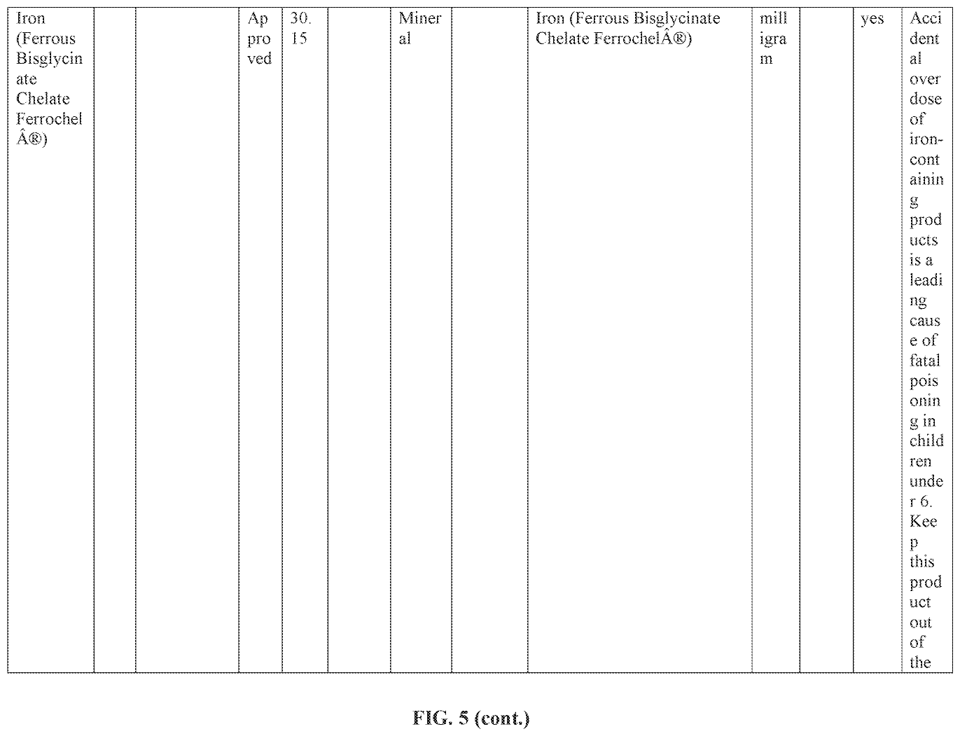

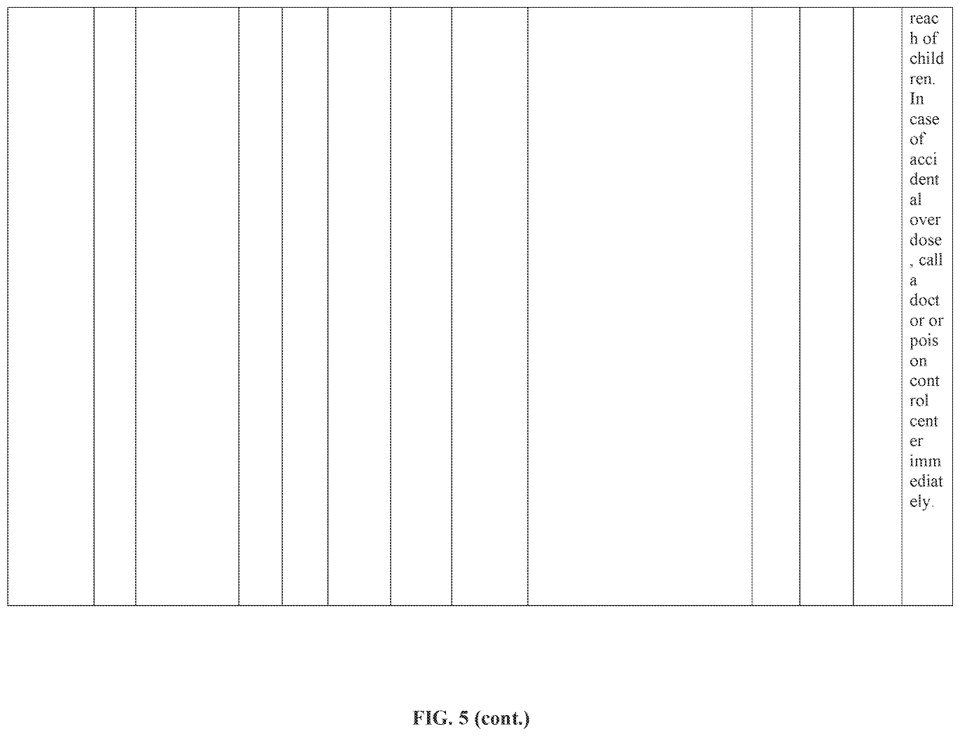

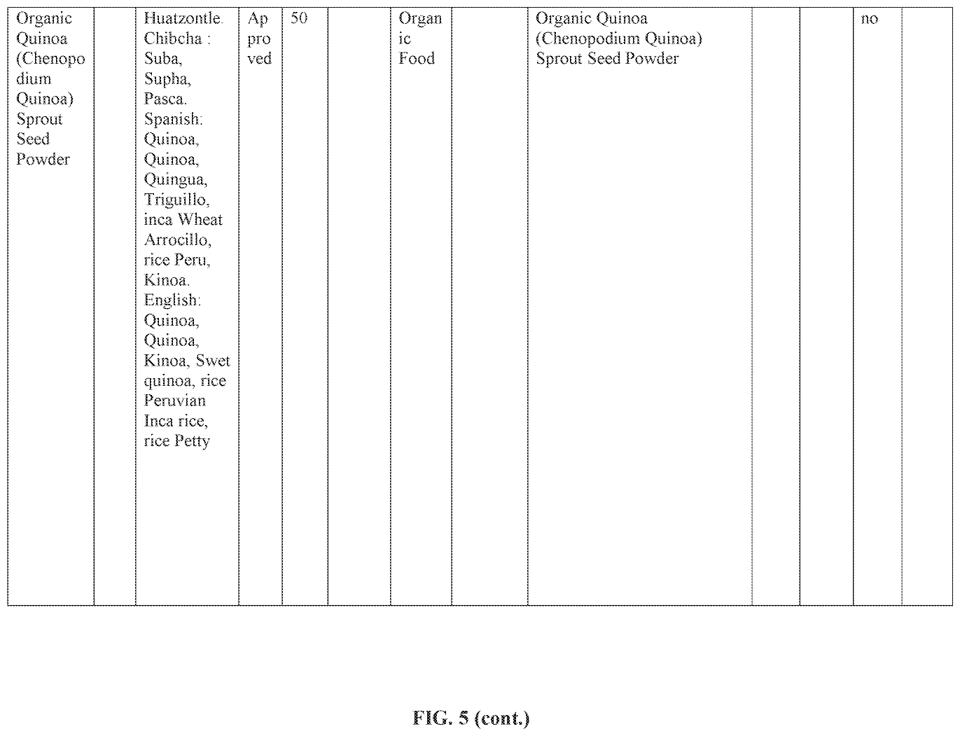

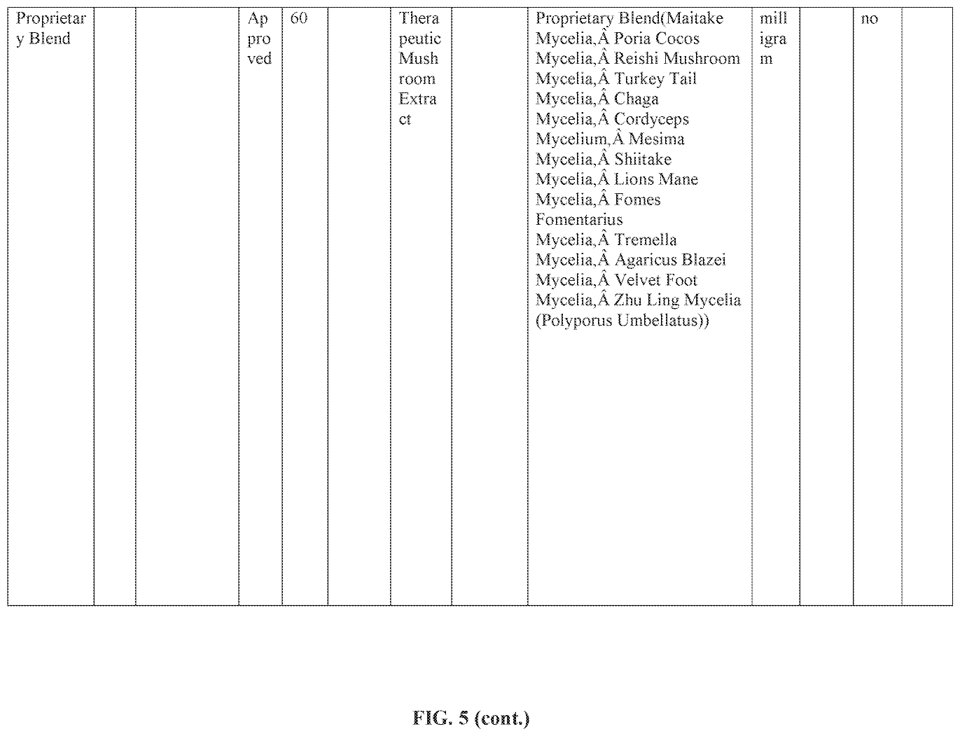

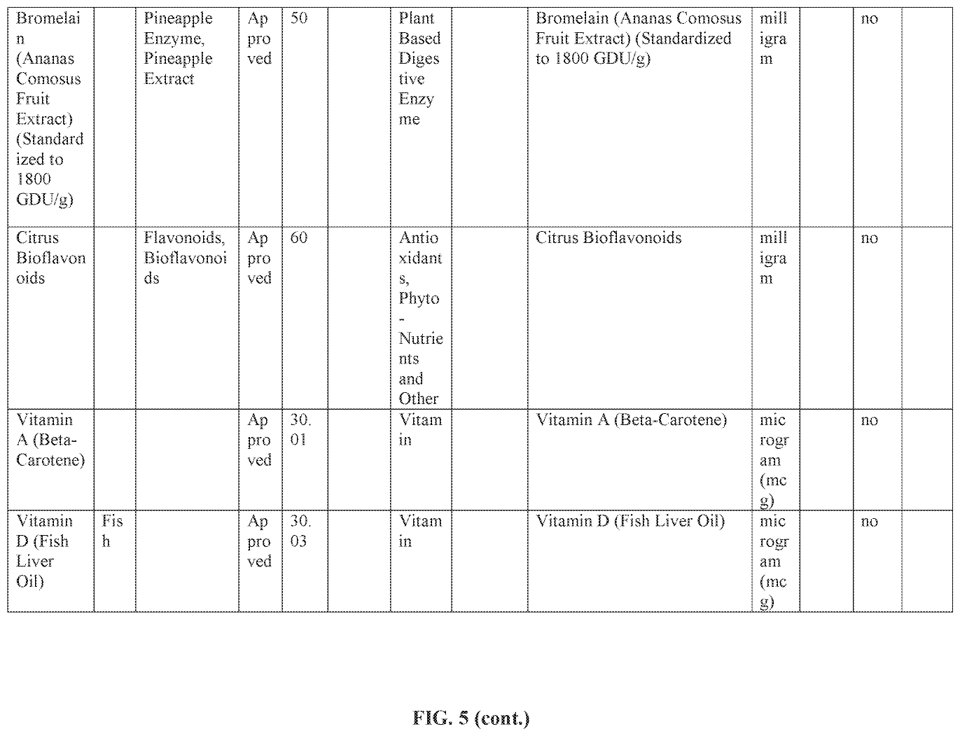

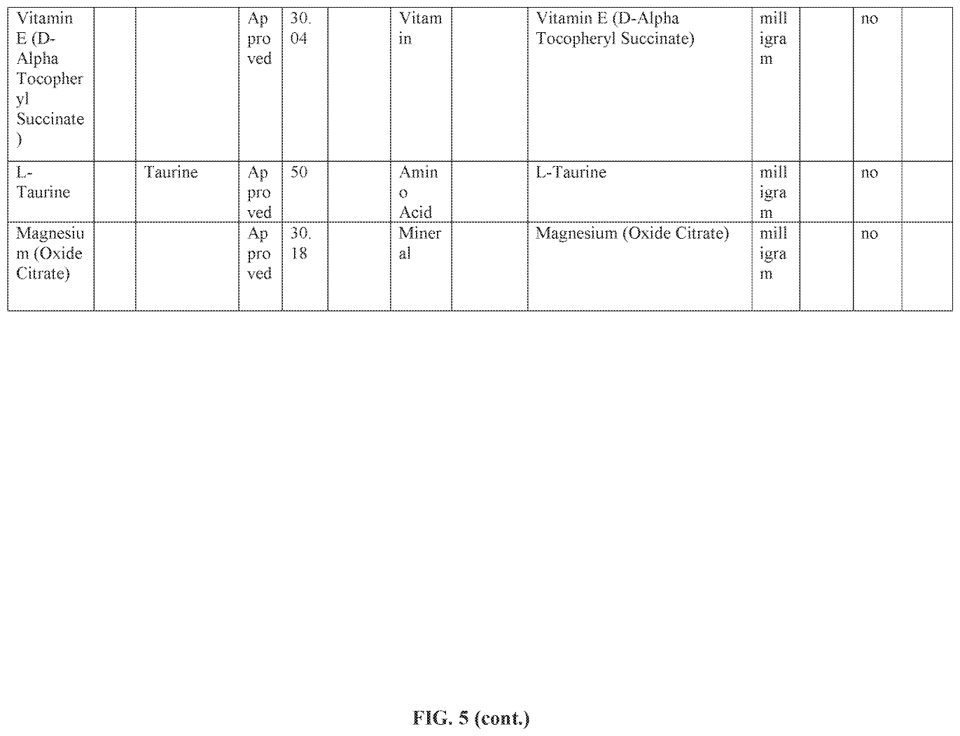

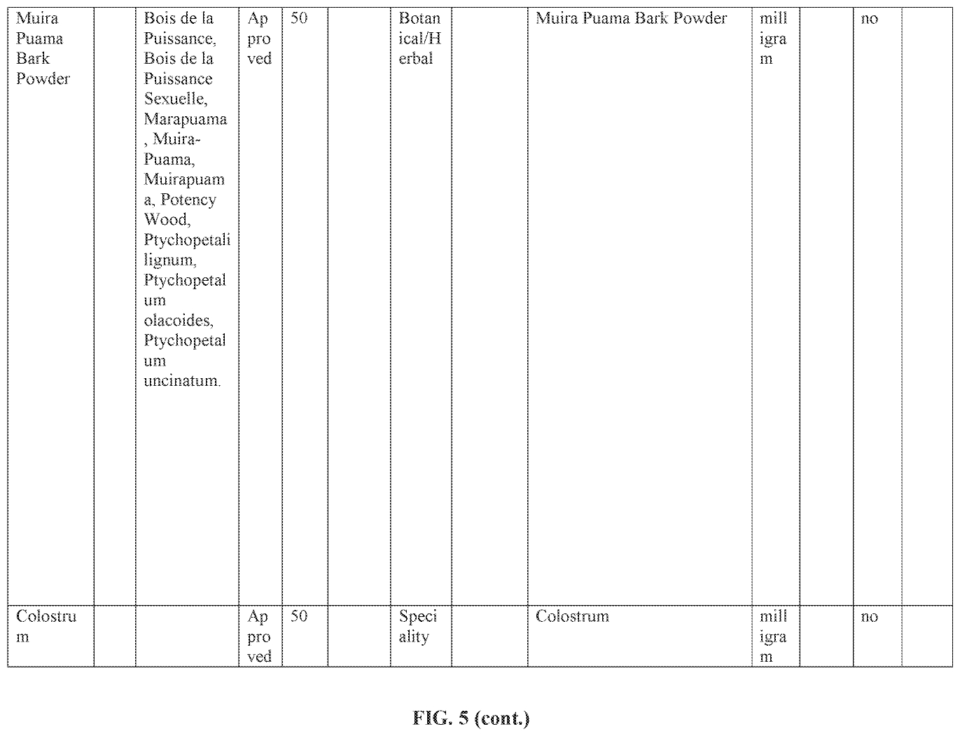

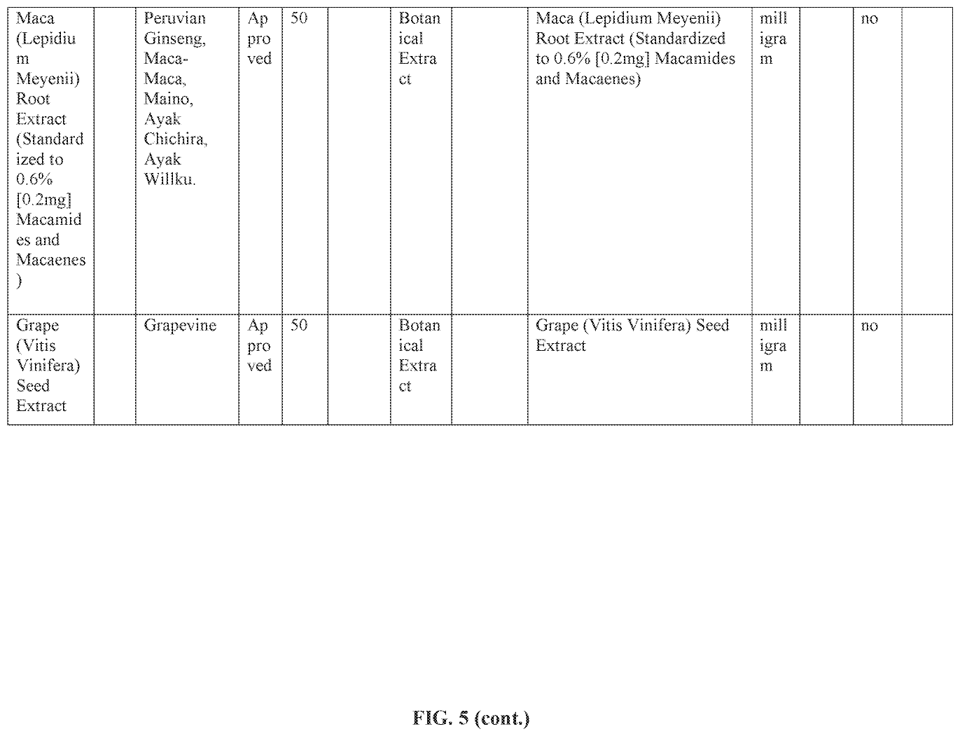

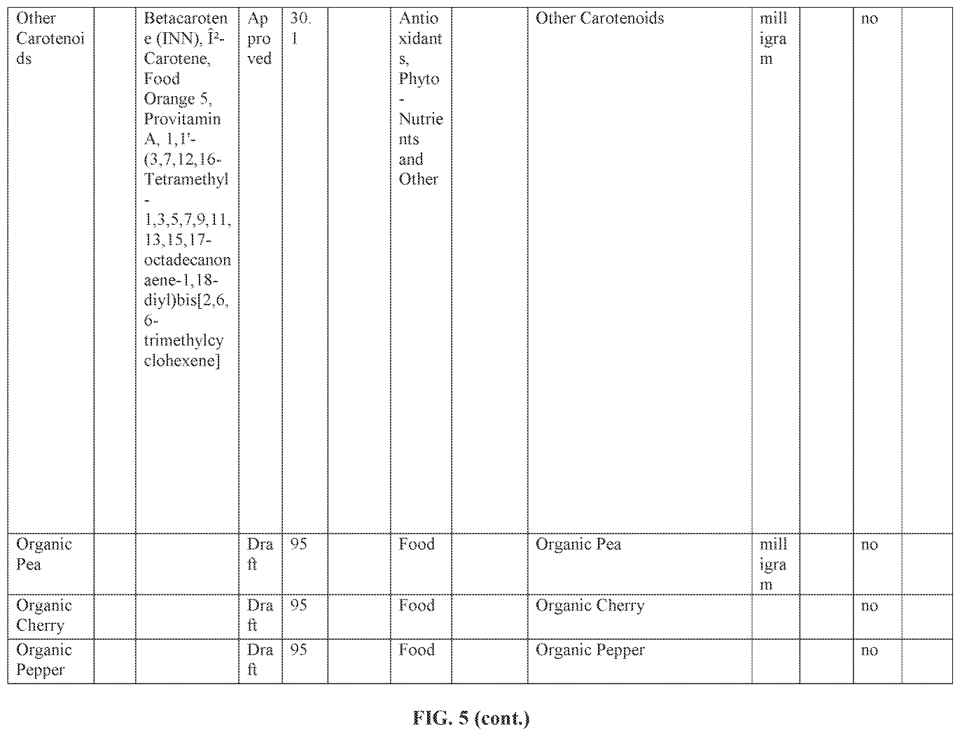

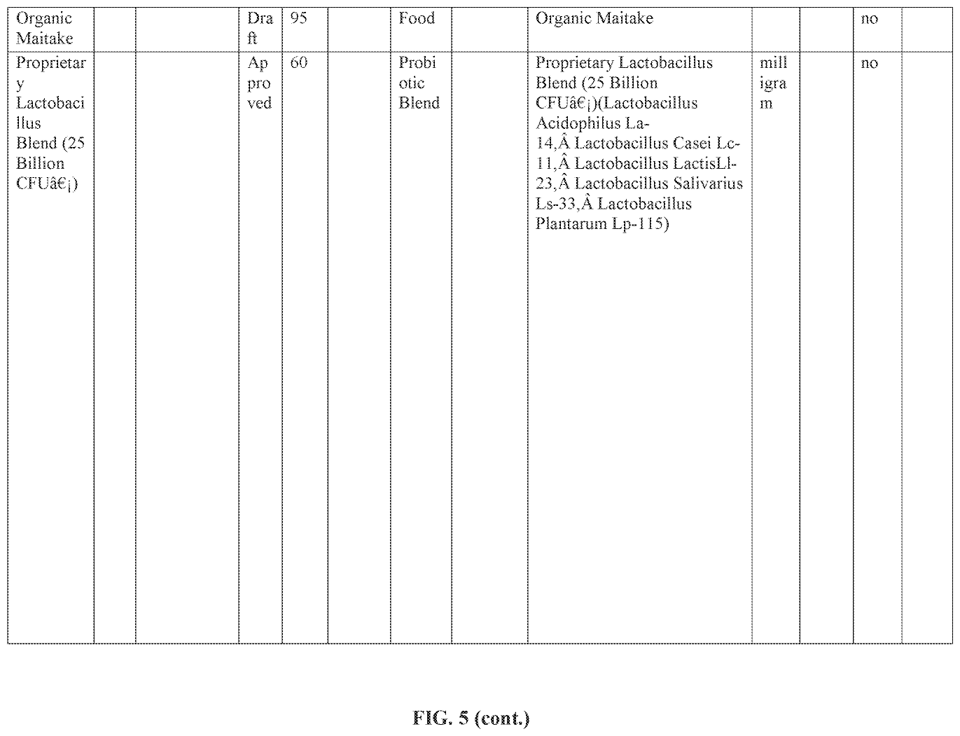

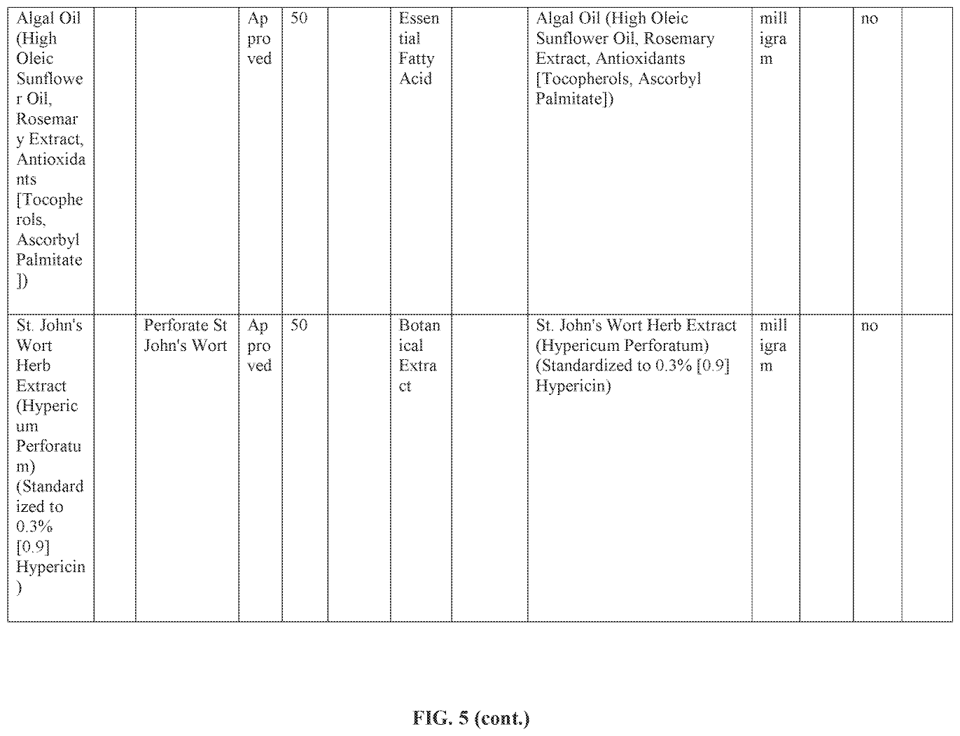

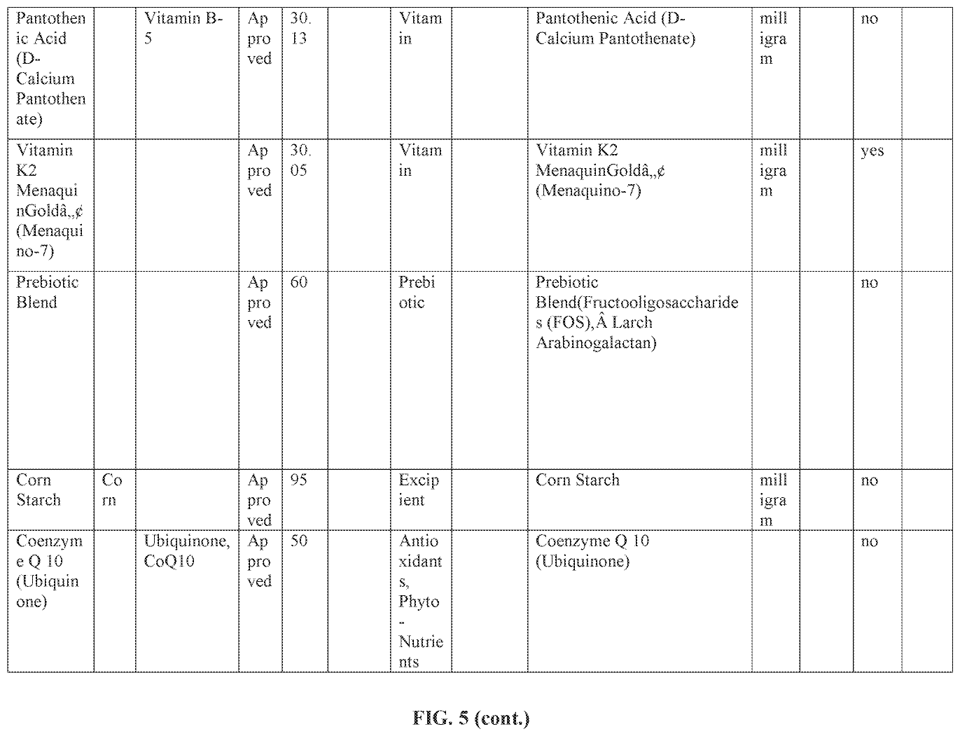

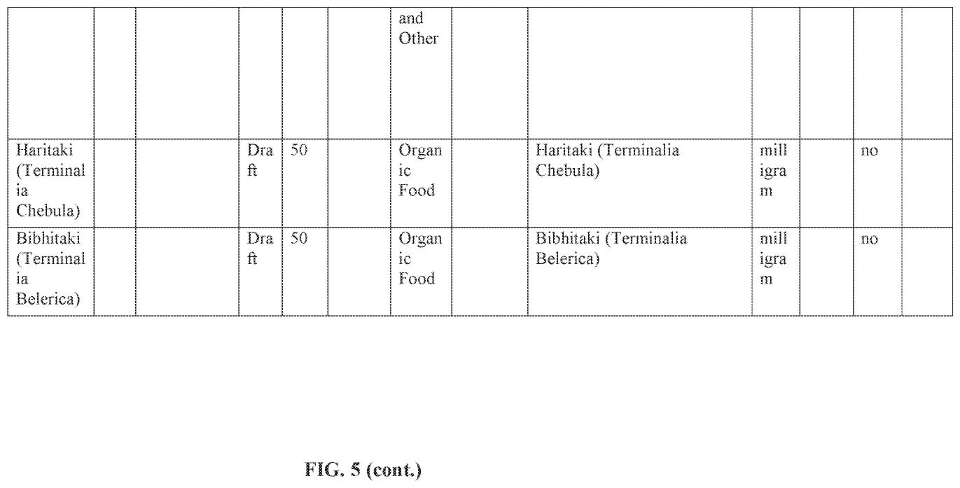

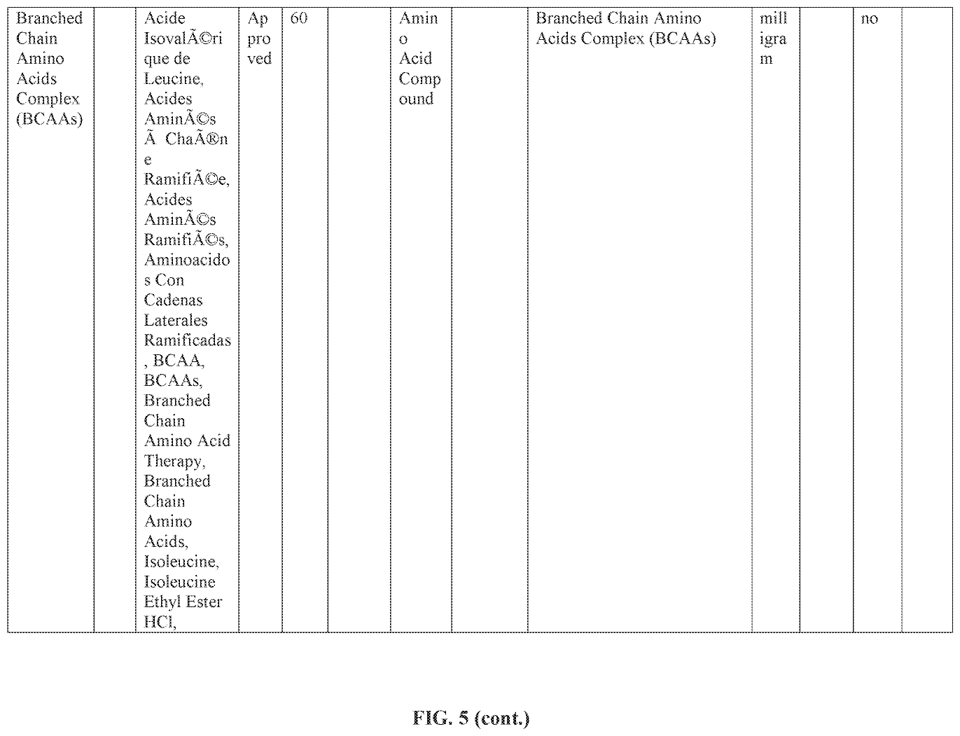

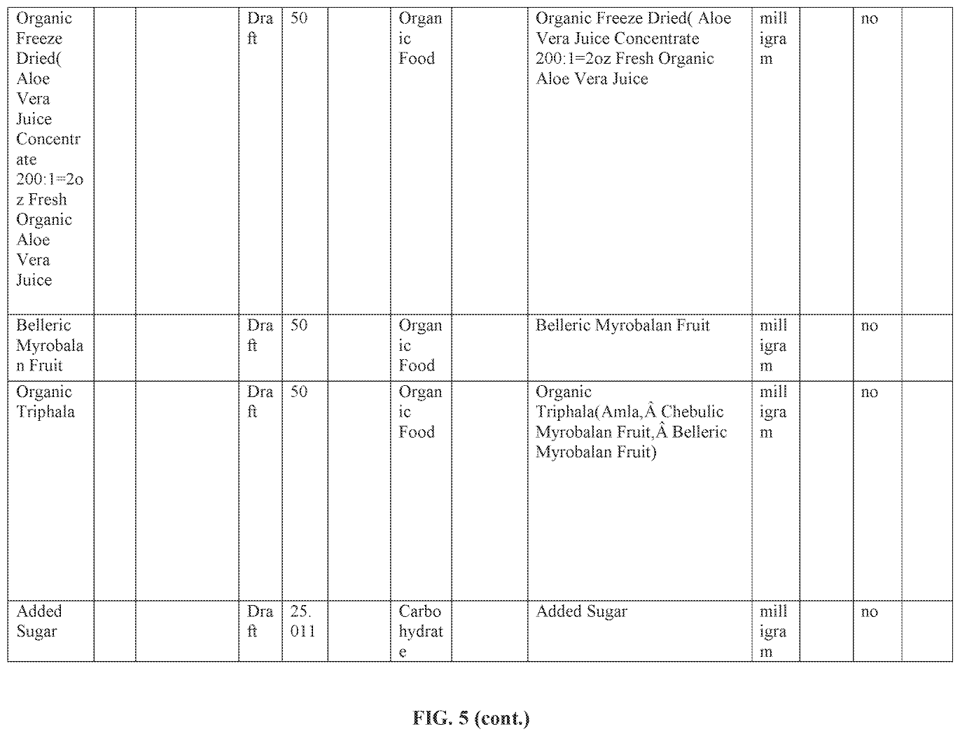

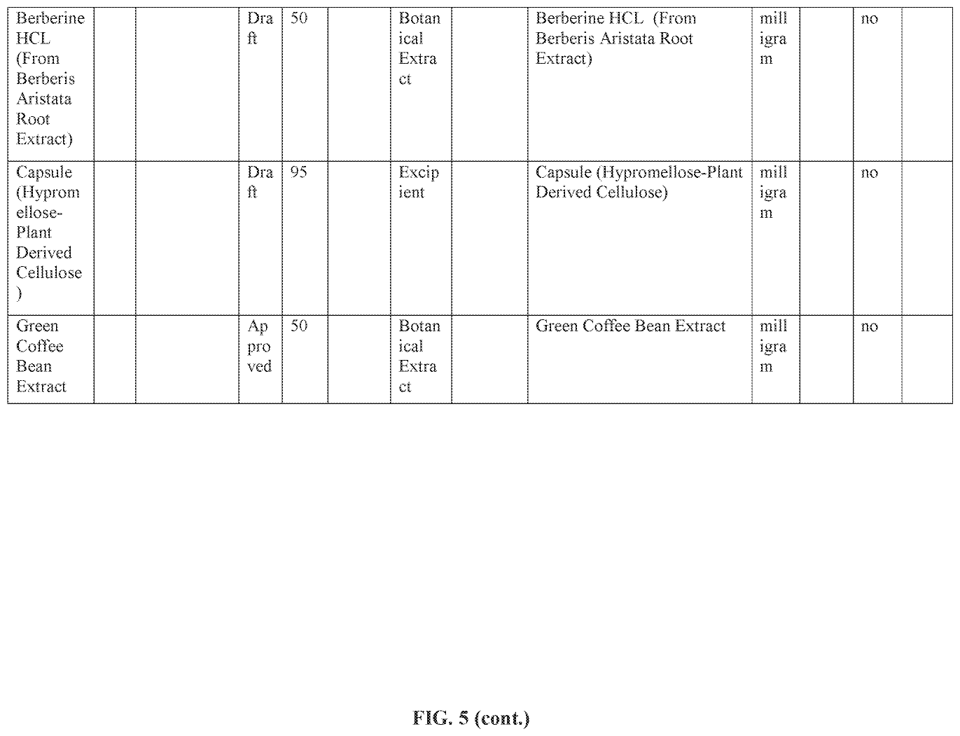

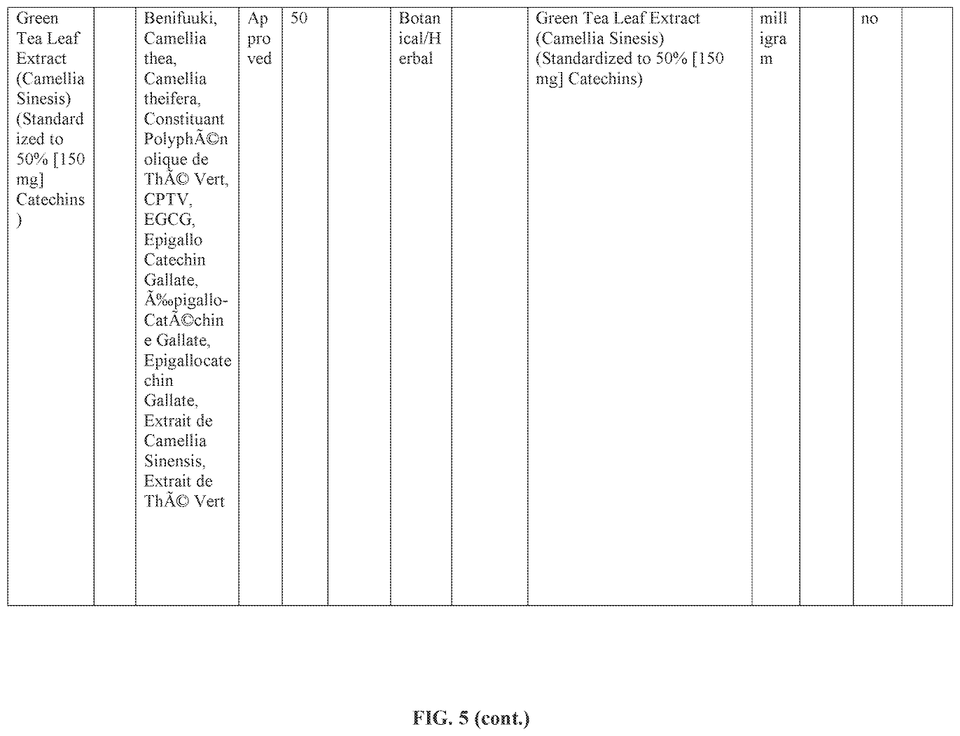

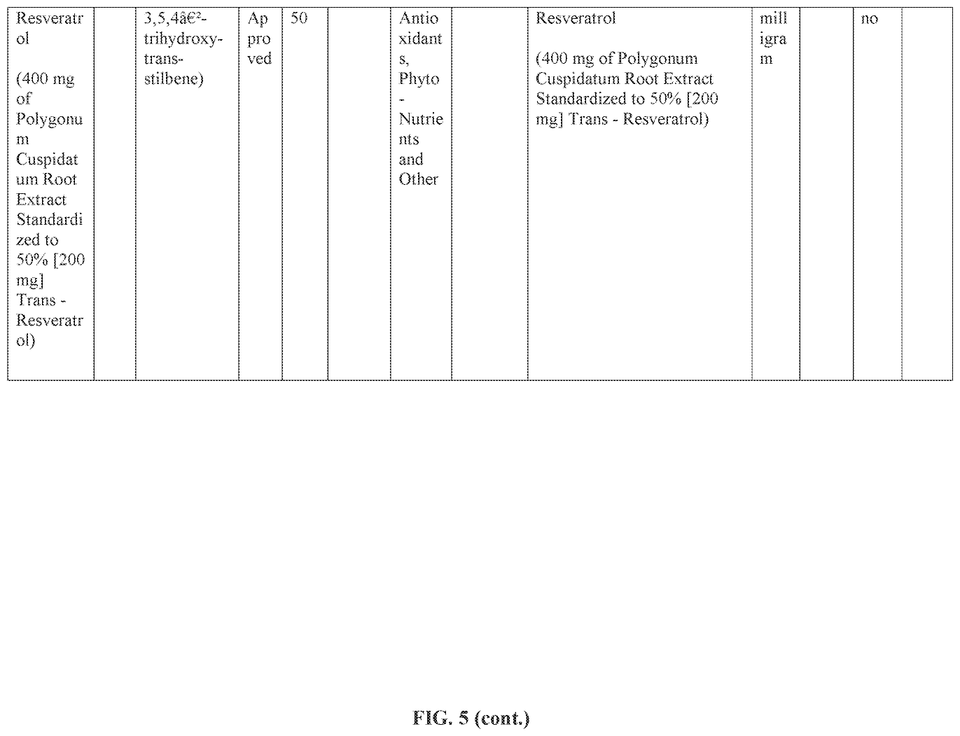

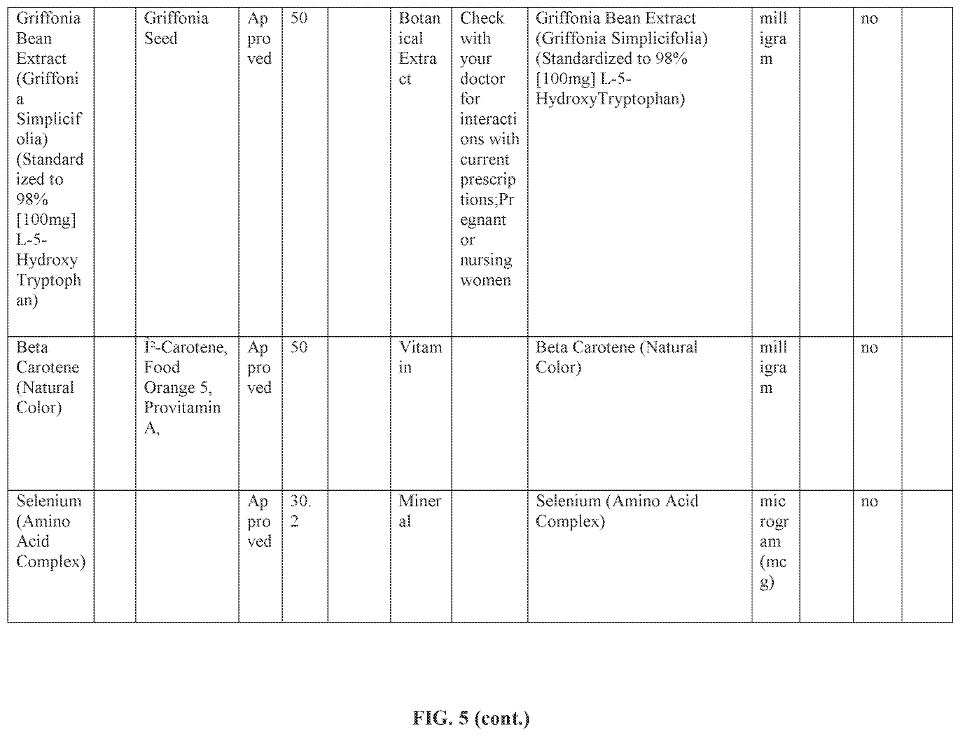

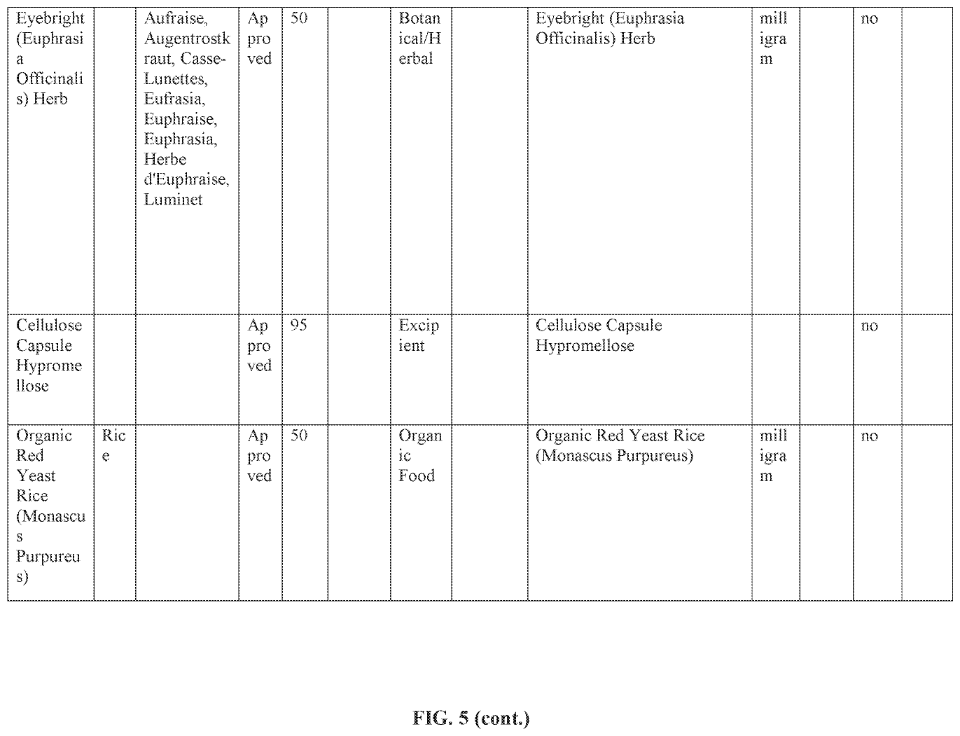

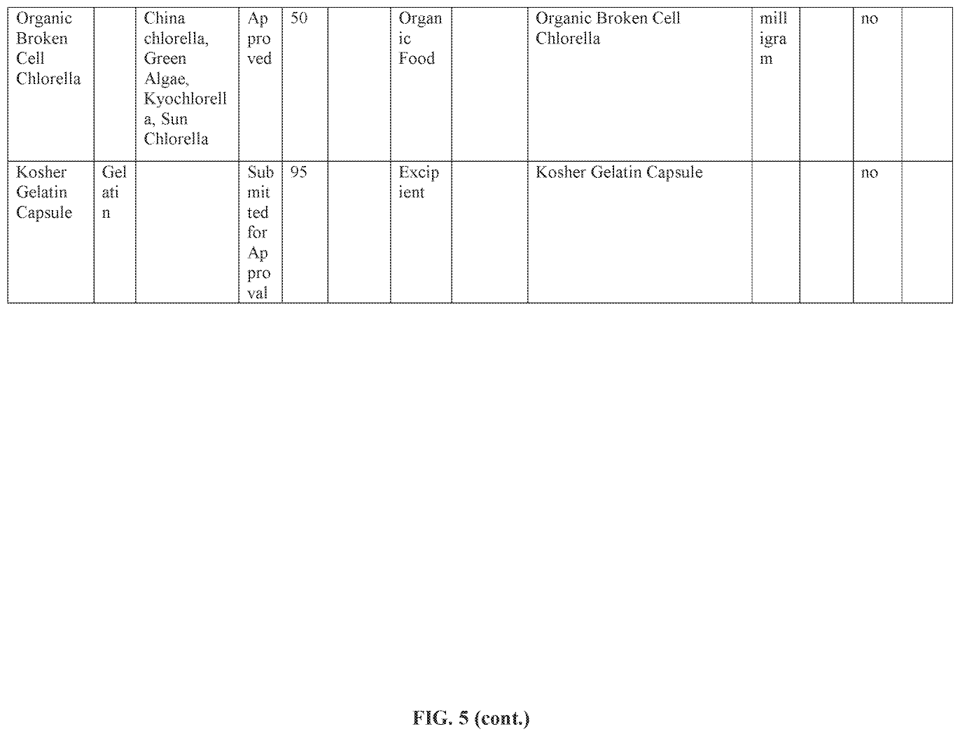

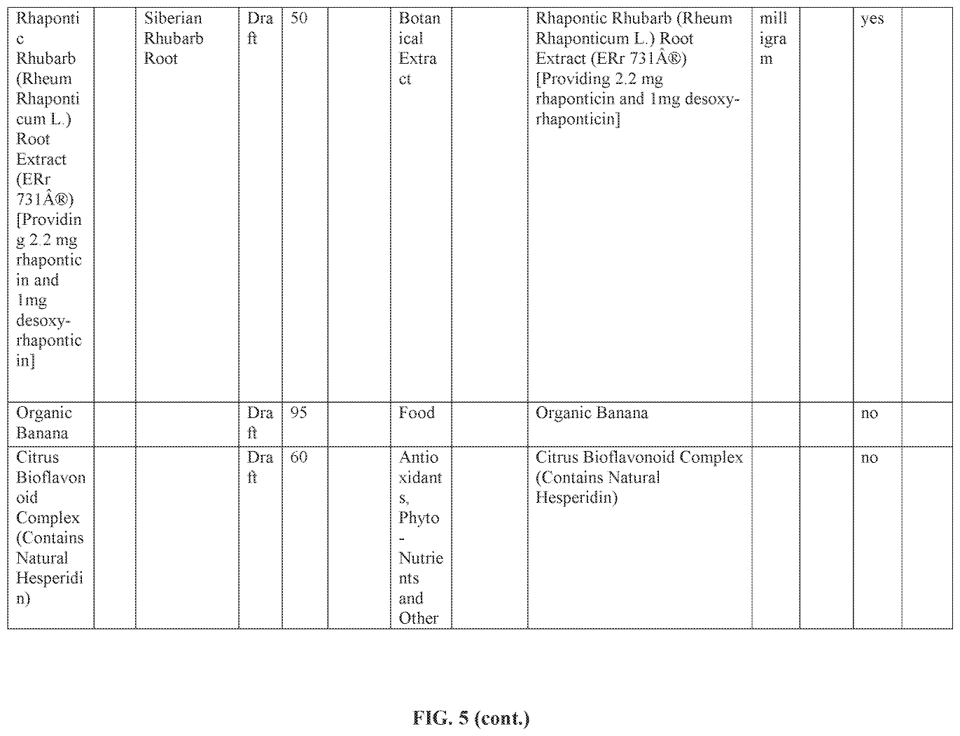

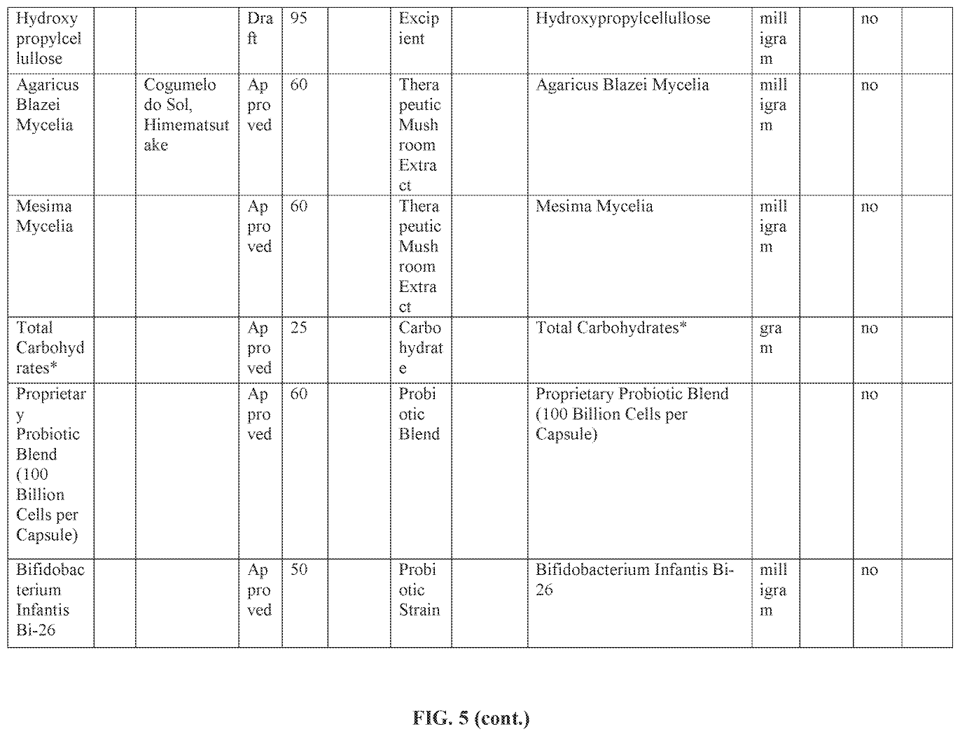

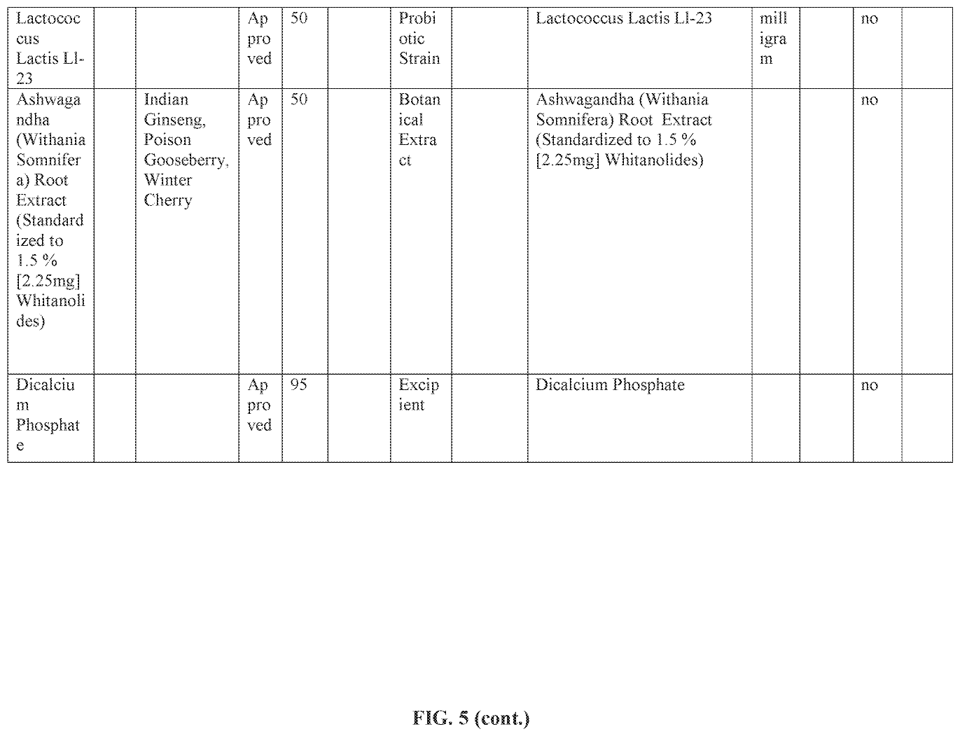

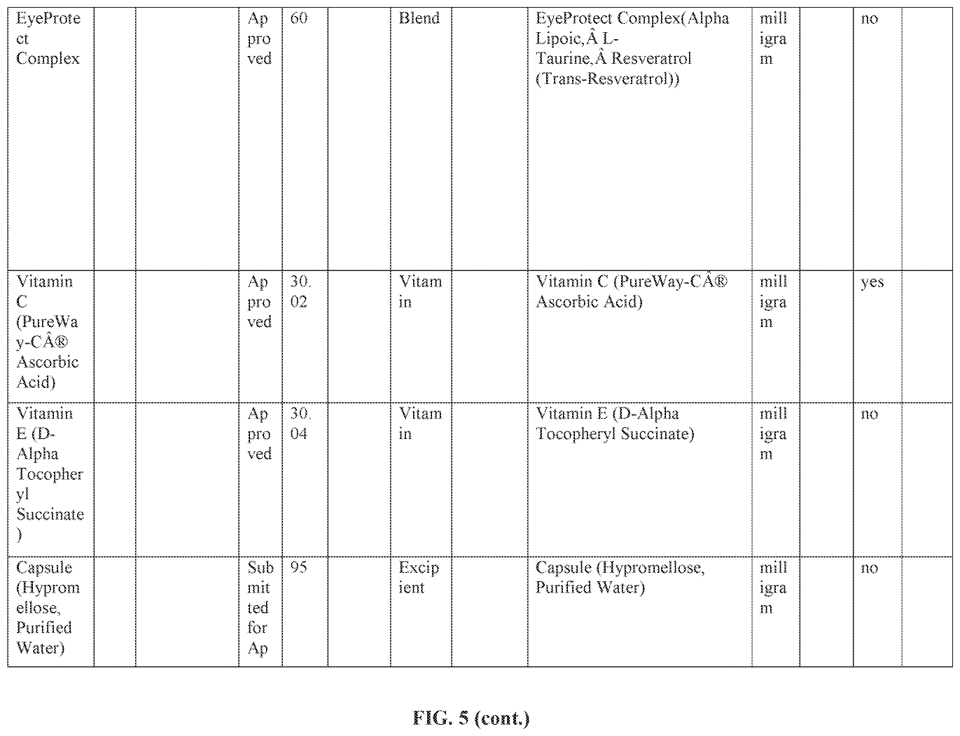

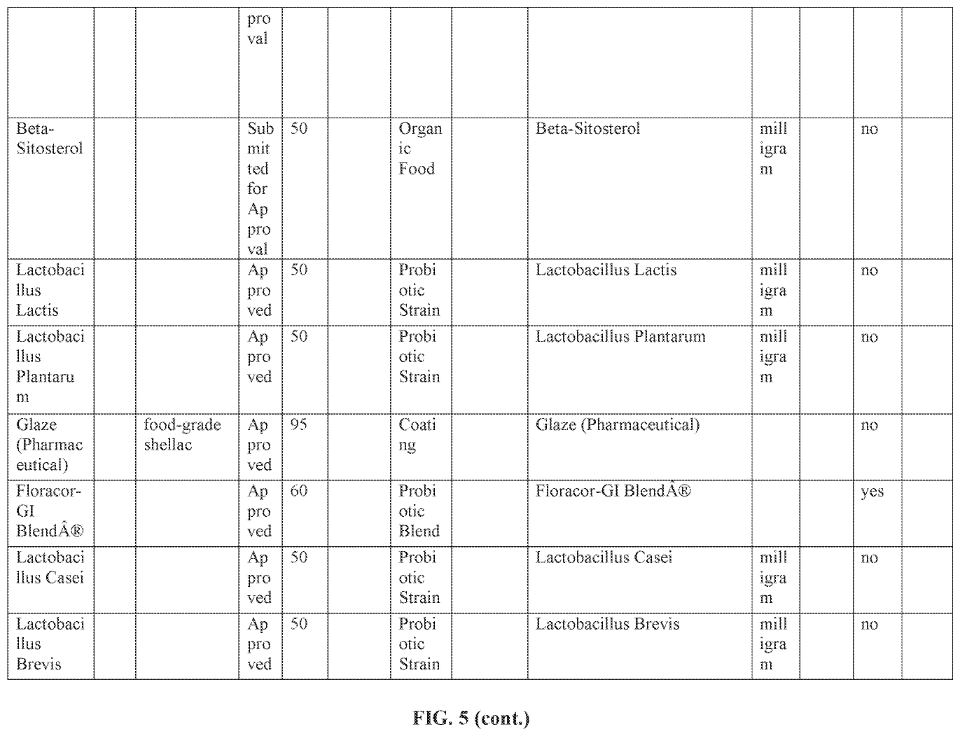

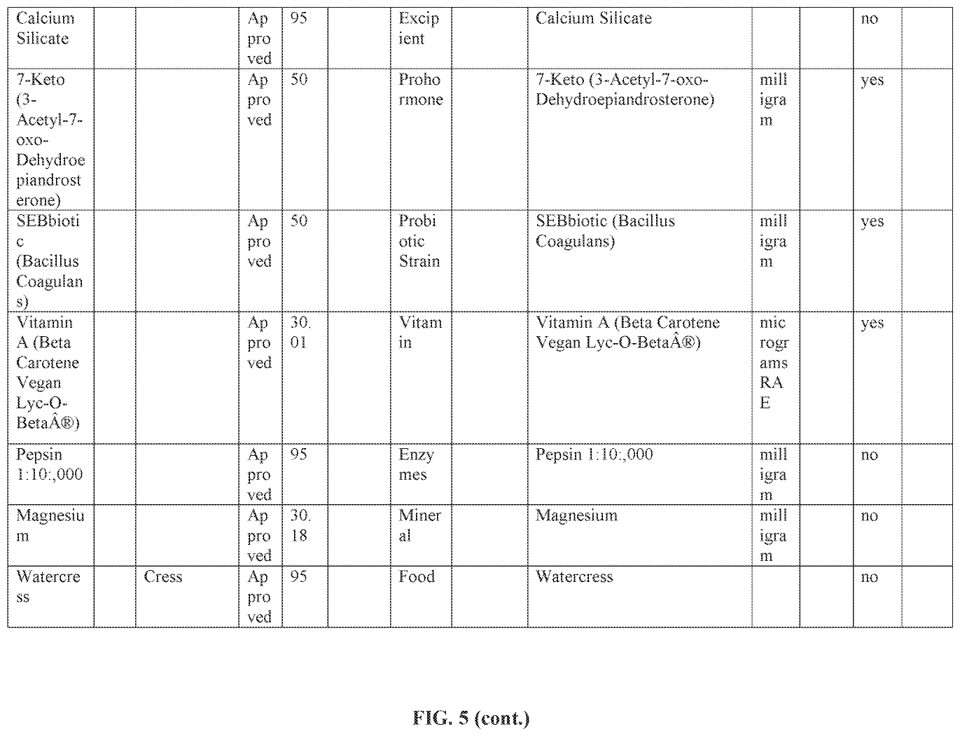

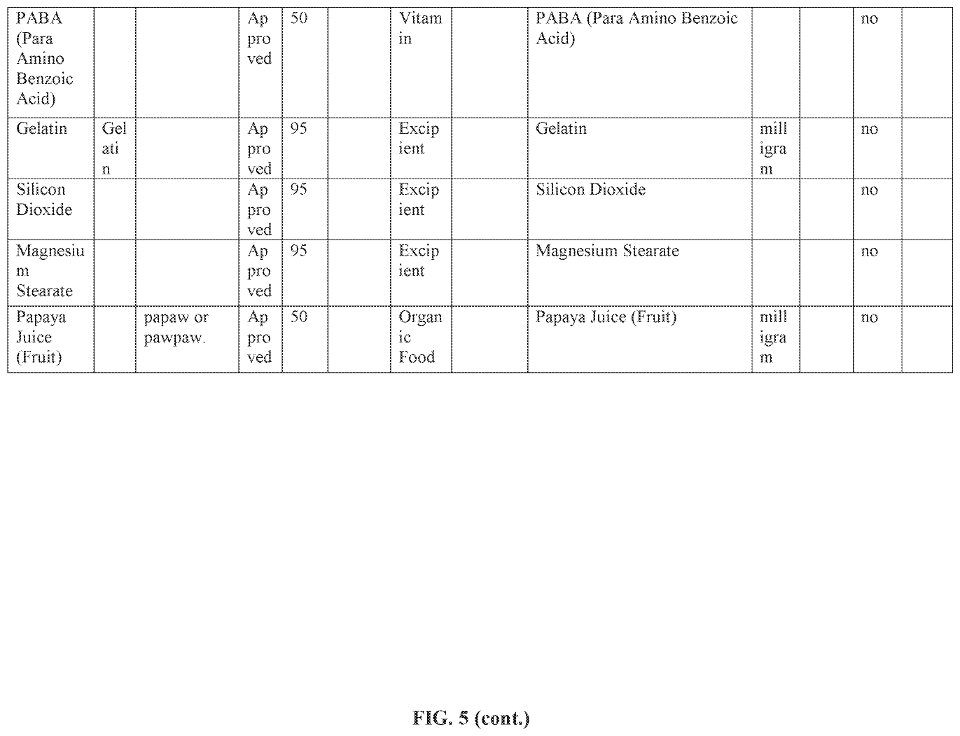

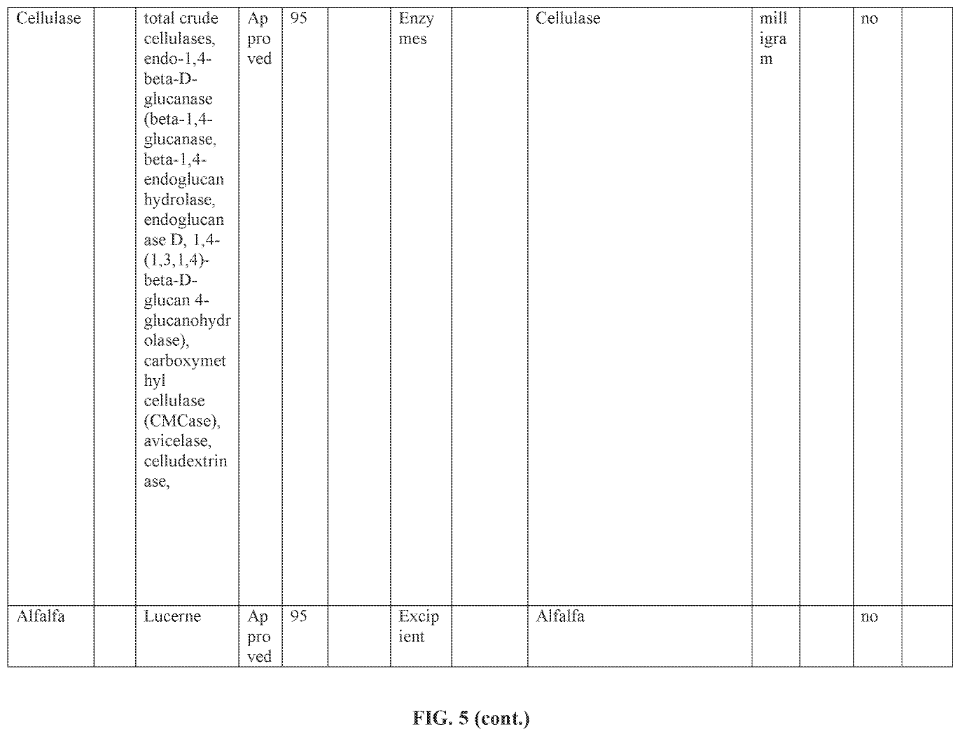

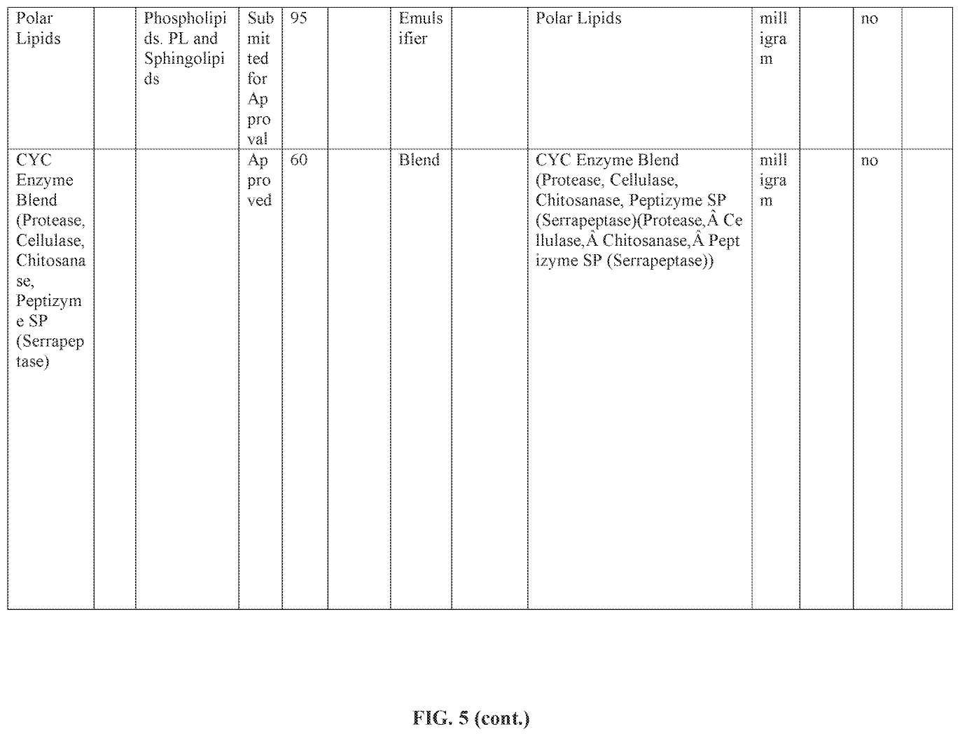

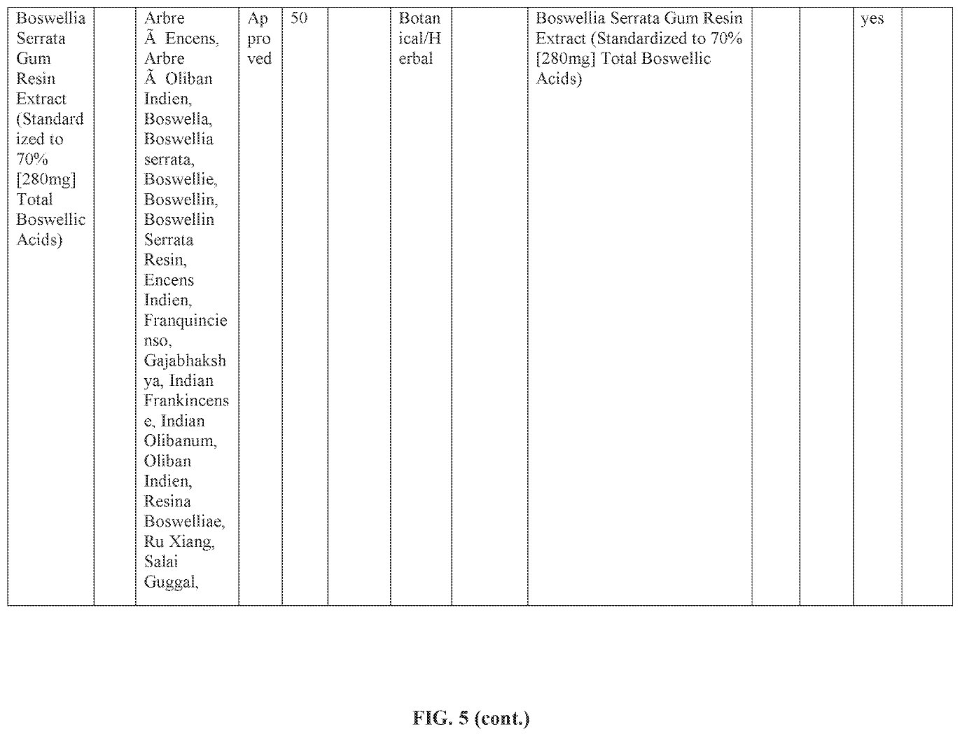

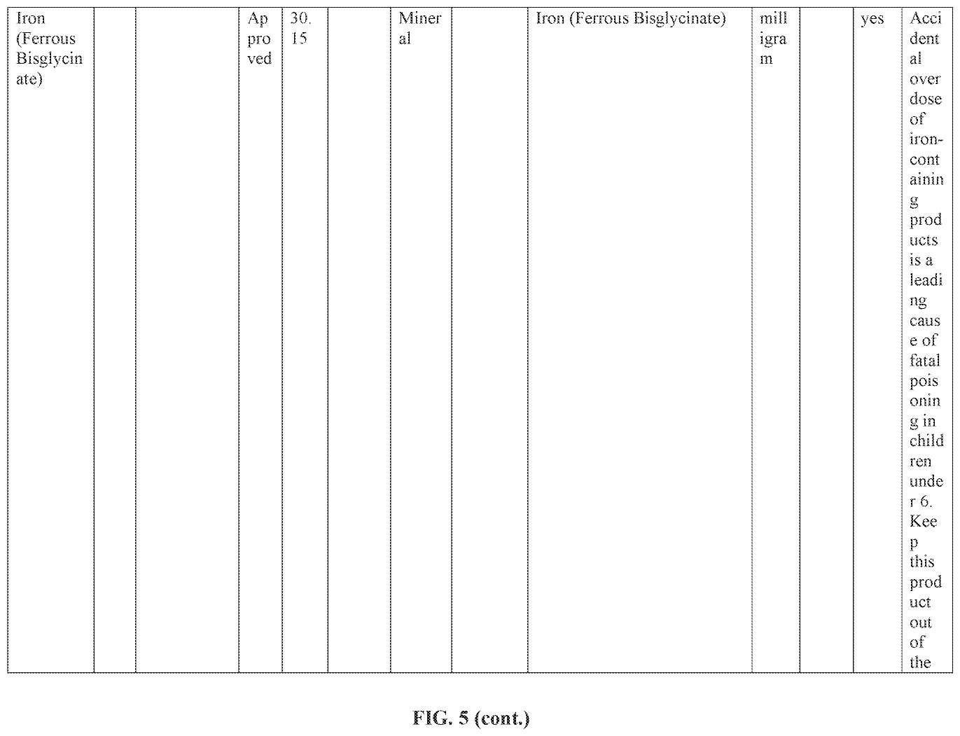

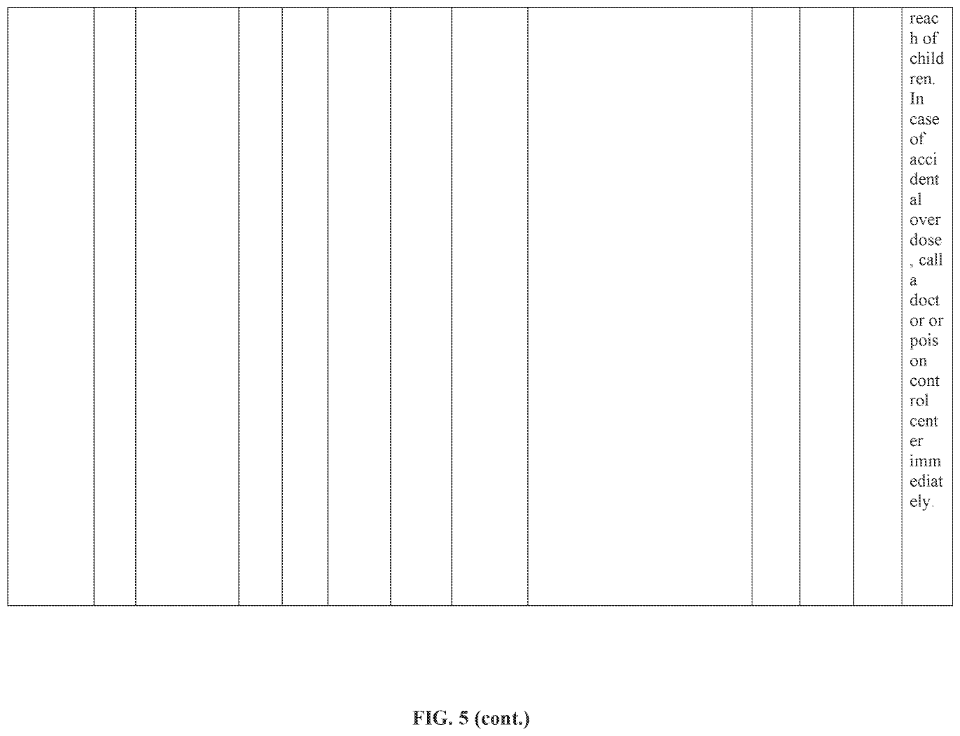

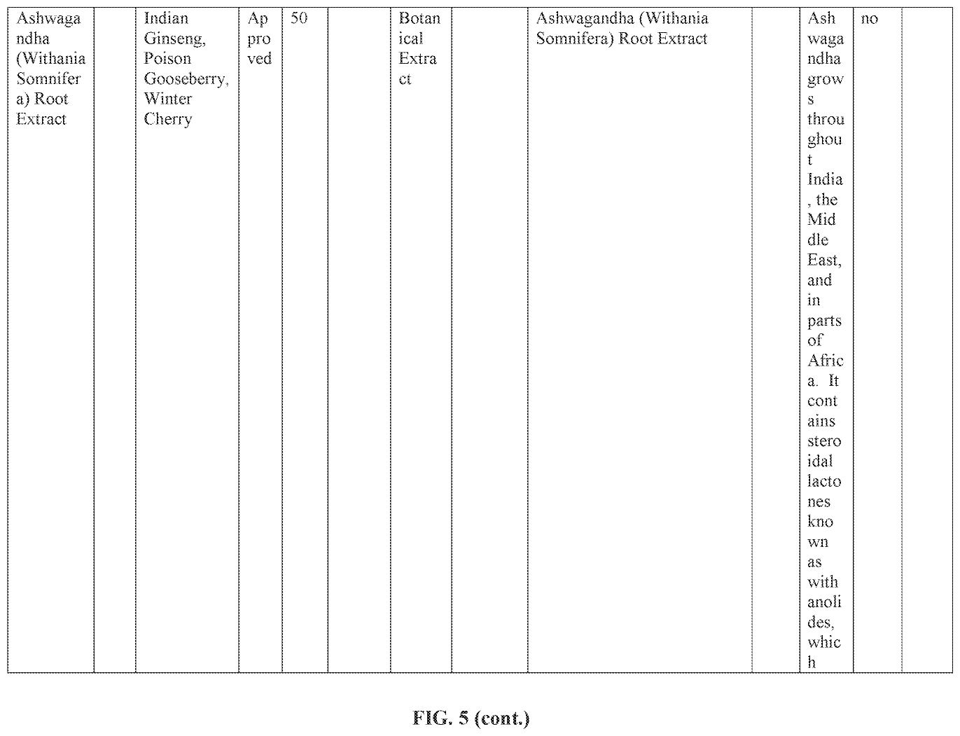

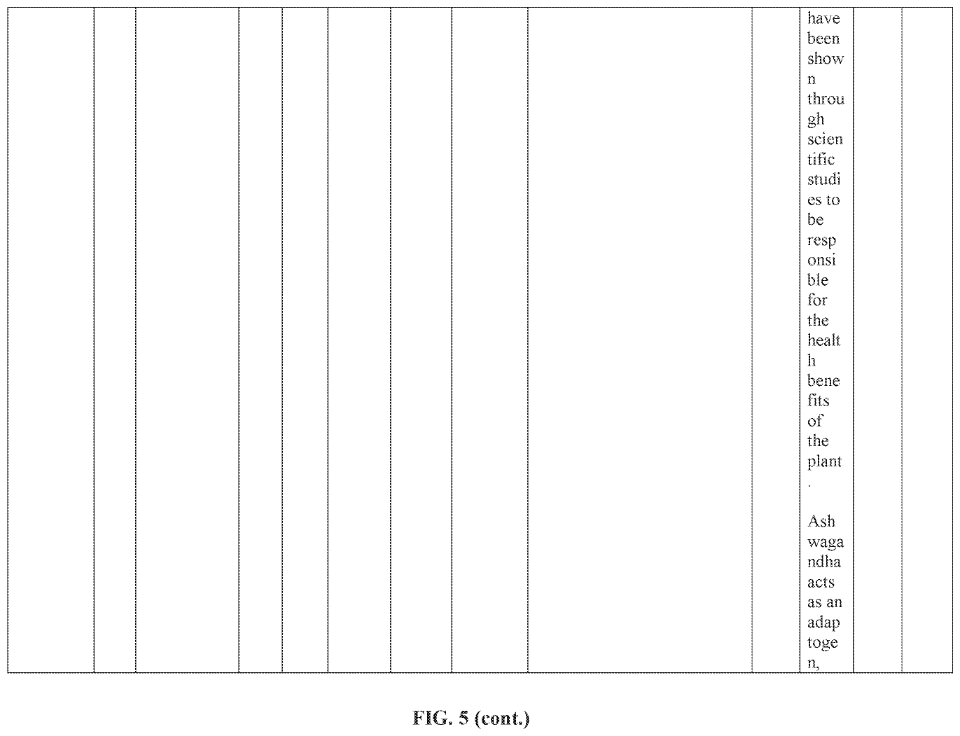

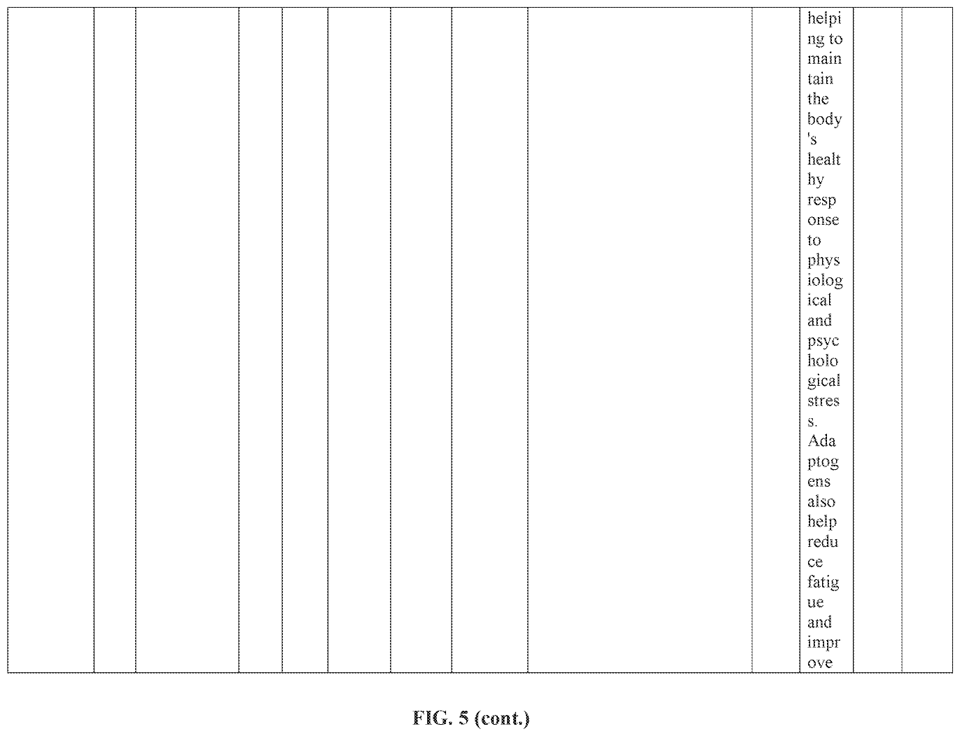

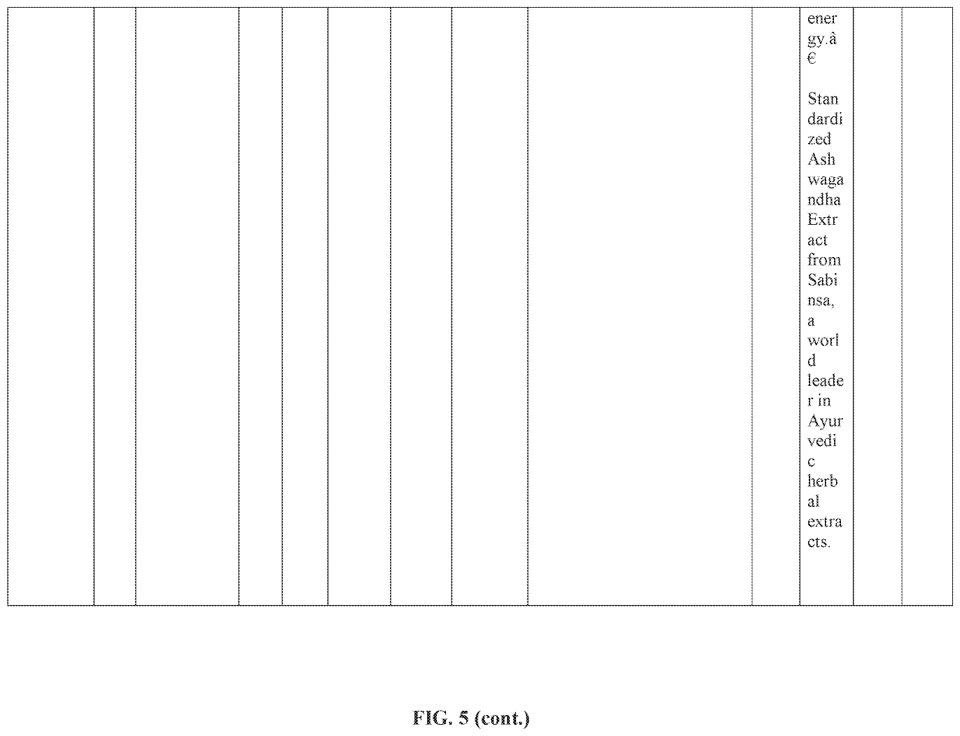

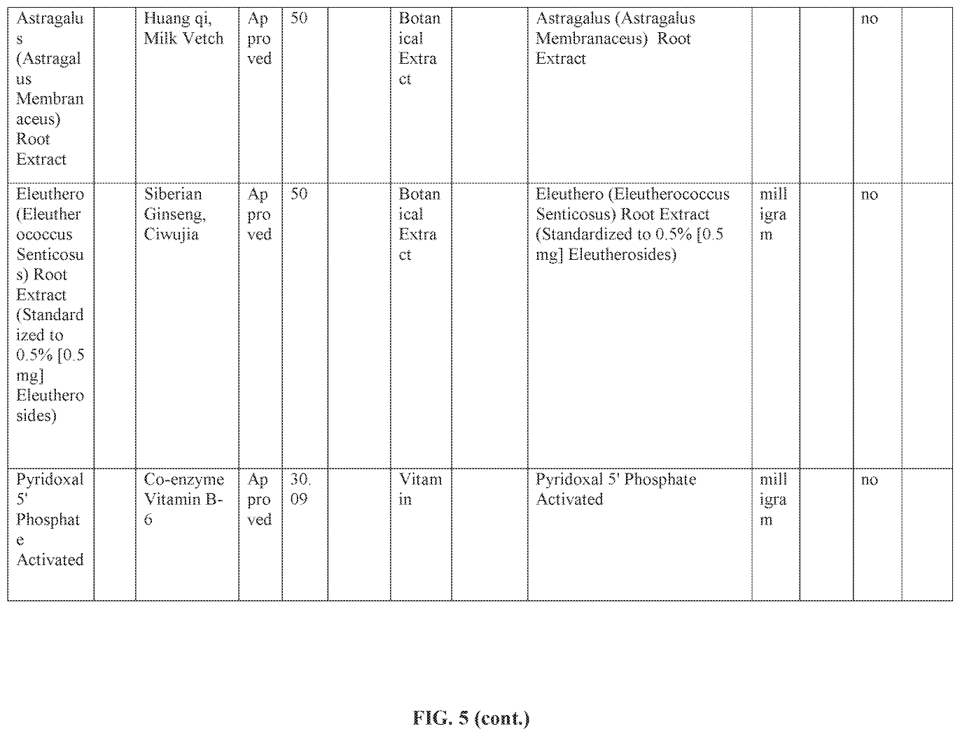

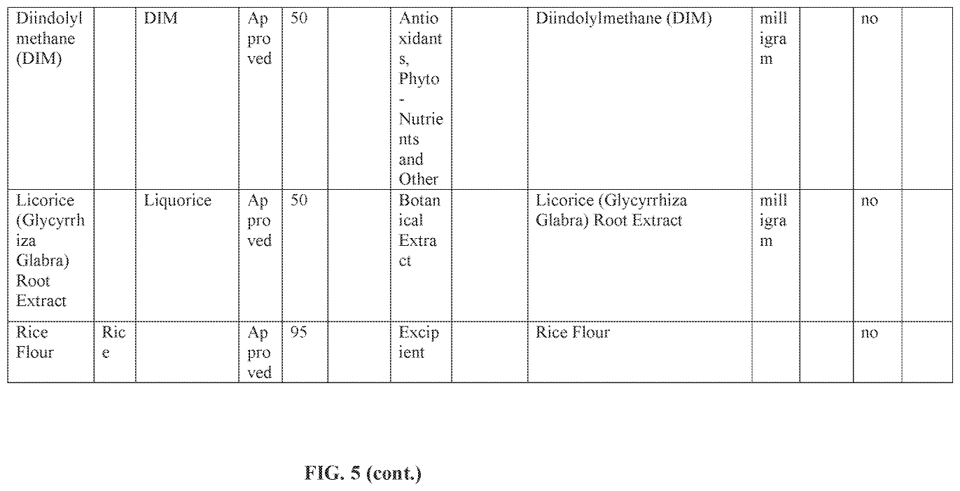

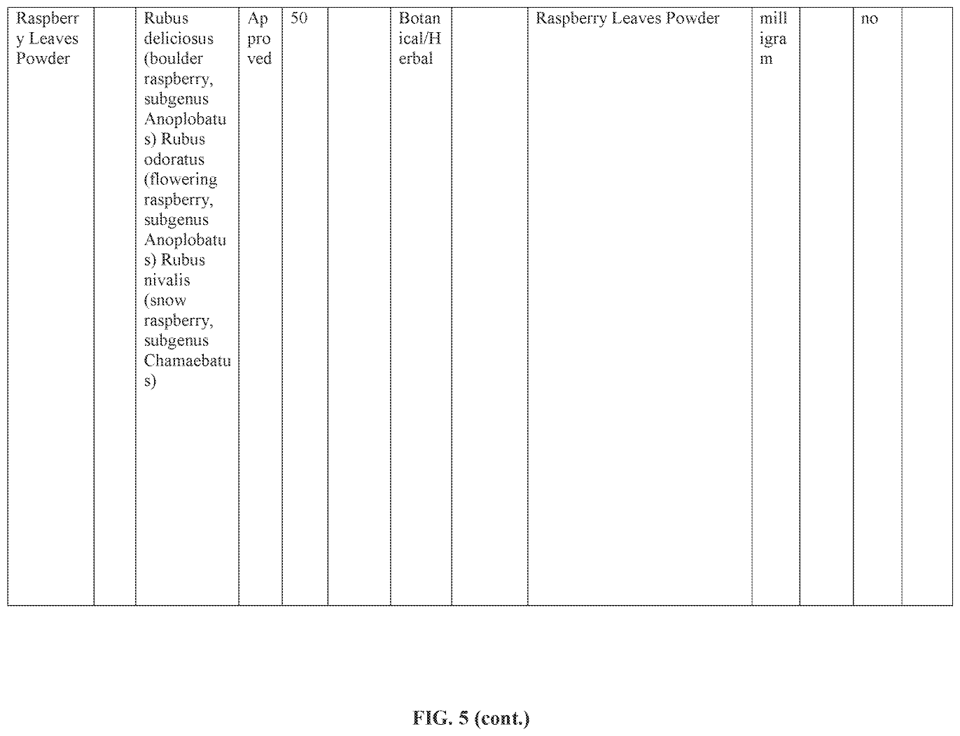

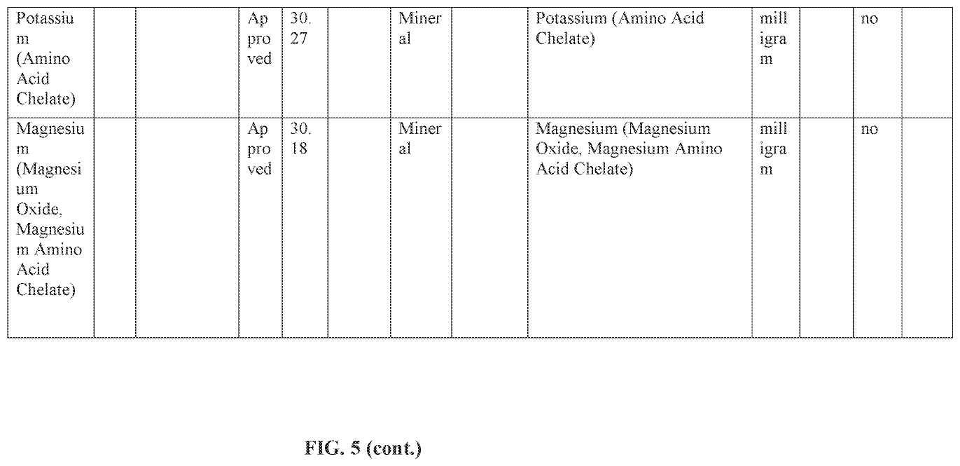

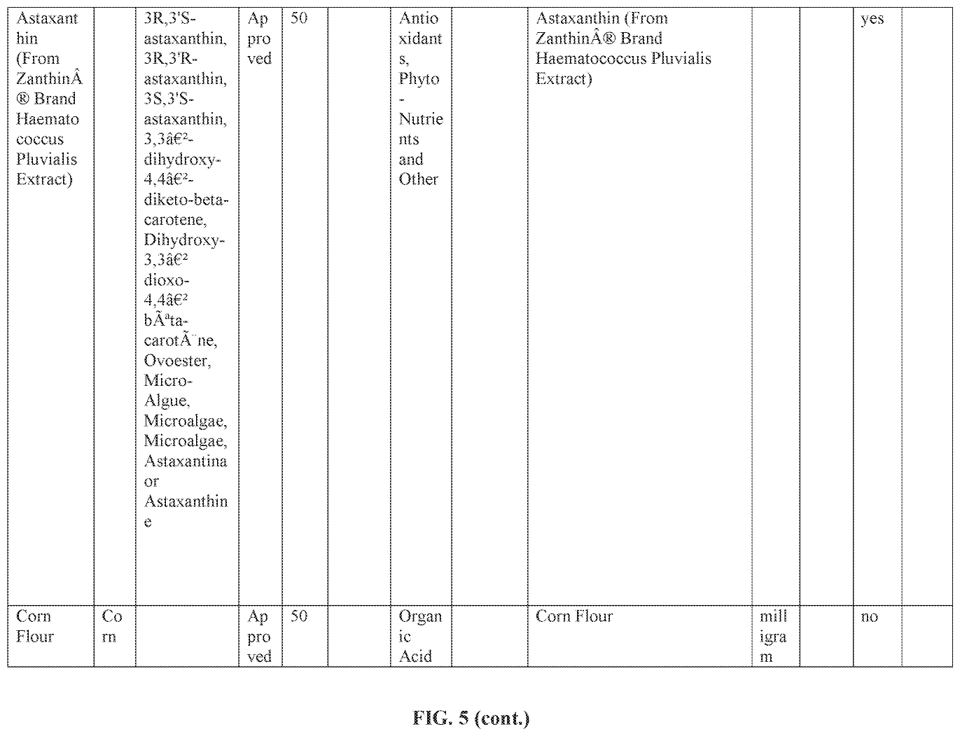

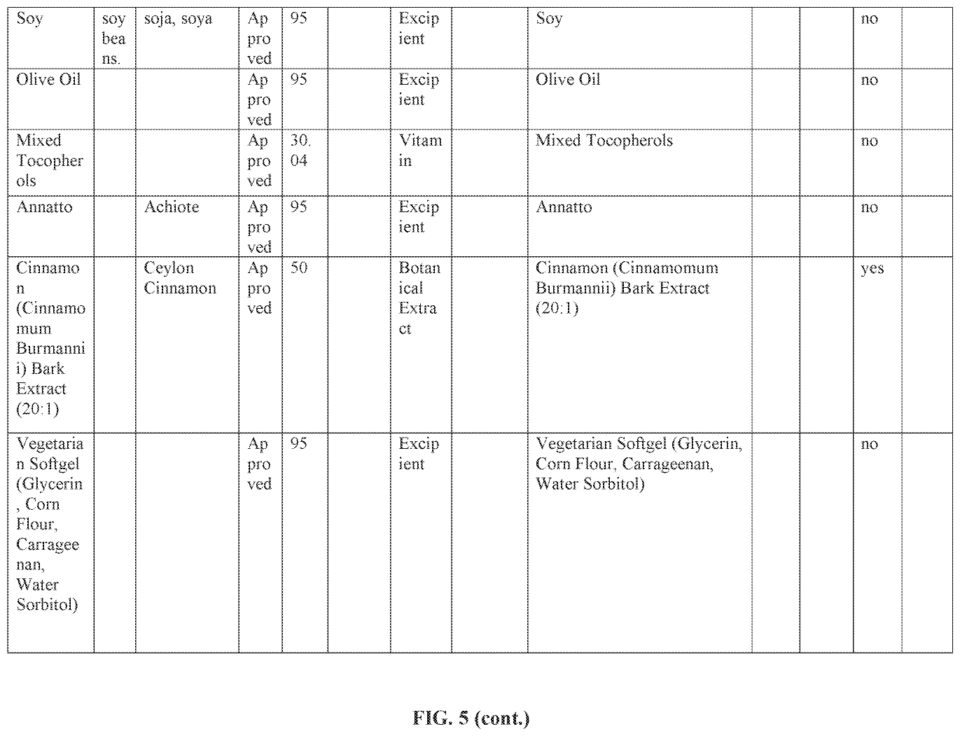

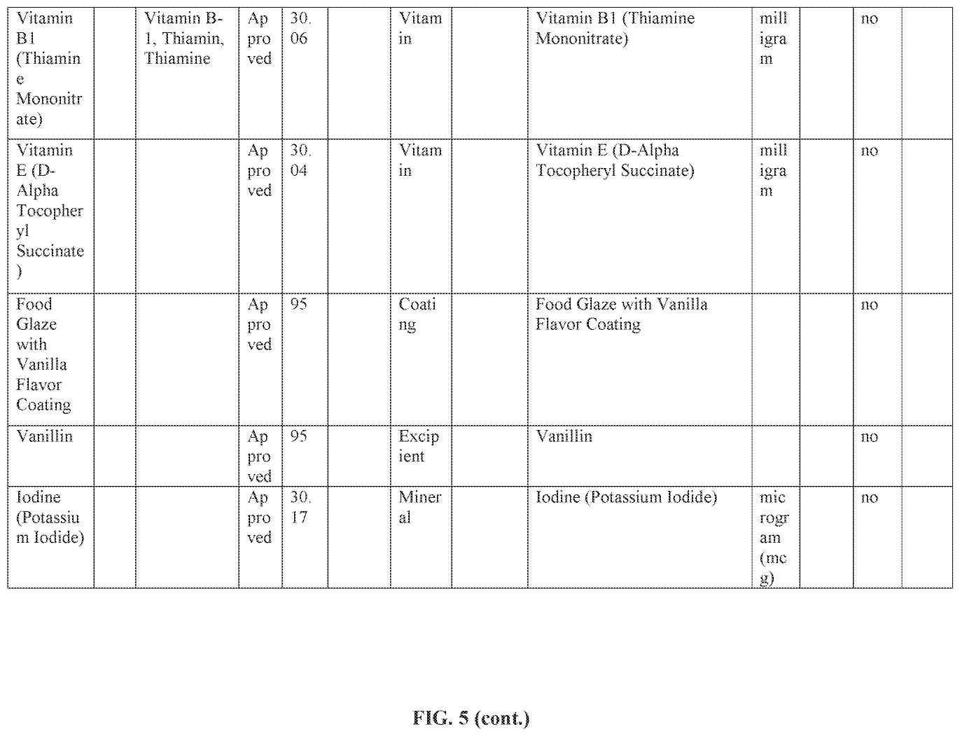

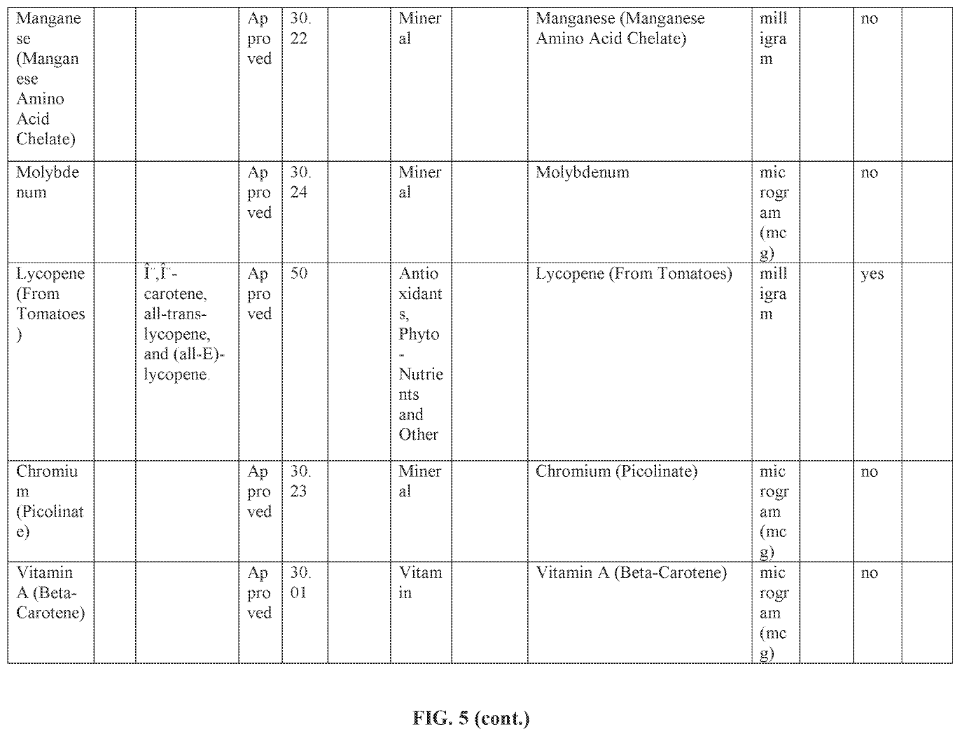

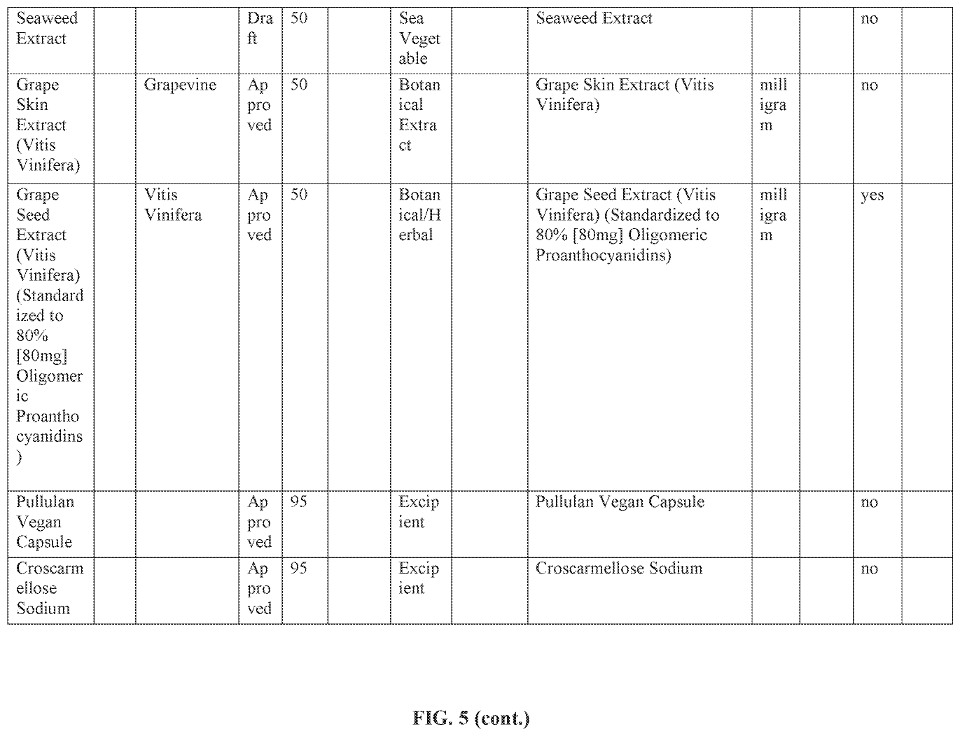

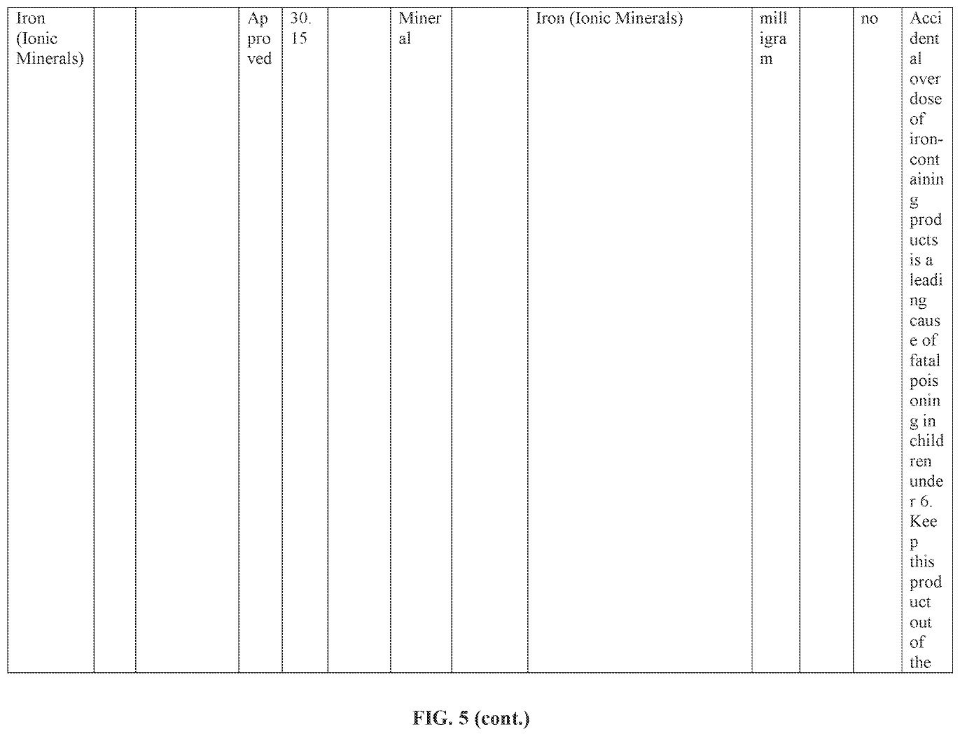

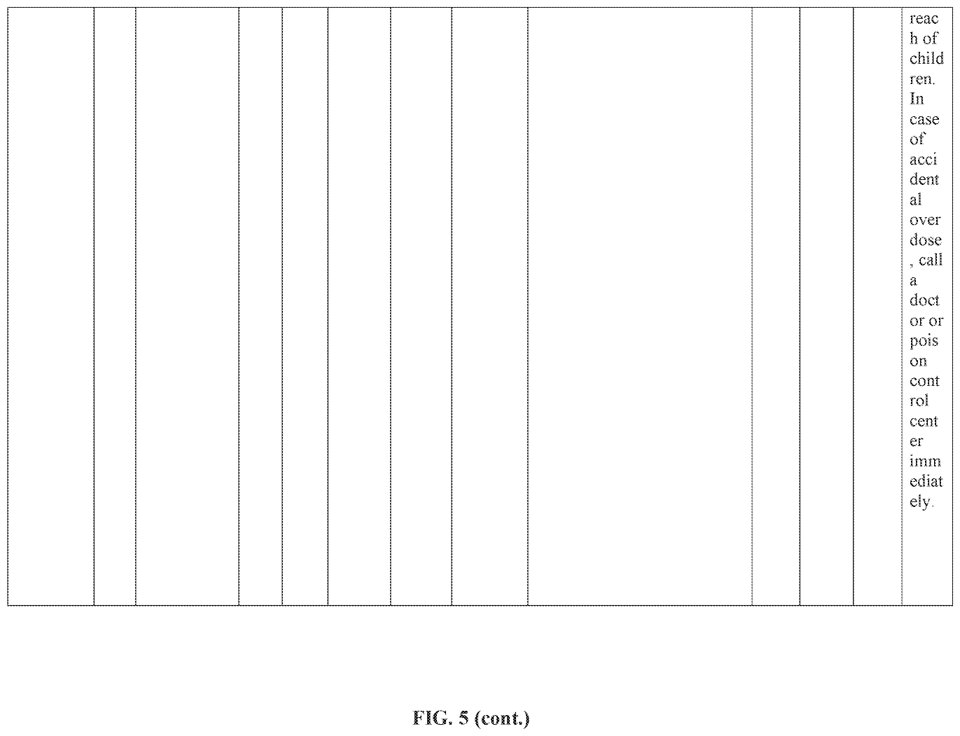

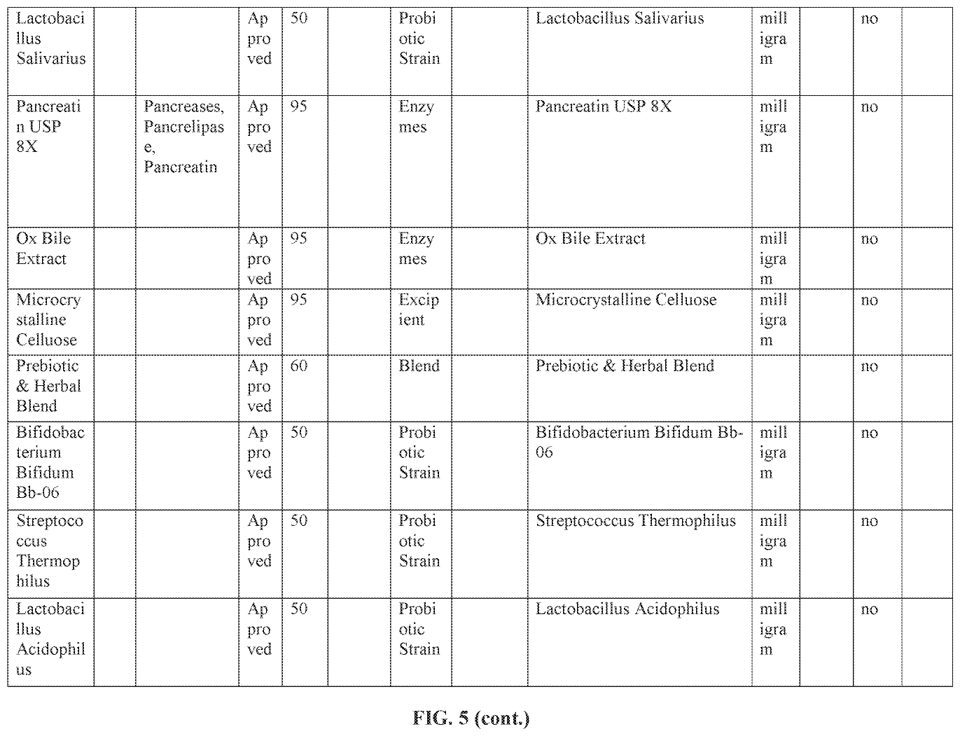

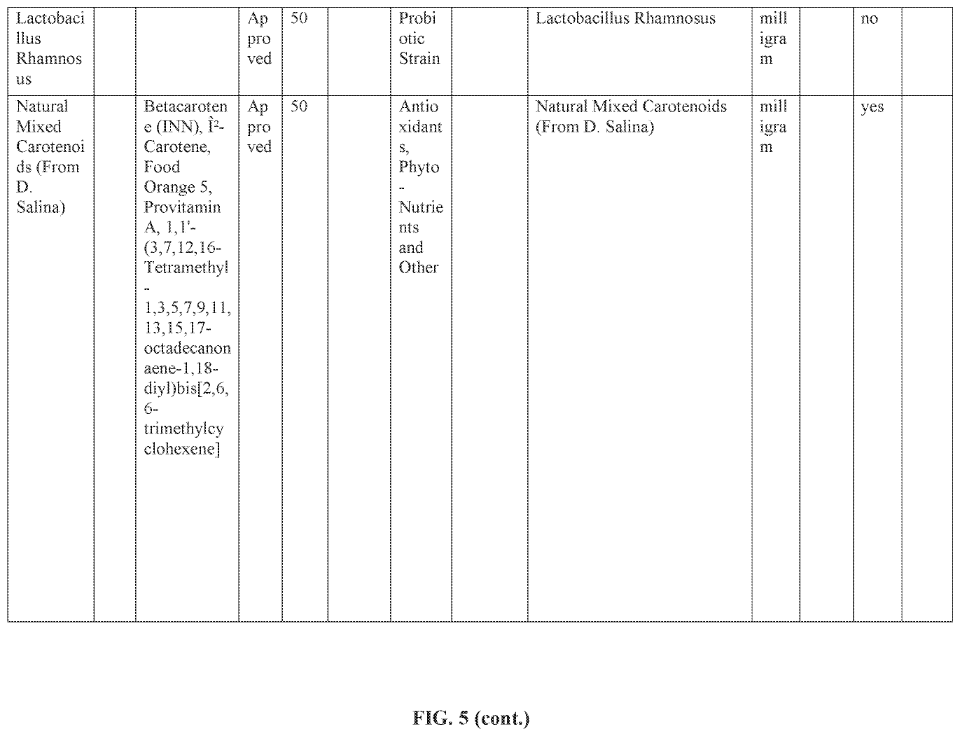

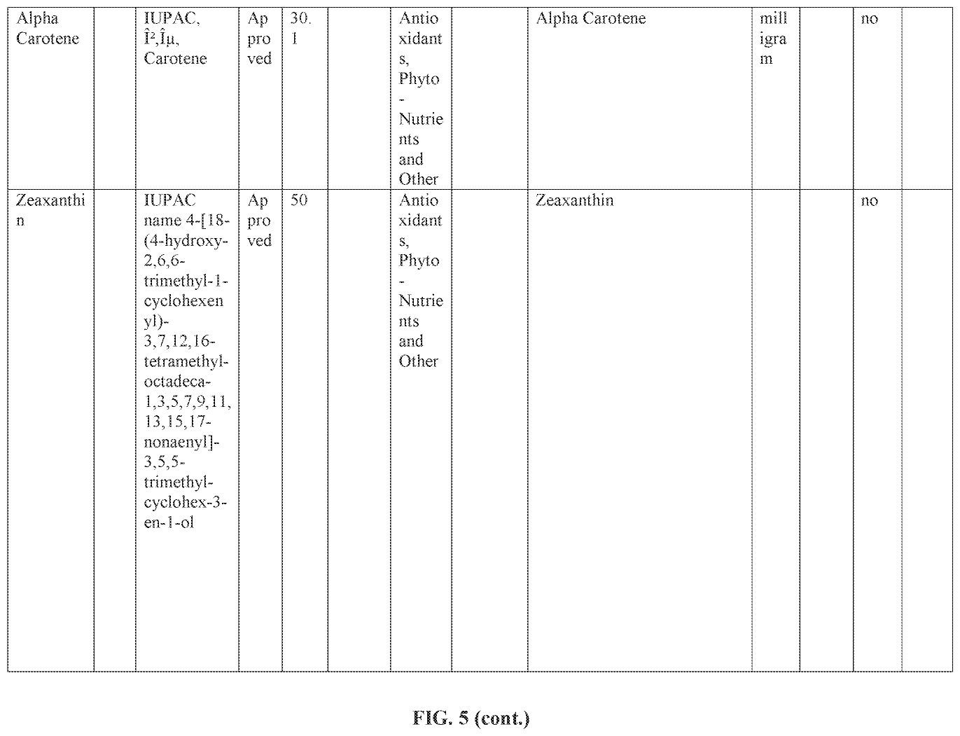

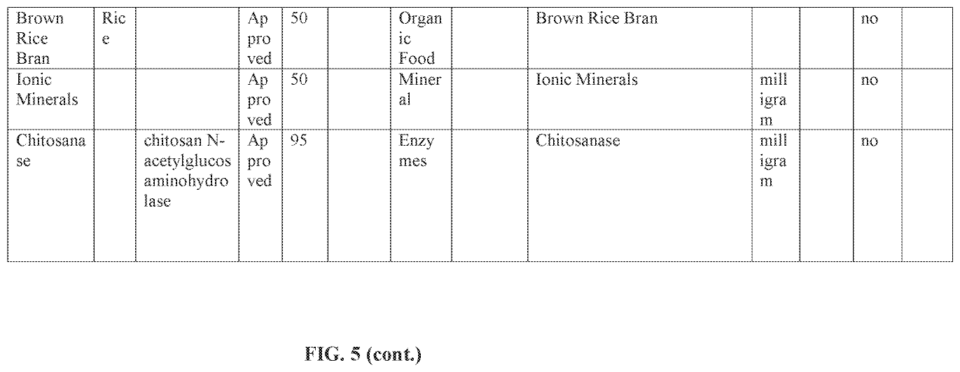

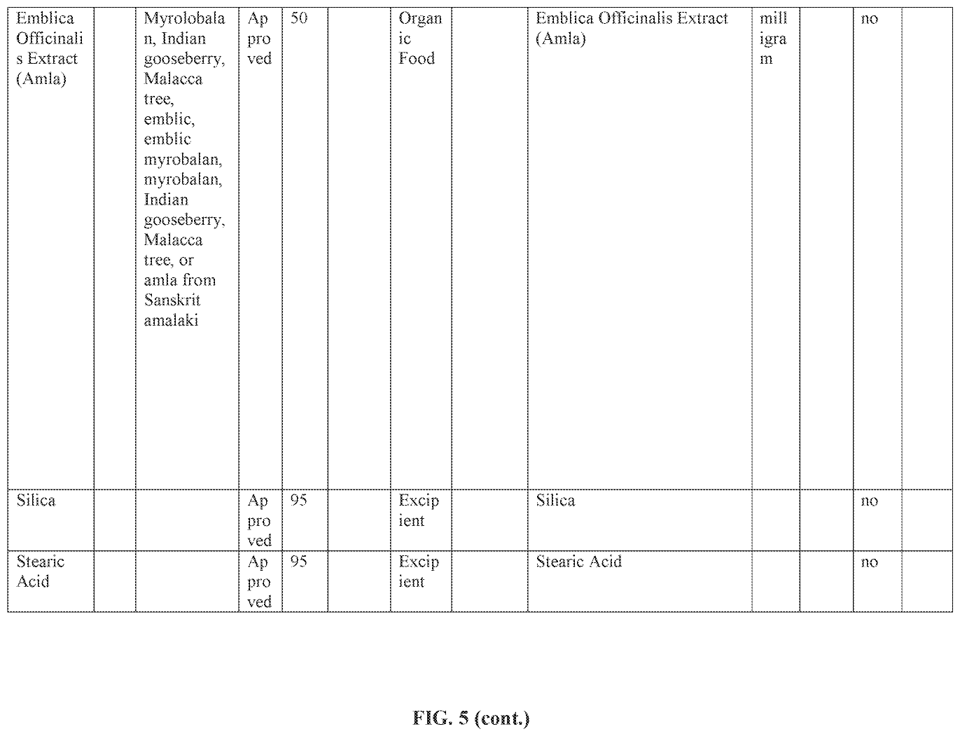

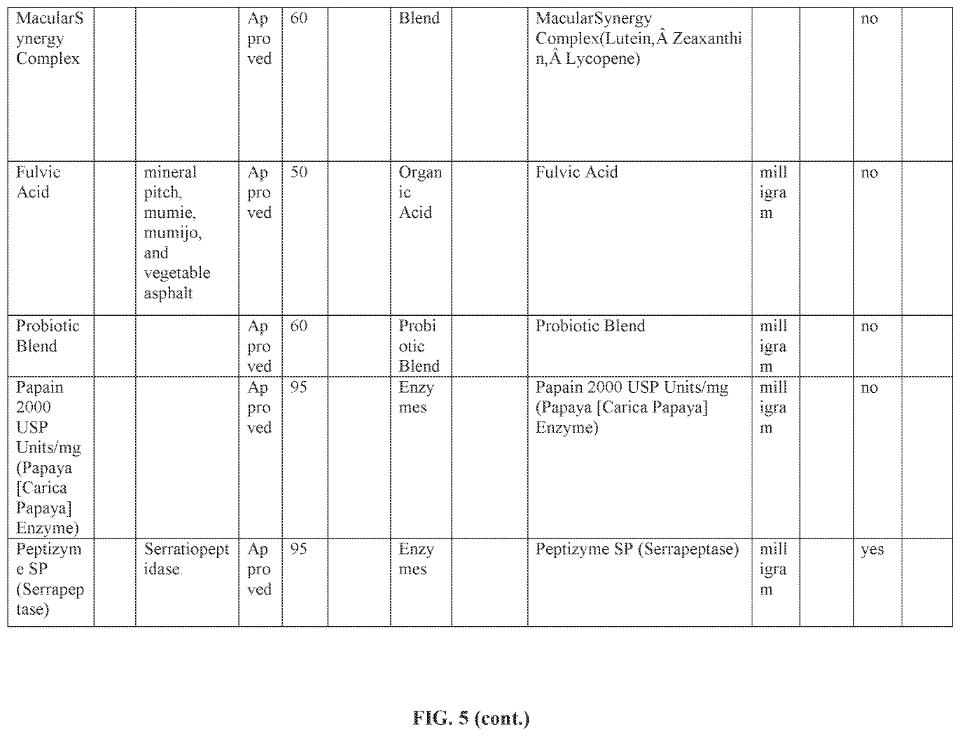

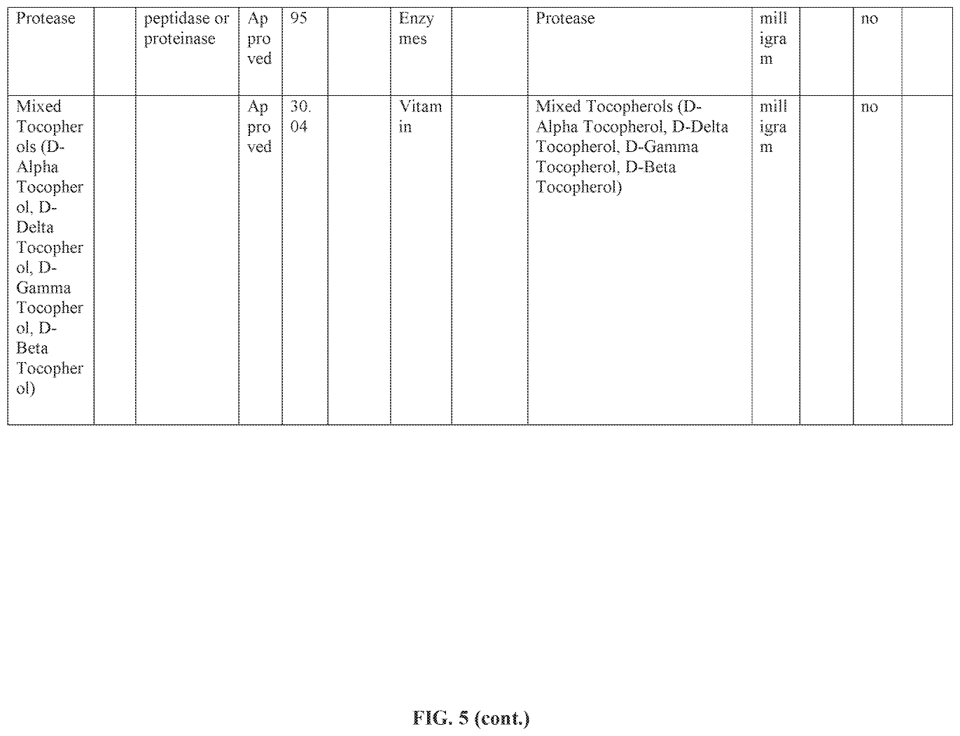

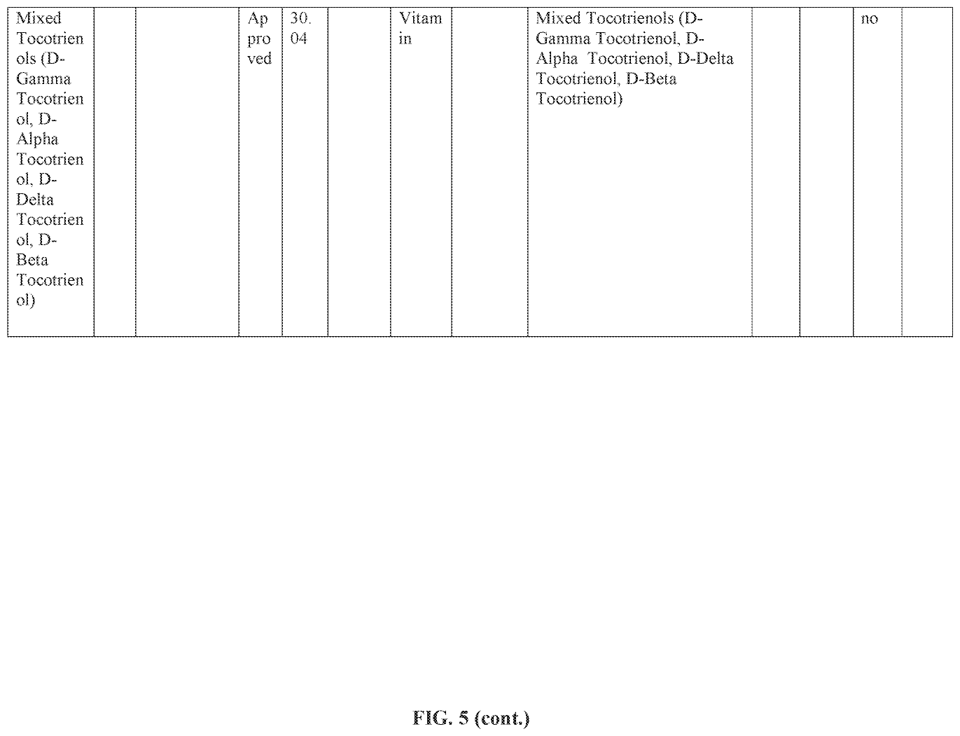

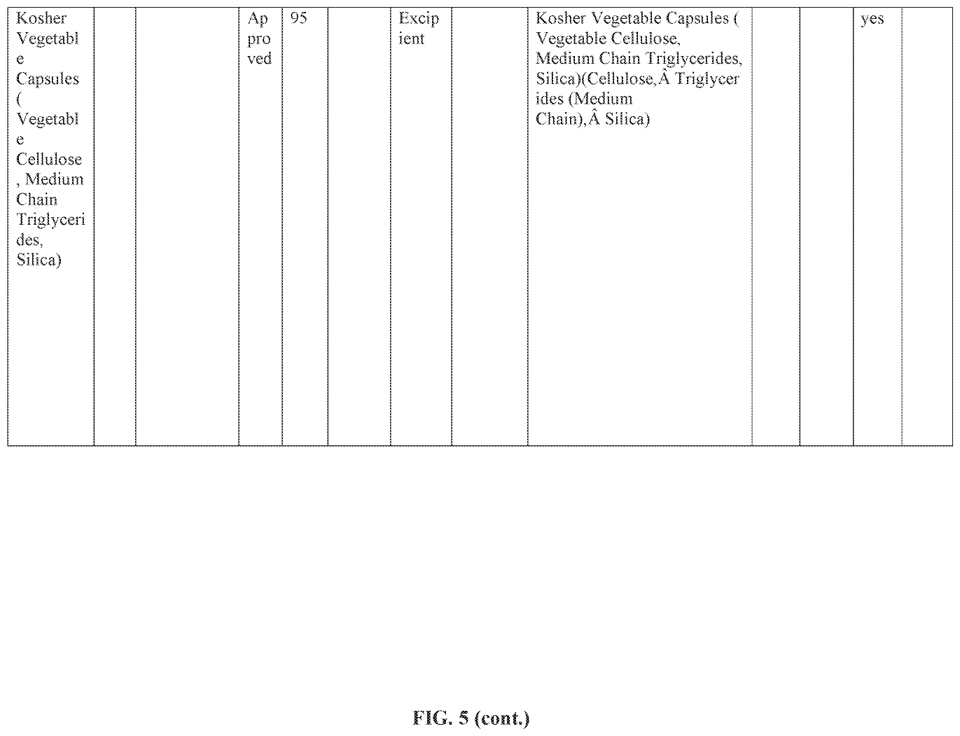

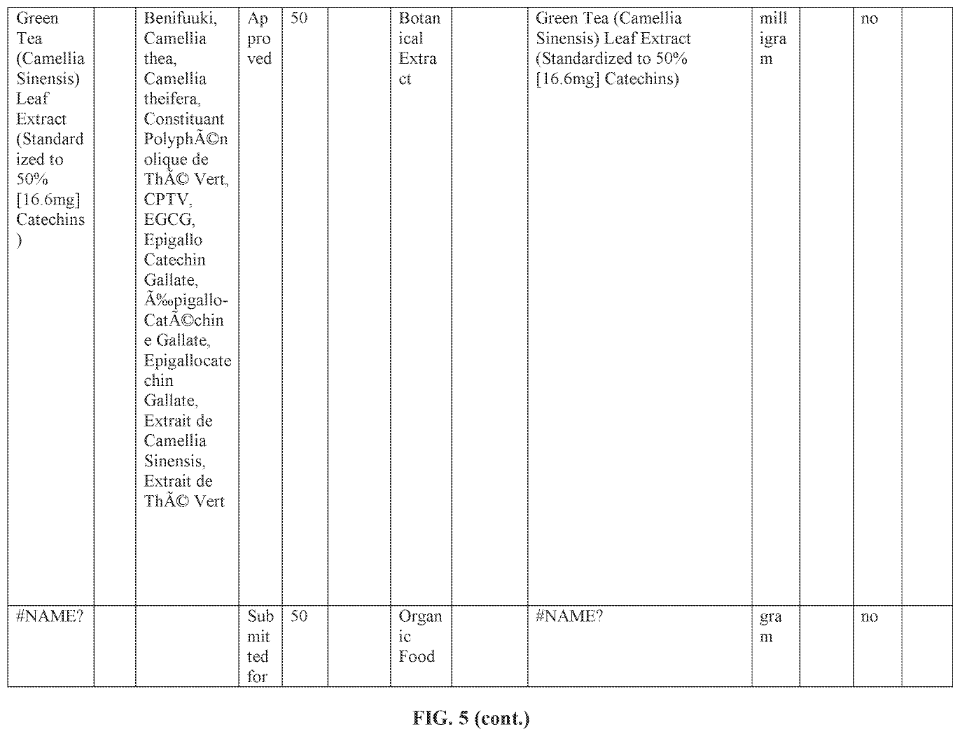

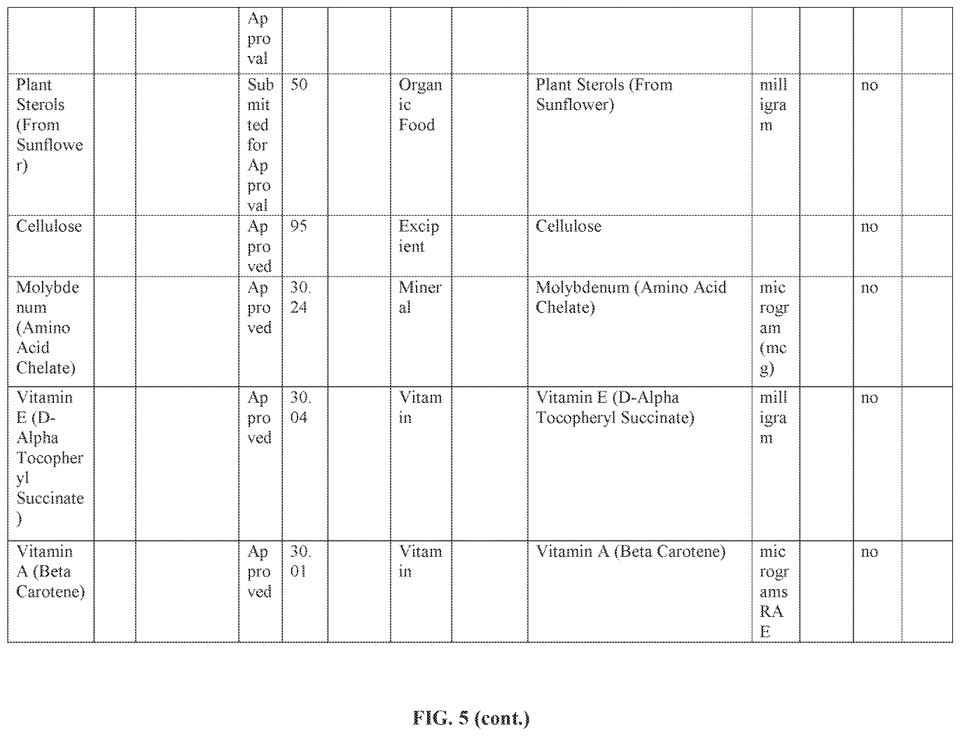

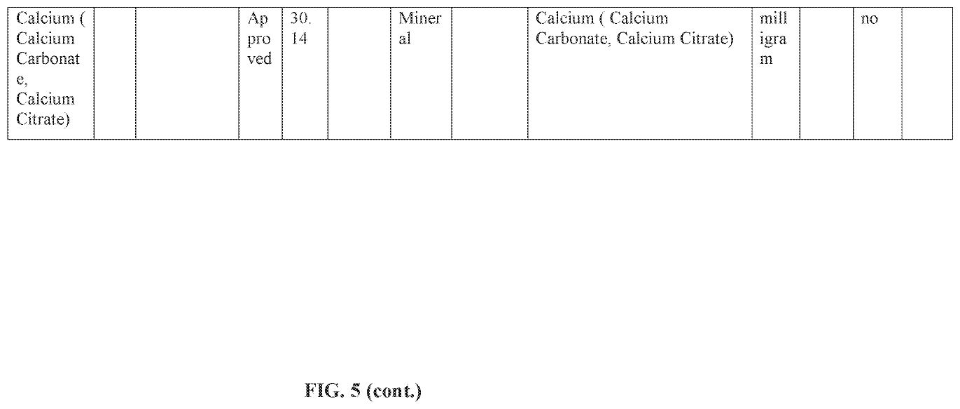

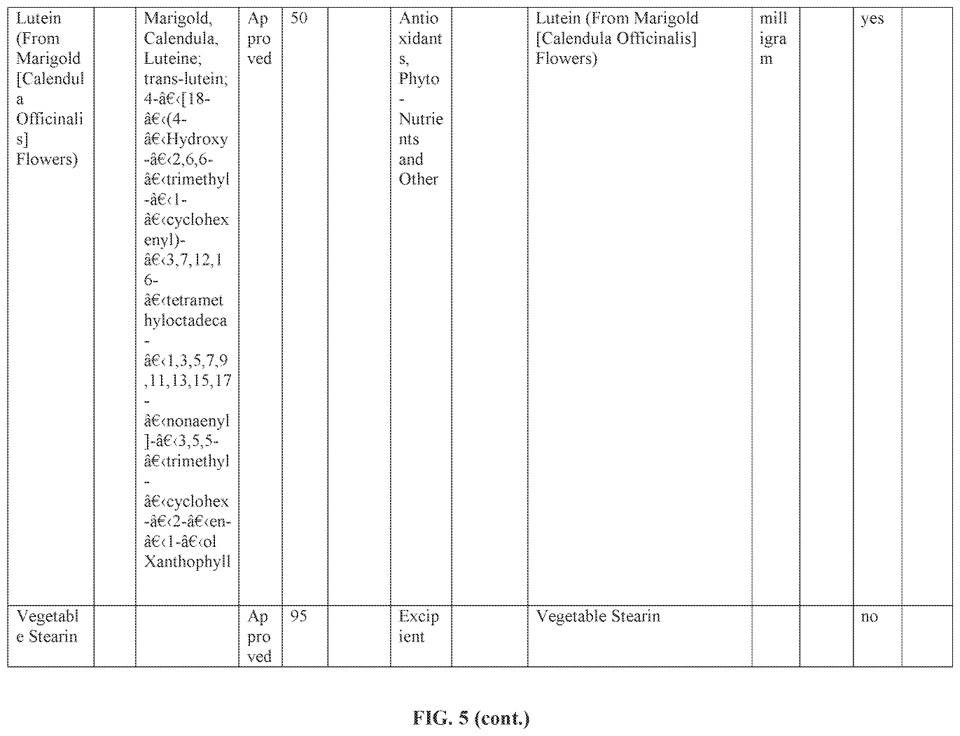

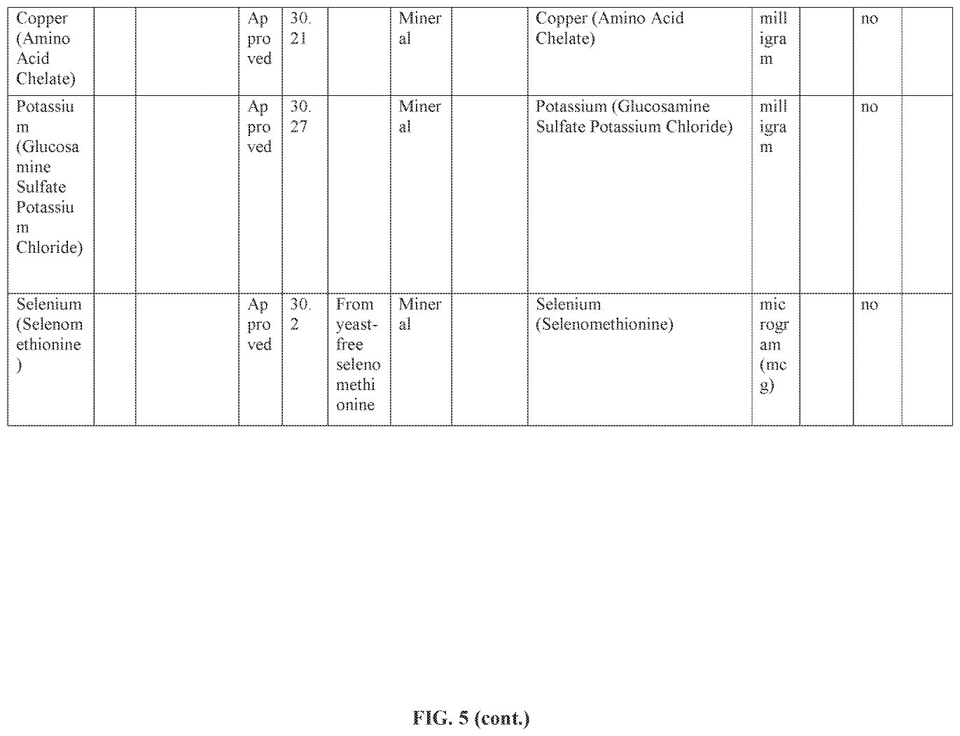

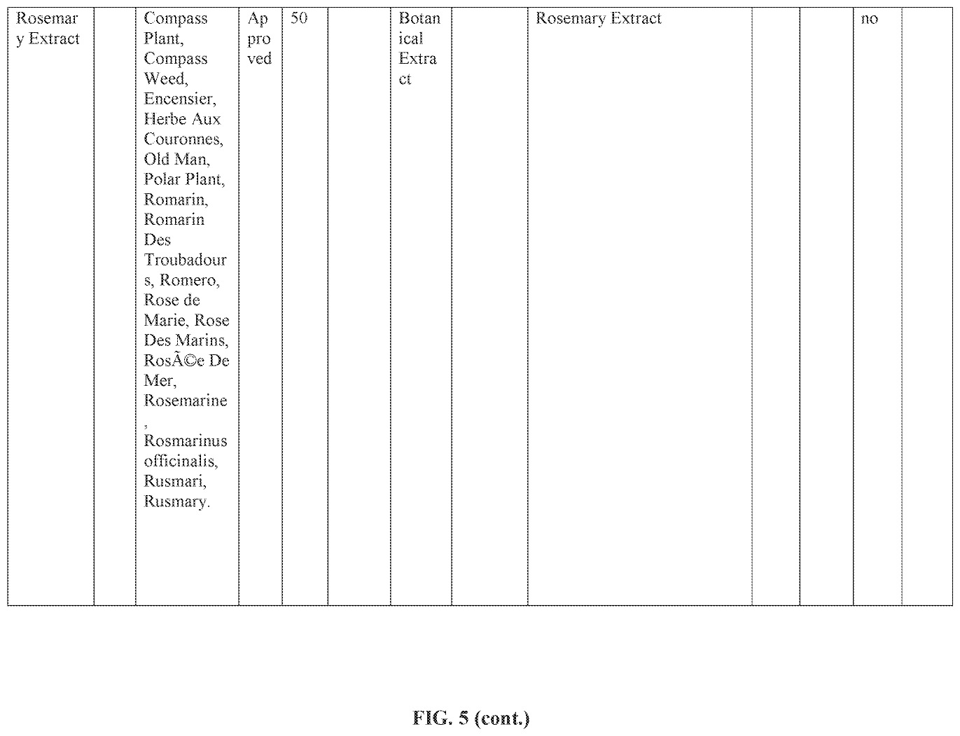

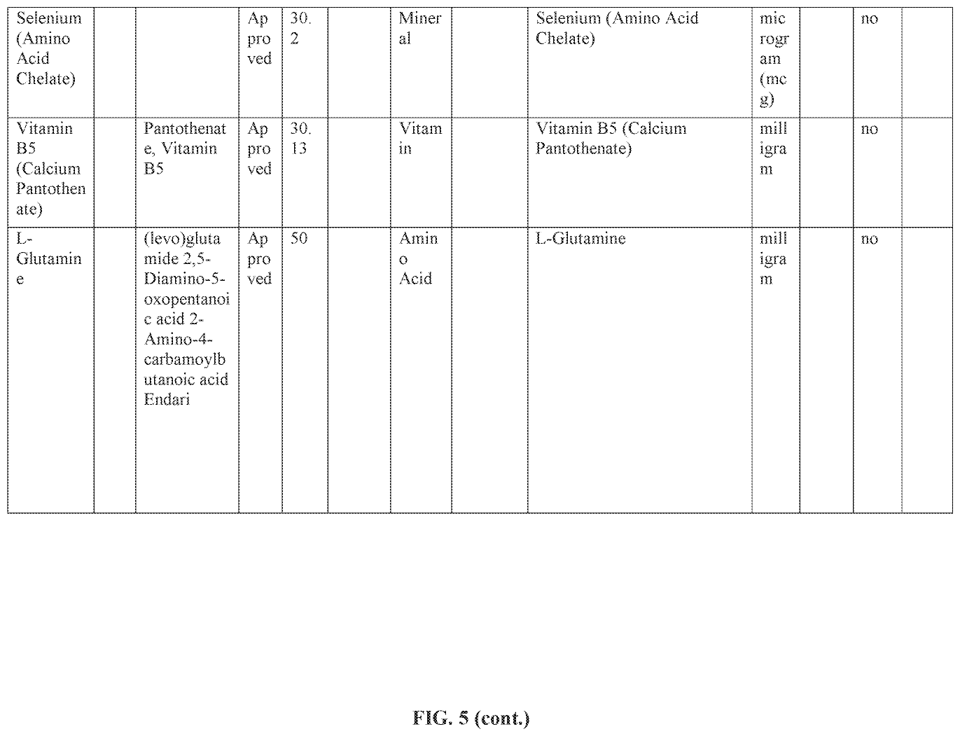

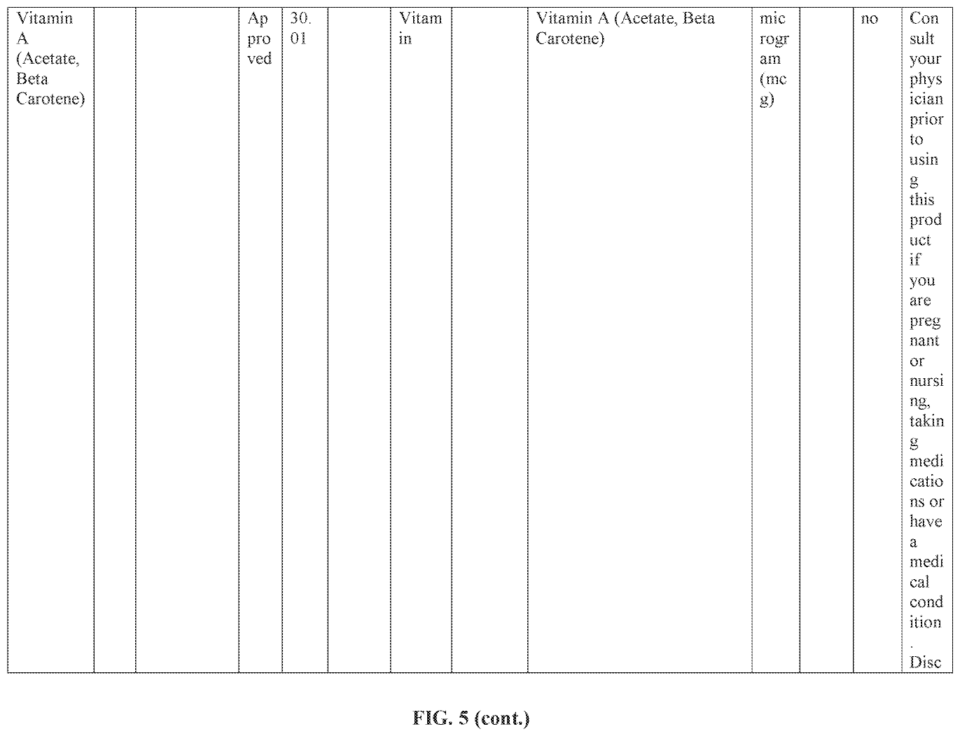

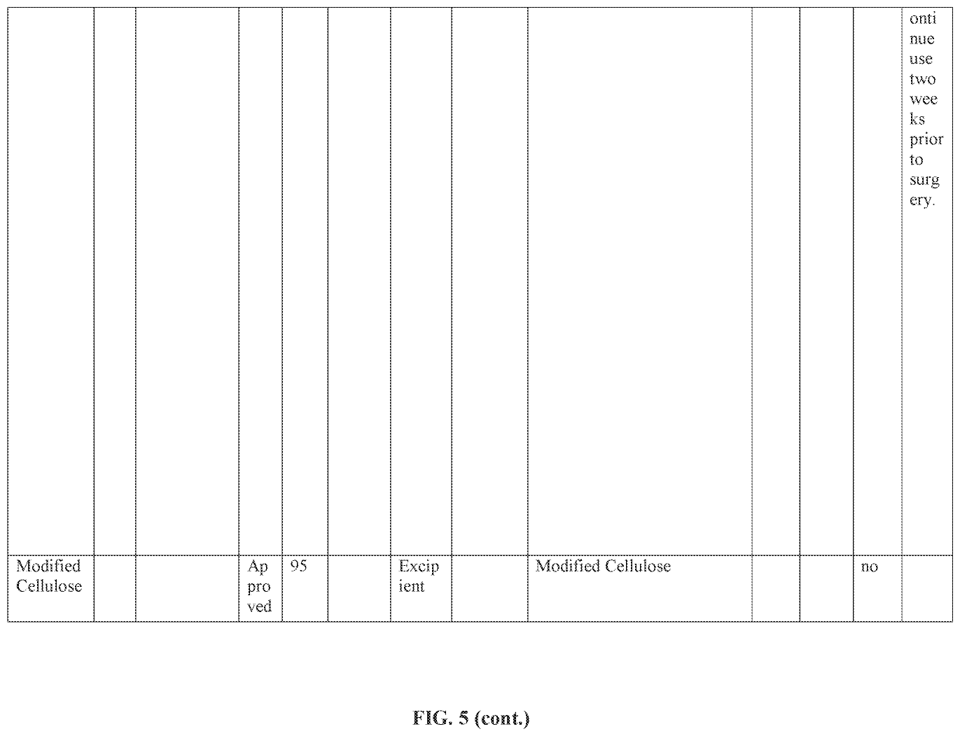

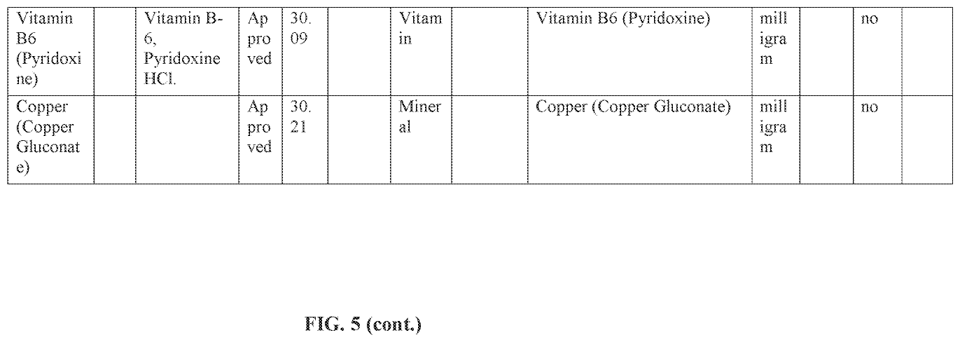

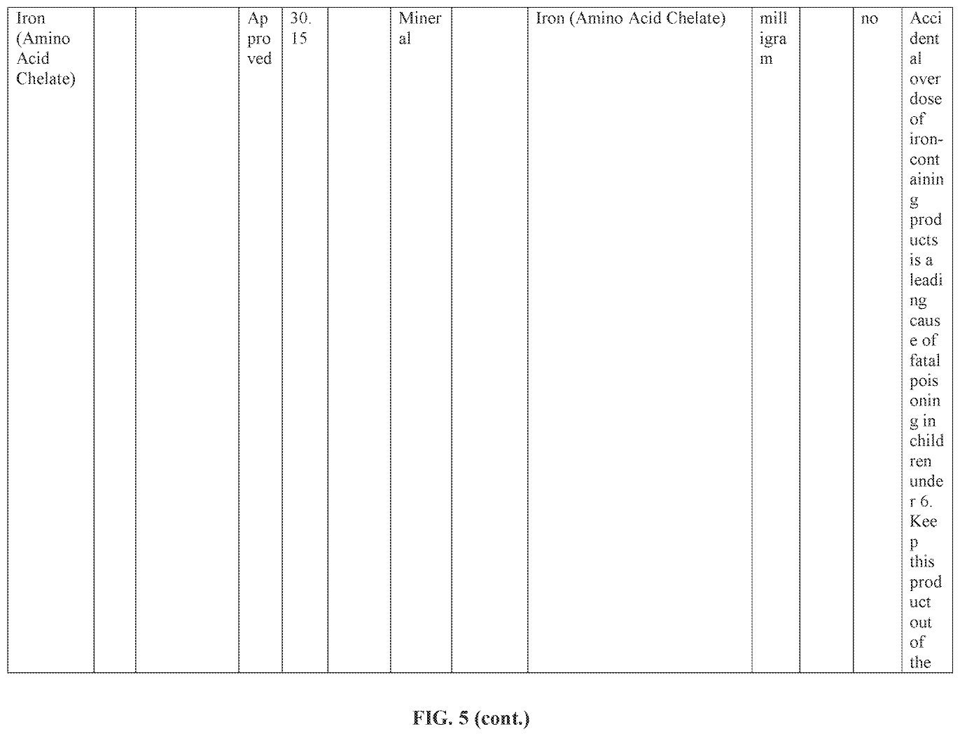

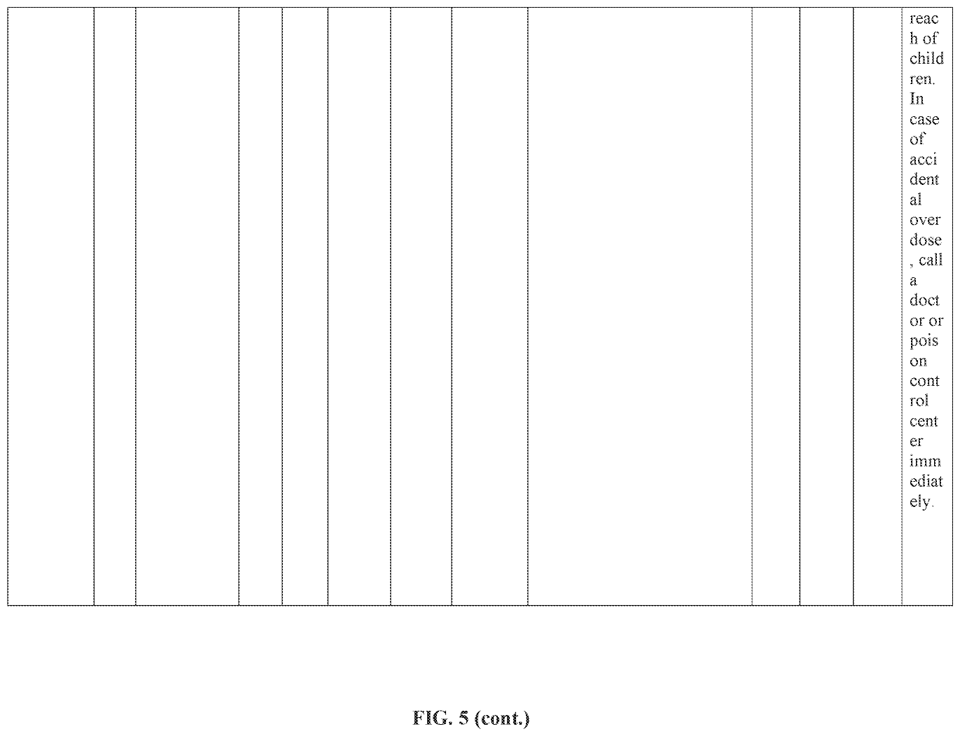

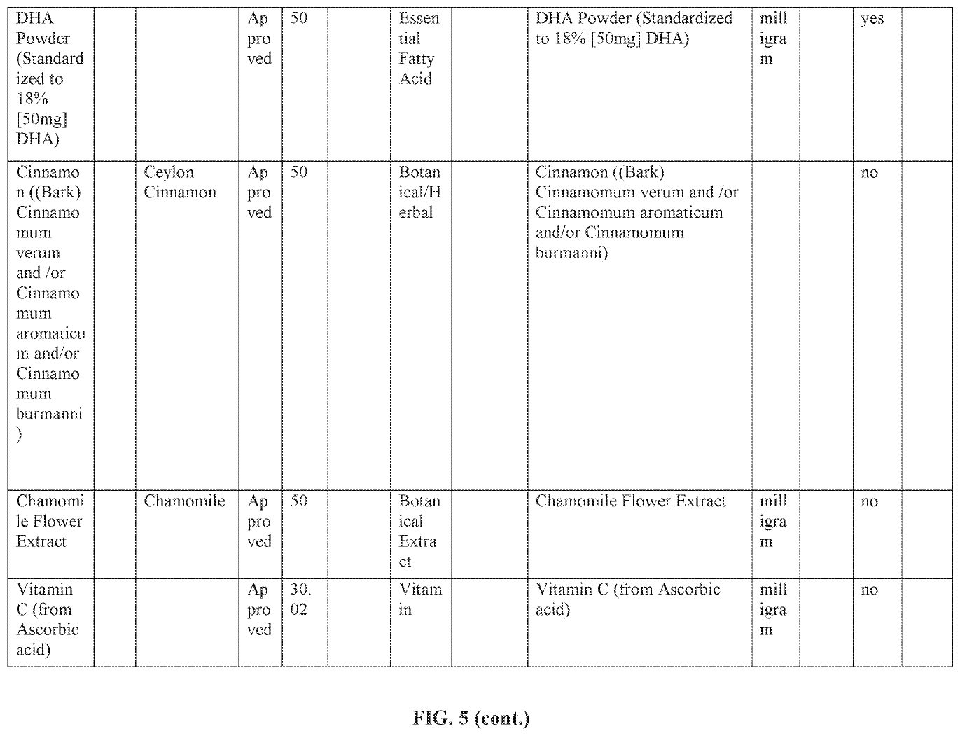

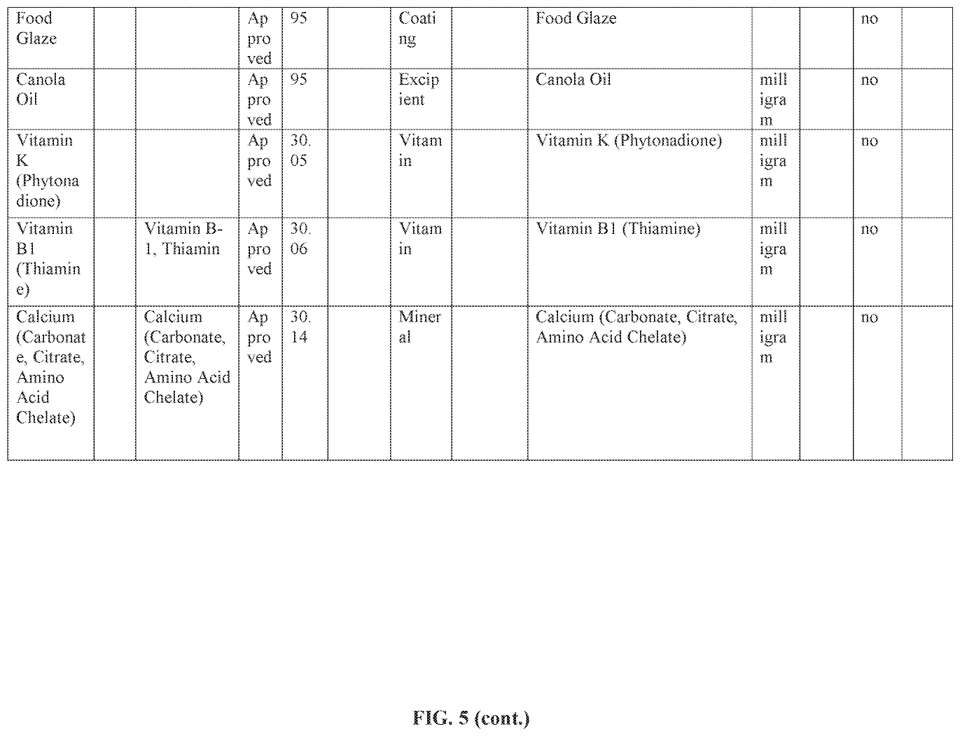

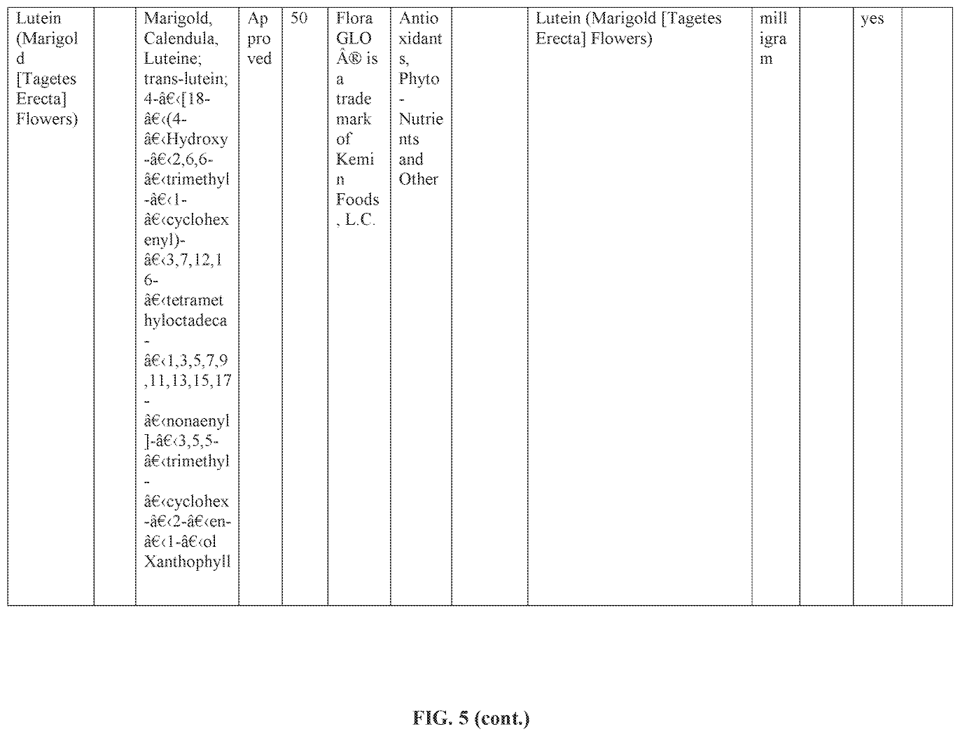

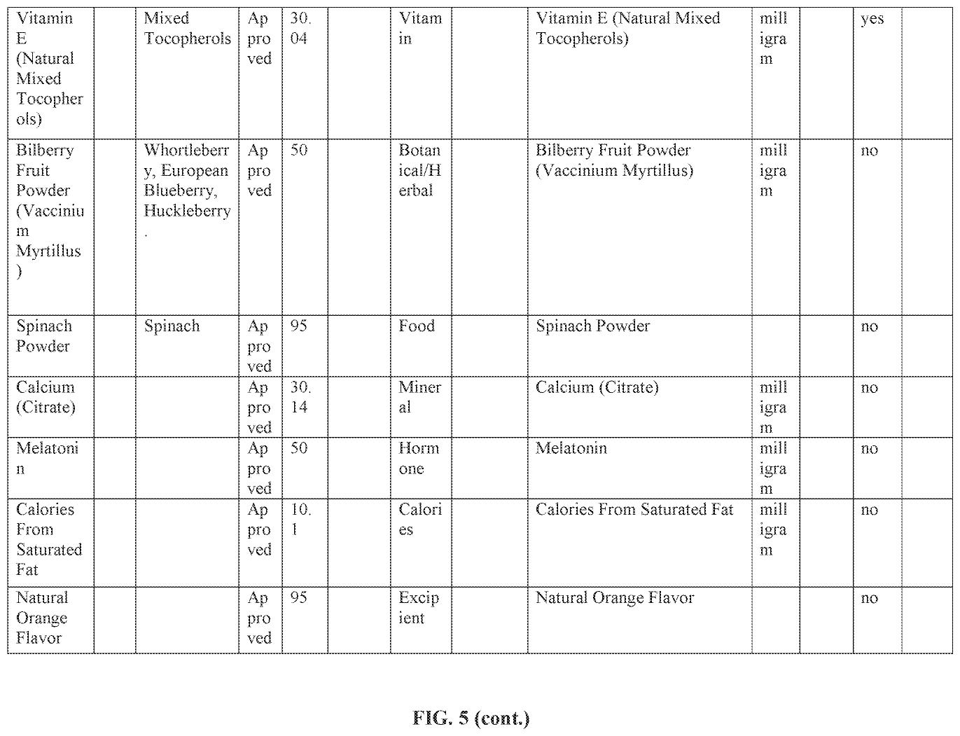

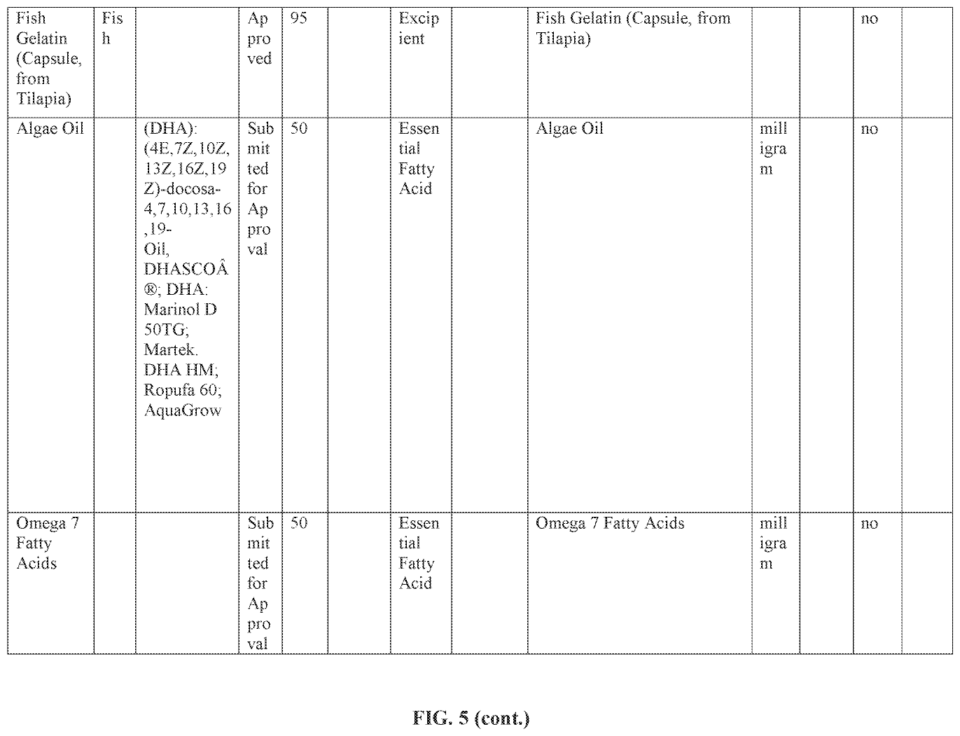

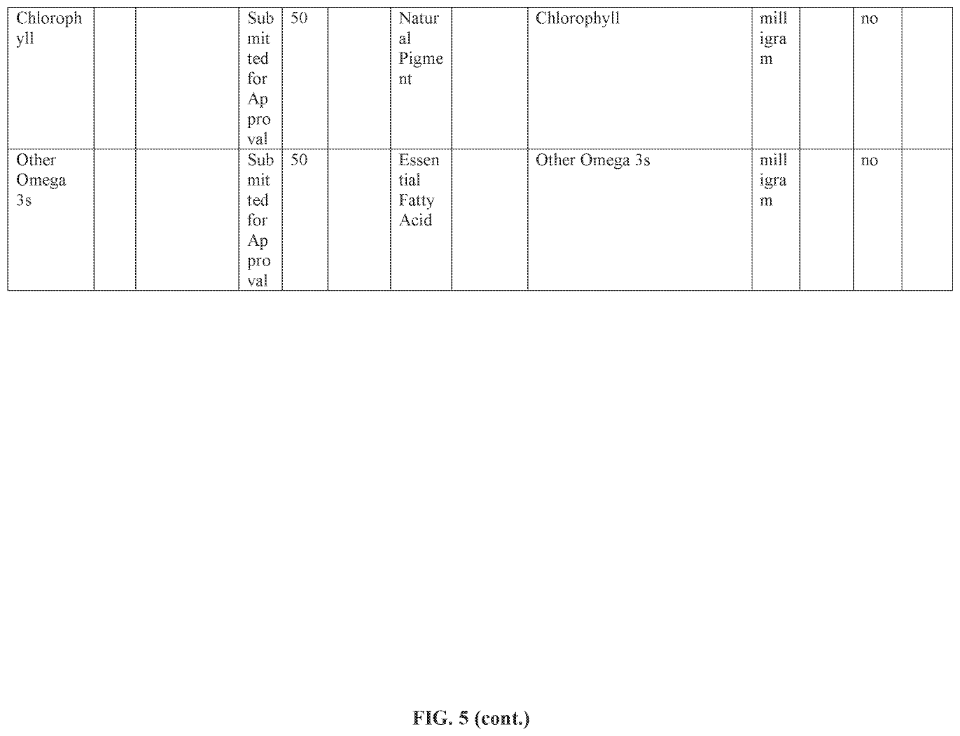

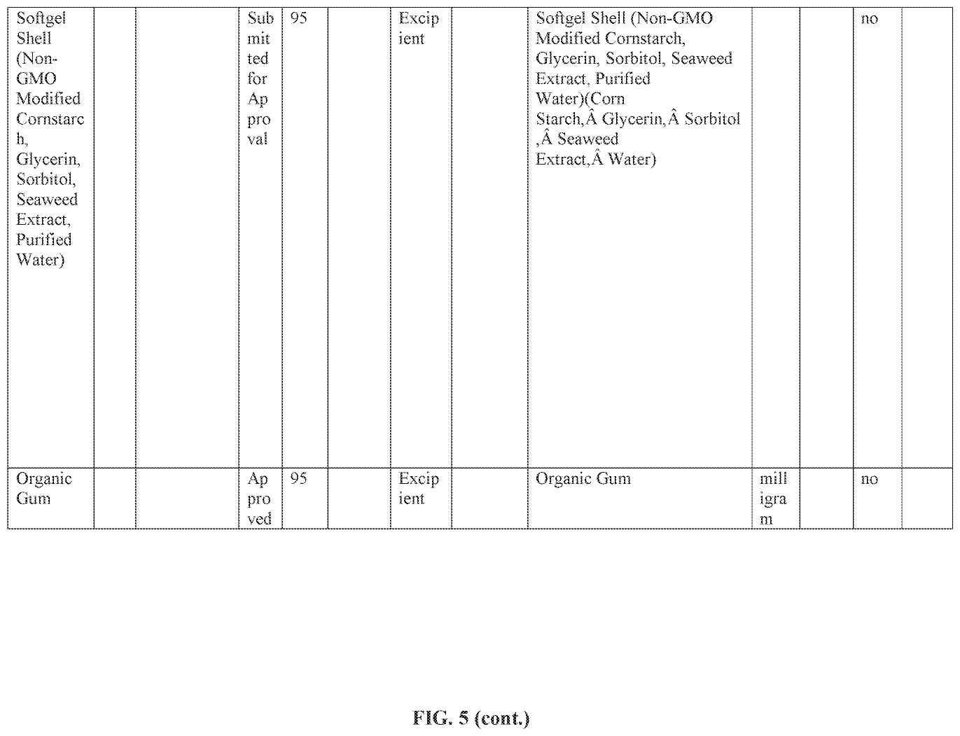

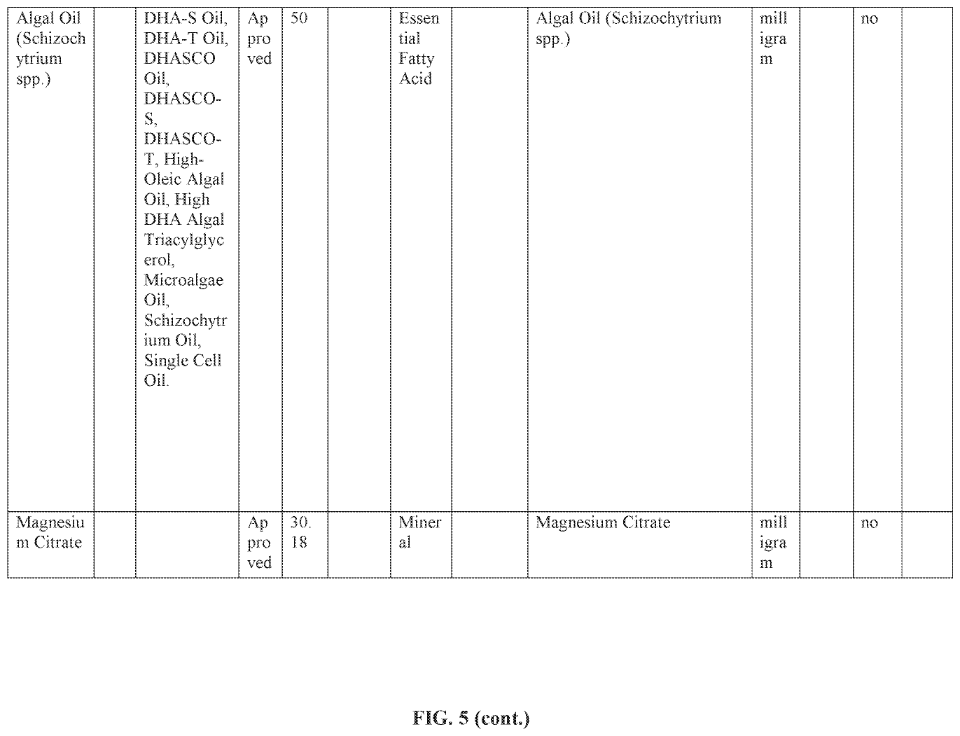

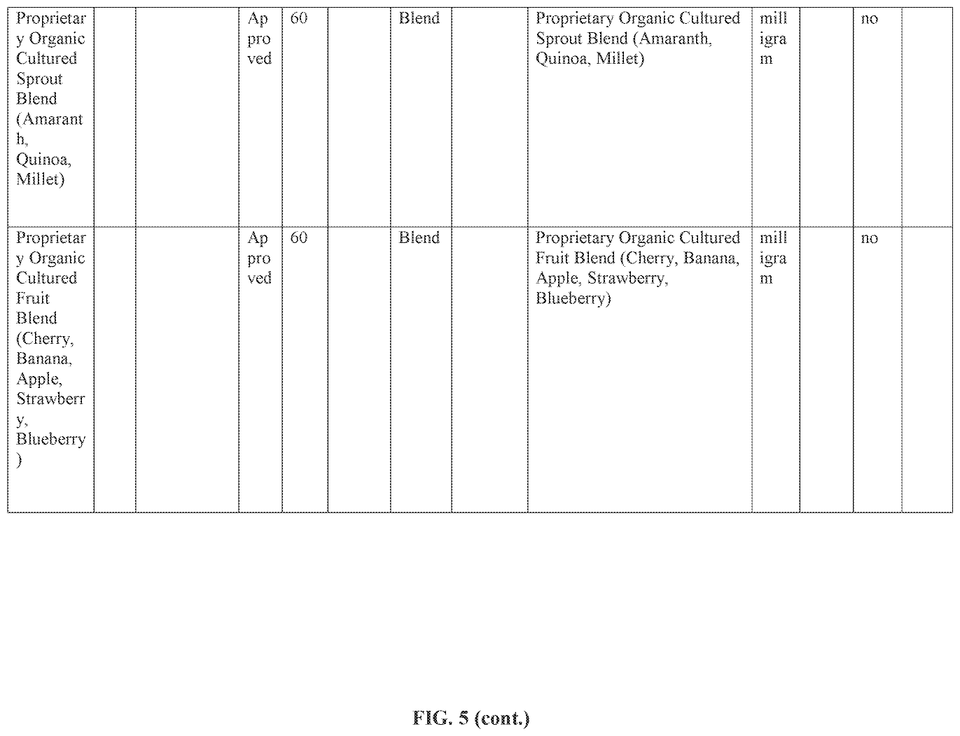

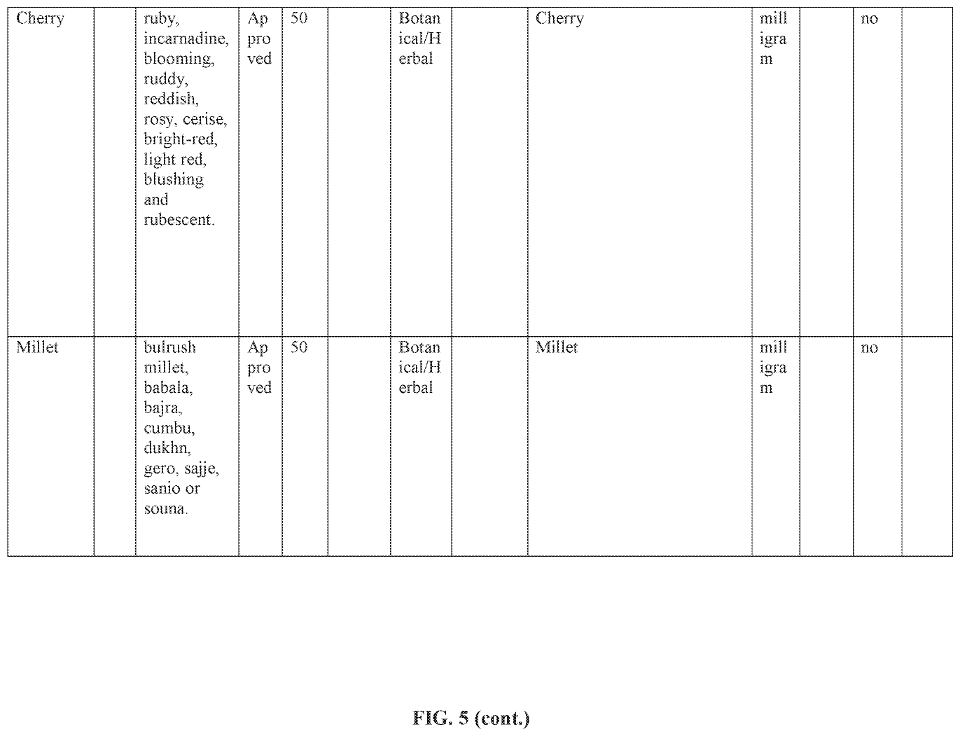

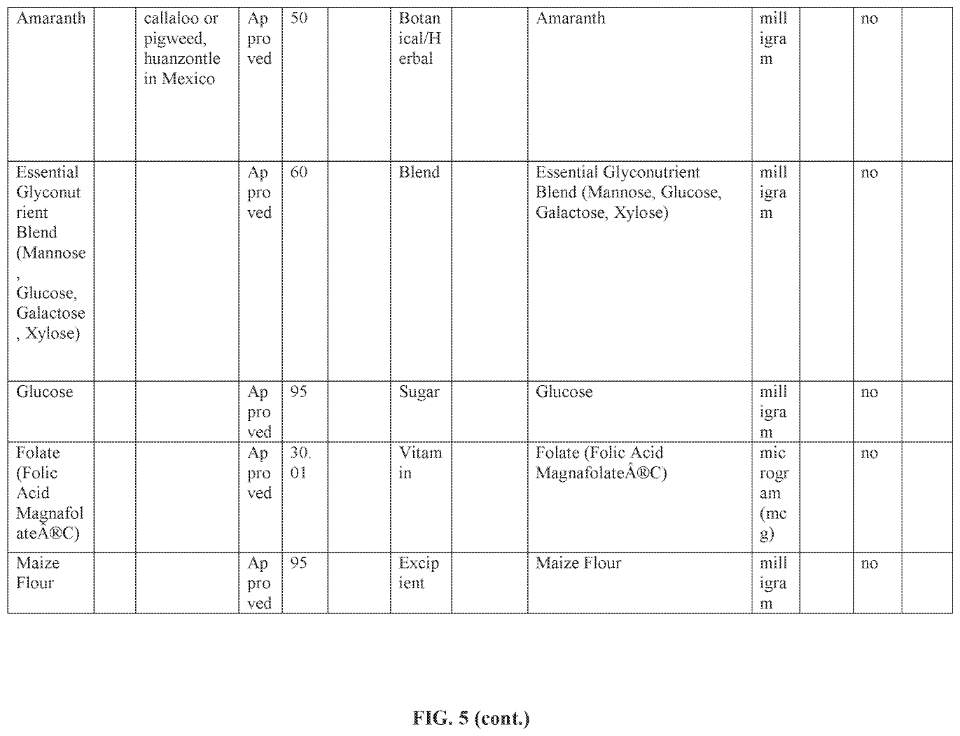

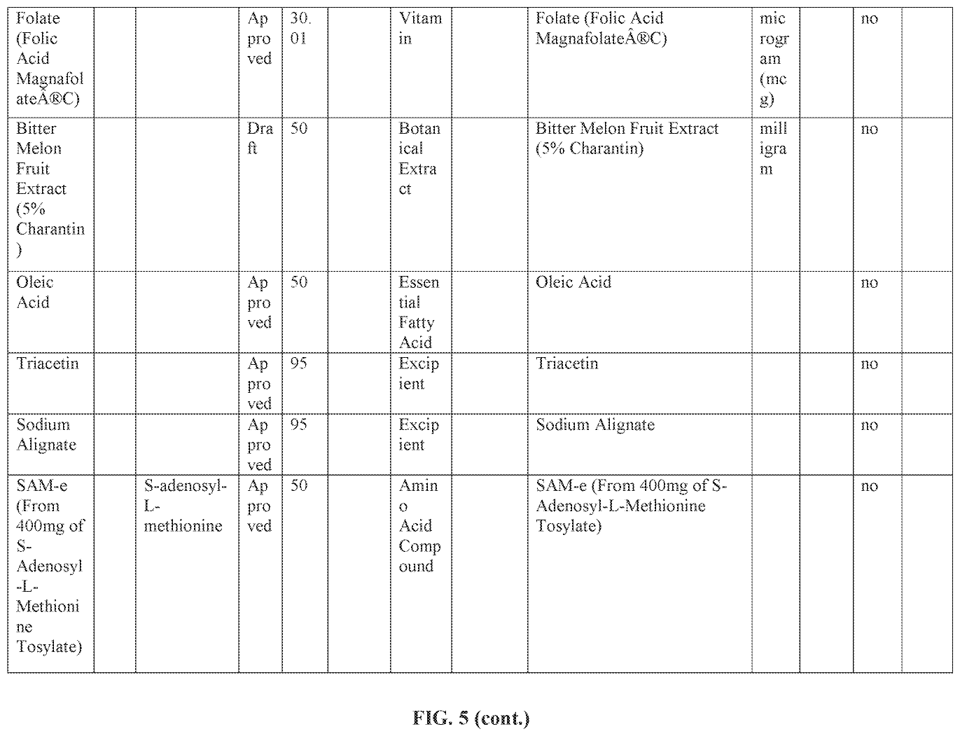

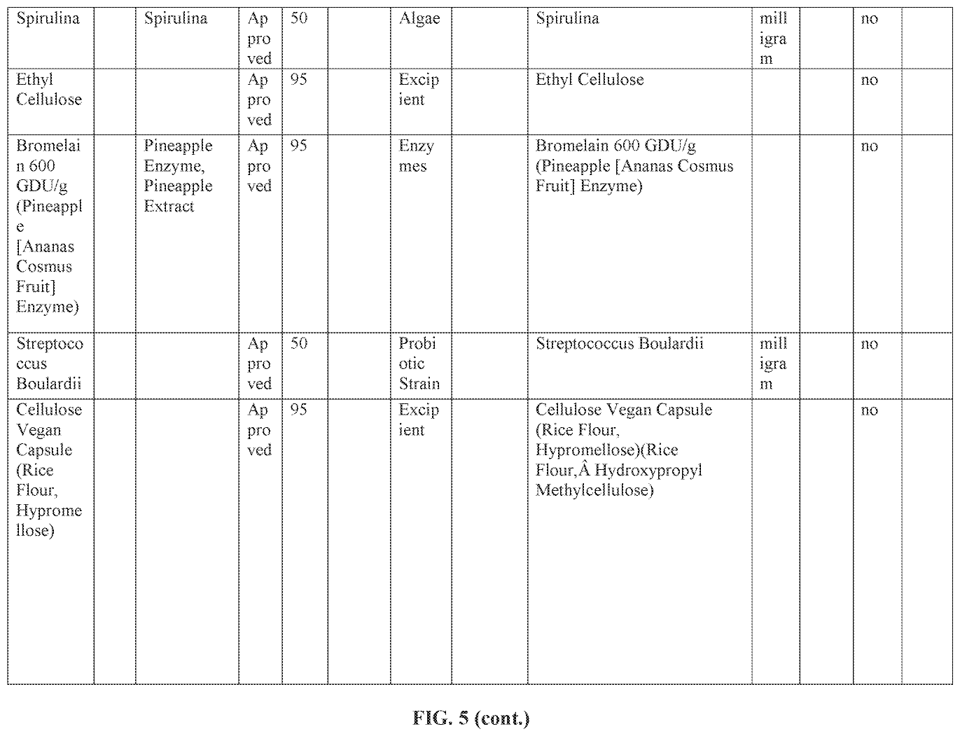

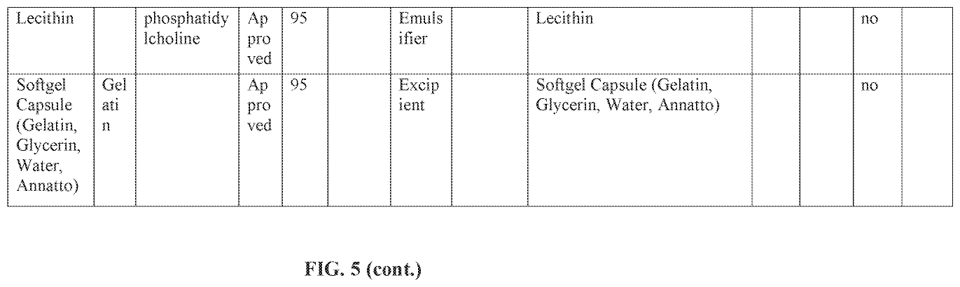

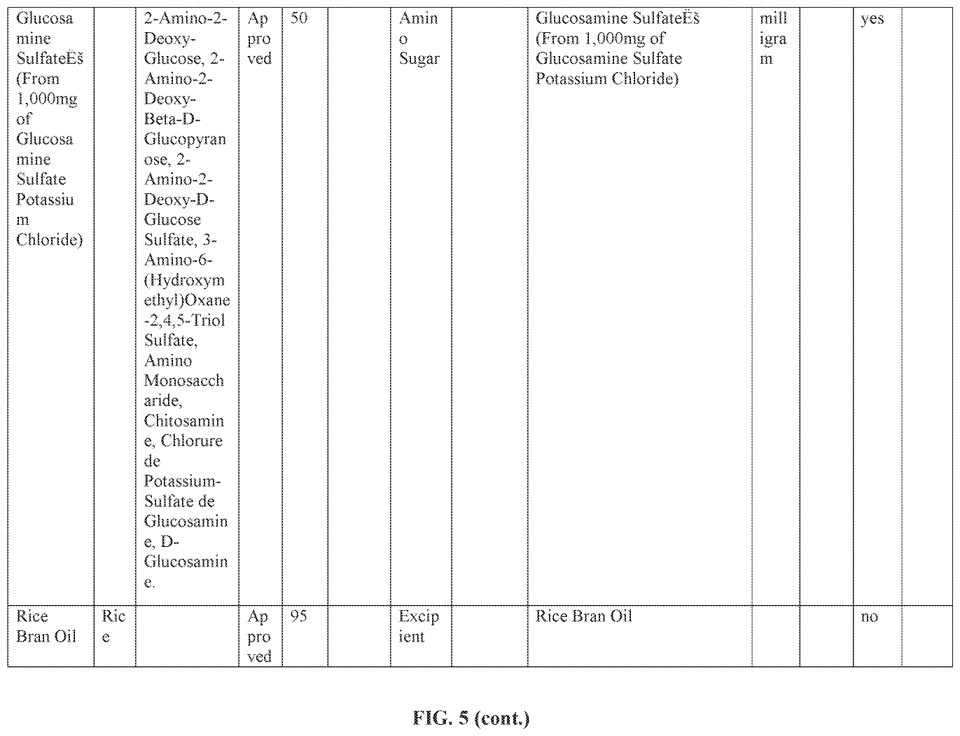

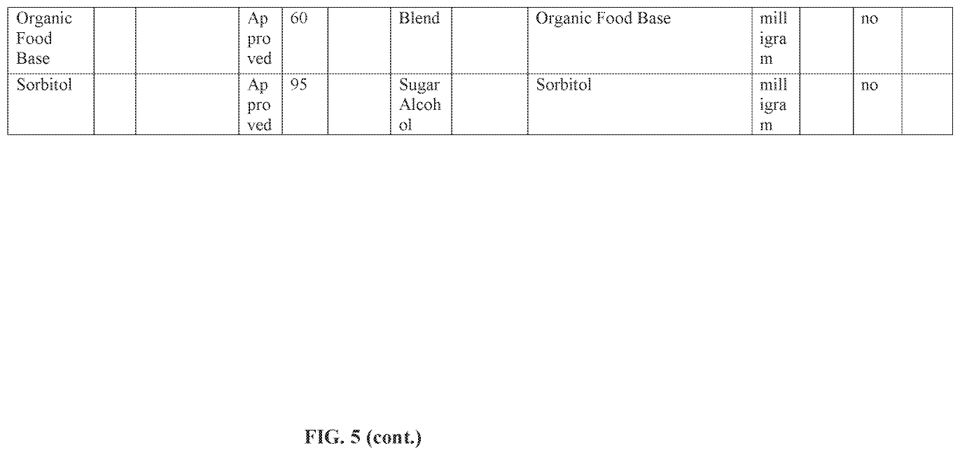

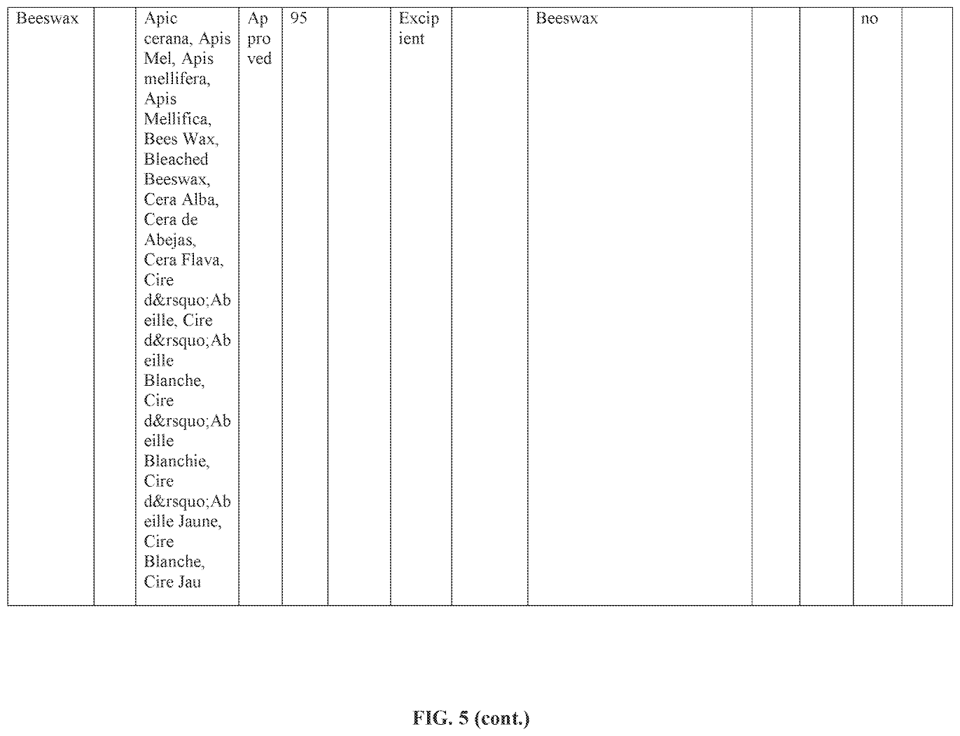

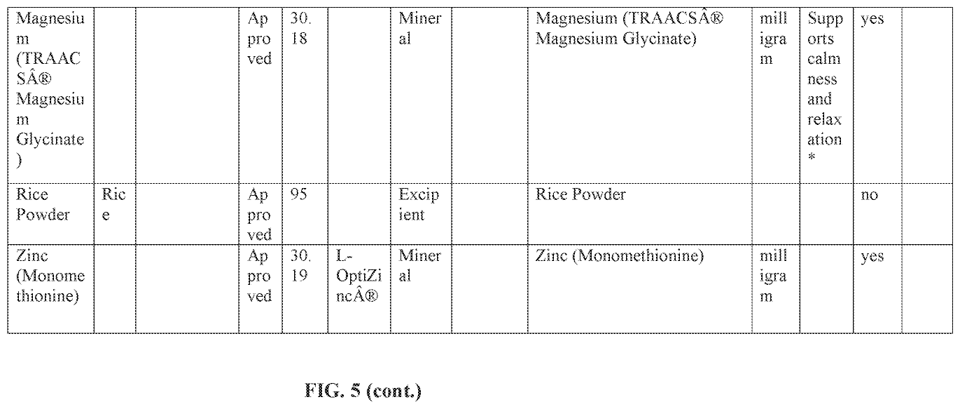

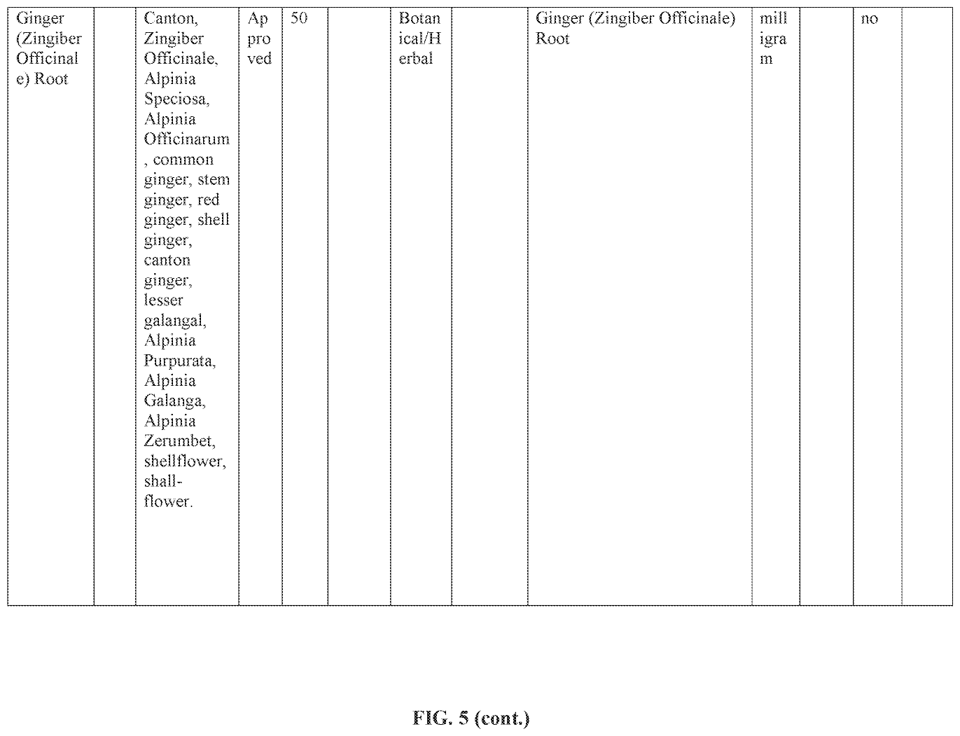

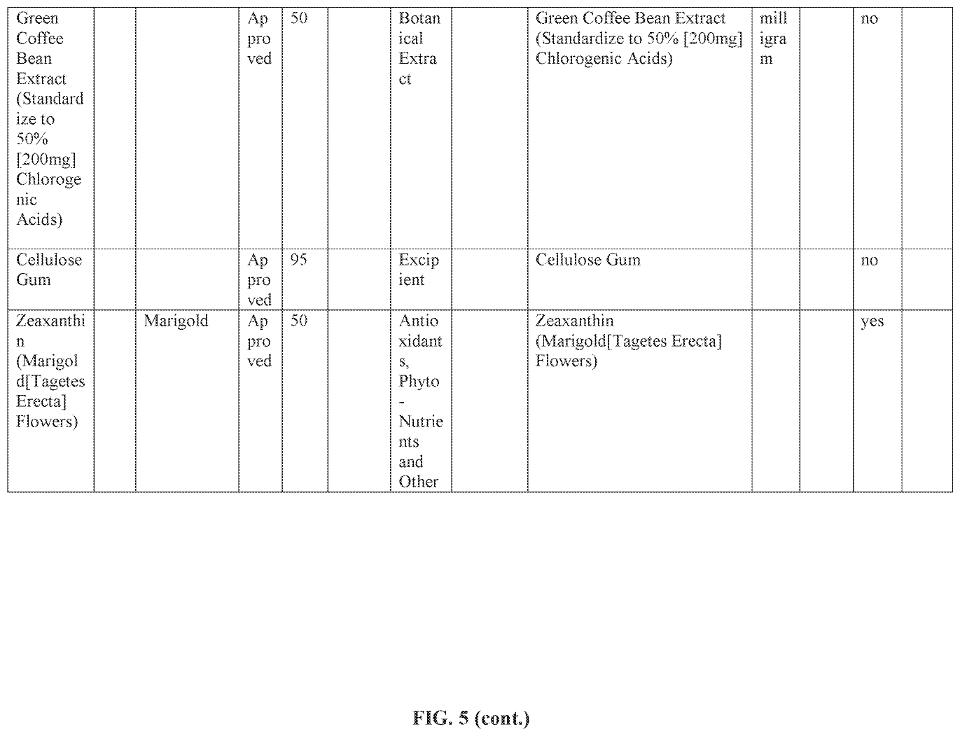

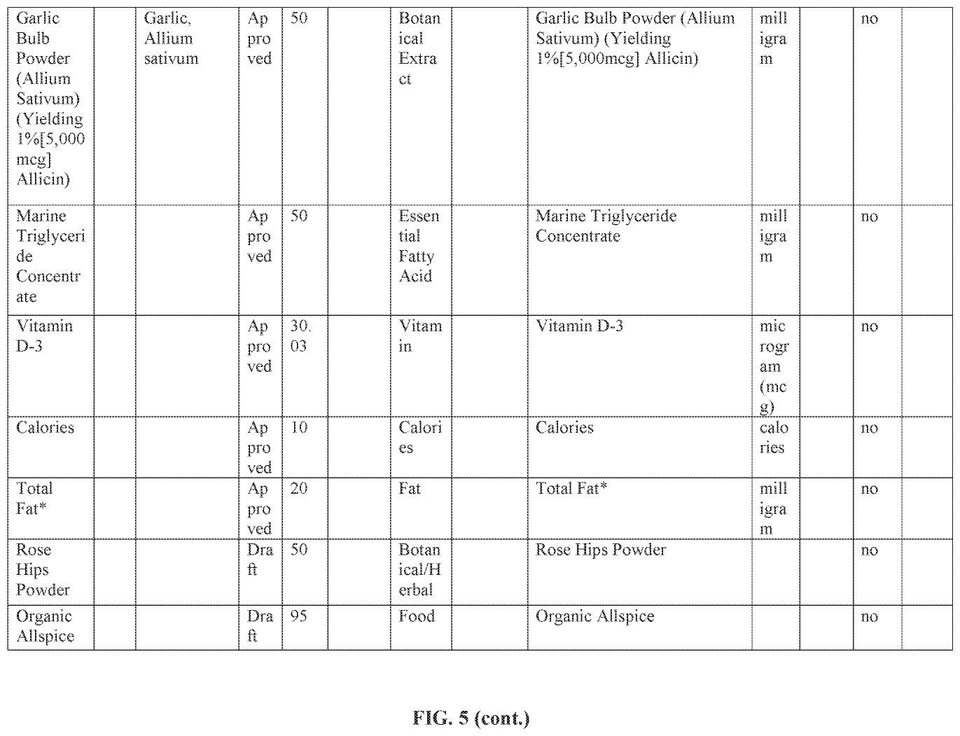

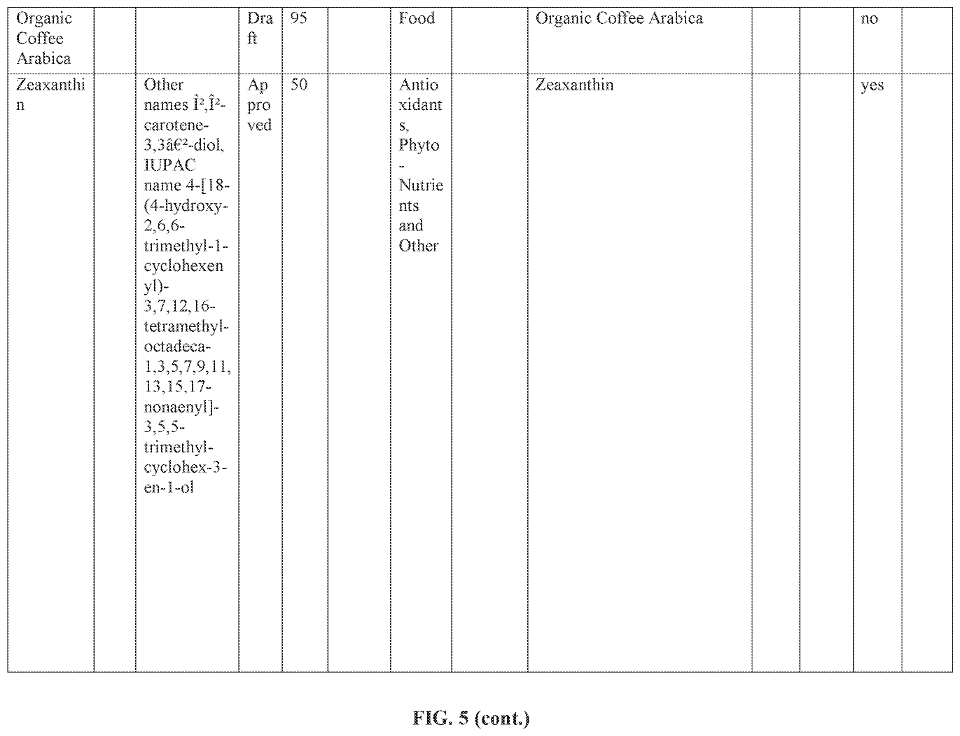

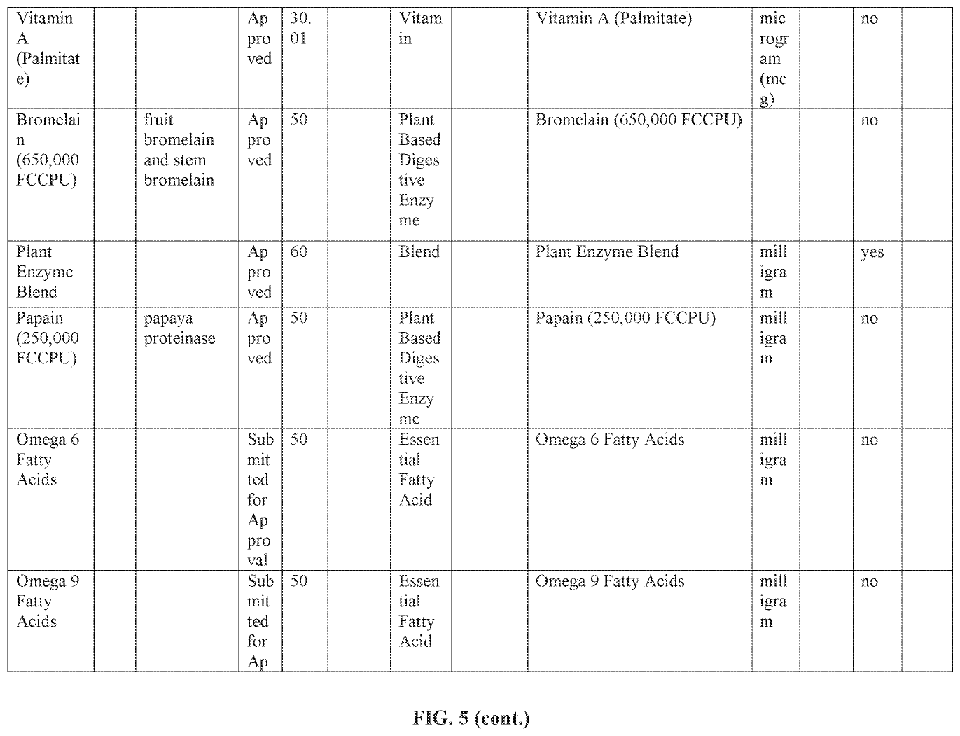

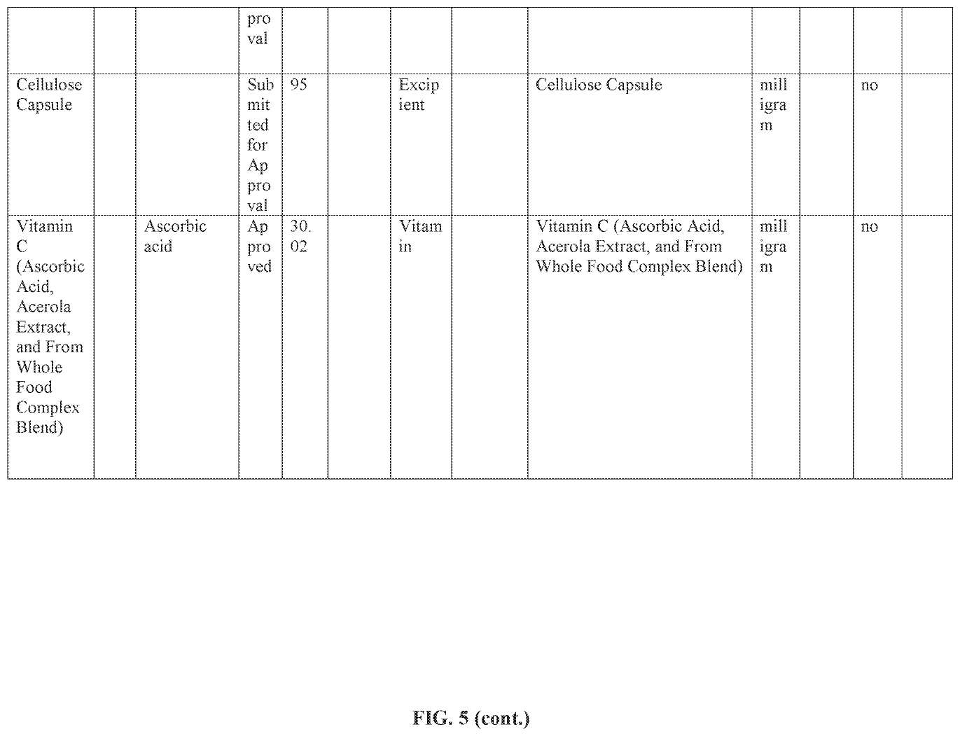

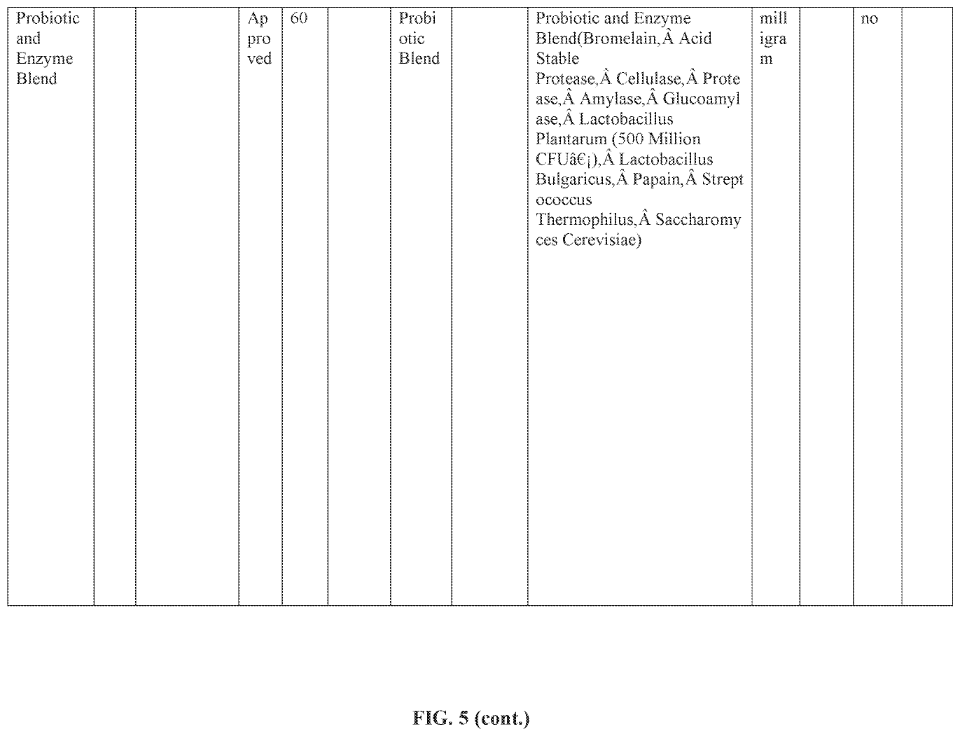

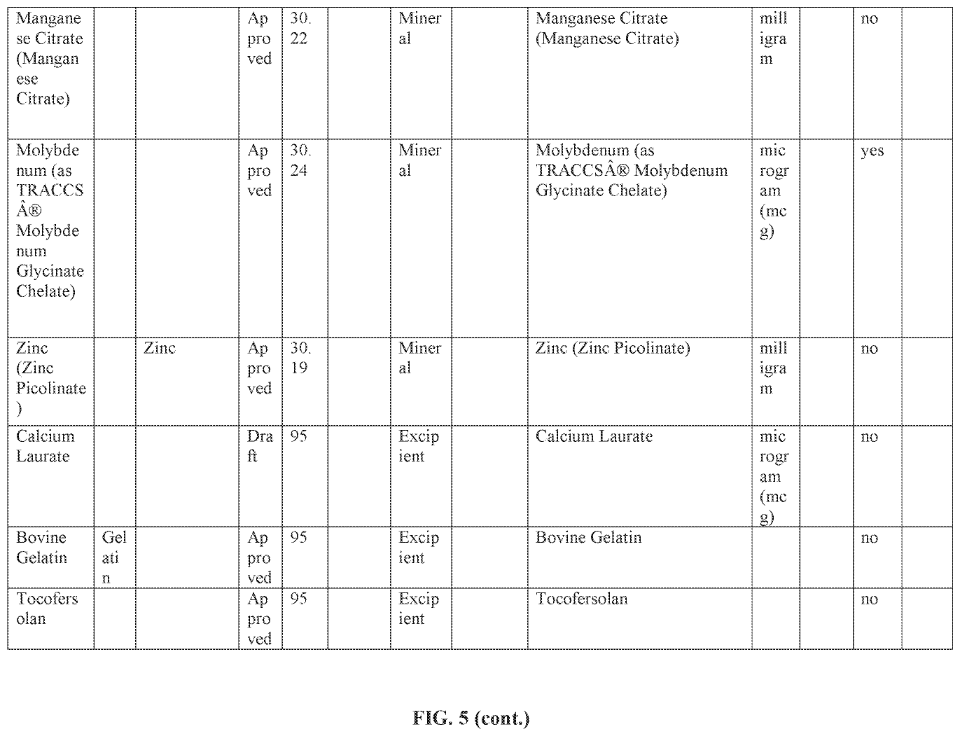

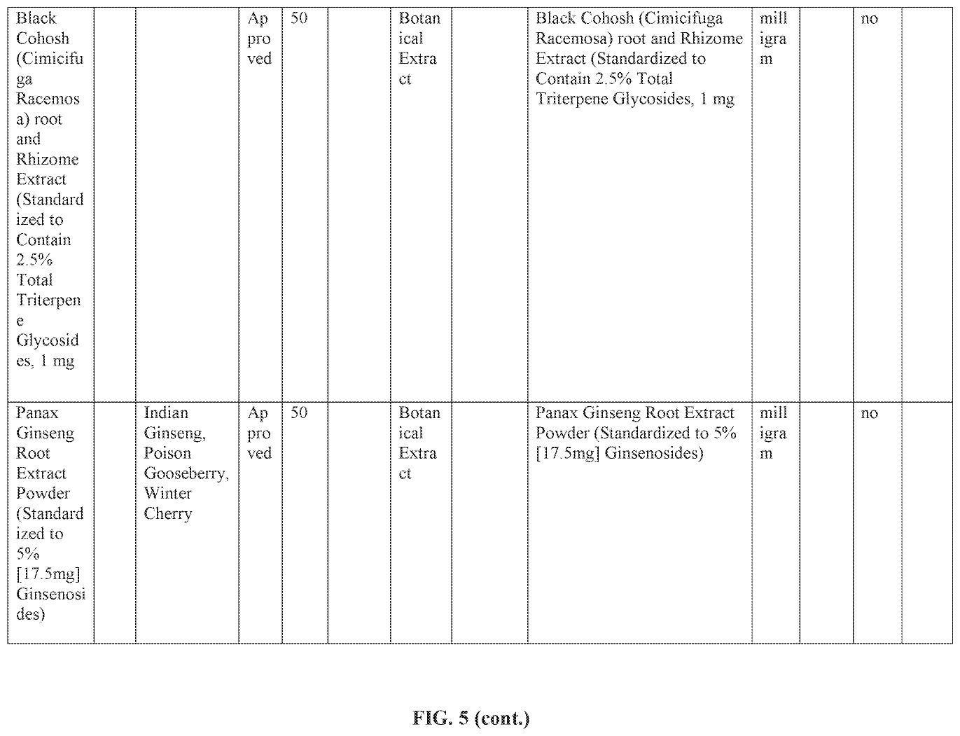

The compliance system and method tracks about 700 different ingredients, as shown in the Table in FIG. 5. The table includes the information for the ingredients, including, but not limited, the following: Ingredient Name, Allergen, Also Known As, Approval Status, Ingredient Sort Order, Ingredient Source Statement, Ingredient Type, Not To Be Used By, Other Full Name, RDA Unit, Structure, Function Claims, Trademark Name, and Warning. There are thousands of others that can be added to the system depending on what the fact panel is generated for. The system generate panels for a dietary supplement inventory. The system can be used to generate a fact panel for a food product, such as a ham sandwich by using those ingredients from the database.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. However, those of skill in the art should, in light of the present disclosure, appreciate that many changes can be made in the specific embodiments which are disclosed and still obtain a like or similar result without departing from the spirit and scope of the invention.

Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### EXAMPLES

The current values for the parameters in the examples below on the API or website include a Formulary Ids, Template name, Serving Size, Brand, Promo Pages, and Time of Administration. The Amount Per Serving is calculated for each supplement, then the values are summed and consolidated to produce a fact panel for the entire pack instead of for each supplement product.

### Example 1

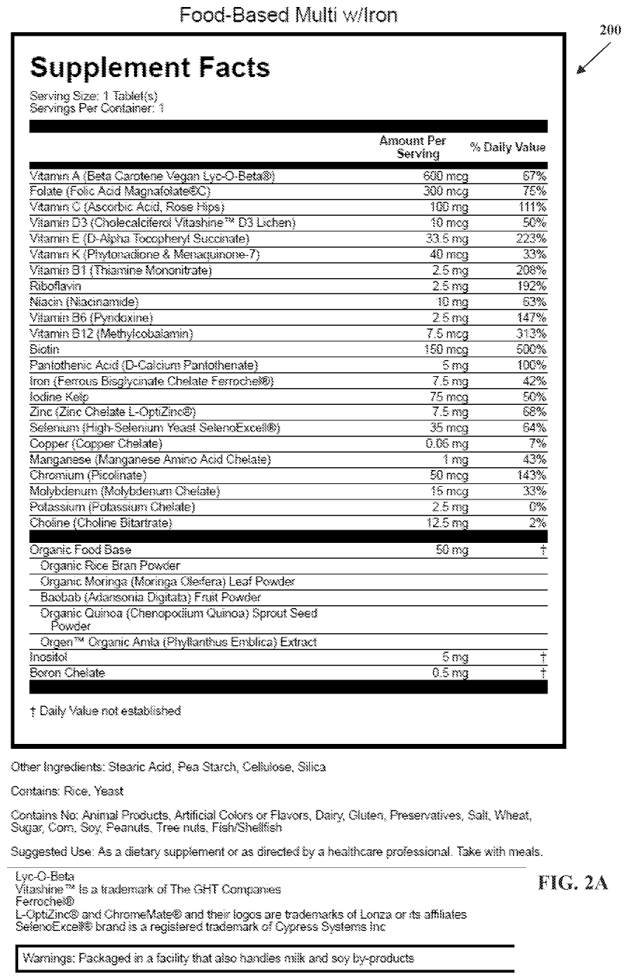

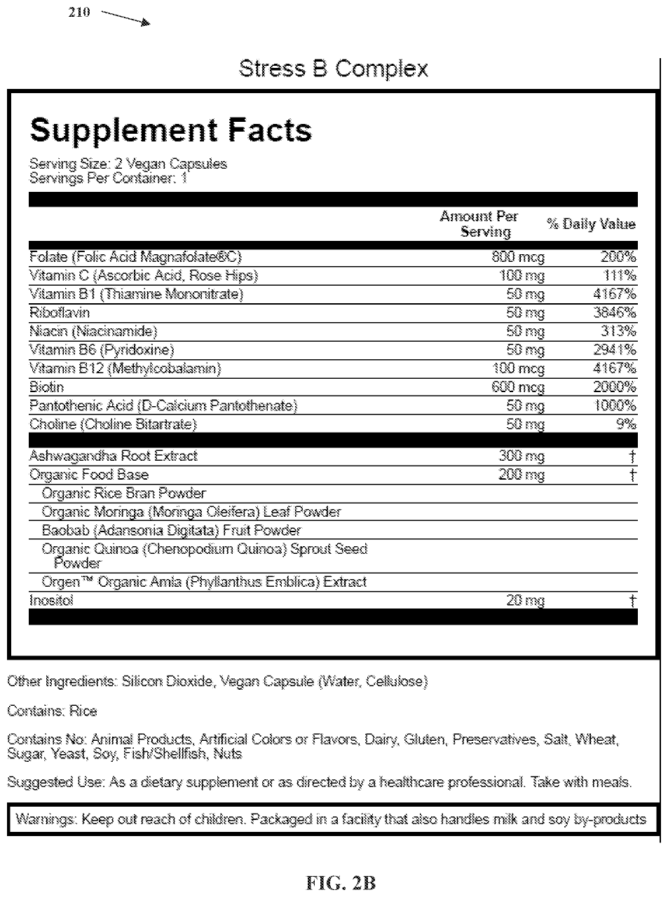

There are two supplements in this pack, as shown in FIGS. 2A-2B.

This is outputting individual fact panels for two separate products, the food-based multi-iron fact panel 200 and the stress B complex fact panel 210 (as opposed to consolidated, as shown in Example 2). One supplement has a serving size of two, the other a serving size of one.

### Example 2

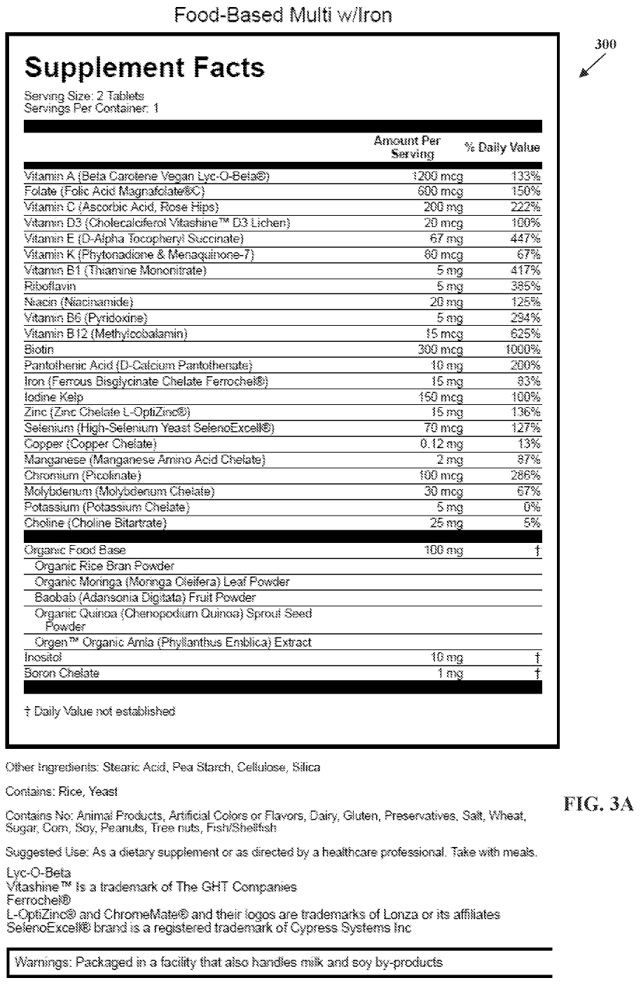

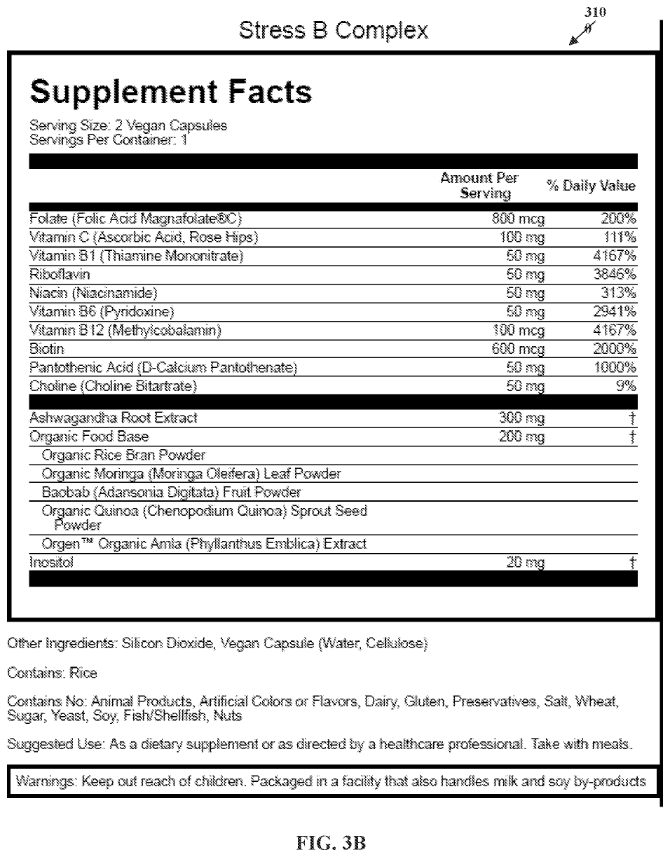

The food-based multi-iron fact panel 300 and the stress B complex fact panel 310 as in example 1, except both products have a serving size of 2, as shown in FIGS. 3A-3B.

### Example 3

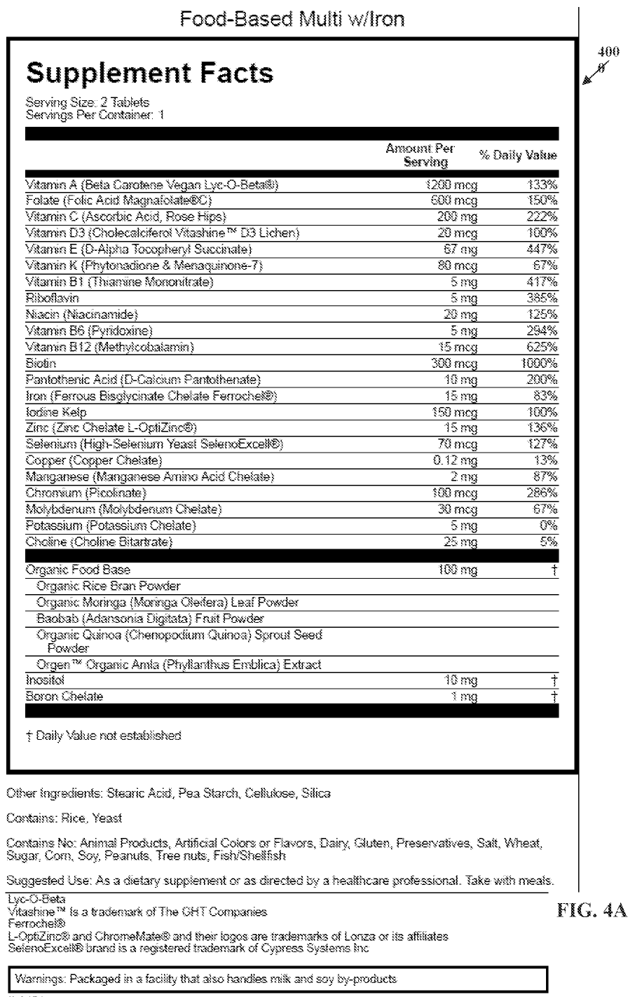

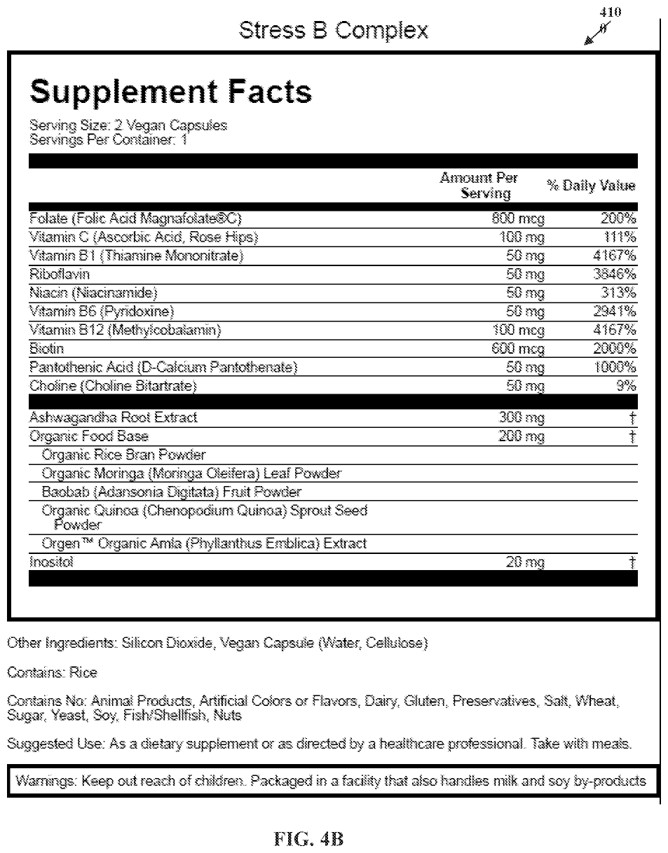

The supplements the food-based multi-iron fact panel 400 and the stress B complex fact panel 410, as examples 1 and 2, is shown in FIGS. 4A-4B. This is a “consolidated” version of the sfp where all ingredients for all supplements included in a single pack are combined into a single fact panel.

System

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Software includes applications and algorithms. Software may be implemented in a smart phone, tablet, or personal computer, in the cloud, on a wearable device, or other computing or processing device. Software may include logs, journals, tables, games, recordings, communications, SMS messages, Web sites, charts, interactive tools, social networks, VOIP (Voice Over Internet Protocol), e-mails, and videos.

In some embodiments, some or all of the functions or process(es) described herein and performed by a computer program that is formed from computer readable program code and that is embodied in a computer readable medium. The phrase “computer readable program code” includes any type of computer code, including source code, object code, executable code, firmware, software, etc. The phrase “computer readable medium” includes any type of medium capable of being accessed by a computer, such as read only memory (ROM), random access memory (RAM), a hard disk drive, a compact disc (CD), a digital video disc (DVD), or any other type of memory.

All publications and patent applications mentioned in this specification are herein incorporated by reference to the same extent as if each individual publication or patent application was specifically and individually indicated to be incorporated by reference.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. A method of producing state and federally mandated nutritional information label information, comprising:
preparing personalized packaged food or medicinal products intended for consumption by a single, named individual;
accepting as input any combination of ingredients and serving sizes for dietary supplements; and
outputting an FDA compliant supplement fact panel as either individual fact panels or a combined pack-based fact panel.

2. The method of claim 1, further comprising varying the serving size for each ingredient, and varying the amount of any ingredient per serving; and outputting the percent of daily allowance on the fact panel.

3. The method of claim 2, further comprising adjusting fact panel to different serving sizes and, the amounts per serving based on the recommended daily allowances based by the FDA, or creating a SFP in different compliant formats based on a packaging size.

4. The method of claim 3, further comprising operating an Application Program Interface (API), a desktop computer, a stand-alone web page, or a kiosk at a store.

5. A system of producing state and federally mandated nutritional information label information, comprising:
Providing the following Attributes:
a. Input any ingredient or combination thereof;
b. Input any product for which ingredient information is available;
c. Input of any combination of products for which ingredient information is available;
d. Input barcode scans on the manufacturing floor to print all required information;
e. Output compliant nutritional labels or “fact panels” and applicable warnings based on the inputs;
f. Output separated or combined pack-based labels;
g. Output information to any printing press or label printer;
h. Validate individual ingredients against state or federally mandated amounts; and
i. Calculate ingredient amounts and percent daily values based on individualized or variable serving sizes.

6. A system of producing state and federally mandated nutritional information label information, comprising:
a. an internally orchestrated software component of a comprehensive order processing system for personalized nutrition products;
b. an Application Programming Interface endpoint that outputs Documents, images and/or data for a supplement fact panel;
c. operates through an API endpoint enabling process automation;
d. accepts serving size as a variable, floating point number parameter instead of a predefined integer;
e. outputs an FDA Supplement Fact Panel;
f. outputs an FDA Nutrition Fact Panel;
g. operates through an API endpoint enabling process automation and orchestration;
h. developed a REST API endpoint that accesses the fact panel generation software, API endpoint is incorporated into an automated order validation and processing system; and
i. accepts a floating point or integer for serving size.

7. The system of claim 6, further comprising providing both whole and fractional serving sizes creates the ability to tailor nutrition to an individual based on a body measurement such as weight, body mass index, blood sugar concentrations, or combinations thereof.
